(19) United States
(12) Patent Application Publication
(10) Pub. No.: US 2020/0008426 A1
(43) Pub. Date: Jan. 9, 2020

(54) ACTIVE COMPOUND COMBINATIONS

(71) Applicants: BAYER AKTIENGESELLSCHAFT, Leverkusen (DE); BAYER CROPSCIENCE AKTIENGESELLSCHAFT, Monheim am Rhein (DE)

(72) Inventors: Andreas GOERTZ, Dormagen (DE); Ruth MEISSNER, Leverkusen (DE); Peter DAHMEN, Neuss (DE); Virginie Pascale DUCROT, Burscheid (DE); Pierre-Yves COQUERON, Lyon (DE); Ricarda MILLER, Duesseldorf (DE)

(21) Appl. No.: 16/484,739

(22) PCT Filed: Jan. 26, 2018
(86) PCT No.: PCT/EP2018/051932

§ 371 Date: Aug. 8, 2019

(30) Foreign Application Priority Data
Feb. 10, 2017 (EP) 17155515.4

(51) Int. Cl. A01N 43/653; A01N 25/34

(52) U.S. Cl. CPC A01N 43/653; A01N 25/34

(57) ABSTRACT

The present invention relates to active compound combinations comprising at least one triazole derivative of formula (I)

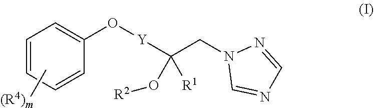

as defined in claim 1 as well as at least one further fungicide, to compositions comprising such compound combination, and to the use thereof as biologically active agents, especially for control of harmful microorganisms in crop protection and in the protection of materials and as plant growth regulators.

The present invention relates to active compound combinations, in particular within a fungicide composition, which comprises (A) a triazole derivative of formula (I) and a further fungicidally active compound (B). Moreover, the invention relates to compositions comprising such compound combination and to the use thereof as biologically active combinations, especially for control of harmful microorganisms in crop protection and in the protection of materials and as plant growth regulators.

It is already known that particular phenoxy-phenyl-substituted triazole derivatives can be used in crop protection as fungicides (e.g. EP-A 0 275 955; J. Agric. Food Chem. 2009, 57, 4854-4860; CN-A 101225074, DE-A 40 03 180; EP-A 0 113 640; EP-A 0 470 466; U.S. Pat. No. 4,949,720; EP-A 0 126 430, DE-A 38 01 233; WO-A 2013/007767; WO-A 2013/010862; WO-A 2013/010885; WO-A 2013/010894; WO-A 2013/024075; WO-A 2013/024076; WO-A 2013/024077; WO-A 2013/024080 WO-A 2013/024081; WO-A 2013/024082; WO-A 2013/024083 and WO-A 2014/082872). It is also known that particular phenoxy-phenyl-substituted triazolinethione derivatives (e.g. WO-A 2010/146114) and particular phenoxy-hetaryl-substituted triazolinethione derivatives (e.g. WO-A 2010/146116) can be used in crop protection as fungicides. Novel phenoxy-hetaryl-substituted triazole derivatives of formula (I) have been developed and are subject of WO-A 2017/029179.

Since the environmental and economic requirements imposed on modern-day crop protection agents and compositions are continually increasing, with regard, for example, to the spectrum of action, toxicity, selectivity, application rate, formation of residues, and favourable preparation ability, and since, furthermore, there may be problems, for example, with resistances, a constant task is to develop new compositions, in particular fungicidal agents, which in some areas at least help to fulfil the abovementioned requirements. The present invention provides active compound combinations and compositions comprising said combinations which in some aspects at least achieve the stated objective.

Accordingly, the present invention provides active compound combinations comprising
(A) at least one triazole derivative of formula (I)

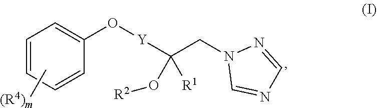

wherein
R¹ represents hydrogen. C₁-C₆-alkyl, C₂-C₆-alkenyl, C₂-C₆-alkynyl, C₃-C₈-cycloalkyl, C₃-C₈-cycloalkyl-C₁-C₄-alkyl, phenyl, phenyl-C₁-C₄-alkyl, phenyl-C₂-C₄-alkenyl or phenyl-C₂-C₄-alkynyl;
R² represents hydrogen. C₁-C₆-alkyl, C₂-C₆-alkenyl, C₂-C₆-alkynyl. C₃-C₈-cycloalkyl, C₃-C₈-cycloalkyl-C₁-C₄-alkyl, phenyl, phenyl-C₁-C₄-alkyl, phenyl-C₂-C₄-alkenyl or phenyl-C₂-C₄-alkynyl,
   wherein the aliphatic moieties, excluding cycloalkyl moieties, of R¹ and/or R² may carry 1, 2, 3 or up to the maximum possible number of identical or different groups R¹ which independently of one another are selected from halogen, CN, nitro, phenyl, C₁-C₄-alkoxy and C₁-C₄-halogenalkoxy, wherein the phenyl may be substituted by 1, 2, 3, 4 or 5 substituents selected independently of one another from halogen, CN, nitro, C₁-C₄-alkyl, C₁-C₄-alkoxy, C₁-C₄-halogenalkyl, C₁-C₄-halogenalkoxy.
   and wherein the cycloalkyl and/or phenyl moieties of R¹ and/or R² may carry 1, 2, 3, 4, 5 or up to the maximum number of identical or different groups R^{b} which independently of one another are selected from halogen, CN, nitro, C₁-C₄-alkyl, C₁-C₄-alkoxy, C₁-C₄-halogenalkyl and C₁-C₄-halogenalkoxy:
each R⁴ represents independently of one another halogen, CN, nitro, C₁-C₄-alkyl, C₁-C₄-halogenalkyl, C₁-C₄-alkoxy, C₁-C₄-halogenalkoxy, C₁-C₄-alkylcarbonyl, hydroxy-substituted C₁-C₄-alkyl or pentafluoro-λ⁶-sulfanyl; preferably halogen, CN, nitro, C₁-C₄-alkyl, C₁-C₄-halogenalkyl, C₁-C₄-alkoxy, C₁-C₄-halogenalkoxy or pentafluoro-λ⁶-sulfanyl;
m is an integer and is 0, 1, 2, 3, 4 or 5:
Y represents a 6-membered aromatic heterocycle containing 1 or 2 nitrogen atom(s) as heteroatom(s) selected from

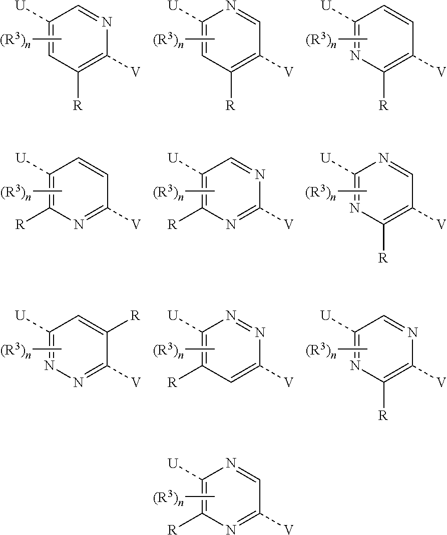

wherein Y is connected to the O of formula (I) via the bonds identified with “U” and Y is connected to the CR¹(OR²) moiety of formula (I) via the bonds identified with “V” and
wherein
R represents hydrogen. C₁-C₂-halogenalkyl, C₁-C₂-halogenalkoxy, C₁-C₂-alkylcarbonyl or halogen; preferably hydrogen. C₁-C₂-halogenalkyl or halogen;
each R³ represents independently of one another halogen, CN, nitro, C₁-C₄-alkyl, C₁-C₄-halogenalkyl, C₁-C₄-alkoxy or C₁-C₄-halogenalkoxy;
n is an integer and is 0, 1 or 2:
   or a salt or N-oxide thereof,
   and
(B) at least one further active compound selected from the following groups
   (1) inhibitors of the ergosterol synthesis,
   (2) inhibitors of the respiratory chain at complex I or II,
   (3) inhibitors of the respiratory chain at complex I,
   (4) inhibitors of the mitosis and cell division.
   (5) compounds capable of having a multisite action.
   (6) compounds capable of inducing a host defense,
   (7) inhibitors of the amino acid and/or protein biosynthesis,
   (8) inhibitors of the ATP production.
   (9) inhibitors of the cell wall synthesis,
   (10) inhibitors of the lipid and membrane synthesis,
   (11) inhibitors of the melanine biosynthesis,
   (12) inhibitors of the nucleic acid synthesis,
   (13) inhibitors of the signal transduction,
   (14) compounds capable of acting as uncoupler,
   (15) other fungicides.

The active compound combinations according to the invention comprise (A) at least one triazole derivative of formula (I) or a salt or N-oxide thereof. The salts or N-oxides of the triazole derivatives of formula (I) also have fungicidal properties.

The formula (I) provides a general definition of the triazole derivatives present in compound combinations according to the invention. Preferred radical definitions for the formulae shown above and below are given below. These definitions apply to the end products of the formula (I) and likewise to all intermediates.
R¹ preferably represents hydrogen. C₁-C₄-alkyl, C₂-C₆-alkenyl, C₂-C₆-alkynyl, cyclopropyl, phenyl, benzyl, phenylethenyl or phenylethinyl,
   wherein the aliphatic moieties, excluding the cycloalkyl moieties, of R¹ may carry 1, 2, 3 or up to the maximum possible number of identical or different groups R^{a} which independently of one another are selected from halogen, CN, nitro, phenyl, C₁-C₄-alkoxy and C₁-C₄-halogenalkoxy, wherein the phenyl may be substituted by 1, 2, 3, 4 or 5 substituents selected independently of one another from halogen, CN, nitro, C₁-C₄-alkyl, C₁-C₄-alkoxy, C₁-C₄-halogenalkyl, C₁-C₄-halogenalkoxy;
   wherein the cycloalkyl and/or phenyl moieties of R¹ may carry 1, 2, 3, 4, 5 or up to the maximum number of identical or different groups R^{b} which independently of one another are selected from halogen, CN, nitro, C₁-C₄-alkyl, C₁-C₄-alkoxy, C₁-C₄-halogenalkyl and C₁-C₄-halogenalkoxy.
R¹ more preferably represents hydrogen, methyl, ethyl, propyl, isopropyl, butyl, cyclopropyl, CF₃, allyl, CH₂C≡C—CH₃ or CH₂C≡H,
   wherein the aliphatic moieties, excluding the cycloalkyl moieties, of R¹ may carry 1, 2, 3 or up to the maximum possible number of identical or different groups R^{a} which independently of one another are selected from halogen, CN, nitro, phenyl. C₁-C₄-alkoxy and C₁-C₄-halogenalkoxy, wherein the phenyl may be substituted by 1, 2, 3, 4 or 5 substituents selected independently of one another from halogen; CN; nitro; C₁-C₄-alkyl; C₁-C₄-alkoxy; C₁-C₄-halogenalkyl; C₁-C₄-halogenalkoxy.
R¹ more preferably represents hydrogen or non-substituted methyl ethyl, propyl, isopropyl, butyl, cyclopropyl, CF₃, allyl, CH₂C—C—CH₃ or CH₂C—CH.
R¹ more preferably represents hydrogen, methyl, ethyl or cyclopropyl,
R¹ even more preferably represents methyl or cyclopropyl,
R¹ most preferably represents methyl.
R² preferably represents hydrogen, C₁-C₄-alkyl, allyl, propargyl or benzyl,
   wherein the aliphatic moieties, excluding the cycloalkyl moieties, of R² may carry 1, 2, 3 or up to the maximum possible number of identical or different groups R¹ which independently of one another are selected from halogen, CN, nitro, phenyl C₁-C₄-alkoxy and C₁-C₄-halogenalkoxy, wherein the phenyl may be substituted by 1, 2, 3, 4 or 5 substituents selected independently of one another from halogen, CN, nitro, C₁-C₄-alkyl, C₁-C₄-alkoxy, C₁-C₄-halogenalkyl, C₁-C₄-halogenalkoxy;
   wherein the cycloalkyl and/or phenyl moieties of R² may carry 1, 2, 3, 4, 5 or up to the maximum number of identical or different groups R^{b} which independently of one another are selected from halogen, CN, nitro, C₁-C₄-alkyl, C₁-C₄-alkoxy, C₁-C₄-halogenalkyl and C₁-C₄-halogenalkoxy.
R² more preferably represents hydrogen, methyl ethyl isopropyl or allyl,
   wherein the aliphatic moieties, excluding the cycloalkyl moieties, of R² may carry 1, 2, 3 or up to the maximum possible number of identical or different groups R¹ which independently of one another are selected from halogen, CN, nitro, phenyl C₁-C₄-alkoxy and C₁-C₄-halogenalkoxy, wherein the phenyl may be substituted by 1, 2, 3, 4 or 5 substituents selected independently of one another from halogen, CN, nitro, C₁-C₄-alkyl, C₁-C₄-alkoxy, C₁-C₄-halogenalkyl, C₁-C₄-halogenalkoxy.
R² more preferably represents hydrogen or non-substituted methyl, ethyl, isopropyl or allyl.
R² more preferably represents hydrogen or methyl.
R² most preferably represents hydrogen.

Each R⁴ preferably represents independently from each other CF₃, OCF₃, Br, Cl or pentafluoro-λ⁶-sulfanyl.
R⁴ more preferably represents CF₃, OCF₃, Br, Cl or pentafluoro-λ⁶-sulfanyl in the 4-position of the phenyl moiety of formula (I).
R⁴ even more preferably represents Cl or Br, most preferably Cl or Br in the 4-position of the phenyl moiety of formula (I).
m preferably is 1, 2 or 3.
m more preferably is 1 or 2.
m most preferably is 1.
Y preferably represents

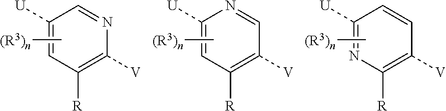

wherein
R, R³ and n are defined as mentioned above for formula (I).
R preferably represents hydrogen, C₁-halogenalkyl, F or Cl.
R more preferably represents C₁-halogenalkyl, F or Cl.
R more preferably represents CF₃ or Cl.
R most preferably represents CF₃.
n preferably is 0.

The radical definitions and explanations given above in general terms or stated within preferred ranges can, however, also be combined with one another as desired, i.e. including between the particular ranges and preferred ranges. They apply both to the end products and correspondingly to precursors and intermediates. In addition, individual definitions may not apply.

Preference is given to presence of those compounds of formula (I) in which each of the radicals have the abovementioned preferred definitions.

Particular preference is given to presence of those compounds of formula (I) in which each of the radicals have the abovementioned more and/or most preferred definitions.

In preferred embodiments of the present invention compounds of formula (I) are present, wherein
R¹ represents hydrogen, C₁-C₄-alkyl, or cyclopropyl;
R² represents hydrogen;
R⁴ represents CF₃, OCF₃, Br, Cl or pentafluoro-λ⁶-sulfanyl;
m is 1;
Y represents

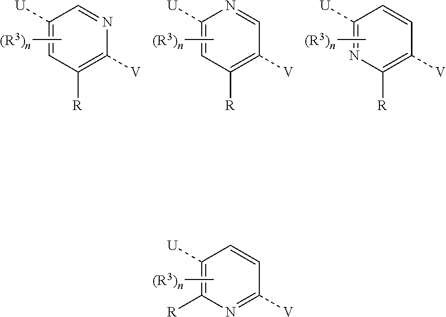

wherein Y is connected to the O of formula (I) via the bonds identified with “U” and Y is connected to the CR¹(OR²) moiety of formula (I) via the bonds identified with “V” and
R represents C₁-halogenalkyl; and
n is 0.

In more preferred embodiments of the present invention compounds of formula (I) are present, wherein
R¹ represents methyl or cyclopropyl;
R² represents hydrogen;
R⁴ represents Cl or Br in the 4-position of the phenyl moiety of formula (I);
m is 1;
Y represents

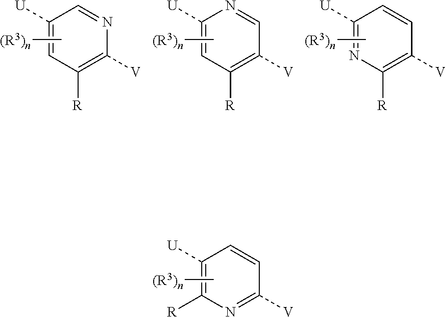

wherein Y is connected to the O of formula (I) via the bonds identified with “U” and Y is connected to the CR¹(OR²) moiety of formula (I) via the bonds identified with “V” and
R represents CF₃; and
n is 0.

More preferred compound combinations according to the invention comprise (A) a compound of formula (I) selected from the group consisting of (I.01) 2-[6-(4-chlorophenoxy)-2-(trifluoromethyl)pyridin-3-yl]-1-(1H-1,2,4-triazol-1-yl)propan-2-ol, (I.59) 2-[6-(4-bromophenoxy)-2-(trifluoromethyl)pyridin-3-yl]-1-(1H-1,2,4-triazol-1-yl)propan-2-ol, (I.81) 1-[6-(4-bromophenoxy)-2-(trifluoromethyl)pyridin-3-yl]-1-cyclopropyl-2-(1H-1,2,4-triazol-1-yl)ethanol and (I.91) 1-[6-(4-chlorophenoxy)-2-(trifluoromethyl)pyridin-3-yl]-1-cyclopropyl-2-(1H-1,2,4-triazol-1-yl)ethanol.

Even more preferred compound combinations according to the invention comprise (A) as compound of formula (I) (I.01) 2-[6-(4-chlorophenoxy)-2-(trifluromethyl)pyridin-3-yl]-1-(H-1,2,4-triazol-1-yl)propan-2-ol and/or (I.59) 2-[6-(4-bromophenoxy)-2-(trifluoromethyl)pyridin-3-yl]-1-(1H-1,2,4-triazol-1-yl)propan-2-ol

In the definitions of the symbols given in the above formulae, collective terms were used which are generally representative of the following substituents:

The definition C₁-C₆-alkyl comprises the largest range defined here for an alkyl radical. Specifically, this definition comprises the meanings methyl, ethyl, n-, isopropyl, n-, iso-, sec-, tert-butyl, and also in each case all isomeric pentyls and hexyls, such as methyl, ethyl propyl, 1-methylethyl, butyl, 1-methylpropyl, 2-methylpropyl, 1,1-dimethyletethyl, n-pentyl, 1-methylbutyl, 2-methylbutyl, 3-methylbutyl, 1,2-dimethylpropyl, 1,1-dimethylpropyl 2,2-dimthylpropyl, 1-ethylpropyl, n-hexyl, 1-methylpentyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-3-methylpropyl, in particular propyl, 1-methylethyl, butyl 1-methylbutyl, 2-methylbutyl, 3-methylbutyl, 1,1-dimethylethyl, 1,2-dimethylbutyl, 1,3-dimethylbutyl, n-pentyl, 1-methylbutyl, 1-ethylpropyl, hexyl, 3-methylpentyl. A preferred range is C₁-C₄-alkyl, such as methyl ethyl, n-, isopropyl, n-, iso-, sec-, tert-butyl. The definition C₁-C₂-alkyl comprises methyl and ethyl.

The definition halogen comprises fluorine, chlorine, bromine and iodine. Halogen-substitution is generally indicated by the prefix halo, halogen or halogeno.

Halogen-substituted alkyl—e.g. referred to as halogenalkyl, halogenoalkyl or haloalkyl, e.g. C₁-C₄-halogenalkyl or C₁-C₂-halogenalkyl—represents, for example, C₁-C₄-alkyl or C₁-C₂-alkyl as defined above substituted by one or more halogen substituents which can be the same or different. Preferably C₁-C₄-halogenalkyl represents chloromethyl, dichloromethyl, trichloromethyl, fluoromethyl, difluoromethyl, trifluoromethyl, chlorofluoromethyl, dichlorofluoromethyl, chlorodifluoromethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, 1,1-difluoroethyl, pentafluoroethyl, 1-fluoro-1-methylethyl, 2-fluoro-1,1-dimethylethyl, 2-fluoro-1-fluoromethyl-1-methylethyl, 2-fluoro-1,1-di(fluoromethyl)-ethyl, 1-chlorobutyl, Preferably C₁-C₂-halogenalkyl represents chloromethyl, dichloromethyl, trichloromethyl, fluoromethyl, difluoromethyl, trifluoromethyl, chlorofluoromethyl, dichlorofluoromethyl, chlorodifluoromethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, 1,1-difluoroethyl, pentafluoroethyl.

Mono- or multiple fluorinated C₁-C₆-alkyl represents, for example, C₁-C₆-alkyl as defined above substituted by one or more fluorine substituent(s). Preferably mono- or multiple fluorinated C₁-C₄-alkyl represents fluoromethyl, difluoromethyl, trifluoromethyl, 1-fluoroethyl, 2-fluoroethyl, 2,2-difluoroethyl, 2,2,2-trifluoroethyl, pentafluoroethyl, 1-fluoro-1-methylethyl, 2-fluoro-1,1-dimethylethyl, 2-fluoro-1-fluoromethyl-1-methylethyl, 2-fluoro-1,1-di(fluoromethyl)-ethyl, 1-methyl-3-trifluoromethylbutyl, 3-methyl-1-trifluoromethylbutyl. The definition C₂-C₆-alkenyl comprises the largest range defined here for an alkenyl radical. Specifically, this definition comprises the meanings ethenyl, n-, isopropenyl, n-, iso-, sec-, tert-butenyl, and also in each case all isomeric pentenyls, hexenyls, 1-methyl-1-propenyl, 1-ethyl-1-butenyl. Halogen-substituted alkenyl—e.g. referred to as C₂-C₆-haloalkenyl—represents, for example, C₂-C₆-alkenyl as defined above substituted by one or more halogen substituents which can be the same or different.

The definition C₂-C₆-alkynyl comprises the largest range defined here for an alkynyl radical. Specifically, this definition comprises the meanings ethynyl, n-, isopropynyl, n-, iso-, sec-, tert-butynyl, and also in each case all isomeric pentynyls, hexynyls. Halogen-substituted alkynyl—e.g. referred to as C₂-C₆-haloalkynyl—represents, for example, C₂-C₆-alkynyl as defined above substituted by one or more halogen substituents which can be the same or different.

The definition C₃-C₈-cycloalkyl comprises monocyclic saturated hydrocarbyl groups having 3 to 8 carbon ring members, such as cyclopropyl, cyclobutyl, cyclopentyl, cyclohexyl, cycloheptyl and cyclooctyl.

The definition halogen-substituted cycloalkyl, halogenocycloalkyl, halocycloalkyl and halogencycloalkyl comprises monocyclic saturated hydrocarbyl groups having 3 to 8 carbon ring members, such as 1-fluoro-cyclopropyl and 1-chloro-cyclopropyl.

The definition aryl comprises aromatic, mono-, bi- or tricyclic rings, for example phenyl, naphthyl, anthracenyl (anthryl), phenanthracenyl (phenanthryl).

Optionally substituted radicals may be mono- or polysubstituted, where in the case of polysubstitution, the substituents may be identical or different.

Unless indicated otherwise, a group or a substituent which is substituted according to the invention preferably can be substituted by one or more group(s) selected from the list consisting of halogen; SH; nitro; hydroxyl; cyano; amino; sulfanyl; pentafluoro-λ⁶-sulfanyl; formyl; formyloxy; formylamino; carbamoyl; N-hydroxycarbamoyl; carbamate; (hydroxyimino)-C₁-C₆-alkyl; C₁-C₈-alkyl; C₁-C₈-halogenalkyl; C₁-C₈-alkyloxy; C₁-C₈-halogenalkyloxy; C₁-C₈-alkylthio; C₁-C₈-halogenalkylthio; tri(C₁-C₈-alkyl)silyl; tri(C₁-C₈-alkyl)silyl-C₁-C₈-alkyl; C₃-C₇-cycloalkyl; C₃-C₇-halocycloalkyl; C₃-C₇-cycloalkenyl; C₃-C₇-halocycloalkenyl; C₄-C₁₀-cycloalkylalkyl; C₄-C₁₀-halocycloalkylalkyl; C₆-C₁₂-cycloalkylcycloalkyl; tri(C₁-C₈-alkyl)silyl-C₃-C₇-cycloalkyl; C₂-C₈-alkenyl; C₂-C₈-alkynyl; C₂-C₈-alkenyloxy; C₂-C₈-halogenalkenyloxy; C₂-C₈-alkynyloxy; C₁-C₈-alkylamino; di-C₁-C₈-alkylamino; C₁-C₈-halogenalkylamino; di-C₁-C₈-halogenalkylamino; C₁-C₈-alkylaminoalkyl; di-C₁-C₈-alkylaminoalkyl; C₁-C₈-alkoxy; C₁-C₈-halogenoalkoxy; C₁-C₈-cyanoalkoxy; C₄-C₈-cycloalkylalkoxy; C₃-C₆-cycloalkoxy; C₂-C₈-alkoxyalkoxy; C₁-C₈-alkylcarbonylalkoxy; C₁-C₈-alkylsulfanyl; C₁-C₈-halogenoalkylsulfanyl; C₂-C₈-alkenyloxy; C₂-C₈-halogenoalkenyloxy; C₃-C₈-alkynyloxy; C₃-C₈-halogenoalkynyloxy; C₁-C₈-alkylcarbonyl; C₁-C₈-halogenoalkylcarbonyl; C₃-C₈-cycloalkylcarbonyl; C₃-C₈-halogenocycloalkylcarbonyl; C₁-C₈-alkylcarbamoyl; di-C₁-C₈-alkylcarbamoyl; N—C₁-C₈-alkyloxycarbamoyl; C₁-C₈-alkoxycarbamoyl; N—C₁-C₈-alkyl-C₁-C₈-alkoxycarbamoyl; C₁-C₈-alkoxycarbonyl; C₁-C₈-halogenoalkoxycarbonyl; C₃-C₈-cycloalkoxycarbonyl; C₂-C₈-alkoxyalkycarbonyl; C₂-C₈-halogenoalkoxyalkylcarbonyl; C₃-C₁₀-cycloalkoxyalkylcarbonyl; C₁-C₈-alkylaminocarbonyl; di-C₁-C₈-alkylaminocarbonyl; C₃-C₈-cycloalkylaminocarbonyl; C₁-C₈-alkylcarbonyloxy; C₁-C₈-halogenoalkylcarbonyloxy; C₃-C₈-cycloalkylcarbonyloxy; C₁-C₈-alkylcarbonylamino; C₁-C₈-halogenoalkylcarbonylamino; C₁-C₈-alkylaminocarbonyloxy; di-C₁-C₈-alkylaminocarbonyloxy; C₁-C₈-alkyloxycarbonyloxy; C₁-C₈-alkylsulfinyl; C₁-C₈-halogenoalkylsulfinyl; C₁-C₈-alkylsulfonyl; C₁-C₈-halogenoalkylsulfonyl; C₁-C₈-alkylaminosulfamoyl; di-C₁-C₈-alkylaminosulfamoyl; (C₁-C₈-alkoxyimino)-C₁-C₈-alkyl; (C₃-C₇-cycloalkoxyimino)-C₁-C₈-alkyl; hydroxyimino-C₁-C₈-alkyl; (C₁-C₈-alkoxyimino)-C₃-C₇-cycloalkyl; hydroxyimino-C₃-C₇-cycloalkyl; (C₁-C₈-alkylimino)-oxy; (C₁-C₈-alkylimino)-oxy-C₁-C₈-alkyl; (C₃-C₇-cycloalkylimino)-oxy-C₁-C₈-alkyl; (C₁-C₅-alkylimino)-oxy-C₃-C₇-cycloalkyl; (C₁-C₈-alkenyloxyimino)-C₁-C₈-alkyl; (C₁-C₈-alkynyloxyimino)-C₁-C₈-alkyl; 2-oxopyrrolidin-1-yl, (benzyloxyimino)-C₁-C₈-alkyl; C₁-C₈-alkoxyalkyl; C₁-C₈-alkylthioalkyl; C₁-C₈-alkoxyalkoxyalkyl; C₁-C₈-halogenoalkoxyalkyl; benzyl; phenyl; 5-membered heteroaryl; 6-membered heteroaryl; benzyloxy; phenyloxy; benzylsulfanyl; benzylamino; phenoxy; phenylsulfanyl; or phenylamino; wherein the benzyl, phenyl 5-membered heteroaryl, 6-membered heteroaryl 7-membered heteroaryl, benzyloxy or phenyloxy may be optionally substituted by one or more group(s) selected from the aforementioned list.

As not otherwise indicated—the definition 5-, 6- or 7-membered hetaryl or heteroaryl comprises unsaturated heterocyclic 5- to 7-membered ring containing up to 4 heteroatoms selected from N, O and S: for example 2-furyl, 3-furyl, 2-thienyl, 3-thienyl, 2-pyrrolyl, 3-pyrrolyl, 1-pyrrolyl, 3-pyrazolyl, 4-pyrazolyl, 5-pyrazolyl, 1-pyrazolyl, 1H-imidazol-2-yl, 1H-imidazol-4-yl, 1H-imidazol-5-yl, 1H-imidazol-1-yl, 2-oxazolyl, 4-oxazolyl, 5-oxazolyl, 2-thiazolyl, 4-thiazolyl, 5-thiazolyl, 3-isoxazolyl, 4-isoxazolyl, 5-isoxazolyl, 3-isothiazolyl, 4-isothiazolyl, 5-isothiazolyl, 1H-1,2,3-triazol-1-yl, 1H-1,23-triazol-4-yl, 1H-1,23-triazol-5-yl, 2H-1,2,3-triazol-2-yl, 2H-1,23-triazol-4-yl, 1H-1,2,4-triazol-3-yl, 1H-1,2,4-triazol-5-yl, 1H-1,2,4-triazol-1-yl, 4H-1,2,4-triazol-3-yl, 4H-1,2,4-triazol-4-yl, 1H-tetrazol-1-yl, 1H-tetrazol-5-yl, 2H-tetrazol-2-yl, 2H-tetrazol-5-yl, 1,2,4-oxadiazol-3-yl, 1,2,4-oxadiazol-5-yl, 1,2,4-thiadiazol-3-yl, 1,2,4-thiadiazol-5-yl, 1,3,4-oxadiazol-2-yl, 1,3,4-thiadiazol-2-yl, 1,2,3-oxadiazol-4-yl, 1,23-oxadiazol-5-yl, 1,2,3-thiadiazol-4-yl 1,23-thiadiazol-5-yl, 1,2,5-oxadiazol-3-yl, 1,2,5-thiadiazol-3-yl, 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,3,5-triazin-2-yl, 1,2,4-triazin-3-yl, 1,2,4-triazin-5-yl, 1,2,4-triazin-6-yl.

Depending on the nature of the substituents, the compounds of formula (I) can be present as mixtures of different possible isomeric forms, in particular of stereoisomers, such as, for example, E and Z, threo and erythro, and also optical isomers, and, if appropriate, also of tautomers. If applicable, compounds of formula (I) comprise both the E and the Z isomers, and also the threo and erythro, and the optical isomers, any mixtures of these isomers, and the possible tautomeric forms.

Depending on the nature of the substituents, the compounds of formula (I) can exist in one or more optical or chiral isomer forms depending on the number of asymmetric centres in the compound. The invention thus relates equally to combinations comprising any of the optical isomers and their racemic or scalemic mixtures (the term “scalemic” denotes a mixture of enantiomers in different proportions) and mixtures of all the possible stereoisomers, in all proportions. The diastereoisomers and/or the optical isomers can be separated according to the methods which are known per se by the man ordinary skilled in the art.

Depending on the nature of the substituents, the compounds of formula (I) can also exist in one or more geometric isomer forms depending on the number of double bonds in the compound. The invention thus relates equally to all geometric isomers and to all possible mixtures, in all proportions. The geometric isomers can be separated according to general methods, which are known per se by the man ordinary skilled in the art.

Depending on the nature of the substituents, the compounds of formula (I) can also exist in one or more geometric isomer forms depending on the relative position (syn/anti or cis/trans) of the substituents of a ring. The invention thus relates equally to all syn/anti (or cis/trans) isomers and to all possible syn/anti (or cis/trans) mixtures, in all proportions. The syn/anti (or cis/trans) isomers can be separated according to general methods, which are known per se by the man ordinary skilled in the art.

### Illustration of Synthesis of Compounds of Formula (I) and Intermediates

The compounds of formula (I) can be obtained by various routes in analogy to prior art processes known (see e.g. J. Agric. Food Chem. (2009) 57, 4854-4860 EP-A 0 275 955; DE-A 40 03 180, EP-A 0 113 640; EP-A 0 126 430; WO-A 2013/007767 and references therein) and by synthesis routes shown schematically below and in the experimental part of this application. Unless indicated otherwise, the radicals Y, R, R¹, R², R³, R⁴, m and n have the meanings given above for the compounds of formula (I). These definitions apply not only to the end products of the formula (I) but likewise to all intermediates.

If individual compounds (I) cannot be obtained by those routes, they can be prepared by derivatization of other compounds (I).

Only for better understanding of the following Schemes the alcohols of formula (I) have been named as alcohols (I-H), although such alcohols (I-H) are encompassed by general formula (I) as defined above.

Process A (Scheme 1):

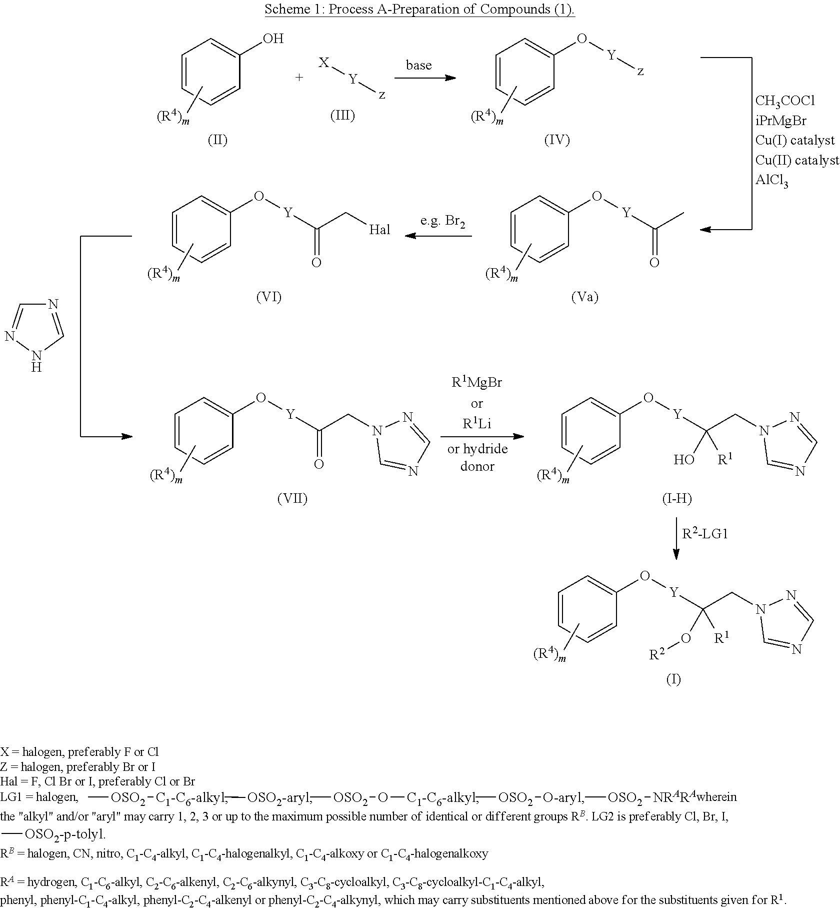

The compounds (II) and (III) (Scheme 1) can be converted by means of methods described in the literature to the corresponding compounds (IV) and subsequently to compounds (Va), (VI), (VII), (I-H) and (I) (see WO-A 2013/07767). Phenols (II) are reacted with aryls (III), wherein X stands for F or Cl and Z stands for Br or I, Z is in particular Br and the reaction is optionally performed in the presence of a base to obtain compounds (IV). These intermediates, in particular with Z being Br, are then transformed into Grignard reagents by the reaction with magnesium or by transmetallation reactions with reagents such as isopropylmagnesium halides and subsequently reacted with acetyl chloride to yield acetophenones (Va). Those reactions are preferably performed under anhydrous conditions and in the presence of a catalyst such as CuCl, CuCl₂, AlCl₃, LiCl and mixtures thereof. Compounds (Va) can be halogenated in a next step, for instance with Cl₂ or Br₂ in order to obtain α-haloketones (VI). The reactions are preferably carried out in an organic solvent such as diethyl ether, methyl tert.-butyl ether, methanol or acetic acid. The halogen in α-position, preferably Cl or Br, can be subsequently replaced by a 1,2,4-triazole. Preferably, this transformation is being conducted in the presence of a base, such as Na₂CO₃, K₂CO₃, Cs₂CO₃, NaOH, KOtBu. NaH or mixtures thereof, preferably in the presence of an organic solvent, such as tetrahydrofuran, dimethylformamide or toluene. Ketones (VII) are subsequently reacted with nucleophilic substrates, such as Grignard reagents R¹MgBr or organolithium compounds R¹Li or a hydride donor such as sodium borohydride to obtain alcohols (I-H). These transformations are preferably conducted under anhydrous conditions, optionally in the presence of a Lewis acid such as LaCl₃x2LiCl or MgBr₂xOEt₂. After further derivatization of alcohol (I-H) with an alkylating agent R²-LG compounds of the general formula (I) can be obtained. LG is a replaceable group such as halogen, alkylsulfonyl, alkylsulfonyloxy and arylsulfonyloxy, preferably Br, I and methylsulfonyloxy. These derivatizations are optionally performed in the presence of a base such as NaH and in the presence of an organic solvent such as tetrahydrofuran.

Process B (Scheme 2):

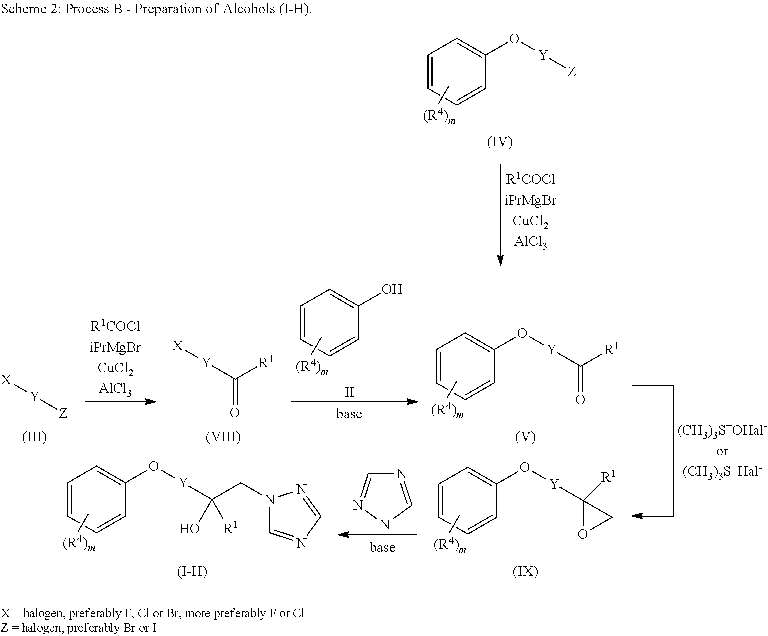

Compounds of the general structure (III), in particular with Z being Br, are being transformed into Grignard reagents by the reaction with magnesium or by transmetallation reactions with reagents such as isopropylmagnesium halides and subsequently reacted with acyl chlorides to yield ketones (VIII). Those reactions are preferably performed under anhydrous conditions and in the presence of a catalyst such as CuCl₂, AlCl₃, LiCl and mixtures thereof. Ketones (VIII) are subsequently reacted with Phenols (II), optionally in the presence of a base such as K₂CO₃ or Cs₂CO₃ and a solvent such as DMF (dimethylformamide), to obtain compounds (V). Alternatively, compounds (V) can be produced by the reaction of (IV) with magnesium or transmetallation reagents and subsequent reaction with acyl chlorides R¹COCl. Those reactions are preferably performed under anhydrous conditions and in the presence of a catalyst such as CuCl₂, AlCl₃, LiCl and mixtures thereof, Z being preferably Br. Thereafter, intermediates (V) can be converted by means of methods described in the literature to the corresponding epoxides (IX) (see e.g. EP-A 461 502, DE-A 33 15 681, EP-A 291 797, WO-A 2013/007767). Intermediates (V) are preferably reacted with trimethylsulfoxonium- or trimethylsulfonium-salts, which might be prepared in situ, preferably trimethylsulfoxonium halides, trimethylsulfonium halides, trimethylsulfoxonium methylsulfates or trimethylsulfonium methylsulfates, preferably in the presence of a base such as sodium hydroxide. Epoxides (IX) can be subsequently reacted with a 1,2,4-triazole in order to obtain compounds (I-H). Preferably, this transformation is being conducted in the presence of a base, such as Na₂CO₃, K₂CO₃, Cs₂CO₃, NaOH, KOtBu, NaH or mixtures thereof, preferably in the presence of an organic solvent, such as tetrahydrofuran, dimethylformamide or toluene.

Process C (Scheme 3):

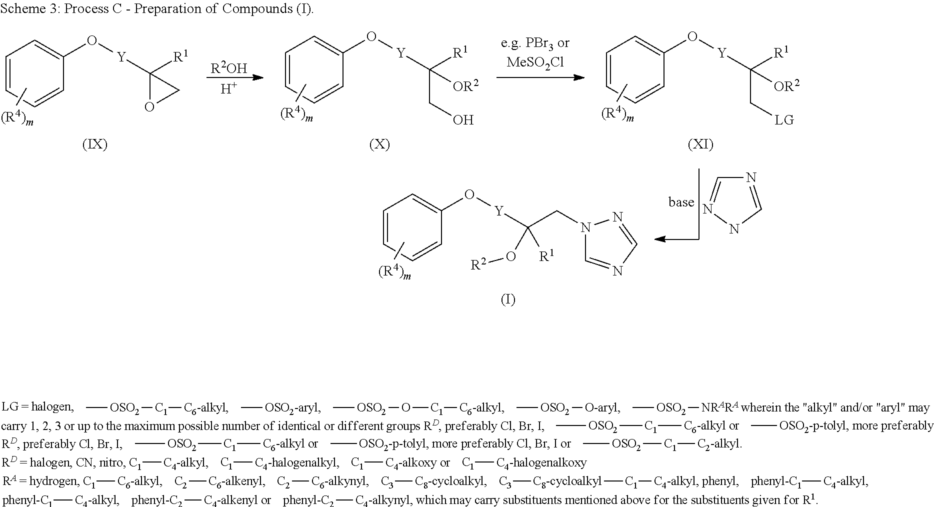

Epoxides of the general structure (IX) can be reacted with alcohols R²OH to yield alcohol (X). Preferably, this transformation is being performed in the presence of an acid. Thereafter, alcohol (X) is being prepared for a nucleophilic substitution reaction. Along those lines, the alcohol functionality in compound (X) is being reacted with halogenating agents or sulfonating agents such as PBr₃, PCl₃, MeSO₂Cl, tosyl chloride or thionyl chloride to obtain compounds (XI). Subsequently, Intermediates (XI) can be reacted with a 1,2,4-triazole in order to obtain compounds (I). Optionally, this transformation is being conducted in the presence of a base, such as Na₂CO₃, K₂CO₃, Cs₂CO₃, NaOH, KOtBu, NaH or mixtures thereof, preferably in the presence of an organic solvent, such as tetrahydrofuran, dimethylformamide or toluene.

Process D (Scheme 4):

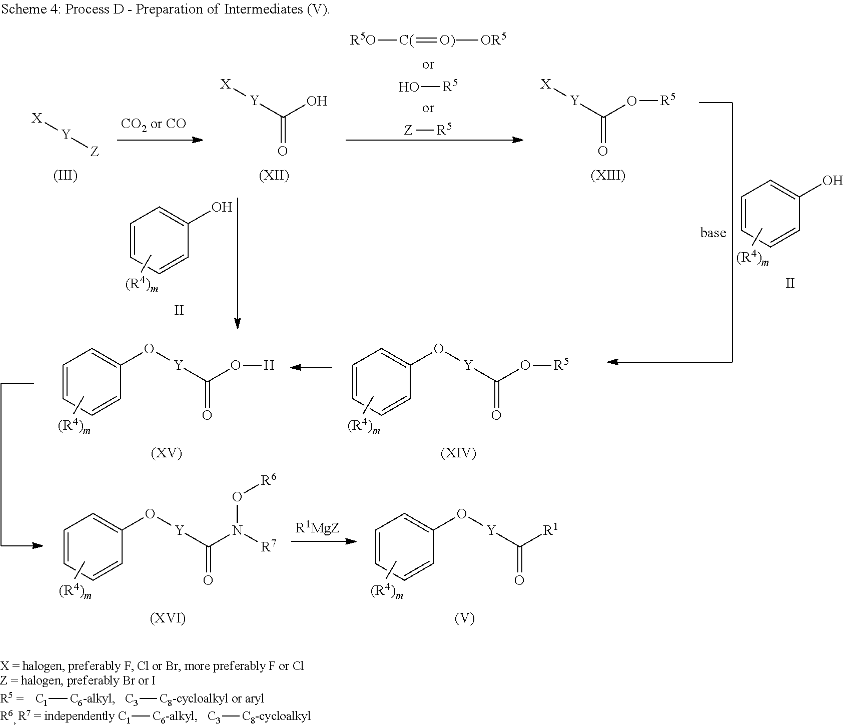

Compounds (III) (Scheme 4) can be converted by means of methods described in the literature to the corresponding compounds (XII) and subsequently to compounds (XIII), (XIV), (XV), (XVI) and (V). Alternatively, one or several reaction steps might be skipped. This is particularly true if certain protecting groups are not essential and thus process D might be shortened (e.g. (XII)→(XV)).

Compounds (III), wherein X stands for F or Cl and Z stands for Cl, Br or I, are optionally reacted with carbon dioxide or formate salts to obtain compounds (XII). This transformation is performed in the presence of reagents or catalysts such as lithium, magnesium, n-butyllithium, methyllithium or nickel (e.g. Organic & Biomolecular Chemistry, 8(7), 1688-1694; 2010; WO-A 2003/033504; Organometallics, 13(11), 4645-7; 1994 and references cited therein). Alternatively, compound (HI) is reacted in a hydroxycarbonylation reaction with carbon monoxide or a formate salt, preferentially in the presence of a catalyst such as Pd(OAc)₂ and Co(OAc)₂ (e.g. Dalton Transactions, 40(29), 7632-7638; 2011; Synlett, (11), 1663-1666; 2006 and references cited therein).

Subsequently, acids (XII) are reacted with anhydrides R⁵O—C(═O)—OR⁵, alcohols HO—R⁵ or alkyl halides Z—R⁵ in order to obtain ester of the general structure (XIII) (e.g. Russian Journal of General Chemistry, 70 (9), 1371-1377, 2000; Bulletin of the Chemical Society of Japan 76 (8), 1645-1667, 2003). The reactions are preferentially performed in the presence of a coupling reagent such as CDI or DEAD and/or a base such as triethylamine or DMAP. Optionally, the corresponding acid chlorides are being formed before the reaction with alcohols HO—R⁵ takes place (e.g. WO-A 2007/059265). Ester (XIII) are subsequently reacted with Phenols (II) optionally in the presence of a base such as K₂CO₃, Cs₂CO₃, NEt3 or DABCO and a solvent such as DMF, to obtain compounds (XIV). The following hydrolysis can be carried out in the presence of an acid such as H₂SO₄, HNO₃ or p-toluenesulfonic acid or in the presence of a base such as KOH to yield acid (XV). Thereafter, acid (XV) can be reacted with alkoxyalkylamine, preferentially methoxymethylamine. The corresponding reaction can be carried out in the presence of reagents such as carbodiimides (e.g. WO-A 2011/076744), diimidazolyl ketone CDI, N-alkoxy-N-alkylcarbamoyl chlorides (e.g. Bulletin of the Korean Chemical Society 2002, 23, 521-524), S,S-di-2-pyridyl dithiocarbonates (e.g. Bulletin of the Korean Chemical Society 2001, 22, 421-423), trichloromethyl chloroformate (e.g. Synthetic communications 2003, 33, 4013-4018) or peptide coupling reagent HATU. Intermediates (V) can be obtained after reaction of Weinreb amides (XVI) with magnesium halides R₁MgZ such as methylmagnesium bromide, methylmagnesium chloride or ethylmagnesiumbromide, preferentially in a solvent such as THF.

Process E (Scheme 5):

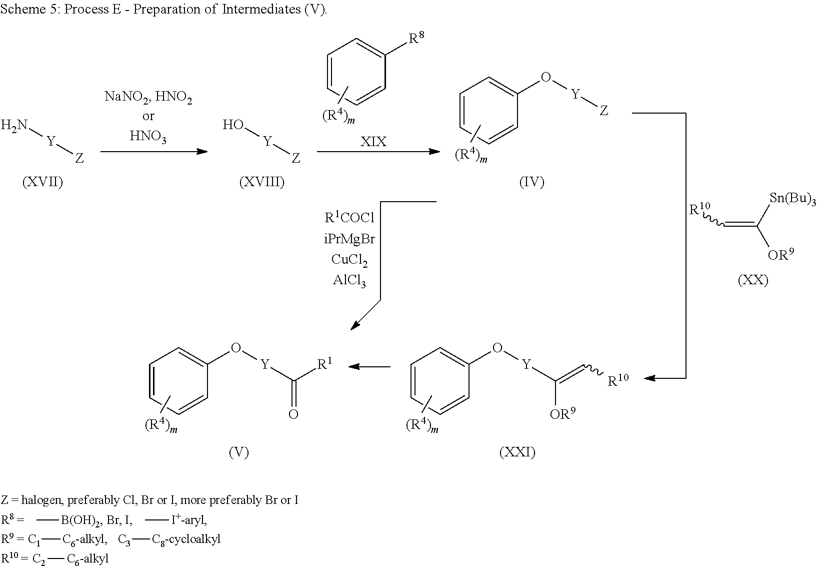

Amines (XVII) (Scheme 5) can be converted to the corresponding alcohols (XVIII) by means of methods described in the literature (e.g. Journal of Medicinal Chemistry 1999, 42, 95-108; WO-A 2007/017754; WO-A 2007/016525; Tetrahedron let. 2003, 44, 725-728), preferentially in the presence of sulfuric acid or hydrochloric acid as well as NaNO₂. Subsequently, alcohols (XVIII) can be converted to compounds of the general structure (IV) by literature know methods (e.g. Chemistry—A European Journal 2012, 18, 1414014149; Organic Letters 2011, 13, 1552-1555; Synlett 2012, 23, 101-106; WO-A 2005/040112; Organic Letters 2007, 9, 643-646; WO-A 2009/044160 and references cited therein). Compounds (XIX) could be for instance aryliodides which are optionally converted to diaryliodonium salts prior to the reaction, arylbromides or -iodides which are preferably reacted in the presence of a catalyst such as Cu or CuI or arylboronic acids or -esters which are preferentially reacted in the presence of a catalyst such as Cu(OAc)₂. Compounds (IV) can be reacted with a stannane such as (XX) in the presence of a transition metal catalyst such as Pd(PPh₃)₄, PdCl₂(PPh₃)₂, PdCl₂ or CuI (e.g. WO-A 2011/126960; WO-A 2011/088025; Journal of Organic Chemistry 1997, 62, 2774-2781; WO-A 2005/019212). Compounds (XXI) can be subsequently hydrolyzed to yield compounds (V), wherein R¹ is represented by C₁-C₆-alkyl, preferentially in the presence of an acid such as HCl or H₂SO₄ (e.g. Journal of Organic Chemistry 1990, 55, 3114-3118). Compounds (V) can be alternatively produced by the reaction of (IV) with magnesium or transmetallation reagents and subsequent reaction with acyl chlorides R¹COCl. Those reactions are preferably performed under anhydrous conditions and in the presence of a catalyst such as CuCl₂, AlCl₃, LiCl and mixtures thereof, Z being preferably Br.

General

The processes A to E for preparing compounds of the formula (I) are optionally performed using one or more reaction auxiliaries.

Useful reaction auxiliaries are, as appropriate, inorganic or organic bases or acid acceptors. These preferably include alkali metal or alkaline earth metal acetates, amides, carbonates, hydrogencarbonates, hydrides, hydroxides or alkoxides, for example sodium acetate, potassium acetate or calcium acetate, lithium amide, sodium amide, potassium amide or calcium amide, sodium carbonate, potassium carbonate or calcium carbonate, sodium hydrogencarbonate, potassium hydrogencarbonate or calcium hydrogencarbonate, lithium hydride, sodium hydride, potassium hydride or calcium hydride, lithium hydroxide, sodium hydroxide, potassium hydroxide or calcium hydroxide, n-butyllithium, sec-butyllithium, tert-butyllithium, lithium diisopropylamide, lithium bis(trimethylsilyl)amide, sodium methoxide, ethoxide, n- or i-propoxide, n-, i-, s- or t-butoxide or potassium methoxide, ethoxide, n- or i-propoxide, n-, i-, s- or t-butoxide; and also basic organic nitrogen compounds, for example trimethylamine, triethylamine, tripropylamine, tributylamine, ethyldiisopropylamine, N,N-dimethylcyclohexylamine, dicyclohexylamine, ethyldicyclohexylamine, N,N-dimethylaniline, N,N-dimethylbenzylamine, pyridine, 2-methyl-, 3-methyl-, 4-methyl-, 2,4-dimethyl-, 2,6-dimethyl-, 3,4-dimethyl- and 3,5-dimethylpyridine, 5-ethyl-2-methylpyridine, 4-dimethylaminopyridine, N-methylpiperidine, 1,4-diazabicyclo[2,2,2]-octane (DABCO), 1,5-diazabicyclo[4,3,0]-non-5-ene (DBN) or 1,8-diazabicyclo[5,4,0]-undec-7-ene (DBU).

Useful reaction auxiliaries are, as appropriate, inorganic or organic acids. These preferably include inorganic acids, for example hydrogen fluoride, hydrogen chloride, hydrogen bromide and hydrogen iodide, sulphuric acid, phosphoric acid and nitric acid, and acidic salts such as NaHSO₄ and KHSO₄, or organic acids, for example, formic acid, carbonic acid and alkanoic acids such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, saturated or mono- or diunsaturated C₆-C₂₀ fatty acids, alkylsulphuric monoesters, alkylsulphonic acids (sulphonic acids having straight-chain or branched alkyl radicals having 1 to 20 carbon atoms), arylsulphonic acids or aryldisulphonic acids (aromatic radicals, such as phenyl and naphthyl, which bear one or two sulphonic acid groups), alkylphosphonic acids (phosphonic acids having straight-chain or branched alkyl radicals having 1 to 20 carbon atoms), arylphosphonic acids or aryldiphosphonic acids (aromatic radicals, such as phenyl and naphthyl which bear one or two phosphonic acid radicals), where the alkyl and aryl radicals may bear further substituents, for example p-toluenesulphonic acid, salicylic acid, p-aminosalicylic acid, 2-phenoxybenzoic acid, 2-acetoxybenzoic acid, etc.

The processes A to E are optionally performed using one or more diluents. Useful diluents are virtually all inert organic solvents. Unless otherwise indicated for the above described processes A to E, these preferably include aliphatic and aromatic, optionally halogenated hydrocarbons, such as pentane, hexane, heptane, cyclohexane, petroleum ether, benzine, ligroin, benzene, toluene, xylene, methylene chloride, ethylene chloride, chloroform, carbon tetrachloride, chlorobenzene and o-dichlorobenzene, ethers such as diethyl ether, dibutyl ether and methyl tert-butyl ether, glycol dimethyl ether and diglycol dimethyl ether, tetrahydrofuran and dioxane, ketones such as acetone, methyl ethyl ketone, methyl isopropyl ketone and methyl isobutyl ketone, esters, such as methyl acetate and ethyl acetate, nitriles, for example acetonitrile and propionitrile, amides, for example dimethylformamide, dimethylacetamide and N-methylpyrrolidone, and also dimethyl sulphoxide, tetramethylenesulphone and hexamethylphosphoramide and DMPU.

In the processes the reaction temperatures can be varied within a relatively wide range. In general, the temperatures employed are between −78° C. and 250° C., preferably temperatures between −78° C. and 150° C.

The reaction time varies as a function of the scale of the reaction and of the reaction temperature, but is generally between a few minutes and 48 hours.

The processes according to the invention are generally performed under standard pressure. However, it is also possible to work under elevated or reduced pressure.

For performance of the processes according to the invention, the starting materials required in each case are generally used in approximately equimolar amounts. However, it is also possible to use one of the components used in each case in a relatively large excess.

After a reaction has ended, the compounds are optionally separated from the reaction mixture by one of the customary separation techniques. If necessary, the compounds are purified by recrystallization or chromatography.

If appropriate, in the processes A to E also salts and/or N-oxides of the starting compounds can be used.

The invention further relates to novel intermediates of the compounds of formula (I), which form part of the invention.

The compounds of the formulae (I) can be converted into physiologically acceptable salts, e.g. as acid addition salts or metal salt complexes.

Depending on the nature of the substituents defined above, the compounds of the formula (I) have acidic or basic properties and can form salts, if appropriate also inner salts, or adducts with inorganic or organic acids or with bases or with metal ions. If the compounds of the formula (I) carry amino, alkylamino or other groups which induce basic properties, these compounds can be reacted with acids to give salts, or they are directly obtained as salts in the synthesis. If the compounds of the formula (I) carries hydroxyl, carboxyl or other groups which induce acidic properties, these compounds can be reacted with bases to give salts. Suitable bases are, for example, hydroxides, carbonates, bicarbonates of the alkali metals and alkaline earth metals, in particular those of sodium, potassium, magnesium and calcium, furthermore ammonia, primary, secondary and tertiary amines having (C₁-C₄)-alkyl groups, mono-, di- and trialkanolamines of (C₁-C₄)-alkanols, choline and also chlorocholine.

The salts obtainable in this manner also have fungicidal properties.

Examples of inorganic acids are hydrohalic acids, such as hydrogen fluoride, hydrogen chloride, hydrogen bromide and hydrogen iodide, sulphuric acid, phosphoric acid and nitric acid, and acidic salts, such as NaHSO₄ and KHSO₄. Suitable organic acids are, for example, formic acid, carbonic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, maleic acid, fumaric acid, tartaric acid, sorbic acid oxalic acid, alkylsulphonic acids (sulphonic acids having straight-chain or branched alkyl radicals of 1 to 20 carbon atoms), arylsulphonic acids or aryldisulphonic acids (aromatic radicals, such as phenyl and naphthyl, which carry one or two sulphonic acid groups), alkylphosphonic acids (phosphonic acids having straight-chain or branched alkyl radicals of 1 to 20 carbon atoms), arylphosphonic acids or aryldiphosphonic acids (aromatic radicals, such as phenyl and naphthyl, which carry one or two phosphonic acid radicals), where the alkyl and aryl radicals may carry further substituents, for example p-toluenesulphonic acid, 1,5-naphthalenedisulphonic acid, salicylic acid, p-aminosalicylic acid, 2-phenoxybenzoic acid, 2-acetoxybenzoic acid, etc.

Suitable metal ions are in particular the ions of the elements of the second main group, in particular calcium and magnesium, of the third and fourth main group, in particular aluminium, tin and lead, and also of the first to eighth transition group, in particular chromium, manganese, iron, cobalt, nickel, copper, zinc and others. Particular preference is given to the metal ions of the elements of the fourth period. Here, the metals can be present in various valencies that they can assume.

The acid addition salts of the compounds of the formula (I) can be obtained in a simple manner by customary methods for forming salts, for example by dissolving a compound of the formula (I) in a suitable inert solvent and adding the acid, for example hydrochloric acid, and be isolated in a known manner, for example by filtration, and, if required, be purified by washing with an inert organic solvent.

Suitable anions of the salts are those which are preferably derived from the following acids: hydrohalic acids, such as, for example, hydrochloric acid and hydrobromic acid, furthermore phosphoric acid, nitric acid and sulphuric acid.

The metal salt complexes of compounds of the formula (I) can be obtained in a simple manner by customary processes, for example by dissolving the metal salt in alcohol, for example ethanol, and adding the solution to the compound of the formula (I). Metal salt complexes can be isolated in a known manner, for example by filtration, and, if required, be purified by recrystallization.

Salts of the intermediates can also be prepared according to the processes mentioned above for the salts of compounds of formula (I).

N-oxides of compounds of the formula (I) or intermediates thereof can be obtained in a simple manner by customary processes, for example by N-oxidation with hydrogen peroxide (H₂O₂), peracids, for example peroxy sulfuric acid or peroxy carboxylic acids, such as meta-chloroperoxybenzoic acid or peroxymonosulfuric acid (Caro's acid).

E.g. the corresponding N-oxides may be prepared starting from compounds (I) using conventional oxidation methods, e.g. by treating compounds (I) with an organic peracid such as metachloroperbenzoic acid (e.g. WO-A 2003/64572 or J. Med. Chem. 38 (11), 1892-1903, 1995); or with inorganic oxidizing agents such as hydrogen peroxide (e.g. J. Heterocyc. Chem. 18 (7), 1305-1308, 1981) or oxone (e.g. J. Am. Chem. Soc. 123 (25), 5962-5973, 2001). The oxidation may lead to pure mono-N-oxides or to a mixture of different N-oxides, which can be separated by conventional methods such as chromatography.

Further Active Compounds

The active compound combinations according to the invention comprise (B) at least one further active compound selected from the following groups
(1) inhibitors of the ergosterol synthesis,
(2) inhibitors of the respiratory chain at complex I or II,
(3) inhibitors of the respiratory chain at complex III,
(4) inhibitors of the mitosis and cell division.
(5) compounds capable of having a multisite action.
(6) compounds capable of inducing a host defense,
(7) inhibitors of the amino acid and/or protein biosynthesis.
(8) inhibitors of the ATP production.
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler,
(15) other fungicides.

Preferred compound combinations according to the invention comprise (B) at least one further active compound selected from:
inhibitors of the ergosterol synthesis selected from the group consisting of (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol. (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)-cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopyl]-(1H-1-triazol-1-yl)butan-2-ol, (1.032) (2S)-2-(1-chlorocyclopropyl)-4-[(1S)-2,2-dichlorocyclopropyl]-1-(1H-1,24-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-([3-(2-chlorophenyl)-2-(2,4-difluorophenyl)oxiran-2-yl]methyl-1H-1,2,4-triazol-5-yl thiocyanate, (1.040) 1{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) 2-[4-(4-chlorophenoxy)-2-(trifluoromethyl)phenyl]-1-(1H-1,2,4-triazol-1-yl)propan-2-ol, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Mefentrifluconazole, and (1.082) Ipfentrifluconazole,
   inhibitors of the respiratory chain at complex I or II selected from the group consisting of (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) 3-(difluoromethyl)-N-(7-fluoro-1,1,3-trimethyl-2,3-dihydro-1H-inden-4-yl)-1-methyl-1H-pyrazole-4-carboxamide, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, and (2.056) N-cyclopropyl-N-(2-cyclopropylbenzyl)-3-(difluoromethyl)-5-fluoro-1-methyl-1H-pyrazole-4-carboxamide,
   inhibitors of the respiratory chain at complex III selected from the group consisting of (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, and (3.029) methyl {5-[3-(2,4-dimethylphenyl)-1H-pyrazol-1-yl]-2-methylbenzyl}carbamate,
   inhibitors of the mitosis and cell division selected from the group consisting of (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, and (4.025) N-(4-chloro-2,6-difluorophenyl)-4-(2-chloro-4-fluorophenyl)-1,3-dimethyl-1H-pyrazol-5-amine,
   compounds capable of having a multisite action selected from the group consisting of (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, and (5.023) 6-ethyl-5,7-dioxo-6,7-dihydro-5H-pyrrolo[3′,4′:5,6][1,4]dithiino[2,3-c][1,2]thiazole-3-carbonitrile,
   compounds capable of inducing a host defense selected from the group consisting of (6.001) acibenzolar-S-methyl, (6.002) isotianil, (6.003) probenazole, and (6.004) tiadinil,
   inhibitors of the amino acid and/or protein biosynthesis selected from the group consisting of (7.001) cyprodinil, (7.002) kasugamycin, (7.003) kasugamycin hydrochloride hydrate, (7.004) oxytetracycline, (7.005) pyrimethanil, and (7.006) 3-(5-fluoro-3,3,4,4-tetramethyl-3,4-dihydroisoquinolin-1-yl)quinolone,
   inhibitors of the ATP production selected from the group consisting of (8.001) silthiofam,
   inhibitors of the cell wall synthesis selected from the group consisting of (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, and (9.009) (2Z)-3-(4-tert-butylphenyl)-3-(2-chloropyridin-4-yl)-1-(morpholin-4-yl)prop-2-en-1-one,
   inhibitors of the lipid and membrane synthesis selected from the group consisting of (10.001) propamocarb, (10.002) propamocarb hydrochloride, and (10.003) tolclofos-methyl,
   inhibitors of the melanine biosynthesis selected from the group consisting of (11.001) tricyclazole, and (11.002) 2,2,2-trifluoroethyl {3-methyl-1-[(4-methylbenzoyl)amino]butan-2-yl}carbamate,
   inhibitors of the nucleic acid synthesis selected from the group consisting of (12.001) benalaxyl, (12.002) benalaxyl-M (kiralaxyl), (12.003) metalaxyl, and (12.004) metalaxyl-M (mefenoxam),
   inhibitors of the signal transduction selected from the group consisting of (13.001) fludioxonil, (13.002) iprodione, (13.003) procymidone, (13.004) proquinazid, (13.005) quinoxyfen, and (13.006) vinclozolin, compounds capable of acting as uncoupler selected from the group consisting of (14.001) fluazinam, and (14.002) meptyldinocap,
   other fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) 2,6-dimethyl-1H,5H-[1,4]dithiino[2,3-c:5,6-c′]dipyrrole-1,3,5,7(2H,6H)-tetrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) 2-{2-[(7,8-difluoro-2-methylquinolin-3-yl)oxy]-6-fluorophenyl}propan-2-ol, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) 3-(4,4-difluoro-3,3-dimethyl-3,4-dihydroisoquinolin-1-yl)quinoline, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, and (15.062) 5-fluoro-4-imino-3-methyl-1-[(4-methylphenyl) sulfonyl]-3,4-dihydropyrimidin-2(1H)-one.

More preferred compound combinations according to the invention comprise (B) at least one further active compound selected from:

(1.001) cyproconazole, (1.002) difenoconazole, (1.003) epoxiconazole, (1.004) fenhexamid, (1.010) imazalil, (1.012) ipconazole, (1.013) metconazole, (1.017) propiconazole, (1.018) prothioconazole, (1.020) spiroxamine, (1.021) tebuconazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.059) 5-(4-chlorobenzyl)-2-(chloromethyl)-2-methyl-1-(1H-1,2,4-triazol-1-ylmethyl)cyclopentanol, (1.081) Mefentrifluconazole, and (1.082) Ipfentrifluconazole,
(2.001) benzovindiflupyr, (2.002) bixafen, (2.003) boscalid, (2.005) fluopyram, (2.007) fluxapyroxad, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.021) sedaxane, (2.027) 3-(difluoromethyl)-1-methyl-N-(1,1l-N-(3-trimethyl-2,3-dihydro-1H-inden-4-yl)-1H-pyrazole-4-carboxamide, (2.030) 3-(difluoromethyl)-N-(7-fluoro-1,3-trimethyl-2,3-dihydro-1H-inden-4-yl)-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide,
(3.003) azoxystrobin, (3.007) dimoxystrobin, (3.012) fluoxastrobin, (3.013) kresoxim-methyl, (3.016) picoxystrobin, (3.017) pyraclostrobin, (3.020) trifloxystrobin, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide,
(4.005) pencycuron, (4.007) thiophanate-methyl, (4.012) 4-(2-bromo-4-fluorophenyl)-N-(2,6-difluorophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine,
(5.003) captan, (5.004) chlorothalonil, (5.011) dodine, (5.012) folpet, (5.013) mancozeb, (5.015) metiram, (5.018) propineb,
(6.002) isotianil,
(7.001) cyprodinil, (7.005) pyrimethanil,
(12.003) metalaxyl, (12.004) metalaxyl-M (mefenoxam),
(13.001) fludioxonil, (13.002) iprodione, (13.004) proquinazid, (13.005) quinoxyfen,
(14.001) fluazinam, (14.002) meptyldinocap,
(15.008) cyflufenamid, (15.010) cyprosulfamide, (15.011) flutianil, (15.012) fosetyl-aluminium, (15.016) metrafenone, (15.027) pyriofenone (chlazafenone), and (15.047) 3-(4,4-difluoro-3,3-dimethyl-3,4-dihydroisoquinolin-1-yl)quinolone, (15.048) 4-amino-5-fluoropyrimidin-2-ol (tautomeric form: 4-amino-5-fluoropyrimidin-2(1H)-one), (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.062) 5-fluoro-4-imino-3-methyl-1-[(4-methylphenyl)sulfonyl]-3,4-dihydropyrimidin-2(1H)-one.

Even more preferred compound combinations according to the invention comprise (B) at least one further active compound selected from:

(1.002) difenoconazole, (1.010) imazalil, (1.012) ipconazole, (1.018) prothioconazole, (1.020) spiroxamine, (1.021) tebuconazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.059) 5-(4-chlorobenzyl)-2-(chloromethyl)-2-methyl-1-(1H-1,2,4-triazol-1-ylmethyl)cyclopentanol, (1.081) Mefentrifluconazole, and (1.082) Ipfentrifluconazole,
(2.001) benzovindiflupyr, (2.002) bixafen, (2.005) fluopyram, (2.007) fluxapyroxad, (2.017) penflufen, (2.018) penthiopyrad, (2.019) pydiflumetofen, (2.021) sedaxane, (2.027) 3-(difluoromethyl)-1-methyl-N-(1,1,3-trimethyl-2,3-dihydro-1H-inden-4-yl)-1H-pyrazole-4-carboxamide, (2.030) 3-(difluoromethyl)-N-(7-fluoro-1,1,3-trimethyl-2,3-dihydro-1H-inden-4-yl)-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide,
(3.003) azoxystrobin, (3.012) fluoxastrobin, (3.016) picoxystrobin, (3.017) pyraclostrobin, (3.020) trifloxystrobin, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide,
(4.005) pencycuron, (4.007) thiophanate-methyl, (4.012) 4-(2-bromo-4-fluorophenyl)-N-(2,6-difluorophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine,
(5.004) chlorothalonil, (5.011) dodine, (5.012) folpet, (5.013) mancozeb, (5.018) propineb,
(6.002) isotianil,
(7.005) pyrimethanil,
(12.003) metalaxyl, (12.004) metalaxyl-M (mefenoxam),
(13.001) fludioxonil, (13.004) proquinazid,
(14.001) fluazinam, (14.002) meptyldinocap,
(15.008) cyflufenamid, (15.027) pyriofenone (chlazafenone), (15.047) 3-(4,4-difluoro-3,3-dimethyl-3,4-dihydroisoquinolin-1-yl)quinolone, (15.048) 4-amino-5-fluoropyrimidin-2-ol (tautomeric form: 4-amino-5-fluoropyrimidin-2(1H)-one), (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.062) 5-fluoro-4-imino-3-methyl-1-[(4-methylphenyl)sulfonyl]-3,4-dihydropyrimidin-2(1H)-one.

Most preferred compound combinations according to the invention comprise (B) at least one further active compound selected from:

(1.012) ipconazole, (1.018) prothioconazole, (1.020) spiroxamine, (1.021) tebuconazole,
(2.002) bixafen, (2.005) fluopyram, (2.017) penflufen, (2.027) 3-(difluoromethyl)-1-methyl-N-(1,1,3-trimethyl-2,3-dihydro-1H-inden-4-yl)-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide,
(3.020) trifloxystrobin, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate,
(4.005) pencycuron,
(5.004) chlorothalonil, (5.013) mancozeb, (5.018) propineb,
(12.003) metalaxyl, (12.004) metalaxyl-M (mefenoxam),
(13.001) fludioxonil, (13.004) proquinazid,
(15.008) cyflufenamid, and (15.047) 3-(4,4-difluoro-3,3-dimethyl-3,4-dihydroisoquinolin-1-yl)quinoline.

Preferred compound combinations are selected from the group (G1) consisting of the following mixtures:

(I.01)+(1.001), (I.01)+(1.002), (I.01)+(1.003), (I.01)+(1.004), (I.01)+(1.005), (I.01)+(1.006), (I.01)+(1.007), (I.01)+(1.008), (I.01)+(1.009), (I.01)+(1.010), (I.01)+(1.011), (I.01)+(1.012), (I.01)+(1.013), (I.01)+(1.014), (I.01)+(1.015), (I.01)+(1.016), (I.01)+(1.017), (I.01)+(1.018), (I.01)+(1.019), (I.01)+(1.020), (I.01)+(1.021), (I.01)+(1.022), (I.01)+(1.023), (I.01)+(1.024), (I.01)+(1.025), (I.01)+(1.026), (I.01)+(1.027), (I.01)+(1.028), (I.01)+(1.029), (I.01)+(1.030), (I.01)+(1.031), (I.01)+(1.032), (I.01)+(1.033), (I.01)+(1.034), (I.01)+(1.035), (I.01)+(1.036), (I.01)+(1.037), (I.01)+(1.038), (I.01)+(1.039), (I.01)+(1.040), (I.01)+(1.041), (I.01)+(1.042), (I.01)+(1.043), (I.01)+(1.044), (I.01)+(1.045), (I.01)+(1.046), (I.01)+(1.047), (I.01)+(1.048), (I.01)+(1.049), (I.01)+(1.050), (I.01)+(1.051), (I.01)+(1.052), (I.01)+(1.053), (I.01)+(1.054), (I.01)+(1.055), (I.01)+(1.056), (I.01)+(1.057), (I.01)+(1.058), (I.01)+(1.059), (I.01)+(1.060), (I.01)+(1.061), (I.01)+(1.062), (I.01)+(1.063), (I.01)+(1.064), (I.01)+(1.065), (I.01)+(1.066), (I.01)+(1.067), (I.01)+(1.068), (I.01)+(1.069), (I.01)+(1.070), (I.01)+(1.071), (I.01)+(1.072), (I.01)+(1.073), (I.01)+(1.074), (I.01)+(1.075), (I.01)+(1.076), (I.01)+(1.077), (I.01)+(1.078), (I.01)+(1.079), (I.01)+(1.080), (I.01)+(1.081), (I.01)+(1.082), (I.01)+(2.001), (I.01)+(2.002), (I.01)+(2.003), (I.01)+(2.004), (I.01)+(2.005), (I.01)+(2.006), (I.01)+(2.007), (I.01)+(2.008), (I.01)+(2.009), (I.01)+(2.010), (I.01)+(2.011), (I.01)+(2.012), (I.01)+(2.013), (I.01)+(2.014), (I.01)+(2.015), (I.01)+(2.016), (I.01)+(2.017), (I.01)+(2.018), (I.01)+(2.019), (I.01)+(2.020), (I.01)+(2.021), (I.01)+(2.022), (I.01)+(2.023), (I.01)+(2.024), (I.01)+(2.025), (I.01)+(2.026), (I.01)+(2.027), (I.01)+(2.028), (I.01)+(2.029), (I.01)+(2.030), (I.01)+(2.031), (I.01)+(2.032), (I.01)+(2.033), (I.01)+(2.034), (I.01)+(2.035), (I.01)+(2.036), (I.01)+(2.037), (I.01)+(2.038), (I.01)+(2.039), (I.01)+(2.040), (I.01)+(2.041), (I.01)+(2.042), (I.01)+(2.043), (I.01)+(2.044), (I.01)+(2.045), (I.01)+(2.046), (I.01)+(2.047), (I.01)+(2.048), (I.01)+(2.049), (I.01)+(2.050), (I.01)+(2.051), (I.01)+(2.052), (I.01)+(2.053), (I.01)+(2.054), (I.01)+(2.055), (I.01)+(2.056), (I.01)+(3.001), (I.01)+(3.002), (I.01)+(3.003), (I.01)+(3.004), (I.01)+(3.005), (I.01)+(3.006), (I.01)+(3.007), (I.01)+(3.008), (I.01)+(3.009), (I.01)+(3.010), (I.01)+(3.011), (I.01)+(3.012), (I.01)+(3.013), (I.01)+(3.014), (I.01)+(3.015), (I.01)+(3.016), (I.01)+(3.017), (I.01)+(3.018), (I.01)+(3.019), (I.01)+(3.020), (I.01)+(3.021), (I.01)+(3.022), (I.01)+(3.023), (I.01)+(3.024), (I.01)+(3.025), (I.01)+(3.026), (I.01)+(3.027), (I.01)+(3.028), (I.01)+(3.029), (I.01)+(4.001), (I.01)+(4.002), (I.01)+(4.003), (I.01)+(4.004), (I.01)+(4.005), (I.01)+(4.006), (I.01)+(4.007), (I.01)+(4.008), (I.01)+(4.009), (I.01)+(4.010), (I.01)+(4.011), (I.01)+(4.012), (I.01)+(4.013), (I.01)+(4.014), (I.01)+(4.015), (I.01)+(4.016), (I.01)+(4.017), (I.01)+(4.018), (I.01)+(4.019), (I.01)+(4.020), (I.01)+(4.021), (I.01)+(4.022), (I.01)+(4.023), (I.01)+(4.024), (I.01)+(4.025), (I.01)+(5.001), (I.01)+(5.002), (I.01)+(5.003), (I.01)+(5.004), (I.01)+(5.005), (I.01)+(5.006), (I.01)+(5.007), (I.01)+(5.008), (I.01)+(5.009), (I.01)+(5.010), (I.01)+(5.011), (I.01)+(5.012), (I.01)+(5.013), (I.01)+(5.014), (I.01)+(5.015), (I.01)+(5.016), (I.01)+(5.017), (I.01)+(5.018), (I.01)+(5.019), (I.01)+(5.020), (I.01)+(5.021), (I.01)+(5.022), (I.01)+(5.023), (I.01)+(6.001), (I.01)+(6.002), (I.01)+(6.003), (I.01)+(6.004), (I.01)+(7.001), (I.01)+(7.002), (I.01)+(7.003), (I.01)+(7.004), (I.01)+(7.005), (I.01)+(7.006), (I.01)+(8.001), (I.01)+(9.001), (I.01)+(9.002), (I.01)+(9.003), (I.01)+(9.004), (I.01)+(9.005), (I.01)+(9.006), (I.01)+(9.007), (I.01)+(9.008), (I.01)+(9.009), (I.01)+(10.001), (I.01)+(10.002), (I.01)+(10.003), (I.01)+(11.001), (I.01)+(11.002), (I.01)+(12.001), (I.01)+(12.002), (I.01)+(12.003), (I.01)+(12.004), (I.01)+(13.001), (I.01)+(13.002), (I.01)+(13.003), (I.01)+(13.004), (I.01)+(13.005), (I.01)+(13.006), (I.01)+(14.001), (I.01)+(14.002), (I.01)+(15.001), (I.01)+(15.002), (I.01)+(15.003), (I.01)+(15.004), (I.01)+(15.005), (I.01)+(15.006), (I.01)+(15.007), (I.01)+(15.008), (I.01)+(15.009), (I.01)+(15.010), (I.01)+(15.011), (I.01)+(15.012), (I.01)+(15.013), (I.01)+(15.014), (I.01)+(15.015), (I.01)+(15.016), (I.01)+(15.017), (I.01)+(15.018), (I.01)+(15.019), (I.01)+(15.020), (I.01)+(15.021), (I.01)+(15.022), (I.01)+(15.023), (I.01)+(15.024), (I.01)+(15.025), (I.01)+(15.026), (I.01)+(15.027), (I.01)+(15.028), (I.01)+(15.029), (I.01)+(15.030), (I.01)+(15.031), (I.01)+(15.032), (I.01)+(15.033), (I.01)+(15.034), (I.01)+(15.035), (I.01)+(15.036), (I.01)+(15.037), (I.01)+(15.038), (I.01)+(15.039), (I.01)+(15.040), (I.01)+(15.041), (I.01)+(15.042), (I.01)+(15.043), (I.01)+(15.044), (I.01)+(15.045), (I.01)+(15.046), (I.01)+(15.047), (I.01)+(15.048), (I.01)+(15.049), (I.01)+(15.050), (I.01)+(15.051), (I.01)+(15.052), (I.01)+(15.053), (I.01)+(15.054), (I.01)+(15.055), (I.01)+(15.056), (I.01)+(15.057), (I.01)+(15.058), (I.01)+(15.059), (I.01)+(15.060), (I.01)+(15.061), and (I.01)+(15.062).

Also preferred compound combinations are selected from the group (G2) consisting of the following mixtures:

(I.59)+(1.001), (I.59)+(1.002), (I.59)+(1.003), (I.59)+(1.004), (I.59)+(1.005), (I.59)+(1.006), (I.59)+(1.007), (I.59)+(1.008), (I.59)+(1.009), (I.59)+(1.010), (I.59)+(1.011), (I.59)+(1.012), (I.59)+(1.013), (I.59)+(1.014), (I.59)+(1.015), (I.59)+(1.016), (I.59)+(1.017), (I.59)+(1.018), (I.59)+(1.019), (I.59)+(1.020), (I.59)+(1.021), (I.59)+(1.022), (I.59)+(1.023), (I.59)+(1.024), (I.59)+(1.025), (I.59)+(1.026), (I.59)+(1.027), (I.59)+(1.028), (I.59)+(1.029), (I.59)+(1.030), (I.59)+(1.031), (I.59)+(1.032), (I.59)+(1.033), (I.59)+(1.034), (I.59)+(1.035), (I.59)+(1.036), (I.59)+(1.037), (I.59)+(1.038), (I.59)+(1.039), (I.59)+(1.040), (I.59)+(1.041), (I.59)+(1.042), (I.59)+(1.043), (I.59)+(1.044), (I.59)+(1.045), (I.59)+(1.046), (I.59)+(1.047), (I.59)+(1.048), (I.59)+(1.049), (I.59)+(1.050), (I.59)+(1.051), (I.59)+(1.052), (I.59)+(1.053), (I.59)+(1.054), (I.59)+(1.055), (I.59)+(1.056), (I.59)+(1.057), (I.59)+(1.058), (I.59)+(1.059), (I.59)+(1.060), (I.59)+(1.061), (I.59)+(1.062), (I.59)+(1.063), (I.59)+(1.064), (I.59)+(1.065), (I.59)+(1.066), (I.59)+(1.067), (I.59)+(1.068), (I.59)+(1.069), (I.59)+(1.070), (I.59)+(1.071), (I.59)+(1.072), (I.59)+(1.073), (I.59)+(1.074), (I.59)+(1.075), (I.59)+(1.076), (I.59)+(1.077), (I.59)+(1.078), (I.59)+(1.079), (I.59)+(1.080), (I.59)+(1.081), (I.59)+(1.082), (I.59)+(2.001), (I.59)+(2.002), (I.59)+(2.003), (I.59)+(2.004), (I.59)+(2.005), (I.59)+(2.006), (I.59)+(2.007), (I.59)+(2.008), (I.59)+(2.009), (I.59)+(2.010), (I.59)+(2.011), (I.59)+(2.012), (I.59)+(2.013), (I.59)+(2.014), (I.59)+(2.015), (I.59)+(2.016), (I.59)+(2.017), (I.59)+(2.018), (I.59)+(2.019), (I.59)+(2.020), (I.59)+(2.021), (I.59)+(2.022), (I.59)+(2.023), (I.59)+(2.024), (I.59)+(2.025), (I.59)+(2.026), (I.59)+(2.027), (I.59)+(2.028), (I.59)+(2.029), (I.59)+(2.030), (I.59)+(2.031), (I.59)+(2.032), (I.59)+(2.033), (I.59)+(2.034), (I.59)+(2.035), (I.59)+(2.036), (I.59)+(2.037), (I.59)+(2.038), (I.59)+(2.039), (I.59)+(2.040), (I.59)+(2.041), (I.59)+(2.042), (I.59)+(2.043), (I.59)+(2.044), (I.59)+(2.045), (I.59)+(2.046), (I.59)+(2.047), (I.59)+(2.048), (I.59)+(2.049), (I.59)+(2.050), (I.59)+(2.051), (I.59)+(2.052), (I.59)+(2.053), (I.59)+(2.054), (I.59)+(2.055), (I.59)+(2.056), (I.59)+(3.001), (I.59)+(3.002), (I.59)+(3.003), (I.59)+(3.004), (I.59)+(3.005), (I.59)+(3.006), (I.59)+(3.007), (I.59)+(3.008), (I.59)+(3.009), (I.59)+(3.010), (I.59)+(3.011), (I.59)+(3.012), (I.59)+(3.013), (I.59)+(3.014), (I.59)+(3.015), (I.59)+(3.016), (I.59)+(3.017), (I.59)+(3.018), (I.59)+(3.019), (I.59)+(3.020), (I.59)+(3.021), (I.59)+(3.022), (I.59)+(3.023), (I.59)+(3.024), (I.59)+(3.025), (I.59)+(3.026), (I.59)+(3.027), (I.59)+(3.028), (I.59)+(3.029), (I.59)+(4.001), (I.59)+(4.002), (I.59)+(4.003), (I.59)+(4.004), (I.59)+(4.005), (I.59)+(4.006), (I.59)+(4.007), (I.59)+(4.008), (I.59)+(4.009), (I.59)+(4.010), (I.59)+(4.011), (I.59)+(4.012), (I.59)+(4.013), (I.59)+(4.014), (I.59)+(4.015), (I.59)+(4.016), (I.59)+(4.017), (I.59)+(4.018), (I.59)+(4.019), (I.59)+(4.020), (I.59)+(4.021), (I.59)+(4.022), (I.59)+(4.023), (I.59)+(4.024), (I.59)+(4.025), (I.59)+(5.001), (I.59)+(5.002), (I.59)+(5.003), (I.59)+(5.004), (I.59)+(5.005), (I.59)+(5.006), (I.59)+(5.007), (I.59)+(5.008), (I.59)+(5.009), (I.59)+(5.010), (I.59)+(5.011), (I.59)+(5.012), (I.59)+(5.013), (I.59)+(5.014), (I.59)+(5.015), (I.59)+(5.016), (I.59)+(5.017), (I.59)+(5.018), (I.59)+(5.019), (I.59)+(5.020), (I.59)+(5.021), (I.59)+(5.022), (I.59)+(5.023), (I.59)+(6.001), (I.59)+(6.002), (I.59)+(6.003), (I.59)+(6.004), (I.59)+(7.001), (I.59)+(7.002), (I.59)+(7.003), (I.59)+(7.004), (I.59)+(7.005), (I.59)+(7.006), (I.59)+(8.001), (I.59)+(9.001), (I.59)+(9.002), (I.59)+(9.003), (I.59)+(9.004), (I.59)+(9.005), (I.59)+(9.006), (I.59)+(9.007), (I.59)+(9.008), (I.59)+(9.009), (I.59)+(10.001), (I.59)+(10.002), (I.59)+(10.003), (I.59)+(11.001), (I.59)+(11.002), (I.59)+(12.001), (I.59)+(12.002), (I.59)+(12.003), (I.59)+(12.004), (I.59)+(13.001), (I.59)+(13.002), (I.59)+(13.003), (I.59)+(13.004), (I.59)+(13.005), (I.59)+(13.006), (I.59)+(14.001), (I.59)+(14.002), (I.59)+(15.001), (I.59)+(15.002), (I.59)+(15.003), (I.59)+(15.004), (I.59)+(15.005), (I.59)+(15.006), (I.59)+(15.007), (I.59)+(15.008), (I.59)+(15.009), (I.59)+(15.010), (I.59)+(15.011), (I.59)+(15.012), (I.59)+(15.013), (I.59)+(15.014), (I.59)+(15.015), (I.59)+(15.016), (I.59)+(15.017), (I.59)+(15.018), (I.59)+(15.019), (I.59)+(15.020), (I.59)+(15.021), (I.59)+(15.022), (I.59)+(15.023), (I.59)+(15.024), (I.59)+(15.025), (I.59)+(15.026), (I.59)+(15.027), (I.59)+(15.028), (I.59)+(15.029), (I.59)+(15.030), (I.59)+(15.031), (I.59)+(15.032), (I.59)+(15.033), (I.59)+(15.034), (I.59)+(15.035), (I.59)+(15.036), (I.59)+(15.037), (I.59)+(15.038), (I.59)+(15.039), (I.59)+(15.040), (I.59)+(15.041), (I.59)+(15.042), (I.59)+(15.043), (I.59)+(15.044), (I.59)+(15.045), (I.59)+(15.046), (I.59)+(15.047), (I.59)+(15.048), (I.59)+(15.049), (I.59)+(15.050), (I.59)+(15.051), (I.59)+(15.052), (I.59)+(15.053), (I.59)+(15.054), (I.59)+(15.055), (I.59)+(15.056), (I.59)+(15.057), (I.59)+(15.058), (I.59)+(15.059), (I.59)+(15.060), (I.59)+(15.061), and (I.59)+(15.062).

Also preferred compound combinations are selected from the group (G3) consisting of the following mixtures:

(I.81)+(1.001), (I.81)+(1.002), (I.81)+(1.003), (I.81)+(1.004), (I.81)+(1.005), (I.81)+(1.006), (I.81)+(1.007), (I.81)+(1.008), (I.81)+(1.009), (I.81)+(1.010), (I.81)+(1.011), (I.81)+(1.012), (I.81)+(1.013), (I.81)+(1.014), (I.81)+(1.015), (I.81)+(1.016), (I.81)+(1.017), (I.81)+(1.018), (I.81)+(1.019), (I.81)+(1.020), (I.81)+(1.021), (I.81)+(1.022), (I.81)+(1.023), (I.81)+(1.024), (I.81)+(1.025), (I.81)+(1.026), (I.81)+(1.027), (I.81)+(1.028), (I.81)+(1.029), (I.81)+(1.030), (I.81)+(1.031), (I.81)+(1.032), (I.81)+(1.033), (I.81)+(1.034), (I.81)+(1.035), (I.81)+(1.036), (I.81)+(1.037), (I.81)+(1.038), (I.81)+(1.039), (I.81)+(1.040), (I.81)+(1.041), (I.81)+(1.042), (I.81)+(1.043), (I.81)+(1.044), (I.81)+(1.045), (I.81)+(1.046), (I.81)+(1.047), (I.81)+(1.048), (I.81)+(1.049), (I.81)+(1.050), (I.81)+(1.051), (I.81)+(1.052), (I.81)+(1.053), (I.81)+(1.054), (I.81)+(1.055), (I.81)+(1.056), (I.81)+(1.057), (I.81)+(1.058), (I.81)+(1.059), (I.81)+(1.060), (I.81)+(1.061), (I.81)+(1.062), (I.81)+(1.063), (I.81)+(1.064), (I.81)+(1.065), (I.81)+(1.066), (I.81)+(1.067), (I.81)+(1.068), (I.81)+(1.069), (I.81)+(1.070), (I.81)+(1.071), (I.81)+(1.072), (I.81)+(1.073), (I.81)+(1.074), (I.81)+(1.075), (I.81)+(1.076), (I.81)+(1.077), (I.81)+(1.078), (I.81)+(1.079), (I.81)+(1.080), (I.81)+(1.081), (I.81)+(1.082), (I.81)+(2.001), (I.81)+(2.002), (I.81)+(2.003), (I.81)+(2.004), (I.81)+(2.005), (I.81)+(2.006), (I.81)+(2.007), (I.81)+(2.008), (I.81)+(2.009), (I.81)+(2.010), (I.81)+(2.011), (I.81)+(2.012), (I.81)+(2.013), (I.81)+(2.014), (I.81)+(2.015), (I.81)+(2.016), (I.81)+(2.017), (I.81)+(2.018), (I.81)+(2.019), (I.81)+(2.020), (I.81)+(2.021), (I.81)+(2.022), (I.81)+(2.023), (I.81)+(2.024), (I.81)+(2.025), (I.81)+(2.026), (I.81)+(2.027), (I.81)+(2.028), (I.81)+(2.029), (I.81)+(2.030), (I.81)+(2.031), (I.81)+(2.032), (I.81)+(2.033), (I.81)+(2.034), (I.81)+(2.035), (I.81)+(2.036), (I.81)+(2.037), (I.81)+(2.038), (I.81)+(2.039), (I.81)+(2.040), (I.81)+(2.041), (I.81)+(2.042), (I.81)+(2.043), (I.81)+(2.044), (I.81)+(2.045), (I.81)+(2.046), (I.81)+(2.047), (I.81)+(2.048), (I.81)+(2.049), (I.81)+(2.050), (I.81)+(2.051), (I.81)+(2.052), (I.81)+(2.053), (I.81)+(2.054), (I.81)+(2.055), (I.81)+(2.056), (I.81)+(3.001), (I.81)+(3.002), (I.81)+(3.003), (I.81)+(3.004), (I.81)+(3.005), (I.81)+(3.006), (I.81)+(3.007), (I.81)+(3.008), (I.81)+(3.009), (I.81)+(3.010), (I.81)+(3.011), (I.81)+(3.012), (I.81)+(3.013), (I.81)+(3.014), (I.81)+(3.015), (I.81)+(3.016), (I.81)+(3.017), (I.81)+(3.018), (I.81)+(3.019), (I.81)+(3.020), (I.81)+(3.021), (I.81)+(3.022), (I.81)+(3.023), (I.81)+(3.024), (I.81)+(3.025), (I.81)+(3.026), (I.81)+(3.027), (I.81)+(3.028), (I.81)+(3.029), (I.81)+(4.001), (I.81)+(4.002), (I.81)+(4.003), (I.81)+(4.004), (I.81)+(4.005), (I.81)+(4.006), (I.81)+(4.007), (I.81)+(4.008), (I.81)+(4.009), (I.81)+(4.010), (I.81)+(4.011), (I.81)+(4.012), (I.81)+(4.013), (I.81)+(4.014), (I.81)+(4.015), (I.81)+(4.016), (I.81)+(4.017), (I.81)+(4.018), (I.81)+(4.019), (I.81)+(4.020), (I.81)+(4.021), (I.81)+(4.022), (I.81)+(4.023), (I.81)+(4.024), (I.81)+(4.025), (I.81)+(5.001), (I.81)+(5.002), (I.81)+(5.003), (I.81)+(5.004), (I.81)+(5.005), (I.81)+(5.006), (I.81)+(5.007), (I.81)+(5.008), (I.81)+(5.009), (I.81)+(5.010), (I.81)+(5.011), (I.81)+(5.012), (I.81)+(5.013), (I.81)+(5.014), (I.81)+(5.015), (I.81)+(5.016), (I.81)+(5.017), (I.81)+(5.018), (I.81)+(5.019), (I.81)+(5.020), (I.81)+(5.021), (I.81)+(5.022), (I.81)+(5.023), (I.81)+(6.001), (I.81)+(6.002), (I.81)+(6.003), (I.81)+(6.004), (I.81)+(7.001), (I.81)+(7.002), (I.81)+(7.003), (I.81)+(7.004), (I.81)+(7.005), (I.81)+(7.006), (I.81)+(8.001), (I.81)+(9.001), (I.81)+(9.002), (I.81)+(9.003), (I.81)+(9.004), (I.81)+(9.005), (I.81)+(9.006), (I.81)+(9.007), (I.81)+(9.008), (I.81)+(9.009), (I.81)+(10.001), (I.81)+(10.002), (I.81)+(10.003), (I.81)+(11.001), (I.81)+(11.002), (I.81)+(12.001), (I.81)+(12.002), (I.81)+(12.003), (I.81)+(12.004), (I.81)+(13.001), (I.81)+(13.002), (I.81)+(13.003), (I.81)+(13.004), (I.81)+(13.005), (I.81)+(13.006), (I.81)+(14.001), (I.81)+(14.002), (I.81)+(15.001), (I.81)+(15.002), (I.81)+(15.003), (I.81)+(15.004), (I.81)+(15.005), (I.81)+(15.006), (I.81)+(15.007), (I.81)+(15.008), (I.81)+(15.009), (I.81)+(15.010), (I.81)+(15.011), (I.81)+(15.012), (I.81)+(15.013), (I.81)+(15.014), (I.81)+(15.015), (I.81)+(15.016), (I.81)+(15.017), (I.81)+(15.018), (I.81)+(15.019), (I.81)+(15.020), (I.81)+(15.021), (I.81)+(15.022), (I.81)+(15.023), (I.81)+(15.024), (I.81)+(15.025), (I.81)+(15.026), (I.81)+(15.027), (I.81)+(15.028), (I.81)+(15.029), (I.81)+(15.030), (I.81)+(15.031), (I.81)+(15.032), (I.81)+(15.033), (I.81)+(15.034), (I.81)+(15.035), (I.81)+(15.036), (I.81)+(15.037), (I.81)+(15.038), (I.81)+(15.039), (I.81)+(15.040), (I.81)+(15.041), (I.81)+(15.042), (I.81)+(15.043), (I.81)+(15.044), (I.81)+(15.045), (I.81)+(15.046), (I.81)+(15.047), (I.81)+(15.048), (I.81)+(15.049), (I.81)+(15.050), (I.81)+(15.051), (I.81)+(15.052), (I.81)+(15.053), (I.81)+(15.054), (I.81)+(15.055), (I.81)+(15.056), (I.81)+(15.057), (I.81)+(15.058), (I.81)+(15.059), (I.81)+(15.060), (I.81)+(15.061), and (I.81)+(15.062).

Also preferred compound combinations are selected from the group (G4) consisting of the following mixtures:

(I.91)+(1.001), (I.91)+(1.002), (I.91)+(1.003), (I.91)+(1.004), (I.91)+(1.005), (I.91)+(1.006), (I.91)+(1.007), (I.91)+(1.008), (I.91)+(1.009), (I.91)+(1.010), (I.91)+(1.011), (I.91)+(1.012), (I.91)+(1.013), (I.91)+(1.014), (I.91)+(1.015), (I.91)+(1.016), (I.91)+(1.017), (I.91)+(1.018), (I.91)+(1.019), (I.91)+(1.020), (I.91)+(1.021), (I.91)+(1.022), (I.91)+(1.023), (I.91)+(1.024), (I.91)+(1.025), (I.91)+(1.026), (I.91)+(1.027), (I.91)+(1.028), (I.91)+(1.029), (I.91)+(1.030), (I.91)+(1.031), (I.91)+(1.032), (I.91)+(1.033), (I.91)+(1.034), (I.91)+(1.035), (I.91)+(1.036), (I.91)+(1.037), (I.91)+(1.038), (I.91)+(1.039), (I.91)+(1.040), (I.91)+(1.041), (I.91)+(1.042), (I.91)+(1.043), (I.91)+(1.044), (I.91)+(1.045), (I.91)+(1.046), (I.91)+(1.047), (I.91)+(1.048), (I.91)+(1.049), (I.91)+(1.050), (I.91)+(1.051), (I.91)+(1.052), (I.91)+(1.053), (I.91)+(1.054), (I.91)+(1.055), (I.91)+(1.056), (I.91)+(1.057), (I.91)+(1.058), (I.91)+(1.059), (I.91)+(1.060), (I.91)+(1.061), (I.91)+(1.062), (I.91)+(1.063), (I.91)+(1.064), (I.91)+(1.065), (I.91)+(1.066), (I.91)+(1.067), (I.91)+(1.068), (I.91)+(1.069), (I.91)+(1.070), (I.91)+(1.071), (I.91)+(1.072), (I.91)+(1.073), (I.91)+(1.074), (I.91)+(1.075), (I.91)+(1.076), (I.91)+(1.077), (I.91)+(1.078), (I.91)+(1.079), (I.91)+(1.080), (I.91)+(1.081), (I.91)+(1.082), (I.91)+(2.001), (I.91)+(2.002), (I.91)+(2.003), (I.91)+(2.004), (I.91)+(2.005), (I.91)+(2.006), (I.91)+(2.007), (I.91)+(2.008), (I.91)+(2.009), (I.91)+(2.010), (I.91)+(2.011), (I.91)+(2.012), (I.91)+(2.013), (I.91)+(2.014), (I.91)+(2.015), (I.91)+(2.016), (I.91)+(2.017), (I.91)+(2.018), (I.91)+(2.019), (I.91)+(2.020), (I.91)+(2.021), (I.91)+(2.022), (I.91)+(2.023), (I.91)+(2.024), (I.91)+(2.025), (I.91)+(2.026), (I.91)+(2.027), (I.91)+(2.028), (I.91)+(2.029), (I.91)+(2.030), (I.91)+(2.031), (I.91)+(2.032), (I.91)+(2.033), (I.91)+(2.034), (I.91)+(2.035), (I.91)+(2.036), (I.91)+(2.037), (I.91)+(2.038), (I.91)+(2.039), (I.91)+(2.040), (I.91)+(2.041), (I.91)+(2.042), (I.91)+(2.043), (I.91)+(2.044), (I.91)+(2.045), (I.91)+(2.046), (I.91)+(2.047), (I.91)+(2.048), (I.91)+(2.049), (I.91)+(2.050), (I.91)+(2.051), (I.91)+(2.052), (I.91)+(2.053), (I.91)+(2.054), (I.91)+(2.055), (I.91)+(2.056), (I.91)+(3.001), (I.91)+(3.002), (I.91)+(3.003), (I.91)+(3.004), (I.91)+(3.005), (I.91)+(3.006), (I.91)+(3.007), (I.91)+(3.008), (I.91)+(3.009), (I.91)+(3.010), (I.91)+(3.011), (I.91)+(3.012), (I.91)+(3.013), (I.91)+(3.014), (I.91)+(3.015), (I.91)+(3.016), (I.91)+(3.017), (I.91)+(3.018), (I.91)+(3.019), (I.91)+(3.020), (I.91)+(3.021), (I.91)+(3.022), (I.91)+(3.023), (I.91)+(3.024), (I.91)+(3.025), (I.91)+(3.026), (I.91)+(3.027), (I.91)+(3.028), (I.91)+(3.029), (I.91)+(4.001), (I.91)+(4.002), (I.91)+(4.003), (I.91)+(4.004), (I.91)+(4.005), (I.91)+(4.006), (I.91)+(4.007), (I.91)+(4.008), (I.91)+(4.009), (I.91)+(4.010), (I.91)+(4.011), (I.91)+(4.012), (I.91)+(4.013), (I.91)+(4.014), (I.91)+(4.015), (I.91)+(4.016), (I.91)+(4.017), (I.91)+(4.018), (I.91)+(4.019), (I.91)+(4.020), (I.91)+(4.021), (I.91)+(4.022), (I.91)+(4.023), (I.91)+(4.024), (I.91)+(4.025), (I.91)+(5.001), (I.91)+(5.002), (I.91)+(5.003), (I.91)+(5.004), (I.91)+(5.005), (I.91)+(5.006), (I.91)+(5.007), (I.91)+(5.008), (I.91)+(5.009), (I.91)+(5.010), (I.91)+(5.011), (I.91)+(5.012), (I.91)+(5.013), (I.91)+(5.014), (I.91)+(5.015), (I.91)+(5.016), (I.91)+(5.017), (I.91)+(5.018), (I.91)+(5.019), (I.91)+(5.020), (I.91)+(5.021), (I.91)+(5.022), (I.91)+(5.023), (I.91)+(6.001), (I.91)+(6.002), (I.91)+(6.003), (I.91)+(6.004), (I.91)+(7.001), (I.91)+(7.002), (I.91)+(7.003), (I.91)+(7.004), (I.91)+(7.005), (I.91)+(7.006), (I.91)+(8.001), (I.91)+(9.001), (I.91)+(9.002), (I.91)+(9.003), (I.91)+(9.004), (I.91)+(9.005), (I.91)+(9.006), (I.91)+(9.007), (I.91)+(9.008), (I.91)+(9.009), (I.91)+(10.001), (I.91)+(10.002), (I.91)+(10.003), (I.91)+(11.001), (I.91)+(11.002), (I.91)+(12.001), (I.91)+(12.002), (I.91)+(12.003), (I.91)+(12.004), (I.91)+(13.001), (I.91)+(13.002), (I.91)+(13.003), (I.91)+(13.004), (I.91)+(13.005), (I.91)+(13.006), (I.91)+(14.001), (I.91)+(14.002), (I.91)+(15.001), (I.91)+(15.002), (I.91)+(15.003), (I.91)+(15.004), (I.91)+(15.005), (I.91)+(15.006), (I.91)+(15.007), (I.91)+(15.008), (I.91)+(15.009), (I.91)+(15.010), (I.91)+(15.011), (I.91)+(15.012), (I.91)+(15.013), (I.91)+(15.014), (I.91)+(15.015), (I.91)+(15.016), (I.91)+(15.017), (I.91)+(15.018), (I.91)+(15.019), (I.91)+(15.020), (I.91)+(15.021), (I.91)+(15.022), (I.91)+(15.023), (I.91)+(15.024), (I.91)+(15.025), (I.91)+(15.026), (I.91)+(15.027), (I.91)+(15.028), (I.91)+(15.029), (I.91)+(15.030), (I.91)+(15.031), (I.91)+(15.032), (I.91)+(15.033), (I.91)+(15.034), (I.91)+(15.035), (I.91)+(15.036), (I.91)+(15.037), (I.91)+(15.038), (I.91)+(15.039), (I.91)+(15.040), (I.91)+(15.041), (I.91)+(15.042), (I.91)+(15.043), (I.91)+(15.044), (I.91)+(15.045), (I.91)+(15.046), (I.91)+(15.047), (I.91)+(15.048), (I.91)+(15.049), (I.91)+(15.050), (I.91)+(15.051), (I.91)+(15.052), (I.91)+(15.053), (I.91)+(15.054), (I.91)+(15.055), (I.91)+(15.056), (I.91)+(15.057), (I.91)+(15.058), (I.91)+(15.059), (I.91)+(15.060), (I.91)+(15.061), and (I.91)+(15.062).

More preferred the compound combinations are selected from the mixtures belonging to group (G1) or (G2).

Even more preferred compound combinations are selected from the group (G1-A) consisting of the following mixtures:

(I.01)+(1.012), (I.01)+(1.018), (I.01)+(1.020), (I.01)+(1.021), (I.01)+(2.002), (I.01)+(2.005), (I.01)+(2.017), (I.01)+(2.027), (I.01)+(2.038), (I.01)+(3.020), (I.01)+(3.025), (I.01)+(4.005), (I.01)+(5.004), (I.01)+(5.013), (I.01)+(5.018), (I.01)+(12.003), (I.01)+(12.004), (I.01)+(13.001), (I.01)+(13.004), (I.01)+(15.008), (I.01)+(15.047).

Even more preferred compound combinations are also selected from the group (G2-A) consisting of the following mixtures:

(I.59)+(1.012), (I.59)+(1.018), (I.59)+(1.020), (I.59)+(1.021), (I.59)+(2.002), (I.59)+(2.005), (I.59)+(2.017), (I.59)+(2.027), (I.59)+(2.038), (I.59)+(3.020), (I.59)+(3.025), (I.59)+(4.005), (I.59)+(5.004), (I.59)+(5.013), (I.59)+(5.018), (I.59)+(12.003), (I.59)+(12.004), (I.59)+(13.001), (I.59)+(13.004), (I.59)+(15.008), (I.59)+(15.047).

Even more preferred compound combinations are also selected from the group (G3-A) consisting of the following mixtures:

(I.81)+(1.012), (I.81)+(1.018), (I.81)+(1.020), (I.81)+(1.021), (I.81)+(2.002), (I.81)+(2.005), (I.81)+(2.017), (I.81)+(2.027), (I.81)+(2.038), (I.81)+(3.020), (I.81)+(3.025), (I.81)+(4.005), (I.81)+(5.004), (I.81)+(5.013), (I.81)+(5.018), (I.81)+(12.003), (I.81)+(12.004), (I.81)+(13.001), (I.81)+(13.004), (I.81)+(15.008), (I.81)+(15.047).

Even more preferred compound combinations are also selected from the group (G4-A) consisting of the following mixtures:

(I.91)+(1.012), (I.91)+(1.018), (I.91)+(1.020), (I.91)+(1.021), (I.91)+(2.002), (I.91)+(2.005), (I.91)+(2.017), (I.91)+(2.027), (I.91)+(2.038), (I.91)+(3.020), (I.91)+(3.025), (I.91)+(4.005), (I.91)+(5.004), (I.91)+(5.013), (I.91)+(5.018), (I.91)+(12.003), (I.91)+(12.004), (I.91)+(13.001), (I.91)+(13.004), (I.91)+(15.008), (I.91)+(15.047).

Most preferred the compound combinations are selected from the mixtures belonging to group (G1-A) or (G2-A).

In the combinations according to the invention the compounds (A), i.e. triazole derivatives of formula (I), and (B), i.e. further active compounds selected from groups (1) to (15), can be present in a broad range of effective weight ratio of A:B, for example in a range of 100:1 to 1:100, preferably in a weight ratio of 50:1 to 1:50, most preferably in a weight ratio of 20:1 to 1:20. Further ratios of A:B which can be used according to the present invention with increasing preference in the order given are: 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 45:1 to 1:45, 40:1 to 1:40, 35:1 to 1:35, 30:1 to 1:30, 25:1 to 1:25, 15:1 to 1:15, 10:1 to 1:10, 5:1 to 1:5, 4:1 to 1:4, 3:1 to 1:3, 2:1 to 1:2.

Where a compound (A) or a compound (B) can be present in isomeric forms and/or tautomeric forms, such a compound is understood hereinabove and hereinbelow also to include, where applicable, corresponding isomeric and/or tautomeric forms or mixtures thereof, even when these are not specifically mentioned in each case.

Methods and Uses

The invention also relates to a method for controlling unwanted microorganisms, characterized in that a compound combination according to the invention or a composition comprising such combination is applied to the microorganisms and/or in their habitat.

The invention further relates to seed which has been treated with a compound combination according to the invention or a composition comprising such combination.

The invention finally provides a method for protecting seed against unwanted microorganisms by using seed treated with a compound combination according to the invention or a composition comprising such combination.

The compound combinations according to the invention and compositions comprising such combination have potent microbicidal activity and can be used for control of unwanted microorganisms, such as fungi and bacteria, in crop protection and in the protection of materials.

The compound combinations according to the invention and compositions comprising such combination have very good fungicidal properties and can be used in crop protection, for example for control of Plasmodiophoromycetes, Oomycetes, Chytridiomycetes, Zygomycetes, Ascomycetes, Basidiomycetes and Deuteromycetes.

Bactericides can be used in crop protection, for example, for control of Pseudomonadaceae, Rhizobiaceae, Enterobacteriaceae, Corynebacteriaceae and Streptomycetaceae.

The compound combinations according to the invention and compositions comprising such combination can be used for curative or protective control of phytopathogenic fungi. The invention therefore also relates to curative and protective methods for controlling phytopathogenic fungi by the use of the inventive combinations or compositions, which are applied to the seed, the plant or plant parts, the fruit or the soil in which the plants grow.

Plants

All plants and plant parts can be treated in accordance with the invention. Plants are understood here to mean all plants and plant populations, such as desired and undesired wild plants or crop plants (including naturally occurring crop plants). Crop plants may be plants which can be obtained by conventional breeding and optimization methods or by biotechnological and genetic engineering methods or combinations of these methods, including the transgenic plants and including the plant cultivars which are protectable and non-protectable by plant breeders' rights. Plant parts are understood to mean all parts and organs of plants above and below the ground, such as shoot, leaf, flower and root, examples of which include leaves, needles, stalks, stems, flowers, fruit bodies, fruits and seeds, and also roots, tubers and rhizomes. The plant parts also include harvested material and vegetative and generative propagation material, for example cuttings, tubers, rhizomes, slips and seeds.

Plants which can be treated in accordance with the invention include the following: cotton, flax, grapevine, fruit, vegetables, such as Rosaceae sp. (for example pome fruits such as apples and pears, but also stone fruits such as apricots, cherries, almonds and peaches, and soft fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumber), Alliaceae sp. (for example leek, onion), Papilionaceae sp. (for example peas); major crop plants, such as Gramineae sp. (for example maize, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak choi, kohlrabi, radishes, and oilseed rape, mustard, horseradish and cress), Fabacae sp. (for example bean, peanuts), Papilionaceae sp. (for example soya bean), Solanaceae sp. (for example potatoes), Chenopodiaceae sp. (for example sugar beet, fodder beet, swiss chard, beetroot); useful plants and ornamental plants for gardens and wooded areas; and genetically modified varieties of each of these plants.

Pathogens

Non-limiting examples of pathogens of fungal diseases which can be treated in accordance with the invention include:

diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator;
diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae; Puccinia species, for example Puccinia recondita, Puccinia graminis oder Puccinia striiformis; Uromyces species, for example Uromyces appendiculatus;
diseases caused by pathogens from the group of the Oomycetes, for example Albugo species, for example Albugo candida; Bremia species, for example Bremia lactucae; Peronospora species, for example Peronospora pisi or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimum;
leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidial form: Drechslera, syn: Helminthosporium) or Cochliobolus miyabeanus; Colletotrichum species, for example Colletotrichum lindemuthanium; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria maculans; Magnaporthe species, for example Magnaporthe grisea; Microdochium species, for example Microdochium nivale; Mycosphaerella species, for example Mycosphaerella graminicola, Mycosphaerella arachidicola or Mycosphaerella fijiensis; Phaeosphaeria species, for example Phaeosphaeria nodorum; Pyrenophora species, for example Pyrenophora teres or Pyrenophora tritici repentis; Ramularia species, for example Ramularia collo-cygni or Ramularia areola; Rhynchosporium species, for example Rhynchosporium secalis; Septoria species, for example Septoria apii or Septoria lycopersici; Stagonospora species, for example Stagonospora nodorum; Typhula species, for example Typhula incarnata; Venturia species, for example Venturia inaequalis;
root and stem diseases caused, for example, by Corticium species, for example Corticium graminearum; Fusarium species, for example Fusarium oxysporum; Gaeumannomyces species, for example Gaeumannomyces graminis; Plasmodiophora species, for example Plasmodiophora brassicae; Rhizoctonia species, for example Rhizoctonia solani; Sarocladium species, for example Sarocladium oryzae; Sclerotium species, for example Sclerotium oryzae; Tapesia species, for example Tapesia acuformis; Thielaviopsis species, for example Thielaviopsis basicola;
ear and panicle diseases (including corn cobs) caused, for example, by Alternaria species, for example Altemaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Stagnospora species, for example Stagnospora nodorum;
diseases caused by smut fungi, for example Sphacelotheca species, for example Sphacelotheca reiliana; Tilletia species, for example Tilletia caries or Tilletia controversa; Urocystis species, for example Urocystis occulta; Ustilago species, for example Ustilago nuda;
fruit rot caused, for example, by Aspergillus species, for example Aspergillus flavus; Botrytis species, for example Botrytis cinerea; Penicillium species, for example Penicillium expansum or Penicillium purpurogenum; Rhizopus species, for example Rhizopus stolonifer; Sclerotinia species, for example Sclerotinia sclerotiorum; Verticilium species, for example Verticilium alboatrum;
seed- and soil-borne rot and wilt diseases, and also diseases of seedlings, caused, for example, by Altemaria species, for example Altemaria brassicicola; Aphanomyces species, for example Aphanomyces euteiches; Ascochyta species, for example Ascochyta lentis; Aspergillus species, for example Aspergillus flavus; Cladosporium species, for example Cladosporium herbarum; Cochliobolus species, for example Cochliobolus sativus (conidial form: Drechslera, Bipolaris Syn: Helminthosporium); Colletotrichum species, for example Colletotrichum coccodes; Fusarium species, for example Fusarium culmorum; Gibberella species, for example Gibberella zeae; Macrophomina species, for example Macrophomina phaseolina; Microdochium species, for example Microdochium nivale; Monographella species, for example Monographella nivalis; Penicillium species, for example Penicillium expansum; Phoma species, for example Phoma lingam; Phomopsis species, for example Phomopsis sojae; Phytophthora species, for example Phytophthora cactorum; Pyrenophora species, for example Pyrenophora graminea; Pyricularia species, for example Pyricularia oryzae; Pythium species, for example Pythium ultimum; Rhizoctonia species, for example Rhizoctonia solani; Rhizopus species, for example Rhizopus oryzae; Sclerotium species, for example Sclerotium rolfsii; Septoria species, for example Septoria nodorum; Typhula species, for example Typhula incarnata; Verticillium species, for example Verticillium dahliae;
cancers, galls and witches' broom caused, for example, by Nectria species, for example Nectria galligena;
wilt diseases caused, for example, by Monilinia species, for example Monilinia laxa;
deformations of leaves, flowers and fruits caused, for example, by Exobasidium species, for example Exobasidium vexans; Taphrina species, for example Taphrina deformans;
degenerative diseases in woody plants, caused, for example, by Esca species, for example Phaeomoniella chlamydospora, Phaeoacremonium aleophilum or Fomitiporia mediterranea; Ganoderma species, for example Ganoderma boninense;
diseases of flowers and seeds caused, for example, by Botrytis species, for example Botrytis cinerea;
diseases of plant tubers caused, for example, by Rhizoctonia species, for example Rhizoctonia solani; Helminthosporium species, for example Helminthosporium solani;
diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora.

Preference is given to controlling the following diseases of soya beans:

Fungal diseases on leaves, stems, pods and seeds caused, for example, by Alternaria leaf spot (Alternaria spec. atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi, Phakopsora meibomiae), scab (Sphaceloma glycines), stemphylium leaf blight (Stemphylium botryosum), target spot (Corynespora cassiicola).

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

Preference is further given to controlling leaf blotch diseases and leaf wilt diseases as well as root and stem diseases of fruits and vegetables.

Plant Growth Regulation

In some cases, the compound combinations according to the invention and composition comprising such combination can, at particular concentrations or application rates, also be used as growth regulators or agents to improve plant properties, or as microbicides, for example as fungicides, antimycotics, bactericides, viricides (including compositions against viroids) or as compositions against MLO (Mycoplasma-like organisms) and RLO (Rickettsia-like organisms).

The compound combinations according to the invention and compositions comprising such combination intervene in physiological processes of plants and can therefore also be used as plant growth regulators. Plant growth regulators may exert various effects on plants. The effect of the substances depends essentially on the time of application in relation to the developmental stage of the plant, and also on the amounts of active ingredient applied to the plants or their environment and on the type of application. In each case, growth regulators should have a particular desired effect on the crop plants.

Growth regulating effects, comprise earlier germination, better emergence, more developed root system and/or improved root growth, increased ability of tillering, more productive tillers, earlier flowering, increased plant height and/or biomass, shorting of stems, improvements in shoot growth, number of kernels/ear, number of ears/m², number of stolons and/or number of flowers, enhanced harvest index, bigger leaves, less dead basal leaves, improved phyllotaxy, earlier maturation/earlier fruit finish, homogenous riping, increased duration of grain filling, better fruit finish, bigger fruit/vegetable size, sprouting resistance and reduced lodging.

Increased or improved yield is referring to total biomass per hectare, yield per hectare, kernel/fruit weight, seed size and/or hectolitre weight as well as to improved product quality, comprising:

improved processability relating to size distribution (kernel, fruit, etc.), homogenous riping, grain moisture, better milling, better vinification, better brewing, increased juice yield, harvestability, digestibility, sedimentation value, falling number, pod stability, storage stability, improved fiber length/strength/uniformity, increase of milk and/or meet quality of silage fed animals, adaption to cooking and frying;
further comprising improved marketability relating to improved fruit/grain quality, size distribution (kernel, fruit, etc.), increased storage/shelf-life, firmness/softness, taste (aroma, texture, etc.), grade (size, shape, number of berries, etc.), number of berries/fruits per bunch, crispness, freshness, coverage with wax, frequency of physiological disorders, colour, etc.;
further comprising increased desired ingredients such as e.g. protein content, fatty acids, oil content, oil quality, aminoacid composition, sugar content, acid content (pH), sugar/acid ratio (Brix), polyphenols, starch content, nutritional quality, gluten content/index, energy content, taste, etc.;
and further comprising decreased undesired ingredients such as e.g. less mycotoxines, less aflatoxines, geosmin level, phenolic aromas, lacchase, polyphenol oxidases and peroxidases, nitrate content etc.

Plant growth-regulating compounds can be used, for example, to slow down the vegetative growth of the plants. Such growth depression is of economic interest, for example, in the case of grasses, since it is thus possible to reduce the frequency of grass cutting in ornamental gardens, parks and sport facilities, on roadsides, at airports or in fruit crops. Also of significance is the inhibition of the growth of herbaceous and woody plants on roadsides and in the vicinity of pipelines or overhead cables, or quite generally in areas where vigorous plant growth is unwanted.

Also important is the use of growth regulators for inhibition of the longitudinal growth of cereal. This reduces or completely eliminates the risk of lodging of the plants prior to harvest. In addition, growth regulators in the case of cereals can strengthen the culm, which also counteracts lodging. The employment of growth regulators for shortening and strengthening culms allows the deployment of higher fertilizer volumes to increase the yield, without any risk of lodging of the cereal crop.

In many crop plants, vegetative growth depression allows denser planting, and it is thus possible to achieve higher yields based on the soil surface. Another advantage of the smaller plants obtained in this way is that the crop is easier to cultivate and harvest.

Reduction of the vegetative plant growth may also lead to increased or improved yields because the nutrients and assimilates are of more benefit to flower and fruit formation than to the vegetative parts of the plants.

Alternatively, growth regulators can also be used to promote vegetative growth. This is of great benefit when harvesting the vegetative plant parts. However, promoting vegetative growth may also promote generative growth in that more assimilates are formed, resulting in more or larger fruits.

Furthermore, beneficial effects on growth or yield can be achieved through improved nutrient use efficiency, especially nitrogen (N)-use efficiency, phosphours (P)-use efficiency, water use efficiency, improved transpiration, respiration and/or CO2 assimilation rate, better nodulation, improved Ca-metabolism etc.

Likewise, growth regulators can be used to alter the composition of the plants, which in turn may result in an improvement in quality of the harvested products. Under the influence of growth regulators, parthenocarpic fruits may be formed. In addition, it is possible to influence the sex of the flowers. It is also possible to produce sterile pollen, which is of great importance in the breeding and production of hybrid seed.

Use of growth regulators can control the branching of the plants. On the one hand, by breaking apical dominance, it is possible to promote the development of side shoots, which may be highly desirable particularly in the cultivation of ornamental plants, also in combination with an inhibition of growth. On the other hand, however, it is also possible to inhibit the growth of the side shoots. This effect is of particular interest, for example, in the cultivation of tobacco or in the cultivation of tomatoes.

Under the influence of growth regulators, the amount of leaves on the plants can be controlled such that defoliation of the plants is achieved at a desired time. Such defoliation plays a major role in the mechanical harvesting of cotton, but is also of interest for facilitating harvesting in other crops, for example in viticulture. Defoliation of the plants can also be undertaken to lower the transpiration of the plants before they are transplanted.

Furthermore, growth regulators can modulate plant senescence, which may result in prolonged green leaf area duration, a longer grain filling phase, improved yield quality, etc.

Growth regulators can likewise be used to regulate fruit dehiscence. On the one hand, it is possible to prevent premature fruit dehiscence. On the other hand, it is also possible to promote fruit dehiscence or even flower abortion to achieve a desired mass (“thinning”). In addition it is possible to use growth regulators at the time of harvest to reduce the forces required to detach the fruits, in order to allow mechanical harvesting or to facilitate manual harvesting.

Growth regulators can also be used to achieve faster or else delayed ripening of the harvested material before or after harvest. This is particularly advantageous as it allows optimal adjustment to the requirements of the market. Moreover, growth regulators in some cases can improve the fruit colour. In addition, growth regulators can also be used to synchronize maturation within a certain period of time. This establishes the prerequisites for complete mechanical or manual harvesting in a single operation, for example in the case of tobacco, tomatoes or coffee.

By using growth regulators, it is additionally possible to influence the resting of seed or buds of the plants, such that plants such as pineapple or ornamental plants in nurseries, for example, germinate, sprout or flower at a time when they are normally not inclined to do so. In areas where there is a risk of frost, it may be desirable to delay budding or germination of seeds with the aid of growth regulators, in order to avoid damage resulting from late frosts.

Finally, growth regulators can induce resistance of the plants to frost, drought or high salinity of the soil. This allows the cultivation of plants in regions which are normally unsuitable for this purpose.

Resistance Induction/Plant Health and Other Effects

The compound combinations according to the invention and compositions comprising such combination may also exhibit a potent strengthening effect in plants. Accordingly, they can be used for mobilizing the defences of the plant against attack by undesirable microorganisms.

Plant-strengthening (resistance-inducing) substances in the present context are substances capable of stimulating the defence system of plants in such a way that the treated plants, when subsequently inoculated with undesirable microorganisms, develop a high degree of resistance to these microorganisms.

Further, in context with the present invention plant physiology effects comprise the following:

Abiotic stress tolerance, comprising tolerance to high or low temperatures, drought tolerance and recovery after drought stress, water use efficiency (correlating to reduced water consumption), flood tolerance, ozone stress and UV tolerance, tolerance towards chemicals like heavy metals, salts, pesticides etc.

Biotic stress tolerance, comprising increased fungal resistance and increased resistance against nematodes, viruses and bacteria. In context with the present invention, biotic stress tolerance preferably comprises increased fungal resistance and increased resistance against nematodes.

Increased plant vigor, comprising plant health/plant quality and seed vigor, reduced stand failure, improved appearance, increased recovery after periods of stress, improved pigmentation (e.g. chlorophyll content, stay-green effects, etc.) and improved photosynthetic efficiency.

Mycotoxins

In addition, the compound combinations according to the invention and compositions comprising such combination can reduce the mycotoxin content in the harvested material and the foods and feeds prepared therefrom. Mycotoxins include particularly, but not exclusively, the following: deoxynivalenol (DON), nivalenol, 15-Ac-DON, 3-Ac-DON, T2- and HT2-toxin, fumonisins, zearalenon, moniliformin, fusarin, diaceotoxyscirpenol (DAS), beauvericin, enniatin, fusaroproliferin, fusarenol, ochratoxins, patulin, ergot alkaloids and aflatoxins which can be produced, for example, by the following fungi: Fusarium spec., such as F. acuminatum, F. asiaticum, F. avenaceum, F. crookwellense, F. culmorum, F. graminearum (Gibberella zeae), F. equiseti, F. fujikoroi, F. musarum, F. oxysporum, F. proliferatum, F. poae, F. pseudograminearum, F. sambucinum, F. scirpi, F. semitectum, F. solani, F. sporotrichoides, F. langsethiae, F. subglutinans, F. tricinctum, F. verticillioides etc., and also by Aspergillus spec., such as A. flavus, A. parasiticus, A. nomius, A. ochraceus, A. clavatus, A. terreus, A. versicolor, Penicillium spec., such as P. verrucosum, P. viridicatum, P. citrinum, P. expansum, P. clavifonne, P. roqueforti, Claviceps spec., such as C. purpurea, C. fusiformis, C. paspali, C. africana, Stachybotrys spec. and others.

Material Protection

The compound combinations according to the invention and compositions comprising such combination can also be used in the protection of materials, for protection of industrial materials against attack and destruction by phytopathogenic fungi.

In addition, the compound combinations according to the invention and compositions comprising such combination can be used as antifouling compositions, alone or in combinations with other active ingredients.

Industrial materials in the present context are understood to mean inanimate materials which have been prepared for use in industry. For example, industrial materials which are to be protected by inventive compositions from microbial alteration or destruction may be adhesives, glues, paper, wallpaper and board/cardboard, textiles, carpets, leather, wood, fibers and tissues, paints and plastic articles, cooling lubricants and other materials which can be infected with or destroyed by microorganisms. Parts of production plants and buildings, for example cooling-water circuits, cooling and heating systems and ventilation and air-conditioning units, which may be impaired by the proliferation of microorganisms may also be mentioned within the scope of the materials to be protected. Industrial materials within the scope of the present invention preferably include adhesives, sizes, paper and card, leather, wood, paints, cooling lubricants and heat transfer fluids, more preferably wood.

The compound combinations according to the invention and compositions comprising such combination may prevent adverse effects, such as rotting, decay, discoloration, decoloration or formation of mould.

In the case of treatment of wood the compound combinations according to the invention and compositions comprising such combination may also be used against fungal diseases liable to grow on or inside timber. The term “timber” means all types of species of wood, and all types of working of this wood intended for construction, for example solid wood, high-density wood, laminated wood, and plywood. The method for treating timber according to the invention mainly consists in contacting a composition according to the invention; this includes for example direct application, spraying, dipping, injection or any other suitable means.

In addition, the compound combinations according to the invention and compositions comprising such combination can be used to protect objects which come into contact with saltwater or brackish water, especially hulls, screens, nets, buildings, moorings and signalling systems, from fouling.

The compound combinations according to the invention and compositions comprising such combination can also be employed for protecting storage goods. Storage goods are understood to mean natural substances of vegetable or animal origin or processed products thereof which are of natural origin, and for which long-term protection is desired. Storage goods of vegetable origin, for example plants or plant parts, such as stems, leaves, tubers, seeds, fruits, grains, can be protected freshly harvested or after processing by (pre)drying, moistening, comminuting, grinding, pressing or roasting. Storage goods also include timber, both unprocessed, such as construction timber, electricity poles and barriers, or in the form of finished products, such as furniture. Storage goods of animal origin are, for example, hides, leather, furs and hairs. The inventive compositions may prevent adverse effects, such as rotting, decay, discoloration, decoloration or formation of mould.

Microorganisms capable of degrading or altering the industrial materials include, for example, bacteria, fungi, yeasts, algae and slime organisms. The compounds of the formula (I) preferably act against fungi, especially moulds, wood-discoloring and wood-destroying fungi (Ascomycetes, Basidiomycetes, Deuteromycetes and Zygomycetes), and against slime organisms and algae. Examples include microorganisms of the following genera: Alternaria, such as Alternaria tenuis; Aspergillus, such as Aspergillus niger; Chaetomium, such as Chaetomium globosum; Coniophora, such as Coniophora puetana; Lentinus, such as Lentinus tigrinus; Penicillium, such as Penicillium glaucum; Polyporus, such as Polyporus versicolor; Aureobasidium, such as Aureobasidium pullulans; Sclerophoma, such as Sclerophoma pityophila; Trichoderma, such as Trichoderma viride; Ophiostoma spp., Ceratocystis spp., Humicola spp., Petriella spp., Trichurus spp., Coriolus spp., Gloeophyllum spp., Pleurotus spp., Poria spp., Serpula spp. and Tyromyces spp., Cladosporium spp., Paecilomyces spp. Mucor spp., Escherichia, such as Escherichia coli; Pseudomonas, such as Pseudomonas aeruginosa; Staphylococcus, such as Staphylococcus aureus, Candida spp. and Saccharomyces spp., such as Saccharomyces cerevisae.

Formulations

The present invention further relates to a composition for controlling unwanted microorganisms, comprising compound combinations according to the invention. These are preferably fungicidal compositions which comprise agriculturally suitable auxiliaries, like solvents, carriers, surfactants or extenders.

According to the invention, a carrier is a natural or synthetic, organic or inorganic substance with which the active ingredients are mixed or combined for better applicability, in particular for application to plants or plant parts or seed. The carrier, which may be solid or liquid, is generally inert and should be suitable for use in agriculture.

Useful solid carriers include: for example ammonium salts and natural rock flours, such as kaolins, clays, talc, chalk, quartz, attapulgite, montmorillonite or diatomaceous earth, and synthetic rock flours, such as finely divided silica, alumina and silicates; useful solid carriers for granules include: for example, crushed and fractionated natural rocks such as calcite, marble, pumice, sepiolite and dolomite, and also synthetic granules of inorganic and organic flours, and granules of organic material such as paper, sawdust, coconut shells, maize cobs and tobacco stalks; useful emulsifiers and/or foam-formers include: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Additionally suitable are oligo- or polymers, for example those derived from vinylic monomers, from acrylic acid, from EO and/or PO alone or in combination with, for example, (poly)alcohols or (poly)amines. It is also possible to use lignin and its sulphonic acid derivatives, unmodified and modified celluloses, aromatic and/or aliphatic sulphonic acids and also their adducts with formaldehyde.

The active ingredients can be converted to the customary formulations, such as solutions, emulsions, wettable powders, water- and oil-based suspensions, powders, dusts, pastes, soluble powders, soluble granules, granules for broadcasting, suspoemulsion concentrates, natural products impregnated with active ingredient, synthetic substances impregnated with active ingredient, fertilizers and also microencapsulations in polymeric substances.

The active ingredients can be applied as such, in the form of their formulations or the use forms prepared therefrom, such as ready-to-use solutions, emulsions, water- or oil-based suspensions, powders, wettable powders, pastes, soluble powders, dusts, soluble granules, granules for broadcasting, suspoemulsion concentrates, natural products impregnated with active ingredient, synthetic substances impregnated with active ingredient, fertilizers and also microencapsulations in polymeric substances. Application is accomplished in a customary manner, for example by watering, spraying, atomizing, broadcasting, dusting, foaming, spreading-on and the like. It is also possible to deploy the active ingredients by the ultra-low volume method or to inject the active ingredient preparation/the active ingredient itself into the soil. It is also possible to treat the seed of the plants.

The formulations mentioned can be prepared in a manner known per se, for example by mixing the active ingredients with at least one customary extender, solvent or diluent, emulsifier, dispersant and/or binder or fixing agent, wetting agent, a water repellent, if appropriate siccatives and UV stabilizers and if appropriate dyes and pigments, antifoams, preservatives, secondary thickeners, stickers, gibberellins and also other processing auxiliaries.

The present invention includes not only formulations which are already ready for use and can be deployed with a suitable apparatus to the plant or the seed, but also commercial concentrates which have to be diluted with water prior to use.

The compound combinations according to the invention may be present as such or in their (commercial) formulations and in the use forms prepared from these formulations as a mixture with other (known) active ingredients, such as insecticides, attractants, sterilants, bactericides, acaricides, nematicides, growth regulators, herbicides, fertilizers, safeners and/or semiochemicals.

The auxiliaries used may be those substances which are suitable for imparting particular properties to the composition itself or and/or to preparations derived therefrom (for example spray liquors, seed dressings), such as certain technical properties and/or also particular biological properties. Typical auxiliaries include: extenders, solvents and carriers.

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which may optionally also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

Liquefied gaseous extenders or carriers are understood to mean liquids which are gaseous at standard temperature and under standard pressure, for example aerosol propellants such as halohydrocarbons, or else butane, propane, nitrogen and carbon dioxide.

In the formulations it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids. Further additives may be mineral and vegetable oils.

If the extender used is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Compositions comprising compound combinations according to the invention may additionally comprise further components, for example surfactants. Suitable surfactants are emulsifiers and/or foam formers, dispersants or wetting agents having ionic or nonionic properties, or mixtures of these surfactants. Examples thereof are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example alkylaryl polyglycol ethers, alkylsulphonates, alkyl sulphates, arylsulphonates, protein hydrolysates, lignosulphite waste liquors and methylcellulose. The presence of a surfactant is necessary if one of the active ingredients and/or one of the inert carriers is insoluble in water and when application is effected in water. The proportion of surfactants is between 5 and 40 percent by weight of the inventive composition.

It is possible to use dyes such as inorganic pigments, for example iron oxide, titanium oxide and Prussian Blue, and organic dyes such as alizarin dyes, azo dyes and metal phthalocyanine dyes, and trace nutrients such as salts of iron, manganese, boron, copper, cobalt, molybdenum and zinc.

Further additives may be perfumes, mineral or vegetable, optionally modified oils, waxes and nutrients (including trace nutrients), such as salts of iron, manganese, boron, copper, cobalt, molybdenum and zinc.

Additional components may be stabilizers, such as cold stabilizers, preservatives, antioxidants, light stabilizers, or other agents which improve chemical and/or physical stability.

If appropriate, other additional components may also be present, for example protective colloids, binders, adhesives, thickeners, thixotropic substances, penetrants, stabilizers, sequestering agents, complex formers. In general, the active ingredients can be combined with any solid or liquid additive commonly used for formulation purposes.

The formulations contain generally between 0.05 and 99% by weight, 0.01 and 98% by weight, preferably between 0.1 and 95% by weight, more preferably between 0.5 and 90% of active ingredient, most preferably between 10 and 70 percent by weight.

The formulations described above can be used for controlling unwanted microorganisms, in which the compositions comprising compounds of the formula (I) are applied to the microorganisms and/or in their habitat.

Mixtures

Compound combinations according to the invention can be used as such or in formulations thereof and can be mixed with known bactericides, acaricides, nematicides or insecticides, in order thus to broaden, for example, the activity spectrum or to prevent development of resistance.

Useful mixing partners include, for example, known insecticides, acaricides, nematicides or else bactericides (see also Pesticide Manual, 14th ed.).

A mixture with other known active ingredients, such as herbicides, or with fertilizers and growth regulators, safeners and/or semiochemicals, is also possible.

Seed Treatment

The invention furthermore includes a method for treating seed.

A further aspect of the present invention relates in particular to seeds (dormant, primed, pregerminated or even with emerged roots and leaves) treated with a compound combination according to the invention or a composition comprising such combination. The inventive seeds are used in methods for protection of seeds and emerged plants from the seeds from phytopathogenic harmful fungi. In these methods, seed treated with at least one inventive active ingredient is used.

The compound combinations according to the invention and compositions comprising such combination are also suitable for the treatment of seeds and young seedlings. A large part of the damage to crop plants caused by harmful organisms is triggered by the infection of the seeds before sowing or after germination of the plant. This phase is particularly critical since the roots and shoots of the growing plant are particularly sensitive, and even small damage may result in the death of the plant. Accordingly, there is great interest in protecting the seed and the germinating plant by using appropriate compositions.

It is also desirable to optimize the amount of the active ingredient used so as to provide the best possible protection for the seeds, the germinating plants and emerged seedlings from attack by phytopathogenic fungi, but without damaging the plants themselves by the active ingredient used. In particular, methods for the treatment of seed should also take into consideration the intrinsic phenotypes of transgenic plants in order to achieve optimum protection of the seed and the germinating plant with a minimum of crop protection compositions being employed.

The present invention therefore also relates to a method for protecting seeds, germinating plants and emerged seedlings against attack by animal pests and/or phytopathogenic harmful microorganisms by treating the seeds with an inventive combination or composition. The invention also relates to the use of the combinations or compositions according to the invention for treating seeds for protecting the seeds, the germinating plants and emerged seedlings against animal pests and/or phytopathogenic microorganisms. The invention further relates to seeds which have been treated with an inventive combination or composition for protection from animal pests and/or phytopathogenic microorganisms.

One of the advantages of the present invention is that the treatment of the seeds with these compositions not only protects the seed itself, but also the resulting plants after emergence, from animal pests and/or phytopathogenic harmful microorganisms. In this way, the immediate treatment of the crop at the time of sowing or shortly thereafter protect plants as well as seed treatment in prior to sowing. It is likewise considered to be advantageous that the inventive active ingredients combination or composition can be used especially also for transgenic seed, in which case the plant which grows from this seed is capable of expressing a protein which acts against pests, herbicidal damage or abiotic stress. The treatment of such seeds with the inventive active ingredients or compositions, for example an insecticidal protein, can result in control of certain pests.

The compound combinations according to the invention and compositions comprising such combination are suitable for protection of seed of any plant variety which is used in agriculture, in the greenhouse, in forests or in horticulture. More particularly, the seed is that of cereals (such as wheat, barley, rye, millet and oats), oilseed rape, maize, cotton, soybeen, rice, potatoes, sunflower, beans, coffee, beet (e.g. sugar beet and fodder beet), peanut, vegetables (such as tomato, cucumber, onions and lettuce), lawns and ornamental plants. Of particular significance is the treatment of the seed of wheat, soybean, oilseed rape, maize and rice.

As also described below, the treatment of transgenic seed with the inventive active ingredients or compositions is of particular significance. This refers to the seed of plants containing at least one heterologous gene which allows the expression of a polypeptide or protein, e.g. having insecticidal properties. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

In the context of the present invention, the inventive combination or composition is applied to seeds either alone or in a suitable formulation. Preferably, the seed is treated in a state in which it is sufficiently stable for no damage to occur in the course of treatment. In general, seeds can be treated at any time between harvest and some time after sowing. It is customary to use seed which has been separated from the plant and freed from cobs, shells, stalks, coats, hairs or the flesh of the fruits. For example, it is possible to use seed which has been harvested, cleaned and dried down to a moisture content of less than 15% by weight. Alternatively, it is also possible to use seed which, after drying, for example, has been treated with water and then dried again, or seeds just after priming, or seeds stored in primed conditions or pre-germinated seeds, or seeds sown on nursery trays, tapes or paper.

When treating the seeds, it generally has to be ensured that the amount of the inventive combination or composition applied to the seed and/or the amount of further additives is selected such that the germination of the seed is not impaired, or that the resulting plant is not damaged. This must be ensured particularly in the case of active ingredients which can exhibit phytotoxic effects at certain application rates.

The compound combinations according to the invention and compositions comprising such combination can be applied directly, i.e. without containing any other components and without having been diluted. In general, it is preferable to apply the compositions to the seed in the form of a suitable formulation. Suitable formulations and methods for seed treatment are known to those skilled in the art. The compound combinations according to the invention can be converted to the customary formulations relevant to on-seed applications, such as solutions, emulsions, suspensions, powders, foams, slurries or combined with other coating compositions for seed, such as film forming materials, pelleting materials, fine iron or other metal powders, granules, coating material for inactivated seeds, and also ULV formulations.

These formulations are prepared in a known manner, by mixing the active ingredients or active ingredient combinations with customary additives, for example customary extenders and solvents or diluents, dyes, wetting agents, dispersants, emulsifiers, antifoams, preservatives, secondary thickeners, adhesives, gibberellins, and also water.

Useful dyes which may be present in the seed dressing formulations usable in accordance with the invention are all dyes which are customary for such purposes. It is possible to use either pigments, which are sparingly soluble in water, or dyes, which are soluble in water. Examples include the dyes known by the names Rhodamine B, C.I. Pigment Red 112 and C.I. Solvent Red 1.

Useful wetting agents which may be present in the seed dressing formulations usable in accordance with the invention are all substances which promote wetting and which are conventionally used for the formulation of active agrochemical ingredients. Usable with preference are alkylnaphthalenesulphonates, such as diisopropyl- or diisobutylnaphthalenesulphonates.

Useful dispersants and/or emulsifiers which may be present in the seed dressing formulations usable in accordance with the invention are all nonionic, anionic and cationic dispersants conventionally used for the formulation of active agrochemical ingredients. Usable with preference are nonionic or anionic dispersants or mixtures of nonionic or anionic dispersants. Useful nonionic dispersants include especially ethylene oxide/propylene oxide block polymers, alkylphenol polyglycol ethers and tristryrylphenol polyglycol ether, and the phosphated or sulphated derivatives thereof. Suitable anionic dispersants are especially lignosulphonates, polyacrylic acid salts and arylsulphonate/formaldehyde condensates.

Antifoams which may be present in the seed dressing formulations usable in accordance with the invention are all foam-inhibiting substances conventionally used for the formulation of active agrochemical ingredients. Silicone antifoams and magnesium stearate can be used with preference.

Preservatives which may be present in the seed dressing formulations usable in accordance with the invention are all substances usable for such purposes in agrochemical compositions. Examples include dichlorophene and benzyl alcohol hemiformal.

Secondary thickeners which may be present in the seed dressing formulations usable in accordance with the invention are all substances usable for such purposes in agrochemical compositions. Preferred examples include cellulose derivatives, acrylic acid derivatives, xanthan, modified clays and finely divided silica.

Adhesives which may be present in the seed dressing formulations usable in accordance with the invention are all customary binders usable in seed dressing products. Preferred examples include polyvinylpyrrolidone, polyvinyl acetate, polyvinyl alcohol and tylose.

The formulations for on-seed applications usable in accordance with the invention can be used to treat a wide variety of different kinds of seed either directly or after prior dilution with water. For instance, the concentrates or the preparations obtainable therefrom by dilution with water can be used to dress the seed of cereals, such as wheat, barley, rye, oats, and triticale, and also seeds of maize, soybean, rice, oilseed rape, peas, beans, cotton, sunflowers, and beets, or else a wide variety of different vegetable seeds. The formulations usable in accordance with the invention, or the dilute preparations thereof, can also be used for seeds of transgenic plants. In this case, additional synergistic effects may also occur in interaction with the substances formed by expression.

For treatment of seeds with the formulations usable in accordance with the invention, or the preparations prepared therefrom by adding water, all mixing units usable customarily for on-seed applications are useful. Specifically, the procedure in on-seed applications is to place the seeds into a mixer, to add the particular desired amount of the formulations, either as such or after prior dilution with water, and to mix everything until all applied formulations are distributed homogeneously on the seeds. If appropriate, this is followed by a drying operation.

The application rate of the formulations usable in accordance with the invention can be varied within a relatively wide range. It is guided by the particular content of the active ingredients in the formulations and by the seeds. The application rate of each single active ingredient is generally between 0.001 and 15 g per kilogram of seed, preferably between 0.01 and 5 g per kilogram of seed.

Antimycotic Effects

In addition, the compound combinations according to the invention and compositions comprising such combination also have very good antimycotic effects. They have a very broad antimycotic activity spectrum, especially against dermatophytes and yeasts, moulds and diphasic fungi (for example against Candida species, such as Candida albicans, Candida glabrata), and Epidermophyton floccosum, Aspergillus species, such as Aspergillus niger and Aspergillus fumigatus, Trichophyton species, such as Trichophyton mentagrophytes, Microsporon species such as Microsporon canis and audouinii. The enumeration of these fungi by no means constitutes a restriction of the mycotic spectrum covered, and is merely of illustrative character.

The compound combinations according to the invention and compositions comprising such combination can be used also to control important fungal pathogens in fish and crustacea farming, e.g. saprolegnia diclina in trouts, saprolegnia parasitica in crayfish.

The compound combinations according to the invention and compositions comprising such combination can therefore be used both in medical and in non-medical applications.

The compound combinations according to the invention and compositions comprising such combination can be used as such, in the form of their formulations or the use forms prepared therefrom, such as ready-to-use solutions, suspensions, wettable powders, pastes, soluble powders, dusts and granules. Application is accomplished in a customary manner, for example by watering, spraying, atomizing, broadcasting, dusting, foaming, spreading-on and the like. It is also possible to deploy the active ingredients by the ultra-low volume method or to inject the active ingredient preparation/the active ingredient itself into the soil. It is also possible to treat the seed of the plants.

GMO

As already mentioned above, it is possible to treat all plants and their parts in accordance with the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts” or “parts of plants” or “plant parts” have been explained above. More preferably, plants of the plant cultivars which are commercially available or are in use are treated in accordance with the invention. Plant cultivars are understood to mean plants which have new properties (“traits”) and have been obtained by conventional breeding, by mutagenesis or by recombinant DNA techniques. They can be cultivars, varieties, bio- or genotypes.

The method of treatment according to the invention can be used in the treatment of genetically modified organisms (GMOs), e.g. plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology, RNA interference—RNAi—technology or microRNA—miRNA—technology). A heterologous gene that is located in the genome is also called a transgene. A transgene that is defined by its particular location in the plant genome is called a transformation or transgenic event.

Plants and plant cultivars which are preferably to be treated according to the invention include all plants which have genetic material which impart particularly advantageous, useful traits to these plants (whether obtained by breeding and/or biotechnological means).

Plants and plant cultivars which are also preferably to be treated according to the invention are resistant against one or more biotic stresses, i.e. said plants show a better defense against animal and microbial pests, such as against nematodes, insects, mites, phytopathogenic fungi, bacteria, viruses and/or viroids.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants that may be treated according to the invention are hybrid plants that already express the characteristic of heterosis or hybrid vigor which results in generally higher yield, vigor, health and resistance towards biotic and abiotic stresses).

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance.

Plants or plant cultivars (obtained by plant biotechnology methods such as genetic engineering) which may also be treated according to the invention show altered quantity, quality and/or storage-stability of the harvested product and/or altered properties of specific ingredients of the harvested product.

Plants or plant cultivars (that can be obtained by plant biotechnology methods such as genetic engineering) which may also be treated according to the invention are plants, such as cotton plants, with altered fiber characteristics. Such plants can be obtained by genetic transformation, or by selection of plants contain a mutation imparting such altered fiber characteristics.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation, or by selection of plants contain a mutation imparting such altered oil profile characteristics.

Plants or plant cultivars (that can be obtained by plant biotechnology methods such as genetic engineering) which may also be treated according to the invention are plants, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering.

Plants or plant cultivars (that can be obtained by plant biotechnology methods such as genetic engineering) which may also be treated according to the invention are plants, such as Tobacco plants, with altered post-translational protein modification patterns.

Application Rates

When using the compound combinations according to the invention and compositions comprising such combination as fungicides, the application rates can be varied within a relatively wide range, depending on the kind of application. The application rate is

in the case of treatment of plant parts, for example leaves: from 0.1 to 10 000 g/ha, preferably from 10 to 1000 g/ha, more preferably from 50 to 300 g/ha (in the case of application by watering or dripping, it is even possible to reduce the application rate, especially when inert substrates such as rockwool or perlite are used);
in the case of seed treatment: from 0.1 to 200 g per 100 kg of seed, preferably from 1 to 150 g per 100 kg of seed, more preferably from 2.5 to 25 g per 100 kg of seed, even more preferably from 2.5 to 12.5 g per 100 kg of seed;
in the case of soil treatment: from 0.1 to 10 000 g/ha, preferably from 1 to 5000 g/ha,
wherein the given amounts refer to the total amount of active ingredient in the respective combination or composition.

These application rates are merely by way of example and are not limiting for the purposes of the invention.

The invention is illustrated by the examples below. However, the invention is not limited to the examples.

### EXAMPLES

### Preparation Examples of Compounds of Formula (I)

### Preparation of Compounds of the Formula (I) According to Process A

### Preparation of 2-[6-(4-chlorophenoxy)-2-(trifluoromethyl)pyridin-3-yl]-1-(1H-1,2,4-triazol-1-yl)propan-2-ol (I.01)

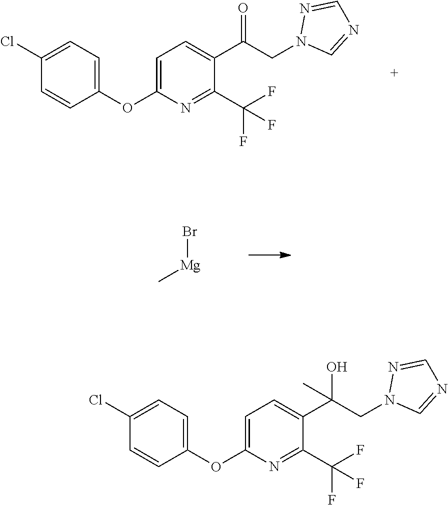

A solution of magnesium bromide diethyl etherate (4.8 g, 18.8 mmol) in dichloromethane (20 mL) and diethyl ether (10 mL) was cooled to 0° C., before a solution of 1-[6-(4-chlorophenoxy)-2-(trifluoromethyl)-3-pyridyl]-2-(1,2,4-triazol-1-yl)ethanone (1.80 g, 4.70 mmol) in dichloromethane (10 mL) was added and stirred for 30 min at 0° C. Then methylmagnesium bromide (3.1 mL, 9.4 mmol, 3M solution in ethyl ether) was added, the cooling bath was removed, and the mixture was stirred for 1.5 hours (h) at 21° C. (room temperature, rt), before the mixture was quenched with water, NH₄Cl (saturated aqueous solution), extracted with dichloromethane, dried (over MgSO₄), and concentrated. As the starting ketone and the target alcohol overlap in terms of retention time, the concentrated material (roughly 2 g of a thick colourless oil containing both ketone and alcohol) was dissolved in pyridine (15.0 mL), and treated with methoxylamine hydrochloride (313 mg, 3.75 mmol) at rt for 20 h (to convert the ketone into the corresponding methyl oxime, which has a significantly different retention time). The mixture was then diluted with dichloromethane, filtered over ChemElut, and concentrated. Preparative HPLC gave 319 mg (17% yield over two steps, 99% pure) of the target compound as colourless oil, which solidified upon standing.

MS (ESI): 398.08 ([M+H]⁺)

### Preparation of 2-[6-(4-chlorophenoxy)-4-(trifluoromethyl)-3-pyridyl]-1-(1,2,4-triazol-1-yl)propan-2-ol (I.02)

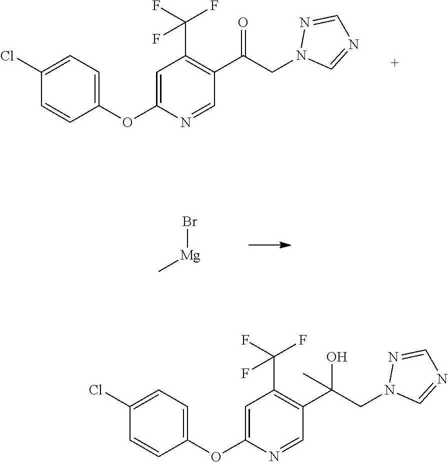

A solution of magnesium bromide diethyl etherate (1.2 g, 4.63 mmol) in dichloromethane (10 mL) was cooled to 0° C., before a solution of 1-[6-(4-chlorophenoxy)-4-(trifluoromethyl)-3-pyridyl]-2-(1,2,4-triazol-1-yl)ethanone (443 mg, 1.16 mmol) in dichloromethane (2 mL) was added and stirred for 30 min at 0° C. Then methylmagnesium bromide (0.78 mL, 2.3 mmol, 3M solution in ethyl ether) was added, the cooling bath was removed, and the mixture was stirred for 1 h at rt, before the mixture was quenched with water, extracted with dichloromethane, dried (over MgSO₄), and concentrated. Preparative HPLC gave 126.6 mg (27% yield, 100% pure) of the target compound as a colourless solid.

MS (ESI): 398.08 ([M+H]⁺)

### Preparation of 1-[6-(4-chlorophenoxy)-2-(trifluoromethyl)-3-pyridyl]-2-(1,2,4-triazol-1-yl)ethanol (I.03)

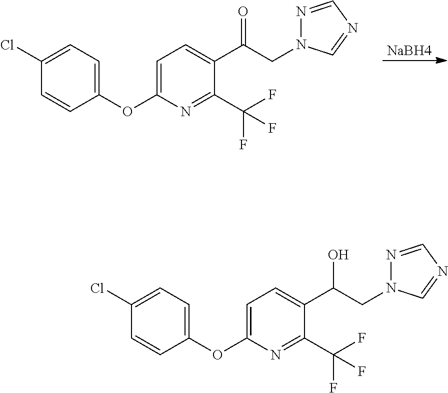

To a solution of 1-[6-(4-chlorophenoxy)-4-(trifluoromethyl)-3-pyridyl]-2-(1,2,4-triazol-1-yl)ethanone (800 mg, 1.67 mmol) in dry methanol (25.0 mL) at 5° C. was added sodium borohydride (127 mg, 3.3 mmol), the cooling bath was removed, mixture warmed to rt and stirred for 1 h. The mixture was then quenched with water, diluted with dichloromethane, filtered over ChemElut, and concentrated. Preparative HPLC gave 286 mg (60% yield, 100% pure) of the target compound as a colourless solid.

MS (ESI): 384.06 ([M+H]⁺)

### Preparation of 1-[6-(4-chlorophenoxy)-4-(trifluoromethyl)-3-pyridyl]-2-(1,2,4-triazol-1-yl)ethanol (I.04)

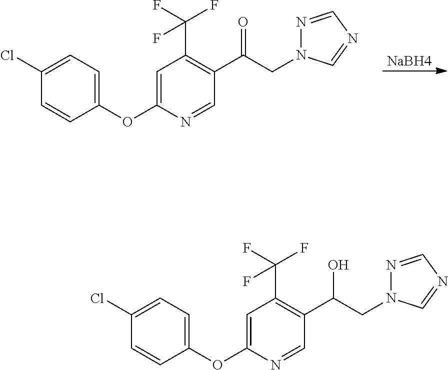

To a solution of 1-[6-(4-chlorophenoxy)-4-(trifluoromethyl)-3-pyridyl]-2-(1,2,4-triazol-1-yl)ethanone (518 mg, 1.35 mmol) in dry methanol (5.0 mL) at 5° C. was added sodium borohydride (102 mg, 2.7 mmol), the cooling bath was removed, mixture warmed to rt and stirred for 1 h. The mixture was then quenched with water, diluted with dichloromethane, filtered over ChemElut, and concentrated. Preparative HPLC gave 252 mg (48% yield, 100% pure) of the target compound as a colourless oil, which crystallized upon standing.

MS (ESI): 384.06 ([M+H]⁺)

### Preparation of Compounds of the Formula (VII) According to Process A

### Preparation of 1-[6-(4-chlorophenoxy)-2-(trifluoromethyl)-3-pyridyl]-2-(1,2,4-triazol-1-yl)ethanone (VII.01)

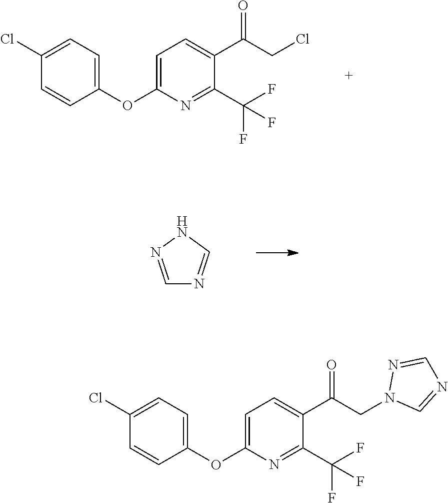 [SMILES: O=C(CCl)c1ccc(Oc2ccc(Cl)cc2)nc1C(F)(F)F ; c1nc[nH]n1 ; O=C(Cn1cncn1)c1ccc(Oc2ccc(Cl)cc2)nc1C(F)(F)F]

A mixture of 2-chloro-1-[6-(4-chlorophenoxy)-2-(trifluoromethyl)-3-pyridyl]ethanone (8.3 g, 23.7 mmol) and 1H-1,2,4-triazole (1.8 g, 26.0 mmol) in acetonitrile (80 mL) was heated to 75° C., before potassium carbonate (3.9 g, 28.5 mmol) was added. The heating was continued for 20 minutes (min) before the mixture was rapidly cooled to room temperature by addition of ice water, extracted with dichloromethane, dried (over MgSO₄), and concentrated. Flash column chromatography (gradient, up to DCM/10% MeOH in DCM=60/40, 254 nm) gave 4.30 g (43% yield, 91% pure) of the target compound as a yellow glass, which was used as such for the next reaction steps. A small quantity was further purified by HPLC to give the target product (100% pure) as a yellow solid.

MS (ESI): 382.04 ([M+H]⁺)

### Preparation of 1-[6-(4-chlorophenoxy)-4-(trifluoromethyl)-3-pyridyl]-2-(1,2,4-triazol-1-yl)ethanone (VII.02)

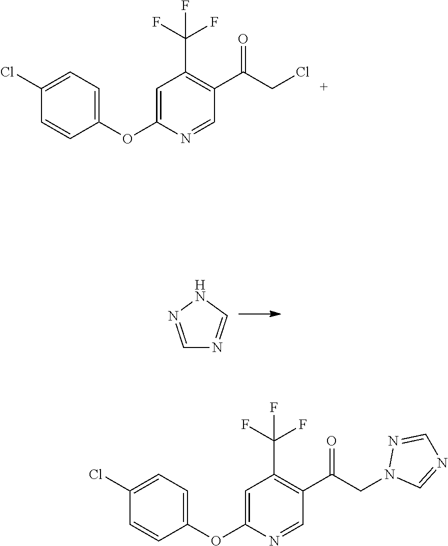 [SMILES: O=C(CCl)c1cnc(Oc2ccc(Cl)cc2)cc1C(F)(F)F ; c1nc[nH]n1 ; O=C(Cn1cncn1)c1cnc(Oc2ccc(Cl)cc2)cc1C(F)(F)F]

A mixture of 2-chloro-1-[6-(4-chlorophenoxy)-4-(trifluoromethyl)-3-pyridyl]ethanone (3.4 g, 9.71 mmol) and 1H-1,2,4-triazole (0.74 g, 10.6 mmol) in acetonitrile (50 mL) was heated to 75° C., before potassium carbonate (1.6 g, 11.6 mmol) was added. The heating was continued for 20 min before the mixture was rapidly cooled to room temperature by addition of ice water, extracted with dichloromethane, dried (over MgSO⁴), and concentrated. Flash column chromatography (gradient, up to DCM/10% MeOH in DCM=70/30, 254 nm) followed by preparative HPLC gave 1.50 g (40% yield, 100% pure) of the target compound as a yellow solid.

MS (ESI): 382.04 ([M+H]⁺)

### Preparation of Compounds of the Formula (VI) According to Process A

### Preparation of 2-chloro-1-[6-(4-chlorophenoxy)-2-(trifluoromethyl)-3-pyridyl]ethanone (VI.01)

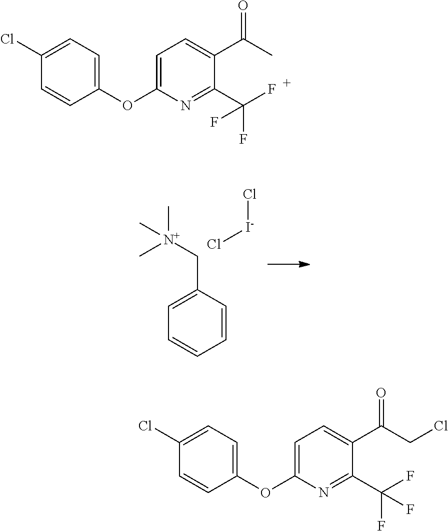

A mixture of 1-[6-(4-chlorophenoxy)-2-(trifluoromethyl)-3-pyridyl]ethanone (8.6 g, 27.2 mmol) and benzyltrimethylammonium dichloroiodate (18.9 g, 54.4 mmol) in 1,2-dichloroethane (60 mL) and methanol (20 mL) was heated to 75° C. for 4 h, before the mixture was concentrated, then diluted with ethyl acetate, washed with Na₂S₂O₃ (10% w/w aqueous solution), washed with brine, dried (over MgSO₄), concentrated, and passed over a plug of silica (heptane/ethyl acetate=1/1, 254 nm) to give 8.3 g (83% yield, 96% pure) of the target compound as a pale yellow solid.

MS (ESI): 348.99 ([M+H]⁺)

### Preparation of 2-chloro-1-[6-(4-chlorophenoxy)-4-(trifluoromethyl)-3-pyridyl]ethanone (VI.02)

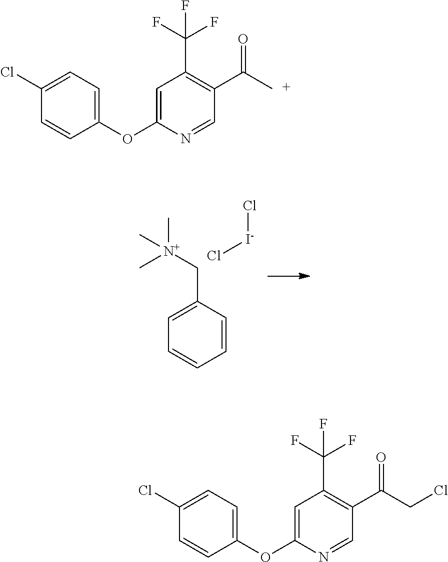

A mixture of 1-[6-(4-chlorophenoxy)-4-(trifluoromethyl)-3-pyridyl]ethanone (3.6 g, 11.4 mmol) and benzyltrimethylammonium dichloroiodate (7.93 g, 22.8 mmol) in 1,2-dichloroethane (30 mL) and methanol (10 mL) was heated to 75° C. for 4 h, before the mixture was concentrated, then diluted with ethyl acetate, washed with Na₂S₂O₃ (10% w/w aqueous solution), washed with brine, dried (over MgSO₄), concentrated, and passed over a plug of silica (heptane/ethyl acetate=85/15, 254 nm) to give 3.4 g (58% yield, 69% pure) of the target compound as a colourless oil, which was used without further purification.

MS (ESI): 348.99 ([M+H]⁺)

### Preparation of Compounds of the Formula (V) According to Process D

### Preparation of 1-[6-(4-chlorophenoxy)-2-(trifluoromethyl)-3-pyridyl]ethanone (V.01)

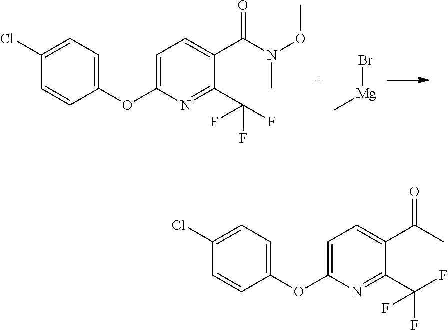

A solution of 6-(4-chlorophenoxy)-N-methoxy-N-methyl-2-(trifluoromethyl)pyridine-3-carboxamide (11.5 g, 31.9 mmol) in THF (150 mL) at 5° C. was treated with methylmagnesium bromide (21.2 mL, 63.7 mmol, 3M solution in diethyl ether). The mixture was then warmed to rt and stirring continued for 4 h at rt, before the reaction was quenched with water, NH₄Cl (saturated aqueous solution), extracted with dichloromethane, dried (over Na₂SO₄), and concentrated to give 8.60 g (82% yield, 96% pure) of the target compound as a pale yellow solid, which was used without further purification.

MS (ESI): 315.03 ([M+H]⁺)

### Preparation of 1-[6-(4-chlorophenoxy)-4-(trifluoromethyl)-3-pyridyl]ethanone (V.02)

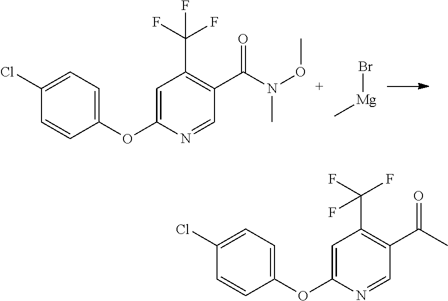

A solution of 6-(4-chlorophenoxy)-N-methoxy-N-methyl-4-(trifluoromethyl)pyridine-3-carboxamide (6.9 g, 17.4 mmol) in THF (100 mL) at 5° C. was treated with methylmagnesium bromide (11.6 mL, 34.8 mmol, 3M solution in diethyl ether). The mixture was then warmed to rt and stirring continued for 4 h at rt, before the reaction was quenched with water, NH₄Cl (saturated aqueous solution), extracted with dichloromethane, dried (over Na₂SO₄), and concentrated. Flash column chromatography (gradient, up to heptane/ethyl acetate=80/20, 254 nm) gave 3.60 g (61% yield, 94% pure) of the target compound as a colourless oil.

MS (ESI): 315.03 ([M+H]⁺)

### Preparation of Compounds of the Formula (XVI) According to Process D

### Preparation of 6-(4-chlorophenoxy)-N-methoxy-N-methyl-2-(trifluoromethyl)pyridine-3-carboxamide (XVI.01)

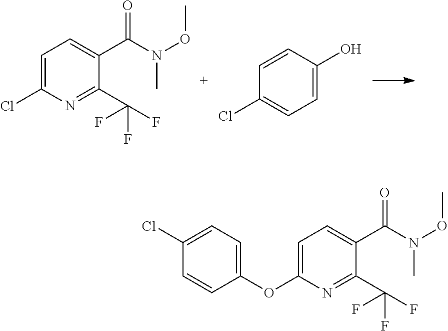 [SMILES: CON(C)C(=O)c1ccc(Cl)nc1C(F)(F)F ; Oc1ccc(Cl)cc1 ; CON(C)C(=O)c1ccc(Oc2ccc(Cl)cc2)nc1C(F)(F)F]

A mixture of 6-chloro-N-methoxy-N-methyl-2-(trifluoromethyl)pyridine-3-carboxamide (9.0 g, 33.5 mmol), 4-chlorophenol (4.3 g, 33.5 mmol), potassium carbonate (11.5 g, 83.7 mmol), copper(I) iodide (638 mg, 3.35 mmol), and N,N,N′,N′-tetramethylethylenediamine (TMEDA; 1.0 mL, 6.7 mmol) in dimethyl sulfoxide (DMSO; 150 mL) was heated for 3 h at 100° C. The reaction mixture was then cooled to rt, water added, extracted with ethyl acetate, dried (over Na₂SO₄), concentrated and passed over a plug of silica (heptane/ethyl acetate=1/1, 254 nm) to give 7.7 g (58% yield, 91% pure) of the target compound as a yellow oil.

MS (ESI): 360.05 ([M+H]⁺)

### Preparation of 6-(4-chlorophenoxy)-N-methoxy-N-methyl-4-(trifluoromethyl)pyridine-3-carboxamide (XVI.02)

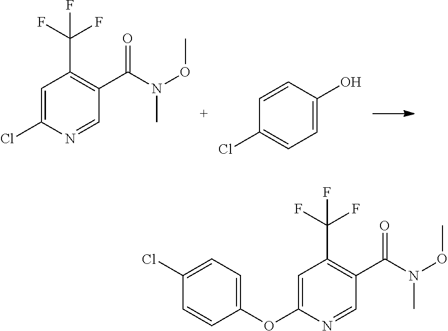 [SMILES: CON(C)C(=O)c1cnc(Cl)cc1C(F)(F)F ; Oc1ccc(Cl)cc1 ; CON(C)C(=O)c1cnc(Oc2ccc(Cl)cc2)cc1C(F)(F)F]

A mixture of 6-chloro-N-methoxy-N-methyl-4-(trifluoromethyl)pyridine-3-carboxamide (5.7 g, 21.3 mmol), 4-chlorophenol (2.7 g, 21.3 mmol), potassium carbonate (7.4 g, 53.3 mmol), copper(I) iodide (406 mg, 2.13 mmol), and TMEDA (0.64 mL, 4.26 mmol) in DMSO (100 mL) was heated for 3 h at 100° C. The reaction mixture was then cooled to rt, water added, extracted with ethyl acetate, dried (over Na₂SO₄), concentrated and passed over a plug of silica (heptane/ethyl acetate=1/1, 254 nm) to give 6.59 g (85% yield, 100% pure) of the target compound as a colourless oil.

MS (ESI): 360.05 ([M+H]⁺)

### Preparation of Compounds of the Formula (I) According to Process B

### Preparation of 1-[6-(4-chlorophenoxy)-2-(trifluoromethyl)pyridin-3-yl]-1-cyclopropyl-2-(1H-1,2,4-triazol-1-yl)ethanol (I.91) According to Process B

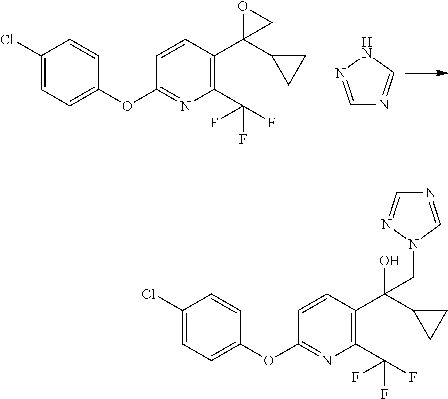

Epoxide IX.07 (1.0 g, 2.81 mmol), 1H-1,2,4-triazole (194 mg, 2.81 mmol), sodium hydroxide (40 mg, 0.984 mmol), 0.013 mL water in DMF (10 mL) was heated at 120° C. for 22 h, before water, NH₄Cl (saturated aqueous solution) and CH₂Cl₂ were added. Phases were separated, the aqueous phase was extracted twice with CH₂Cl₂, the combined organic extracts were dried over Na₂SO₄ and concentrated to give, after purification via preparative HPLC, the desired alcohol 1.91 (362 mg, 30%) as a colorless oil.

MS (ESI): 425.09 ([M+H]+)

### Preparation of 6-(4-chlorophenoxy)-3-(2-cyclopropyloxiran-2-yl)-2-(trifluoromethyl)pyridine (IX.07) According to Process B

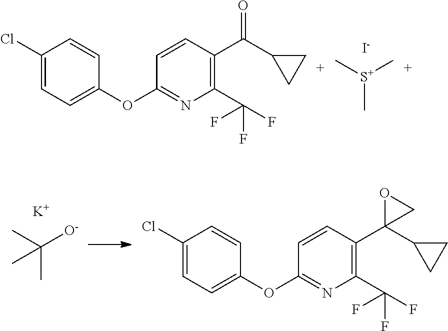

To a suspension of trimethylsulfonium iodide (3.1 g, 15.2 mmol) in THF (100 mL) at 0° C. was added potassium tert-butoxide (1.7 g, 15.2 mmol) in one portion, and the mixture was stirred for 5 min. Then, ketone V.41 (4.0 g, 11.7 mmol) in THF (10 mL) was added, the mixture was warmed to room temperature and stirred for 1.5 h. Then water and CH₂Cl₂ were added, the aqueous phase was extracted with CH₂Cl₂, the combined organic extracts were dried over Na₂SO₄ and concentrated, to give, after flash column chromatography, the desired epoxide IX.07 (138 mg, 3%) as a colorless oil.

MS (ESI): 356.06 ([M+H]+)

### Preparation of [6-(4-chlorophenoxy)-2-(trifluoromethyl)-3-pyridyl]-cyclopropyl-methanone (V.41) According to Process B

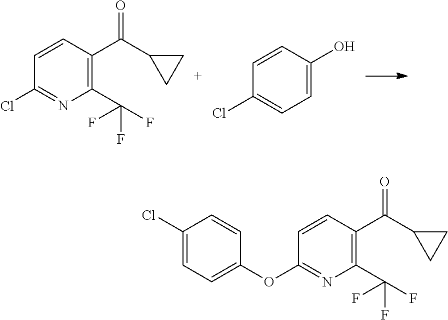 [SMILES: O=C(c1ccc(Cl)nc1C(F)(F)F)C1CC1 ; Oc1ccc(Cl)cc1 ; O=C(c1ccc(Oc2ccc(Cl)cc2)nc1C(F)(F)F)C1CC1]

A mixture of [6-chloro-2-(trifluoromethyl)pyridin-3-yl](cyclopropyl)methanone (6.0 g, 24.0 mmol), 4-chlorophenol (3.1 g, 24.0 mmol), potassium carbonate (8.3 g, 60.1 mmol), copper(I) iodide (458 mg, 2.40 mmol), and N,N,N′,N′-tetramethylethylenediamine (TMEDA; 0.7 mL, 4.8 mmol) in dimethyl sulfoxide (DMSO; 100 mL) was heated for 2 h at 100° C. The reaction mixture was then cooled to rt, water added, extracted with ethyl acetate, dried (over Na₂SO₄), concentrated and passed over a plug of silica (heptane/ethyl acetate=1/1, 254 nm), and recrystallized from CH₂Cl₂ and diisopropyl ether to give 4.2 g (48% yield, 95% pure) of the target compound V.41 as a colorless solid.

MS (ESI): 342.04 ([M+H]+)

### Preparation of [6-chloro-2-(trifluoromethyl)-3-pyridyl]-cyclopropyl-methanone

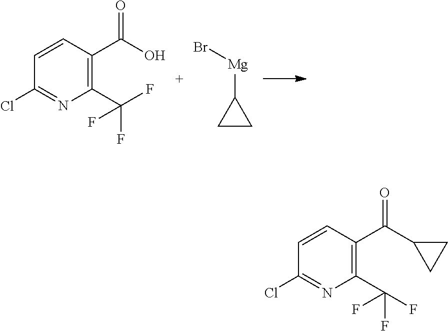

A solution of 6-chloro-2-(trifluoromethyl)pyridine-3-carboxylic acid (6.0 g, 26.6 mmol), thionyl chloride (3.9 mL, 53.2 mmol) and few drops of dimethylformamide in dichloroethane (100 mL) was heated at 85° C. for 4 h, before the mixture was cooled to rt and concentrated. Then dry THF (150 mL) and Fe(acac)₃ (470 mg, 1.33 mmol) were added and the solution was cooled to −78° C., before a solution of cyclopropylmagnesium bromide (69 mL, 0.5 M, 34.6 mmol) was added dropwise, keeping the internal temperature below −70° C. After complete addition, the cooling bath was removed and the reaction was allowed to warm to room temperature. The reaction was then quenched with NH₄Cl (saturated aqueous solution) and extracted with CH₂Cl₂, dried over Na₂SO₄ and concentrated. The target compound [6-chloro-2-(trifluoromethyl)pyridin-3-yl](cyclopropyl)methanone (6.0 g, 87% yield) was used in the following step without further purification.

MS (ESI): 250.02 ([M+H]+)

The following tables illustrate in a non-limiting manner examples of compounds according to formula (I), (V), (VI), (VII), and (IX).

TABLE 1
Compounds according to formula (I)

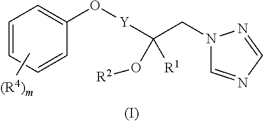

| Ex N° | Y | n | R³ | R | R¹ | R² | m | R⁴ | LogP |
|---|---|---|---|---|---|---|---|---|---|
| I.01 | 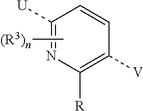 | 0 | — | CF₃ | CH₃ | H | 1 | 4-Cl | 2.88^{[a]} |
| I.02 (*) | 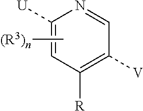 | 0 | — | CF₃ | CH₃ | H | 1 | 4-Cl | 2.90^{[a]} |
| I.03 | 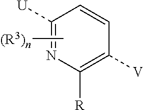 | 0 | — | CF₃ | H | H | 1 | 4-Cl | 2.70^{[a]} |
| I.04 | 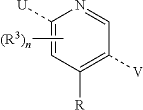 | 0 | — | CF₃ | H | H | 1 | 4-Cl | 2.68^{[a]} |
| I.05 | 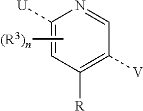 | 0 | — | Cl | CH₃ | H | 0 | — | 2.10^{[a]}; 2.06^{[b]} |
| I.06 | 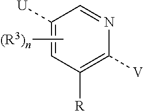 | 0 | — | Cl | CH₃ | H | 0 | — | 2.47^{[a]}; 2.43^{[b]} |
| I.07 | 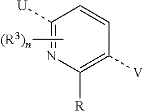 | 0 | — | Cl | CH₃ | H | 0 | — | 2.14^{[a]}; 2.09^{[b]} |
| I.08 (*) | 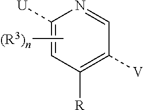 | 0 | — | Cl | CH₃ | H | 1 | 4-Cl | 2.50^{[a]} |
| I.09 (*) | 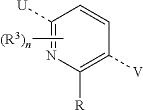 | 0 | — | Cl | CH₃ | H | 1 | 4-Cl | 2.66^{[a]} |
| I.10 | 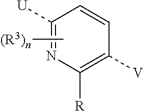 | 0 | — | Cl | H | H | 2 | 3-Cl, 4-Cl | 2.80^{[a]} |
| I.11 | 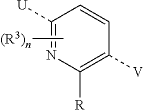 | 0 | — | Cl | H | H | 2 | 3-Cl, 4-OCF₃ | 3.11^{[a]} |
| I.12 | 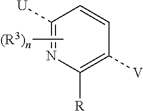 | 0 | — | Cl | H | H | 1 | 4-OCF₃ | 2.73^{[a]} |
| I.13 | 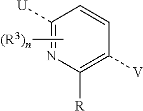 | 0 | — | Cl | H | H | 0 | — | 1.98^{[a]} |
| I.14 | 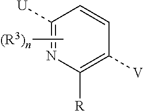 | 0 | — | Cl | H | H | 1 | 4-Cl | 2.42^{[a]} |
| I.15 | 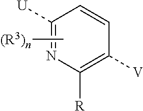 | 0 | — | Cl | H | H | 2 | 2-Me, 4-Cl | 2.75^{[a]} |
| I.16 | 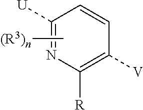 | 0 | — | Cl | H | H | 2 | 3-Cl, 4-Me | 2.73^{[a]} |
| I.17 | 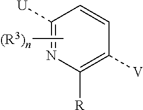 | 0 | — | Cl | H | H | 1 | 4-F | 2.08^{[a]} |
| I.18 | 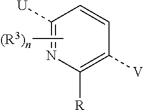 | 0 | — | Cl | H | H | 2 | 2-F, 4-F | 2.18^{[a]} |
| I.19 | 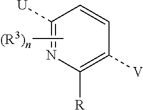 | 0 | — | Cl | H | H | 1 | 2-F | 2.08^{[a]} |
| I.20 | 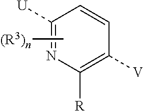 | 0 | — | Cl | H | H | 3 | 3-F, 4-F, 5-F | 1.65^{[a]} |
| I.21 | 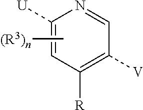 | 0 | — | Cl | H | H | 0 | — | 1.92^{[a]} |
| I.22 | 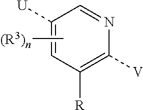 | 0 | — | Cl | H | H | 0 | — | 2.01^{[a]} |
| I.23 | 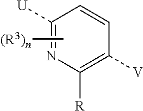 | 0 | — | Cl | H | H | 2 | 2-Cl, 4-Cl | 2.75^{[a]} |
| I.24 | 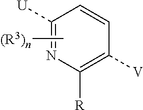 | 0 | — | Cl | H | H | 1 | 4- (1-hydroxyethyl) | 1.48^{[a]} |
| I.25 | 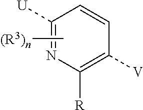 | 0 | — | CHF₂ | H | H | 1 | 4-Cl | 2.44^{[a]} |
| I.26 | 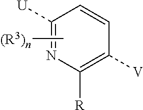 | 0 | — | OCF₃ | H | H | 1 | 4-Cl | 2.92^{[a]} |
| I.27 | 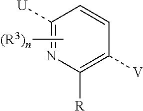 | 0 | — | Cl | CH₃ | H | 1 | 4-F | 2.28^{[a]} |
| I.28 | 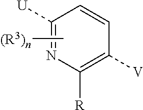 | 0 | — | Cl | CH₃ | H | 2 | 2-Me, 4-Cl | 2.94^{[a]} |
| I.29 | 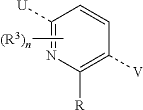 | 0 | — | Cl | CH₃ | H | 2 | 3-Cl, 4-Me | 3.00^{[a]} |
| I.30 | 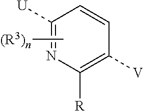 | 0 | — | Cl | H | H | 2 | 2-Cl, 4-OMe | 2.32^{[a]} |
| I.31 | 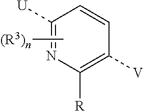 | 0 | — | Cl | CH₃ | H | 2 | 2-Cl, 4-OMe | 2.56^{[a]} |
| I.32 | 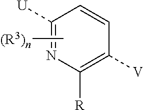 | 0 | — | Cl | CH₃ | H | 2 | 3-Cl, 4-Cl | 3.09^{[a]} |
| I.33 | 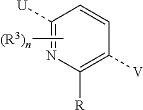 | 0 | — | OCF₃ | CH₃ | H | 1 | 4-Cl | 3.29^{[a]} |
| I.34 | 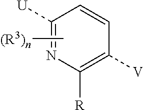 | 0 | — | Cl | H | H | 1 | 4-SF₅ | 2.90^{[a]} |
| I.35 | 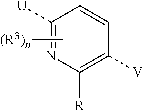 | 0 | — | Cl | CH₃ | H | 1 | 4-SF₅ | 3.17^{[a]} |
| I.36 (*) | 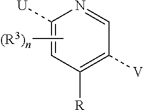 | 0 | — | CF₃ | H | H | 1 | 4-SF₅ | 3.15^{[a]} |
| I.37 | 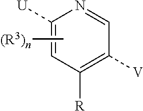 | 0 | — | CF₃ | CH₃ | H | 1 | 4-SF₅ | 3.33^{[a]} |
| I.38 | 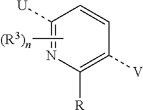 | 0 | — | Cl | H | H | 1 | 4-CHF₂ | 2.17^{[a]} |
| I.39 | 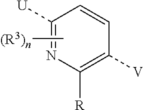 | 0 | — | Cl | CH₃ | H | 1 | 4-CHF₂ | 2.41^{[a]} |
| I.40 | 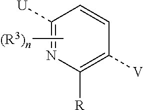 | 0 | — | CF₃ | H | H | 1 | 4-Br | 2.82^{[a]} |
| I.41 | 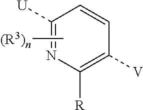 | 0 | — | F | H | H | 1 | 4-Cl | 2.23^{[a]} |
| I.42 | 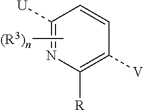 | 0 | — | F | CH₃ | H | 1 | 4-Cl | 2.46^{[a]} |
| I.43 | 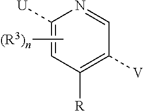 | 0 | — | CF₃ | H | H | 1 | 4-OCF₃ | 3.00^{[a]} |
| I.44 | 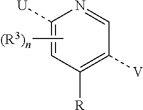 | 0 | — | CF₃ | CH₃ | H | 1 | 4-OCF₃ | 3.23^{[a]} |
| I.45 (*) | 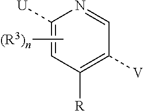 | 0 | — | CF₃ | CH₃ | H | 1 | 4-Cl | 2.84^{[a]} |
| I.46 (*) | 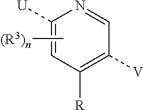 | 0 | — | CF₃ | CH₃ | H | 1 | 4-Cl | 2.93^{[a]} |
| I.47 (*) | 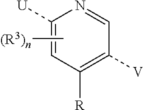 | 0 | — | CF₃ | H | H | 1 | 4-CF₃ | 2.84^{[a]} |
| I.48 | 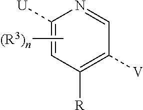 | 0 | — | CF₃ | H | H | 1 | 4-Br | 2.75^{[a]} |
| I.49 | 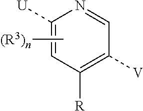 | 0 | — | CF₃ | CH₃ | H | 1 | 4-Br | 2.96^{[a]} |
| I.50 | 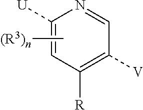 | 0 | — | CF₃ | CH₃ | H | 1 | 4-CF₃ | 3.11^{[a]} |
| I.51 (*) | 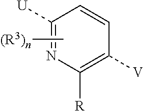 | 0 | — | Cl | CH₃ | H | 1 | 4-Cl | 2.62^{[a]} |
| I.52 (*) | 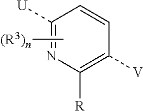 | 0 | — | Cl | CH₃ | H | 1 | 4-Cl | 2.62^{[a]} |
| I.53 (*) | 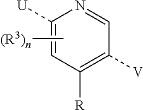 | 0 | — | Cl | CH₃ | H | 1 | 4-Cl | 2.53^{[a]} |
| I.54 (*) | 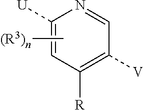 | 0 | — | Cl | CH₃ | H | 1 | 4-Cl | 2.53^{[a]} |
| I.55 | 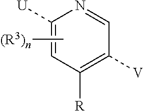 | 0 | — | CF₃ | H | H | 1 | 4-CHF₂ | 2.55^{[a]} |
| I.56 | 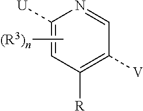 | 0 | — | CF₃ | CH₃ | H | 1 | 4-CHF₂ | 2.73^{[a]} |
| I.57 | 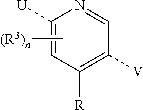 | 0 | — | CF₃ | H | H | 2 | 2-F, 4-Cl | 2.86^{[a]} |
| I.58 | 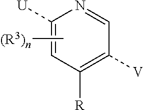 | 0 | — | CF₃ | CH₃ | H | 2 | 2-F, 4-Cl | 3.02^{[a]} |
| I.59 (*) | 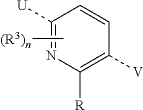 | 0 | — | CF₃ | CH₃ | H | 1 | 4-Br | 2.94^{[a]} |
| I.60 | 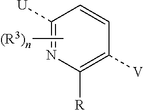 | 0 | — | CF₃ | H | H | 1 | 4-SF₅ | 3.08^{[a]} |
| I.61 | 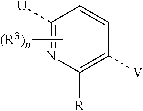 | 0 | — | CF₃ | H | H | 1 | 4-CF₃ | 2.84^{[a]} |
| I.62 | 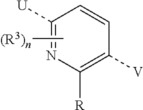 | 0 | — | CF₃ | CH₃ | H | 1 | 4-SF₅ | 3.25^{[a]} |
| I.63 | 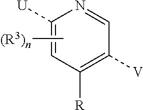 | 0 | — | CHF₂ | H | H | 1 | 4-Br | 2.59^{[a]} |
| I.64 | 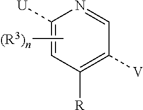 | 0 | — | CHF₂ | CH₃ | H | 1 | 4-Cl | 2.68^{[a]} |
| I.65 | 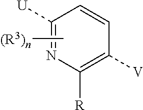 | 0 | — | CF₃ | CH₃ | H | 1 | 4-CF₃ | 3.04^{[a]} |
| I.66 | 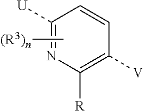 | 0 | — | CF₃ | CH₃ | H | 2 | 2-F, 4-Cl | 2.80^{[a]} |
| I.67 | 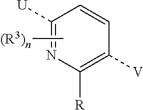 | 0 | — | CF₃ | CH₃ | H | 1 | 4-Cl | 2.68^{[a]} |
| I.68 | 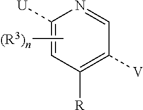 | 0 | — | Cl | H | H | 1 | 4-Cl | 2.48^{[a]} |
| I.69 | 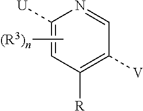 | 0 | — | CF₃ | vinyl | H | 1 | 4-CF₃ | 3.33^{[a]} |
| I.70 | 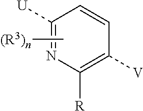 | 0 | — | CF₃ | H | H | 2 | 2-F, 4-Cl | 2.78^{[a]} |
| I.71 | 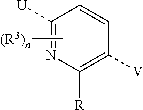 | 0 | — | CF₃ | cyclo- propyl | H | 1 | 4-Cl | 3.35^{[a]} |
| I.72 (*) | 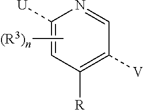 | 0 | — | CF₃ | H | H | 1 | 4-CF₃ | 2.86^{[a]} |
| I.73 | 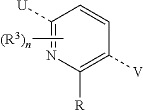 | 0 | — | CHF₂ | H | H | 1 | 4-Br | 2.50^{[a]} |
| I.74 | 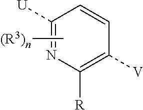 | 0 | — | CF₃ | H | H | 1 | 4-CHF₂ | 2.49^{[a]} |
| I.75 | 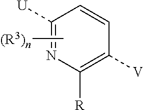 | 0 | — | CF₃ | CH₃ | H | 1 | 4-isopropyl | 3.35^{[a]} |
| I.76 | 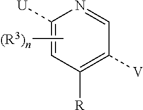 | 0 | — | CF₃ | Et | H | 1 | 4-CF₃ | 3.52^{[a]} |
| I.77 | 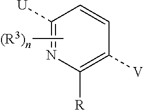 | 0 | — | 4-fluoro- phenoxy | CH₃ | H | 1 | 4-F | 3.13^{[a]} |
| I.78 | 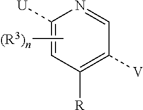 | 0 | — | Cl | CH₃ | H | 1 | 4-CF₃ | 2.88^{[a]} |
| I.79 | 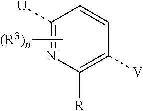 | 0 | — | CF₃ | H | H | 1 | 4-OCF₃ | 2.89^{[a]} |
| I.80 | 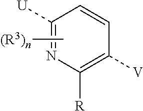 | 0 | — | CF₃ | cyclo- propyl | H | 1 | 4-Cl | 3.32^{[a]} |
| I.81 (*) | 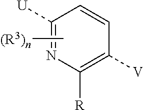 | 0 | — | CF₃ | cyclo- propyl | H | 1 | 4-Br | 3.70^{[a]} |
| I.82 | 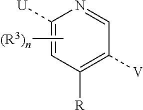 | 0 | — | CHF₂ | CH₃ | H | 1 | 4-Br | 2.78^{[a]} |
| I.83 (*) | 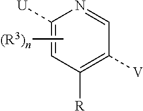 | 0 | — | CF₃ | H | H | 1 | 4-SF₅ | 3.11^{[a]} |
| I.84 (*) | 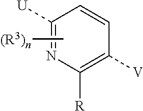 | 0 | — | CF₃ | cyclo- propyl | H | 1 | 4-Br | 3.41 ^{[a]} |
| I.85 | 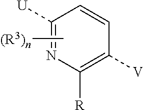 | 0 | — | CF₃ | CF₃ | H | 1 | 4-Br | 3.48^{[a]} |
| I.86 (*) | 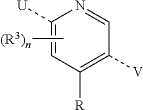 | 0 | — | CF₃ | H | H | 1 | 4-SF₅ | 3.11^{[a]} |
| I.87 | 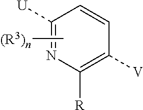 | 0 | — | CF₃ | cyclo- propyl | H | 1 | 4-CF₃ | 3.57^{[a]} |
| I.88 | 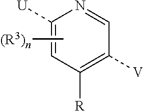 | 0 | — | Cl | H | H | 1 | 4-CF₃ | 2.64^{[a]} |
| I.89 | 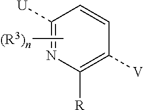 | 0 | — | CF₃ | CH₃ | H | 2 | 2-F, 4-Cl | 3.15^{[a]} |
| I.90 | 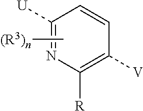 | 0 | — | CF₃ | H | H | 2 | 2-F, 4-Cl | 2.88^{[a]} |
| I.91 | 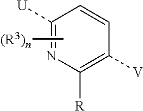 | 0 | — | CF₃ | cyclo- propyl | H | 1 | 4-Cl | 3.26^{[a]} |
| I.92 (*) | 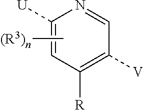 | 0 | — | CF₃ | H | H | 1 | 4-CF₃ | 2.86^{[a]} |
| I.93 | 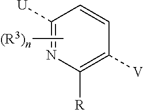 | 0 | — | CF₃ | cyclo- propyl | H | 1 | 4-CHF₂ | 3.13^{[a]} |
| I.94 | 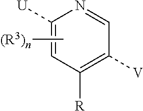 | 0 | — | CHF₂ | H | H | 1 | 4-Cl | 2.13^{[a]} |
| I.95 | 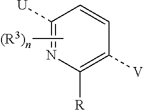 | 0 | — | CF₃ | CH₃ | H | 1 | 4-OCF₃ | 2.98^{[a]} |
| I.96 | 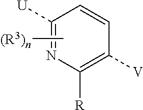 | 0 | — | CF₃ | CH₃ | H | 1 | 4-Cl | 2.68^{[a]} |
| I.97 | 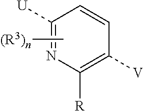 | 0 | — | CF₃ | cyclo- propyl | H | 1 | 4-SF₅ | 3.80^{[a]} |
| I.98 | 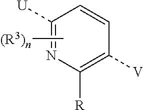 | 0 | — | CF₃ | butyl | H | 1 | 4-Cl | 3.87^{[a]} |
| I.99 (*) | 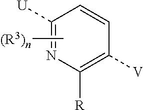 | 0 | — | CF₃ | cyclo- propyl | H | 1 | 4-Br | 3.41^{[a]} |
| I.100 | 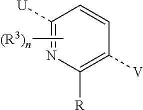 | 0 | — | CF₃ | propyl | H | 1 | 4-Cl | 3.55^{[a]} |
| I.101 (*) | 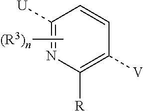 | 0 | — | CF₃ | CH₃ | H | 1 | 4-Br | 2.94^{[a]} |
| I.102 (*) | 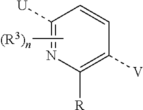 | 0 | — | CF₃ | CH₃ | H | 1 | 4-Br | 2.94^{[a]} |
| I.103 | 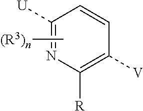 | 0 | — | CF₃ | Et | H | 1 | 4-Cl | 3.19^{[a]} |

Optical Rotation

Concentration c is expressed in g/100 mL

(*) Ex I.45 and I.46 are the 2 enantiomers of Ex I.02

(*) Ex I.53 and I.54 are the 2 enantiomers of Ex I.08

Ex I.53: Optical rotation: −35° (c=0.52, DCM, 20° C.)

Ex I.54: Optical rotation: +52° (c=0.50, DCM, 20° C.)

(*) Ex I.51 and I.52 are the 2 enantiomers of Ex I.09

Ex I.51: Optical rotation: −128.2° (c=0.52, DCM, 20° C.)

Ex I.52: Optical rotation: +133.3° (c=0.51, DCM, 20° C.)

(*) Ex I.83 and I.86 are the 2 enantiomers of Ex I.36

Ex I.83: Optical rotation: +10.0° (c=0.50, CDCl₃, 25° C.)

Ex I.86: Optical rotation: −11.0° (c=0.73, CDCl₃, 25° C.)

(*) Ex I.72 and I.92 are the 2 enantiomers of Ex I.47

Ex I.72: Optical rotation: +11.7° (c=0.52, CDCl₃, 25° C.)

Ex I.92: Optical rotation: −10.4° (c=0.58, CDCl₃, 25° C.)

(*) Ex I.101 and I.102 are the 2 enantiomers of Ex I.59

Ex I.101: Optical rotation: +27.5° (c=0.88; MeOH; 20° C.)

Ex I.102: Optical rotation: −31.5° (c=1.02; MeOH; 20° C.)

(*) Ex I.84 and I.99 are the 2 enantiomers of Ex I.81

Ex I.84: Optical rotation: −8° (c=1.00, MeOH, 25° C.)

Ex I.99: Optical rotation: +7.3° (c=1.10, MeOH, 25° C.)

TABLE 2
Compounds according to formula (V)

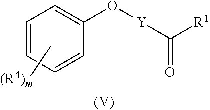

| Ex No° | Y | n | R³ | R | R¹ | m | R⁴ | LogP |
|---|---|---|---|---|---|---|---|---|
| V.01 | 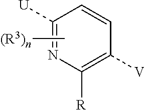 | 0 | — | CF₃ | CH₃ | 1 | 4-Cl | 3.80^{[a]} |
| V.02 | 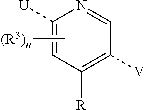 | 0 | — | CF₃ | CH₃ | 1 | 4-Cl | 3.89^{[a]} |
| V.03 | 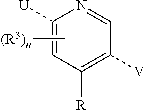 | 0 | — | CF₃ | CH₃ | 1 | 4-SF₅ | 4.32^{[a]} |
| V.04 | 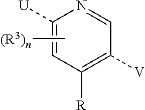 | 0 | — | CF₃ | CH₃ | 1 | 4-CHF₂ | 3.62^{[a]} |
| V.05 | 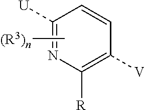 | 0 | — | CHF₂ | CH₃ | 1 | 4-Cl | 3.35^{[a]} |
| V.06 | 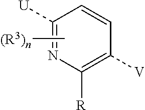 | 0 | — | OCF₃ | CH₃ | 1 | 4-Cl | 4.37^{[a]} |
| V.07 | 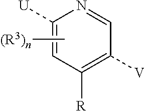 | 0 | — | CF₃ | CH₃ | 2 | 2-F, 4-Cl | 4.09^{[a]} |
| V.08 | 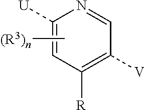 | 0 | — | Cl | CH₃ | 0 | — | 2.94^{[a]}; 2.86^{[b]} |
| V.09 | 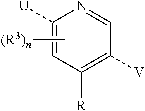 | 0 | — | Cl | CH₃ | 1 | 4-Cl | 3.52^{[a]}; 3.42^{[b]} |
| V.10 | 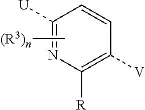 | 0 | — | Cl | CH₃ | 1 | 4-Cl | 3.47^{[a]}; 3.36^{[b]} |
| V.11 | 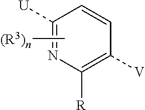 | 0 | — | Cl | CH₃ | 2 | 3-Cl, 4-Cl | 4.10^{[a]} |
| V.12 | 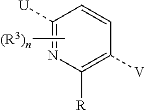 | 0 | — | Cl | CH₃ | 1 | 4-F | 3.11^{[a]} |
| V.13 | 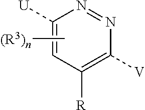 | 0 | — | H | CH₃ | 1 | 4-Cl | 2.73^{[a]} |
| V.14 | 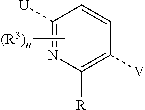 | 0 | — | Cl | CH₃ | 1 | 4-CHF₂ | 3.15^{[a]} |
| V.15 | 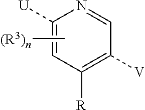 | 0 | — | CF₃ | CH₃ | 1 | 4-OCF₃ | 4.20^{[a]} |
| V.16 | 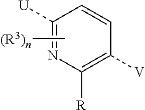 | 0 | — | CF₃ | CH₃ | 1 | 4-SF₅ | 4.09^{[a]} |
| V.17 | 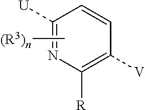 | 0 | — | CF₃ | CH₃ | 1 | 4-CF₃ | 3.96^{[a]} |
| V.18 | 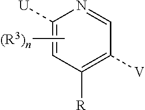 | 0 | — | Cl | CH₃ | 1 | 4-CF₃ | 3.87^{[a]} |
| V.19 | 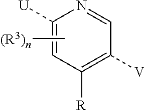 | 0 | — | C(O)CH₃ | CH₃ | 1 | 4-Cl | 3.11^{[a]} |
| V.20 | 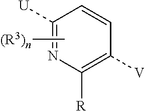 | 0 | — | CF₃ | CH₃ | 1 | 4-Br | 3.85^{[a]} |
| V.21 | 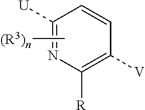 | 0 | — | Cl | CH₃ | 0 | — | 2.94^{[a]}; 2.85^{[b]} |
| V.22 | 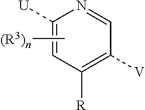 | 0 | — | Cl | CH₃ | 1 | 4-Cl | 3.51^{[a]} |
| V.23 | 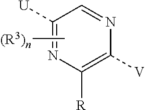 | 0 | — | Cl | CH₃ | 1 | 4-Cl | 3.51^{[a]} |
| V.24 | 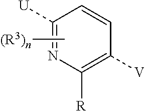 | 0 | — | F | CH₃ | 1 | 4-Cl | 3.51^{[a]} |
| V.25 | 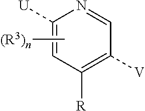 | 0 | — | CF₃ | CH₃ | 1 | 4-CF₃ | 4.04^{[a]} |
| V.26 | 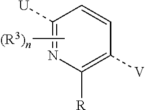 | 0 | — | Cl | CH₃ | 1 | 4-Cl | 3.45^{[a]} |
| V.27 | 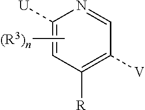 | 0 | — | CF₃ | CH₃ | 1 | 4-Br | 3.99^{[a]} |
| V.28 | 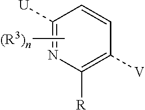 | 0 | — | Cl | CH₃ | 1 | 4-OCF₃ | 3.89^{[a]} |
| V.29 | 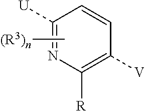 | 0 | — | Cl | CH₃ | 2 | 2-Cl, 4-OCH₃ | 3.44^{[a]} |
| V.30 | 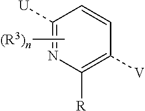 | 0 | — | Cl | CH₃ | 1 | 4-SF₅ | 3.99^{[a]} |
| V.31 | 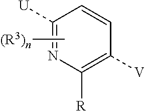 | 0 | — | CF₃ | CH₃ | 3 | 2-F, 4-Cl, 6-F | 4.06^{[a]} |
| V.32 | 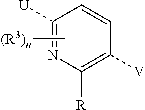 | 0 | — | CF₃ | CH₃ | 1 | 4-CHF₂ | 3.26^{[a]} |
| V.33 | 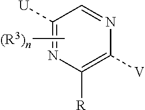 | 0 | — | 4-chloro- phenoxy | CH₃ | 1 | 4-Cl | 4.36^{[a]} |
| V.34 | 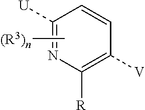 | 0 | — | CHF₂ | CH₃ | 1 | 4-Br | 3.46^{[a]} |
| V.35 | 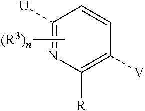 | 0 | — | CF₃ | CH₃ | 1 | 4-OCF₃ | 4.04^{[a]} |
| V.36 | 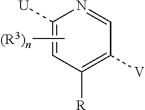 | 0 | — | CHF₂ | CH₃ | 1 | 4-Br | 3.74^{[a]} |
| V.37 | 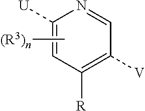 | 0 | — | CHF₂ | CH₃ | 1 | 4-Cl | 3.57^{[a]} |
| V.38 | 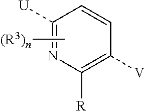 | 0 | — | CF₃ | CH₃ | 2 | 2-F, 4-Cl | 3.87^{[a]} |
| V.39 | 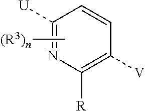 | 0 | — | CF₃ | cyclopropyl | 1 | 4-CF₃ | 4.37^{[a]} |
| V.40 | 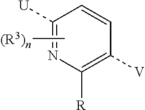 | 0 | — | CF₃ | cyclopropyl | 1 | 4-Br | 4.49^{[a]} |
| V.41 | 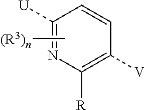 | 0 | — | CF₃ | cyclopropyl | 1 | 4-Cl | 4.17^{[a]} |
| V.42 | 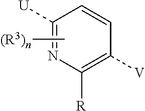 | 0 | — | CF₃ | cyclopropyl | 1 | 4-formyl | 3.21^{[a]} |
| V.43 | 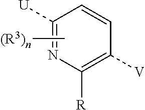 | 0 | — | CF₃ | cyclopropyl | 1 | 4-SF₅ | 4.67^{[a]} |
| V.44 | 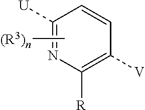 | 0 | — | CF₃ | cyclopropyl | 1 | 4-CHF₂ | 3.80^{[a]} |
| V.45 | 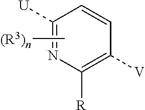 | 0 | — | CF₃ | ethyl | 1 | 4-Cl | 4.20^{[a]} |
| V.46 | 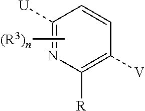 | 0 | — | CF₃ | propyl | 1 | 4-Cl | 4.59^{[a]} |
| V.47 | 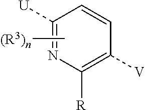 | 0 | — | CF₃ | isobutyl | 1 | 4-Cl | 4.98^{[a]} |
| V.48 | 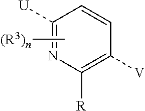 | 0 | — | CF₃ | butyl | 1 | 4-Cl | 5.03^{[a]} |

TABLE 3
Compounds according to formula (VI)

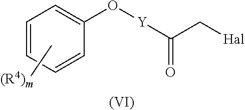

| Ex N° | Y | n | R³ | R | Hal | m | R⁴ | LogP |
|---|---|---|---|---|---|---|---|---|
| VI.01 | 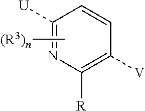 | 0 | — | CF₃ | Cl | 1 | 4-Cl | 4.01^{[a]} |
| VI.02 | 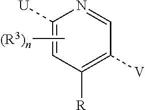 | 0 | — | CF₃ | Cl | 1 | 4-Cl | |
| VI.03 | 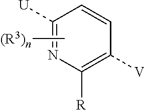 | 0 | — | Cl | Cl | 0 | — | 3.23^{[a]} |
| VI.04 | 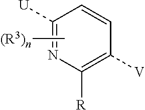 | 0 | — | Cl | Cl | 1 | 4-Cl | 3.72^{[a]} |
| VI.05 | 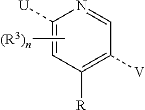 | 0 | — | Cl | Cl | 0 | — | 3.28^{[a]} |
| VI.06 | 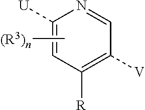 | 0 | — | Cl | Cl | 1 | 4-Cl | 3.77^{[a]} |
| VI.07 | 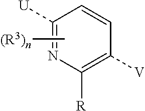 | 0 | — | Cl | Br | 2 | 3-Cl, 4-Cl | 4.58^{[a]} |
| VI.08 | 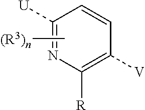 | 0 | — | Cl | Cl | 1 | 4-OCF₃ | 4.09^{[a]} |
| VI.09 | 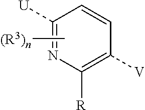 | 0 | — | Cl | Cl | 1 | 4-F | 3.39^{[a]} |
| VI.10 | 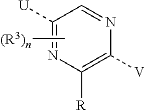 | 0 | — | Cl | Cl | 1 | 4-Cl | 3.78^{[a]} |
| VI.11 | 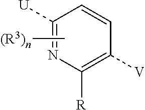 | 0 | — | CHF₂ | Cl | 1 | 4-Cl | 3.62^{[a]} |
| VI.12 | 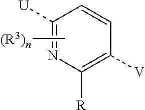 | 0 | — | OCF₃ | Cl | 1 | 4-Cl | 4.51^{[a]} |
| VI.13 | 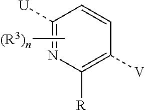 | 0 | — | Cl | Cl | 2 | 2-Cl, 4-OCH₃ | 3.71^{[a]} |
| VI.14 | 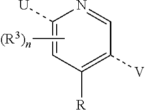 | 0 | — | CF₃ | Br | 1 | 4-Cl | 4.29^{[a]} |
| VI.15 | 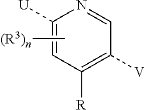 | 0 | — | CF₃ | Br | 1 | 4-Br | 4.34^{[a]} |
| VI.16 | 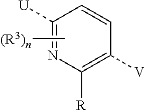 | 0 | — | Cl | Cl | 1 | 4-CHF₂ | 3.42^{[a]} |
| VI.17 | 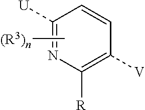 | 0 | — | Cl | Br | 1 | 4-CHF₂ | 3.57^{[a]} |
| VI.18 | 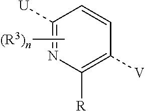 | 0 | — | CF₃ | Br | 1 | 4-Br | 4.23^{[a]} |
| VI.19 | 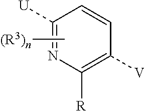 | 0 | — | CF₃ | Cl | 1 | 4-Br | 4.11^{[a]} |
| VI.20 | 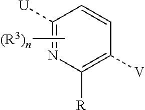 | 0 | — | F | Cl | 1 | 4-Cl | 3.69^{[a]} |
| VI.21 | 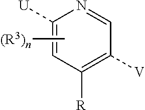 | 0 | — | CF₃ | Cl | 1 | 4-OCF₃ | 4.37^{[a]} |
| VI.22 | 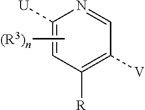 | 0 | — | CF₃ | Cl | 1 | 4-CF₃ | 4.21^{[a]} |
| VI.23 | 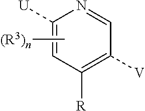 | 0 | — | CF₃ | Cl | 1 | 4-Br | 4.16^{[a]} |
| VI.24 | 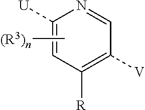 | 0 | — | CF₃ | Br | 2 | 2-F, 4-Cl | 4.34^{[a]} |
| VI.25 | 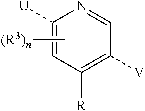 | 0 | — | CF₃ | Cl | 2 | 2-F, 4-Cl | 4.15^{[a]} |
| VI.26 | 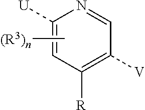 | 0 | — | CF₃ | Cl | 1 | 4-CHF₂ | 3.76^{[a]} |
| VI.27 | 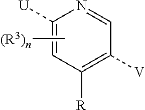 | 0 | — | CF₃ | Br | 1 | 4-CHF₂ | 3.99^{[a]} |
| VI.28 | 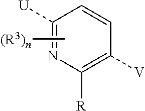 | 0 | — | CF₃ | Cl | 1 | 4-CF₃ | 4.19^{[a]} |
| VI.29 | 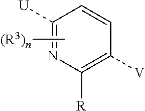 | 0 | — | CF₃ | Cl | 1 | 4-SF₅ | 4.29^{[a]} |
| VI.30 | 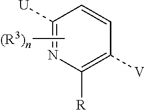 | 0 | — | Cl | Cl | 1 | 4-SF₅ | 4.21^{[a]} |
| VI.31 | 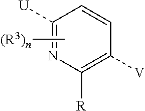 | 0 | — | CF₃ | Cl | 3 | 2-F, 4-Cl, 6-F | 4.26^{[a]} |
| VI.32 | 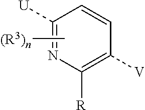 | 0 | — | CF₃ | Br | 3 | 2-F, 4-Cl, 6-F | 4.18^{[a]} |
| VI.33 | 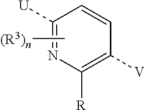 | 0 | — | CF₃ | Cl | 1 | 4-OCF₃ | 4.07^{[a]} |
| VI.34 | 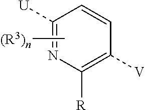 | 0 | — | CF₃ | Br | 1 | 4-Cl | 4.19^{[a]} |
| VI.35 | 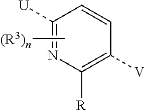 | 0 | — | CF₃ | Cl | 2 | 2-F, 4-Cl | 4.11^{[a]} |
| VI.36 | 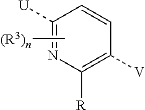 | 0 | — | CF₃ | Cl | 1 | 4-CHF₂ | 3.50^{[a]} |

TABLE 4
Compounds according to formula (VII)

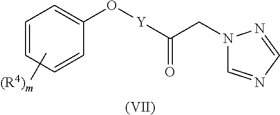

| Ex N° | Y | n | R³ | R | m | R⁴ | LogP |
|---|---|---|---|---|---|---|---|
| VII.01 | 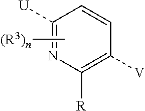 | 0 | — | CF₃ | 1 | 4-Cl | 2.92^{[a]} |
| VII.02 | 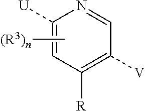 | 0 | — | CF₃ | 1 | 4-Cl | 2.92^{[a]} |
| VII.03 | 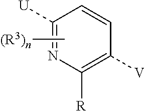 | 0 | — | Cl | 2 | 3-Cl, 4-Cl | 3.06^{[a]} |
| VII.04 | 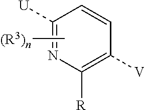 | 0 | — | Cl | 2 | 3-Cl, 4-OCF₃ | 3.33^{[a]} |
| VII.05 | 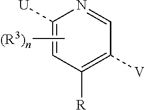 | 0 | — | Cl | 0 | — | 2.20^{[a]} |
| VII.06 | 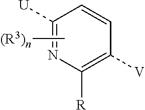 | 0 | — | Cl | 0 | — | 2.21^{[a]} |
| VII.07 | 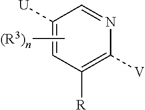 | 0 | — | Cl | 0 | — | 2.45^{[a]} |
| VII.08 | 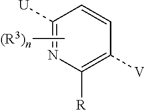 | 0 | — | Cl | 1 | 4-OCF₃ | 2.95^{[a]} |
| VII.09 | 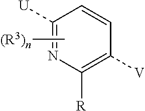 | 0 | — | Cl | 1 | 4-Cl | 2.66^{[a]} |
| VII.10 | 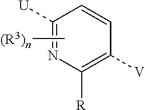 | 0 | — | Cl | 2 | 2-CH₃, 4-Cl | 2.94^{[a]} |
| VII.11 | 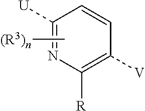 | 0 | — | Cl | 2 | 3-Cl, 4-CH₃ | 3.02^{[a]} |
| VII.12 | 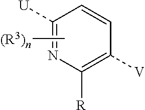 | 0 | — | Cl | 1 | 4-F | 2.30^{[a]} |
| VII.13 | 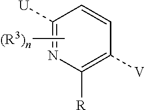 | 0 | — | Cl | 2 | 2-F, 4-F | 2.41^{[a]} |
| VII.14 | 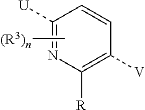 | 0 | — | Cl | 1 | 2-F | 2.28^{[a]} |
| VII.15 | 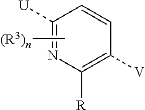 | 0 | — | Cl | 3 | 3-F, 4-F, 5-F | 2.66^{[a]} |
| VII.16 | 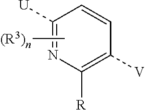 | 0 | — | Cl | 2 | 2-Cl, 4-Cl | 3.02^{[a]} |
| VII.17 | 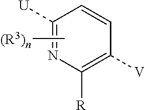 | 0 | — | Cl | 1 | 4-C(O)CH₃ | 1.96^{[a]} |
| VII.18 | 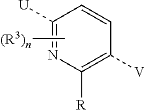 | 0 | — | OCF₃ | 1 | 4-Cl | 3.23^{[a]} |
| VII.19 | 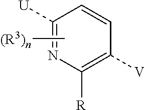 | 0 | — | Cl | 2 | 2-Cl, 4-OCH₃ | 2.58^{[a]} |
| VII.20 | 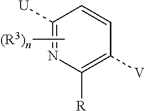 | 0 | — | Cl | 1 | 4-SF₅ | 3.11^{[a]} |
| VII.21 | 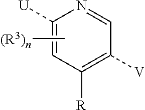 | 0 | — | CF₃ | 1 | 4-SF₅ | 3.35^{[a]} |
| VII.22 | 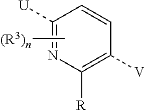 | 0 | — | Cl | 1 | 4-CHF₂ | 2.39^{[a]} |
| VII.23 | 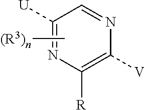 | 0 | — | Cl | 1 | 4-Cl | 2.54^{[a]} |
| VII.24 | 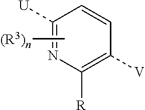 | 0 | — | CF₃ | 1 | 4-Br | 2.99^{[a]} |
| VII.25 | 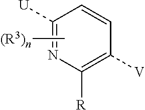 | 0 | — | F | 1 | 4-Cl | 2.50^{[a]} |
| VII.26 | 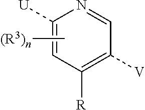 | 0 | — | CF₃ | 1 | 4-OCF₃ | 3.27^{[a]} |
| VII.27 | 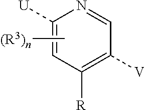 | 0 | — | CF₃ | 1 | 4-Br | 3.02^{[a]} |
| VII.28 | 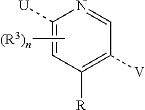 | 0 | — | CF₃ | 1 | 4-CF₃ | 3.17^{[a]} |
| VII.29 | 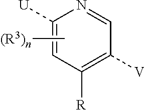 | 0 | — | CF₃ | 1 | 4-CHF₂ | 2.80^{[a]} |
| VII.30 | 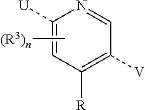 | 0 | — | CF₃ | 2 | 2-F, 4-Cl | 3.06^{[a]} |
| VII.31 | 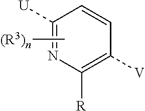 | 0 | — | CF₃ | 1 | 4-SF₅ | 3.23^{[a]} |
| VII.32 | 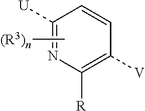 | 0 | — | CF₃ | 1 | 4-CF₃ | 3.04^{[a]} |
| VII.33 | 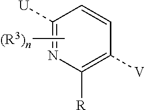 | 0 | — | CF₃ | 3 | 2-F, 4-Cl, 6-F | 2.96^{[a]} |
| VII.34 | 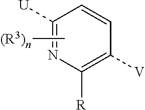 | 0 | — | CF₃ | 1 | 4-isopropyl | 3.44^{[a]} |
| VII.35 | 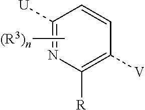 | 0 | — | CHF₂ | 1 | 4-Br | 2.68^{[a]} |
| VII.36 | 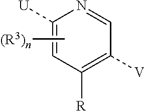 | 0 | — | CHF₂ | 1 | 4-Cl | 2.51^{[a]} |
| VII.37 | 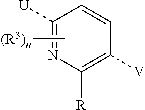 | 0 | — | CF₃ | 2 | 2-F, 4-Cl | 2.74^{[a]} |
| VII.38 | 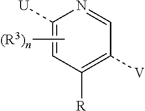 | 0 | — | Cl | 1 | 4-Cl | 2.60^{[a]} |
| VII.39 | 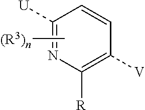 | 0 | — | CF₃ | 1 | 4-OCF₃ | 2.95^{[a]} |
| VII.40 | 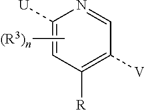 | 0 | — | Cl | 1 | 4-CF₃ | 2.92^{[a]} |
| VII.41 | 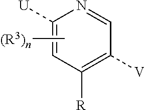 | 0 | — | CHF₂ | 1 | 4-Br | 2.61^{[a]} |
| VII.42 | 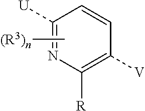 | 0 | — | CF₃ | 1 | 4-CHF₂ | 2.41^{[a]} |

TABLE 5
Compounds according to formula (IX)

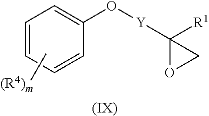

| Ex N° | Y | n | R³ | R | R¹ | m | R⁴ | LogP |
|---|---|---|---|---|---|---|---|---|
| IX.01 | 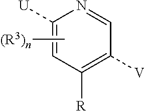 | 0 | — | CF₃ | CH₃ | 1 | 4-Cl | 4.41^{[a]} |
| IX.02 | 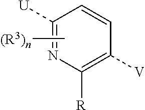 | 0 | — | Cl | CH₃ | 0 | — | 3.40^{[a]}; 3.38^{[b]} |
| IX.03 | 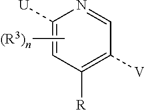 | 0 | — | Cl | CH | 1 | 4-Cl | 4.06^{[a]}; 4.00^{[b]} |
| IX.04 | 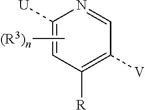 | 0 | — | Cl | CH₃ | 0 | — | 3.42^{[a]}; 3.39^{[b]} |
| IX.05 | 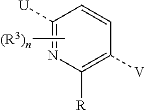 | 0 | — | CF₃ | cyclopropyl | 1 | 4-CHF₂ | 4.49^{[a]} |
| IX.06 | 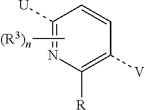 | 0 | — | CF₃ | CH₃ | 1 | 4-Cl | 4.44^{[a]} |
| IX.07 | 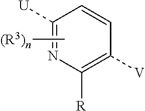 | 0 | — | CF₃ | cyclopropyl | 1 | 4-Cl | 4.80^{[a]} |
| IX.08 | 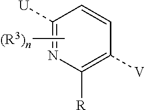 | 0 | — | CF₃ | cyclopropyl | 1 | 4-Br | 5.11^{[a]} |
| IX.09 | 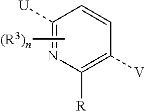 | 0 | — | CF₃ | cyclopropyl | 1 | 4-SF₅ | 5.22^{[a]} |
| IX.10 | 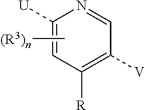 | 0 | — | Cl | CH₃ | 1 | 4-Cl | 4.06^{[a]} |
| IX.11 | 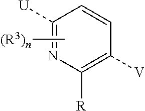 | 0 | — | CF₃ | cyclopropyl | 1 | 4-CF₃ | 5.00^{[a]} |

LogP Values:

Measurement of LogP values was performed according to EEC directive 79/831 Annex V.A8 by HPLC (High Performance Liquid Chromatography) on reversed phase columns with the following methods:

^{[a]} LogP value is determined by measurement of LC-UV, in an acidic range, with 0.1% formic acid in water and acetonitrile as eluent (linear gradient from 10% acetonitrile to 95% acetonitrile).

^{[b]} LogP value is determined by measurement of LC-UV, in a neutral range, with 0.001 molar ammonium acetate solution in water and acetonitrile as eluent (linear gradient from 10% acetonitrile to 95% acetonitrile).

^{[c]} LogP value is determined by measurement of LC-UV, in an acidic range, with 0.1% phosphoric acid in water and acetonitrile as eluent (linear gradient from 10% acetonitrile to 95% acetonitrile).

If more than one LogP value is available within the same method, all the values are given and separated by “+”.

Calibration was done with straight-chain alkan2-ones (with 3 to 16 carbon atoms) with known LogP values (measurement of LogP values using retention times with linear interpolation between successive alkanones). Lambda-max-values were determined using UV-spectra from 200 nm to 400 nm and the peak values of the chromatographic signals.

NMR-Peak Lists

1H-NMR data of selected examples are written in form of 1H-NMR-peak lists. To each signal peak are listed the δ-value in ppm and the signal intensity in round brackets. Between the δ-value—signal intensity pairs are semicolons as delimiters.

The peak list of an example has therefore the form:

δ₁ (intensity₁); δ₂ (intensity₂); . . . ; δᵢ (intensityᵢ); . . . ; δₙ (intensityₙ)

Intensity of sharp signals correlates with the height of the signals in a printed example of a NMR spectrum in cm and shows the real relations of signal intensities. From broad signals several peaks or the middle of the signal and their relative intensity in comparison to the most intensive signal in the spectrum can be shown.

For calibrating chemical shift for 1H spectra, we use tetramethylsilane and/or the chemical shift of the solvent used, especially in the case of spectra measured in DMSO. Therefore in NMR peak lists, tetramethylsilane peak can occur but not necessarily.

The 1H-NMR peak lists are similar to classical 1H-NMR prints and contains therefore usually all peaks, which are listed at classical NMR-interpretation.

Additionally they can show like classical 1H-NMR prints signals of solvents, stereoisomers of the target compounds, which are also object of the invention, and/or peaks of impurities.

To show compound signals in the delta-range of solvents and/or water the usual peaks of solvents, for example peaks of DMSO in DMSO-D6 and the peak of water are shown in our 1H-NMR peak lists and have usually on average a high intensity.

The peaks of stereoisomers of the target compounds and/or peaks of impurities have usually on average a lower intensity than the peaks of target compounds (for example with a purity >90%).

Such stereoisomers and/or impurities can be typical for the specific preparation process. Therefore their peaks can help to recognize the reproduction of our preparation process via “side-products-fingerprints”.

An expert, who calculates the peaks of the target compounds with known methods (MestreC, ACD-simulation, but also with empirically evaluated expectation values) can isolate the peaks of the target compounds as needed optionally using additional intensity filters. This isolation would be similar to relevant peak picking at classical 1H-NMR interpretation.

Further details of NMR-data description with peak lists you find in the publication “Citation of NMR Peaklist Data within Patent Applications” of the Research Disclosure Database Number 564025.

### Example I.01

¹H-NMR (300.2 MHz, CDCl₃): δ=8.232 (2.4); 8.203 (2.5); 8.041 (5.3); 8.022 (0.4); 7.955 (5.9); 7.645 (0.5); 7.424 (0.8); 7.414 (5.5); 7.406 (1.8); 7.391 (2.1); 7.384 (6.6); 7.373 (0.8); 7.368 (0.4); 7.299 (88.2); 7.188 (0.9); 7.177 (6.9); 7.170 (1.8); 7.155 (1.8); 7.147 (5.0); 7.136 (0.4); 7.031 (3.0); 7.002 (2.7); 6.948 (0.5); 5.424 (0.4); 4.764 (2.2); 4.716 (3.6); 4.702 (5.8); 4.554 (3.5); 4.507 (2.4); 4.197 (1.1); 4.173 (3.5); 4.150 (3.5); 4.126 (1.1); 2.085 (16.0); 1.679 (12.3); 1.579 (44.1); 1.323 (4.5); 1.299 (9.1); 1.275 (4.2); 0.917 (0.3); 0.235 (0.6); 0.108 (9.3); 0.050 (4.1); 0.039 (119.3); 0.028 (4.6); −0.027 (0.3); −0.159 (0.5)

### Example I.02

¹H-NMR (300.2 MHz, CDCl₃): δ=8.470 (5.6); 8.063 (6.3); 7.956 (6.4); 7.450 (0.6); 7.439 (5.5); 7.432 (2.0); 7.416 (2.1); 7.409 (7.0); 7.398 (0.8); 7.316 (6.6); 7.300 (30.3); 7.138 (0.8); 7.127 (6.8); 7.120 (2.3); 7.105 (1.9); 7.097 (5.7); 7.087 (0.6); 5.340 (0.7); 4.727 (2.5); 4.679 (3.6); 4.480 (3.9); 4.440 (7.0); 1.675 (16.0); 1.587 (17.3); 1.294 (0.7); 0.109 (1.8); 0.051 (1.7); 0.040 (41.5); 0.029 (1.8)

### Example I.03

¹H-NMR (300.2 MHz, CDCl₃): δ=8.134 (3.3); 8.113 (1.4); 8.084 (1.4); 8.045 (3.4); 7.430 (3.0); 7.423 (1.0); 7.408 (1.1); 7.400 (3.8); 7.390 (0.5); 7.299 (12.4); 7.202 (0.5); 7.192 (3.8); 7.184 (1.2); 7.169 (1.0); 7.162 (3.0); 7.151 (1.7); 7.121 (1.4); 5.551 (0.5); 5.524 (0.5); 4.528 (0.7); 4.520 (0.7); 4.481 (1.0); 4.473 (1.0); 4.312 (1.0); 4.285 (1.0); 4.265 (0.7); 4.238 (0.7); 4.032 (0.9); 1.600 (16.0); 0.108 (1.3); 0.049 (0.6); 0.038 (14.7); 0.027 (0.6)

### Example I.04

¹H-NMR (300.2 MHz, CDCl₃): δ=8.582 (3.2); 8.159 (4.0); 8.055 (3.9); 7.646 (0.5); 7.452 (3.3); 7.430 (1.2); 7.422 (4.4); 7.412 (0.6); 7.367 (0.6); 7.300 (81.3); 7.259 (3.7); 7.234 (0.4); 7.160 (0.5); 7.149 (4.3); 7.126 (1.2); 7.119 (3.5); 6.949 (0.5); 5.470 (0.8); 5.452 (0.9); 5.340 (16.0); 4.515 (0.8); 4.508 (0.8); 4.469 (1.4); 4.461 (1.4); 4.343 (1.2); 4.315 (1.2); 4.297 (0.8); 4.269 (0.7); 3.835 (2.3); 3.824 (2.3); 1.647 (0.6); 1.607 (0.4); 1.581 (79.0); 1.515 (0.4); 1.351 (0.7); 1.293 (1.5); 0.920 (0.6); 0.900 (0.3); 0.235 (0.6); 0.109 (6.3); 0.051 (3.5); 0.040 (105.0); 0.029 (5.2); 0.006 (0.4); −0.026 (0.4); −0.159 (0.5)

### Example I.05

¹H-NMR (400.0 MHz, d₆-DMSO): δ=8.339 (3.2); 8.187 (3.4); 7.953 (2.1); 7.790 (3.1); 7.443 (1.0); 7.438 (0.4); 7.424 (1.8); 7.422 (1.7); 7.407 (0.5); 7.403 (1.5); 7.248 (0.7); 7.246 (0.4); 7.230 (1.1); 7.211 (0.5); 7.147 (3.6); 7.120 (1.6); 7.117 (1.9); 7.112 (0.5); 7.098 (1.6); 7.096 (1.4); 6.002 (2.8); 4.747 (0.9); 4.711 (1.4); 4.597 (1.4); 4.561 (0.9); 3.328 (18.0); 2.891 (16.0); 2.732 (13.3); 2.511 (6.5); 2.507 (13.1); 2.502 (17.3); 2.498 (12.5); 2.493 (5.9); 1.989 (1.1); 1.615 (7.6); 1.175 (0.6); 0.000 (4.4)

### Example I.06

¹H-NMR (400.0 MHz, d₆-DMSO): δ=8.367 (6.6); 8.224 (4.5); 8.218 (4.6); 7.808 (6.2); 7.619 (4.5); 7.613 (4.4); 7.491 (0.3); 7.486 (2.3); 7.480 (0.9); 7.473 (0.5); 7.467 (3.6); 7.464 (3.4); 7.459 (0.5); 7.451 (1.1); 7.446 (3.1); 7.440 (0.4); 7.268 (0.8); 7.265 (1.5); 7.263 (0.9); 7.247 (2.4); 7.231 (0.6); 7.228 (1.1); 7.226 (0.6); 7.133 (3.3); 7.130 (4.2); 7.125 (1.1); 7.114 (1.9); 7.111 (3.5); 7.109 (3.0); 7.102 (0.3); 5.809 (7.5); 5.757 (4.9); 4.764 (1.4); 4.729 (3.5); 4.690 (3.7); 4.655 (1.5); 4.038 (0.4); 4.020 (0.4); 3.327 (20.9); 2.525 (0.4); 2.512 (8.5); 2.507 (17.1); 2.503 (22.5); 2.498 (16.1); 2.493 (7.6); 1.989 (1.8); 1.551 (16.0); 1.397 (0.9); 1.193 (0.5); 1.175 (1.0); 1.157 (0.5); 0.000 (6.5)

### Example I.07

¹H-NMR (400.0 MHz, d₆-DMSO): δ=8.327 (6.5); 7.985 (3.8); 7.963 (4.1); 7.953 (1.2); 7.785 (6.2); 7.477 (0.3); 7.472 (2.2); 7.467 (0.9); 7.453 (3.6); 7.451 (3.5); 7.437 (1.1); 7.432 (3.0); 7.426 (0.4); 7.275 (1.4); 7.256 (2.3); 7.238 (1.0); 7.162 (3.2); 7.160 (4.0); 7.155 (1.1); 7.141 (3.3); 7.139 (2.9); 7.132 (0.3); 6.917 (4.0); 6.896 (4.0); 6.009 (5.5); 4.776 (2.0); 4.740 (2.7); 4.595 (2.8); 4.560 (2.0); 4.056 (0.6); 4.038 (1.9); 4.020 (1.9); 4.002 (0.6); 3.328 (25.8); 2.891 (9.0); 2.732 (7.3); 2.525 (0.6); 2.511 (11.8); 2.507 (23.5); 2.502 (30.8); 2.498 (22.2); 2.493 (10.6); 1.989 (8.2); 1.612 (16.0); 1.397 (1.9); 1.193 (2.2); 1.175 (4.4); 1.157 (2.2); 0.000 (8.0)

### Example I.08

¹H-NMR (499.9 MHz, d₆-DMSO): δ=8.369 (6.3); 8.251 (6.6); 7.785 (5.9); 7.614 (4.8); 7.597 (5.6); 7.400 (5.7); 7.382 (4.8); 6.581 (6.6); 6.047 (5.9); 4.777 (2.3); 4.749 (2.9); 4.542 (2.9); 4.514 (2.3); 3.319 (6.7); 2.892 (0.5); 2.733 (0.5); 2.504 (2.7); 1.629 (16.0); 0.000 (0.7)

### Example I.09

¹H-NMR (300.2 MHz, CDCl₃): δ=8.077 (3.7); 8.049 (3.9); 8.006 (4.7); 7.860 (4.4); 7.378 (0.4); 7.367 (4.5); 7.360 (1.5); 7.345 (1.7); 7.337 (5.5); 7.326 (0.7); 7.269 (2.2); 7.084 (0.6); 7.074 (5.6); 7.066 (1.7); 7.051 (1.5); 7.044 (4.5); 7.033 (0.5); 6.718 (3.9); 6.690 (3.8); 5.300 (0.7); 5.260 (2.0); 5.213 (2.3); 4.991 (1.5); 4.536 (2.4); 4.489 (2.1); 1.744 (0.5); 1.697 (16.0); 0.000 (2.5)

### Example I.10

¹H-NMR (400.1 MHz, CDCl₃): δ=8.092 (12.5); 7.992 (0.9); 7.963 (15.1); 7.913 (11.8); 7.892 (12.2); 7.861 (0.4); 7.839 (0.4); 7.520 (0.3); 7.476 (14.5); 7.454 (16.0); 7.311 (0.4); 7.288 (15.7); 7.281 (16.1); 7.261 (38.0); 7.045 (9.1); 7.039 (8.5); 7.023 (8.2); 7.017 (7.6); 6.997 (0.4); 6.919 (0.6); 6.900 (13.5); 6.879 (12.9); 5.378 (5.7); 5.372 (6.0); 5.358 (6.3); 5.353 (5.8); 4.603 (5.8); 4.597 (5.8); 4.568 (7.1); 4.562 (6.9); 4.260 (6.5); 4.241 (6.4); 4.225 (5.6); 4.206 (5.3); 4.145 (1.0); 4.127 (2.4); 4.109 (2.4); 4.092 (0.9); 2.952 (3.0); 2.872 (2.7); 2.040 (9.7); 1.331 (0.5); 1.324 (0.5); 1.309 (0.5); 1.284 (0.8); 1.275 (3.2); 1.257 (7.5); 1.239 (2.8); 0.880 (0.6); 0.862 (0.3); 0.070 (5.2); 0.008 (1.3); 0.000 (27.0)

### Example I.11

¹H-NMR (300.2 MHz, CDCl₃): δ=8.116 (0.6); 8.097 (14.9); 7.990 (16.0); 7.955 (0.5); 7.931 (7.3); 7.930 (7.3); 7.904 (7.8); 7.902 (7.7); 7.608 (0.5); 7.372 (3.9); 7.368 (4.0); 7.342 (5.1); 7.338 (5.1); 7.308 (9.9); 7.299 (10.9); 7.262 (69.8); 7.125 (6.8); 7.116 (6.2); 7.095 (5.4); 7.086 (5.1); 6.946 (0.4); 6.927 (8.4); 6.911 (0.8); 6.900 (8.0); 5.390 (2.4); 5.365 (2.5); 5.302 (14.5); 4.623 (3.7); 4.615 (3.7); 4.576 (4.7); 4.568 (4.7); 4.286 (4.5); 4.260 (4.3); 4.239 (3.6); 4.214 (3.7); 4.185 (2.8); 2.716 (1.6); 2.046 (0.6); 1.584 (3.2); 1.267 (1.0); 1.260 (0.9); 1.253 (1.0); 1.244 (1.8); 1.236 (0.4); 1.221 (0.9); 0.011 (1.7); 0.000 (56.1); −0.011 (2.6)

### Example I.12

¹H-NMR (300.2 MHz, CDCl₃): δ=8.087 (14.9); 7.953 (16.0); 7.928 (0.3); 7.909 (7.3); 7.908 (7.1); 7.881 (7.7); 7.880 (7.4); 7.276 (5.2); 7.270 (3.8); 7.264 (27.5); 7.248 (10.2); 7.245 (9.9); 7.201 (2.6); 7.191 (19.5); 7.183 (4.9); 7.168 (4.0); 7.160 (8.9); 7.150 (1.1); 7.139 (0.5); 6.883 (8.4); 6.855 (8.1); 5.380 (2.1); 5.354 (2.3); 4.610 (3.5); 4.603 (3.5); 4.564 (4.5); 4.556 (4.4); 4.419 (2.9); 4.407 (2.8); 4.373 (0.3); 4.262 (4.4); 4.236 (4.1); 4.216 (3.4); 4.189 (3.3); 4.155 (0.5); 4.131 (1.3); 4.107 (1.3); 4.083 (0.5); 2.045 (6.0); 1.644 (4.8); 1.283 (1.7); 1.259 (3.5); 1.235 (1.6); 0.071 (1.7); 0.011 (0.6); 0.000 (19.0); −0.011 (0.8)

### Example I.13

¹H-NMR (300.2 MHz, CDCl₃): δ=8.115 (4.1); 8.089 (14.8); 7.985 (4.0); 7.958 (15.1); 7.889 (2.2); 7.863 (9.8); 7.835 (8.2); 7.442 (9.1); 7.417 (16.0); 7.393 (9.0); 7.291 (5.7); 7.277 (12.3); 7.267 (22.4); 7.264 (25.4); 7.240 (7.6); 7.217 (3.0); 7.156 (17.9); 7.130 (11.9); 6.834 (2.2); 6.807 (10.1); 6.792 (4.5); 6.779 (7.8); 5.381 (6.6); 5.358 (5.6); 4.609 (5.8); 4.562 (7.4); 4.332 (6.4); 4.288 (1.8); 4.261 (6.0); 4.235 (5.4); 4.215 (4.6); 4.188 (3.6); 4.158 (1.4); 4.131 (2.8); 4.107 (2.6); 4.087 (0.9); 2.072 (2.4); 2.058 (5.2); 2.048 (8.8); 2.045 (9.9); 1.718 (0.4); 1.711 (0.4); 1.639 (7.3); 1.352 (0.4); 1.283 (4.6); 1.272 (4.2); 1.262 (7.0); 1.259 (7.6); 1.238 (2.8); 1.235 (3.0); 0.904 (0.4); 0.879 (0.5); 0.859 (0.5); 0.097 (0.6); 0.071 (1.8); 0.027 (3.3); 0.013 (7.3); 0.003 (12.0); 0.000 (13.6)

### Example I.14

¹H-NMR (300.2 MHz, CDCl₃): δ=8.148 (0.4); 8.140 (0.4); 8.083 (12.1); 7.916 (14.3); 7.903 (7.1); 7.902 (7.0); 7.876 (7.1); 7.874 (7.0); 7.394 (1.2); 7.383 (12.6); 7.376 (4.3); 7.370 (1.7); 7.361 (5.0); 7.353 (16.0); 7.342 (2.3); 7.330 (0.3); 7.266 (13.6); 7.117 (1.7); 7.106 (15.8); 7.099 (4.8); 7.084 (4.7); 7.076 (12.9); 7.065 (1.5); 7.056 (1.0); 6.954 (0.4); 6.926 (0.4); 6.861 (7.7); 6.833 (7.3); 5.365 (1.9); 5.338 (2.0); 4.676 (2.8); 4.663 (2.7); 4.596 (3.2); 4.588 (3.2); 4.550 (4.0); 4.542 (4.0); 4.320 (0.4); 4.234 (3.8); 4.208 (3.7); 4.188 (3.1); 4.161 (3.0); 4.152 (0.6); 4.128 (1.2); 4.104 (1.2); 4.080 (0.4); 2.042 (5.5); 1.729 (1.5); 1.281 (1.6); 1.257 (3.3); 1.234 (1.6); 0.072 (0.6); 0.000 (9.1); −0.011 (0.4)

### Example I.15

¹H-NMR (300.2 MHz, CDCl₃): δ=8.085 (6.3); 7.972 (6.5); 7.868 (3.0); 7.867 (3.1); 7.840 (3.1); 7.839 (3.3); 7.263 (20.3); 7.219 (1.5); 7.217 (1.5); 7.210 (1.2); 7.208 (1.1); 7.189 (1.9); 7.182 (1.6); 7.180 (1.5); 7.002 (3.7); 6.973 (2.9); 6.789 (3.5); 6.761 (3.4); 5.367 (0.9); 5.356 (0.9); 5.341 (0.9); 4.606 (1.5); 4.599 (1.5); 4.560 (1.9); 4.552 (1.9); 4.265 (1.9); 4.239 (1.8); 4.218 (1.8); 4.210 (2.0); 4.193 (2.4); 2.153 (16.0); 2.046 (0.4); 1.600 (4.1); 1.259 (0.4); 1.254 (0.4); 0.070 (11.1); 0.011 (0.5); 0.000 (13.3); −0.011 (0.6)

### Example I.16

¹H-NMR (300.2 MHz, CDCl₃): δ=8.089 (6.2); 7.951 (6.5); 7.886 (2.9); 7.885 (3.0); 7.859 (3.0); 7.857 (3.1); 7.264 (12.1); 7.236 (2.6); 7.163 (3.0); 7.155 (3.4); 6.977 (2.0); 6.969 (1.9); 6.949 (1.7); 6.941 (1.6); 6.839 (3.4); 6.811 (3.3); 5.373 (0.9); 5.358 (0.8); 5.346 (0.9); 5.301 (0.6); 4.607 (1.4); 4.599 (1.5); 4.560 (1.8); 4.552 (1.8); 4.405 (1.5); 4.391 (1.5); 4.251 (1.8); 4.224 (1.7); 4.204 (1.4); 4.178 (1.3); 2.379 (16.0); 2.044 (0.4); 1.645 (1.7); 1.259 (0.4); 0.071 (11.6); 0.000 (7.2); −0.011 (0.3)

### Example I.17

¹H-NMR (300.2 MHz, CDCl₃): δ=8.152 (0.3); 8.143 (0.3); 8.083 (6.0); 7.950 (6.7); 7.877 (3.1); 7.875 (3.0); 7.849 (3.3); 7.847 (3.2); 7.264 (11.5); 7.130 (0.5); 7.125 (0.7); 7.114 (16.0); 7.102 (3.1); 7.096 (7.1); 7.090 (6.9); 7.081 (1.9); 7.070 (0.6); 7.060 (0.5); 7.055 (0.4); 6.939 (0.3); 6.911 (0.3); 6.831 (3.6); 6.803 (3.4); 5.369 (0.9); 5.343 (1.0); 5.301 (0.6); 4.602 (1.5); 4.594 (1.5); 4.555 (1.9); 4.547 (1.9); 4.389 (1.3); 4.375 (1.4); 4.363 (0.5); 4.255 (1.9); 4.228 (1.8); 4.208 (1.5); 4.182 (1.4); 1.643 (1.4); 0.071 (10.5); 0.000 (7.9); −0.011 (0.4)

### Example I.18

¹H-NMR (300.2 MHz, CDCl₃): δ=8.118 (0.9); 8.109 (1.0); 8.087 (14.8); 7.994 (16.0); 7.902 (8.0); 7.901 (7.6); 7.874 (8.4); 7.873 (8.0); 7.748 (0.5); 7.740 (0.5); 7.719 (0.5); 7.712 (0.5); 7.608 (0.7); 7.292 (0.4); 7.262 (110.9); 7.252 (1.9); 7.244 (1.0); 7.233 (2.8); 7.215 (2.5); 7.203 (4.4); 7.185 (4.3); 7.175 (2.5); 7.157 (2.1); 7.033 (0.9); 7.005 (0.8); 6.996 (2.4); 6.986 (3.0); 6.968 (2.6); 6.958 (3.8); 6.953 (4.3); 6.944 (11.6); 6.934 (3.3); 6.926 (4.3); 6.922 (6.0); 6.917 (12.2); 6.893 (2.2); 6.888 (1.9); 6.883 (1.4); 6.878 (1.4); 5.365 (2.6); 5.346 (2.8); 5.302 (2.2); 5.143 (0.4); 4.600 (3.8); 4.592 (3.9); 4.554 (5.0); 4.546 (5.0); 4.377 (0.6); 4.365 (0.6); 4.340 (0.6); 4.313 (0.7); 4.268 (5.0); 4.242 (4.6); 4.221 (3.8); 4.195 (3.6); 4.098 (0.3); 4.086 (0.4); 4.034 (1.5); 3.735 (0.4); 3.712 (0.5); 2.047 (0.9); 2.011 (0.5); 1.574 (8.0); 1.482 (0.3); 1.284 (0.5); 1.268 (1.2); 1.260 (1.2); 1.254 (1.6); 1.245 (1.9); 1.221 (0.9); 1.151 (0.3); 1.000 (0.3); 0.978 (0.3); 0.070 (43.6); 0.011 (2.7); 0.000 (78.1); −0.011 (3.3); −0.199 (0.3)

### Example I.19

¹H-NMR (300.2 MHz, CDCl₃): δ=8.588 (0.4); 8.134 (3.1); 8.088 (16.0); 7.974 (15.3); 7.900 (7.7); 7.872 (7.4); 7.746 (1.8); 7.716 (1.6); 7.284 (8.3); 7.274 (19.9); 7.266 (31.0); 7.263 (37.2); 7.228 (21.4); 7.217 (21.2); 7.207 (23.6); 7.027 (2.1); 6.999 (1.8); 6.924 (8.0); 6.896 (7.1); 5.367 (5.2); 5.348 (4.8); 5.301 (2.5); 5.155 (1.4); 5.140 (1.4); 5.130 (1.4); 4.599 (5.1); 4.553 (6.6); 4.417 (0.8); 4.371 (2.3); 4.332 (1.7); 4.307 (1.6); 4.256 (4.9); 4.229 (4.9); 4.208 (4.5); 4.181 (9.4); 3.716 (1.8); 2.045 (0.4); 1.603 (15.3); 1.544 (0.4); 1.258 (1.8); 1.003 (0.3); 0.865 (0.4); 0.074 (37.2); 0.022 (5.6); 0.011 (13.2); 0.003 (19.8); 0.000 (23.5); −0.036 (0.4)

### Example I.20

¹H-NMR (300.2 MHz, CDCl₃): δ=8.182 (0.5); 8.173 (0.6); 8.096 (14.1); 7.991 (16.0); 7.951 (0.4); 7.934 (7.8); 7.932 (7.6); 7.906 (8.3); 7.904 (8.0); 7.608 (0.4); 7.279 (0.4); 7.263 (80.1); 7.000 (0.5); 6.972 (0.5); 6.927 (9.2); 6.912 (0.8); 6.900 (8.8); 6.878 (1.4); 6.865 (6.7); 6.859 (2.0); 6.845 (7.2); 6.838 (6.9); 6.824 (2.5); 6.818 (6.6); 6.805 (1.4); 6.796 (0.7); 6.792 (0.8); 5.394 (1.5); 5.387 (2.1); 5.382 (2.0); 5.372 (2.5); 5.356 (2.2); 5.348 (1.8); 5.302 (2.4); 4.619 (4.0); 4.611 (3.9); 4.573 (5.1); 4.565 (5.0); 4.396 (0.4); 4.385 (0.4); 4.349 (0.4); 4.282 (4.9); 4.256 (4.6); 4.236 (3.8); 4.210 (3.7); 4.177 (6.6); 4.163 (6.5); 4.133 (0.4); 4.109 (0.4); 3.719 (0.4); 2.046 (1.3); 2.011 (0.4); 1.579 (32.0); 1.284 (0.5); 1.260 (1.3); 1.253 (1.7); 1.236 (0.6); 0.070 (20.4); 0.011 (1.8); 0.000 (54.2); −0.011 (2.3)

### Example I.21

¹H-NMR (300.2 MHz, CDCl₃): δ=8.328 (11.3); 8.120 (10.1); 8.059 (0.4); 7.965 (11.4); 7.458 (0.8); 7.450 (4.0); 7.443 (1.9); 7.425 (8.2); 7.423 (7.5); 7.415 (1.7); 7.404 (3.2); 7.398 (7.2); 7.390 (1.4); 7.373 (0.4); 7.273 (2.4); 7.269 (4.7); 7.262 (54.0); 7.253 (1.7); 7.250 (2.7); 7.245 (5.6); 7.239 (2.1); 7.224 (1.7); 7.220 (2.4); 7.216 (1.5); 7.205 (0.4); 7.140 (8.0); 7.136 (10.0); 7.129 (2.9); 7.115 (4.9); 7.112 (8.0); 7.108 (6.8); 7.099 (1.1); 6.940 (16.0); 6.911 (0.4); 5.428 (2.3); 5.421 (2.4); 5.401 (2.6); 5.394 (2.5); 4.568 (3.1); 4.560 (3.1); 4.522 (4.3); 4.514 (4.2); 4.307 (4.0); 4.279 (3.8); 4.260 (2.9); 4.233 (2.8); 4.132 (0.8); 4.109 (0.8); 4.085 (0.4); 4.025 (0.7); 3.915 (0.8); 2.046 (3.1); 1.605 (2.2); 1.283 (1.0); 1.260 (2.0); 1.236 (0.9); 0.011 (1.4); 0.000 (38.0); −0.011 (1.2)

### Example I.22

¹H-NMR (300.2 MHz, CDCl₃): δ=8.179 (15.5); 8.164 (9.7); 8.156 (9.8); 7.834 (14.8); 7.609 (0.3); 7.462 (1.0); 7.454 (4.7); 7.448 (2.4); 7.438 (1.6); 7.430 (9.4); 7.427 (8.6); 7.419 (1.9); 7.408 (3.5); 7.402 (8.1); 7.394 (1.4); 7.339 (12.1); 7.331 (12.0); 7.268 (8.1); 7.263 (59.3); 7.252 (1.7); 7.248 (3.0); 7.243 (6.5); 7.238 (2.4); 7.222 (1.8); 7.219 (2.8); 7.215 (1.7); 7.076 (2.3); 7.071 (8.8); 7.067 (11.3); 7.060 (3.2); 7.046 (5.4); 7.042 (8.9); 7.039 (8.0); 7.030 (1.2); 6.912 (0.4); 5.382 (2.0); 5.371 (2.3); 5.362 (2.8); 5.358 (2.7); 5.352 (2.8); 5.347 (2.8); 5.339 (2.7); 5.328 (2.3); 4.644 (2.8); 4.633 (2.9); 4.597 (6.5); 4.585 (16.0); 4.561 (11.5); 4.532 (6.3); 4.513 (6.0); 4.485 (2.8); 4.466 (2.7); 2.047 (0.8); 1.596 (48.3); 1.260 (0.6); 0.011 (1.7); 0.000 (43.8); −0.011 (1.6)

### Example I.23

¹H-NMR (300.2 MHz, CDCl₃): δ=8.088 (15.2); 8.032 (0.6); 8.001 (16.0); 7.950 (0.4); 7.908 (7.7); 7.906 (7.9); 7.880 (8.1); 7.878 (8.5); 7.844 (0.6); 7.763 (0.4); 7.608 (1.1); 7.490 (10.6); 7.482 (11.6); 7.433 (0.4); 7.405 (0.4); 7.334 (0.7); 7.319 (6.0); 7.311 (5.6); 7.290 (9.1); 7.282 (8.8); 7.262 (212.9); 7.215 (0.9); 7.202 (0.8); 7.175 (13.6); 7.147 (9.3); 7.115 (0.5); 7.087 (0.5); 6.969 (0.5); 6.934 (9.1); 6.906 (8.4); 6.879 (0.3); 6.818 (0.4); 5.370 (2.5); 5.346 (2.7); 5.302 (9.4); 4.606 (3.9); 4.599 (3.9); 4.560 (5.1); 4.552 (4.8); 4.281 (4.8); 4.255 (4.5); 4.235 (3.9); 4.209 (3.5); 4.158 (0.9); 4.134 (2.8); 4.110 (3.0); 4.086 (1.1); 3.980 (2.3); 2.174 (0.3); 2.047 (13.9); 1.569 (38.7); 1.473 (0.4); 1.284 (3.8); 1.260 (8.2); 1.237 (3.9); 0.195 (0.5); 0.069 (33.5); 0.057 (1.8); 0.035 (0.6); 0.011 (4.7); 0.000 (141.0); −0.011 (5.6); −0.060 (0.4); −0.200 (0.4)

### Example I.24

¹H-NMR (300.2 MHz, CDCl₃): δ=8.073 (2.1); 7.905 (2.3); 7.854 (1.0); 7.826 (1.1); 7.416 (1.5); 7.410 (0.6); 7.394 (0.7); 7.388 (1.8); 7.379 (0.3); 7.271 (3.2); 7.117 (2.1); 7.110 (0.7); 7.095 (0.7); 7.088 (1.8); 6.808 (1.2); 6.780 (1.2); 5.352 (0.4); 5.331 (0.4); 5.326 (0.4); 4.931 (0.6); 4.909 (0.6); 4.577 (0.5); 4.569 (0.5); 4.531 (0.6); 4.523 (0.6); 4.239 (0.5); 4.213 (0.5); 4.192 (0.4); 4.166 (0.4); 4.152 (1.1); 4.128 (3.4); 4.104 (3.5); 4.081 (1.2); 2.042 (16.0); 2.031 (0.4); 1.523 (3.9); 1.502 (3.9); 1.281 (4.4); 1.258 (8.9); 1.234 (4.6); 0.072 (5.8); 0.060 (0.3); 0.000 (1.7)

### Example I.25

¹H-NMR (300.2 MHz, CDCl₃): δ=8.089 (9.2); 8.022 (7.1); 7.994 (7.6); 7.947 (11.2); 7.397 (1.3); 7.386 (12.9); 7.379 (4.6); 7.364 (5.3); 7.357 (16.0); 7.346 (2.2); 7.265 (9.5); 7.113 (1.9); 7.102 (15.8); 7.095 (5.3); 7.080 (4.7); 7.073 (13.0); 7.062 (1.8); 7.042 (5.8); 7.013 (5.5); 6.678 (3.7); 6.496 (7.5); 6.314 (3.8); 5.645 (2.4); 5.619 (2.6); 4.524 (3.1); 4.516 (3.2); 4.477 (4.5); 4.470 (4.5); 4.327 (2.6); 4.287 (4.4); 4.260 (4.1); 4.240 (3.1); 4.213 (2.9); 4.129 (0.7); 4.105 (0.7); 3.953 (1.1); 2.042 (2.9); 1.694 (4.8); 1.281 (1.2); 1.257 (3.9); 1.234 (1.1); 0.879 (0.5); 0.855 (0.4); 0.071 (5.7); 0.000 (9.7)

### Example I.26

¹H-NMR (300.2 MHz, CDCl₃): δ=18.304 (0.4); 16.267 (0.4); 15.166 (0.4); 12.449 (0.4); 8.100 (0.5); 8.057 (13.2); 7.993 (14.6); 7.886 (6.8); 7.858 (7.1); 7.607 (1.0); 7.531 (0.4); 7.382 (1.8); 7.371 (12.6); 7.364 (4.5); 7.349 (4.9); 7.342 (16.0); 7.331 (1.9); 7.300 (0.7); 7.262 (159.5); 7.127 (2.5); 7.116 (15.0); 7.109 (4.3); 7.093 (4.3); 7.086 (11.8); 7.075 (1.3); 7.065 (0.5); 6.910 (0.7); 6.820 (0.5); 6.793 (8.0); 6.766 (7.4); 5.343 (0.5); 5.329 (0.5); 5.313 (1.7); 5.302 (5.4); 5.289 (3.3); 5.279 (2.3); 4.528 (3.4); 4.519 (3.0); 4.481 (4.9); 4.473 (4.6); 4.317 (4.5); 4.292 (4.2); 4.270 (3.0); 4.246 (2.9); 3.929 (6.7); 3.914 (6.2); 2.516 (0.5); 2.221 (0.5); 2.174 (0.7); 1.617 (0.4); 1.553 (141.0); 1.524 (1.1); 1.508 (0.8); 1.477 (0.5); 1.308 (1.2); 1.255 (3.7); 0.896 (0.6); 0.881 (1.1); 0.853 (0.6); 0.196 (0.8); 0.069 (18.0); 0.011 (6.2); 0.000 (185.3); −0.011 (8.4); −0.065 (0.6); −0.199 (0.9); −1.451 (0.4); −3.269 (0.5)

### Example I.27

¹H-NMR (300.2 MHz, CDCl₃): δ=8.062 (3.3); 8.034 (3.5); 8.007 (4.0); 7.860 (4.2); 7.269 (1.8); 7.088 (13.5); 7.067 (12.6); 6.686 (3.5); 6.658 (3.4); 5.300 (1.5); 5.261 (2.2); 5.214 (2.4); 4.978 (1.7); 4.535 (2.5); 4.488 (2.2); 1.696 (16.0); 1.255 (0.6); 0.000 (0.9)

### Example I.28

¹H-NMR (300.2 MHz, CDCl₃): δ=8.054 (3.3); 8.026 (3.4); 8.000 (4.4); 7.859 (4.1); 7.317 (0.3); 7.298 (0.4); 7.291 (0.4); 7.266 (3.8); 7.245 (1.5); 7.238 (1.9); 7.199 (1.0); 7.197 (1.0); 7.190 (0.8); 7.189 (0.7); 7.170 (1.2); 7.169 (1.2); 7.162 (1.0); 7.160 (1.0); 6.973 (2.6); 6.945 (2.0); 6.642 (3.4); 6.613 (3.3); 5.713 (0.4); 5.301 (0.7); 5.253 (1.9); 5.206 (2.1); 4.950 (0.5); 4.535 (2.2); 4.488 (2.0); 2.150 (0.5); 2.115 (11.2); 1.697 (16.0); 0.000 (3.9)

### Example I.29

¹H-NMR (300.2 MHz, CDCl₃): δ=8.067 (3.6); 8.052 (0.6); 8.039 (3.8); 8.023 (0.5); 8.013 (4.3); 7.863 (4.4); 7.268 (2.6); 7.247 (1.6); 7.219 (1.9); 7.141 (2.4); 7.133 (2.5); 6.943 (1.6); 6.935 (1.5); 6.916 (1.3); 6.907 (1.2); 6.702 (0.4); 6.695 (3.8); 6.673 (0.4); 6.667 (3.7); 5.300 (0.4); 5.250 (1.9); 5.203 (2.2); 4.968 (0.9); 4.544 (2.3); 4.497 (2.1); 2.368 (12.5); 1.735 (1.3); 1.697 (16.0); 0.000 (2.4)

### Example I.30

¹H-NMR (300.2 MHz, CDCl₃): δ=8.089 (4.3); 8.005 (4.2); 7.861 (2.4); 7.833 (2.6); 7.608 (0.4); 7.313 (0.4); 7.262 (51.7); 7.141 (2.3); 7.111 (2.9); 7.012 (3.0); 7.002 (2.6); 6.872 (2.1); 6.863 (1.6); 6.842 (2.9); 6.837 (3.3); 6.809 (2.3); 5.375 (1.3); 5.361 (1.3); 5.350 (1.2); 4.606 (1.4); 4.559 (1.9); 4.280 (1.4); 4.254 (1.4); 4.234 (1.1); 4.209 (1.1); 3.904 (2.9); 3.890 (2.3); 3.828 (16.0); 1.664 (0.4); 1.570 (143.6); 1.293 (0.9); 1.257 (1.8); 0.887 (0.6); 0.856 (0.4); 0.069 (7.1); 0.000 (47.4); −0.032 (0.4)

### Example I.31

¹H-NMR (300.2 MHz, CDCl₃): δ=8.055 (2.8); 8.027 (2.8); 7.989 (3.8); 7.866 (3.5); 7.263 (46.0); 7.115 (2.3); 7.086 (2.8); 6.993 (2.2); 6.983 (2.6); 6.854 (1.6); 6.844 (1.4); 6.824 (1.3); 6.814 (1.1); 6.687 (2.8); 6.658 (2.7); 5.302 (9.2); 5.246 (1.6); 5.199 (1.9); 4.874 (2.9); 4.532 (2.0); 4.486 (1.7); 3.819 (16.0); 1.692 (10.3); 1.571 (113.0); 1.254 (1.0); 0.069 (8.2); 0.011 (1.2); 0.000 (38.4); −0.011 (1.7)

### Example I.32

¹H-NMR (300.2 MHz, CDCl₃): δ=8.141 (1.5); 8.116 (3.9); 8.088 (3.3); 8.047 (2.6); 8.024 (4.8); 7.878 (2.7); 7.859 (5.6); 7.489 (1.4); 7.480 (1.4); 7.466 (3.7); 7.452 (1.7); 7.437 (3.3); 7.273 (4.3); 7.269 (4.2); 7.035 (1.5); 7.019 (3.0); 7.015 (3.0); 6.990 (2.2); 6.795 (1.5); 6.770 (3.9); 6.758 (1.7); 6.742 (2.8); 5.358 (0.3); 5.324 (0.9); 5.316 (0.8); 5.301 (2.0); 5.238 (2.6); 5.192 (2.9); 5.053 (1.0); 4.581 (1.4); 4.555 (2.9); 4.534 (1.5); 4.523 (1.2); 4.509 (2.6); 2.194 (0.5); 2.187 (0.5); 2.172 (1.2); 1.761 (0.9); 1.724 (7.3); 1.715 (6.9); 1.702 (16.0); 0.000 (0.8)

### Example I.33

¹H-NMR (300.2 MHz, CDCl₃): δ=8.447 (0.4); 8.418 (0.4); 8.193 (0.5); 8.024 (10.1); 8.011 (0.8); 7.996 (10.5); 7.915 (13.4); 7.865 (13.2); 7.418 (0.5); 7.388 (0.6); 7.365 (1.3); 7.354 (12.7); 7.347 (4.4); 7.332 (4.8); 7.324 (16.3); 7.314 (1.8); 7.268 (5.6); 7.142 (0.6); 7.112 (0.6); 7.097 (1.8); 7.087 (16.0); 7.079 (4.8); 7.064 (4.4); 7.057 (12.9); 7.046 (1.3); 6.954 (0.3); 6.926 (0.3); 6.684 (9.4); 6.656 (9.1); 5.571 (1.1); 4.939 (8.6); 4.819 (5.6); 4.773 (7.0); 4.454 (7.6); 4.407 (6.0); 1.750 (3.6); 1.579 (41.0); 0.000 (4.9)

### Example I.34

¹H-NMR (300.2 MHz, CDCl₃): δ=8.099 (2.6); 7.999 (2.7); 7.942 (1.3); 7.914 (1.3); 7.817 (2.3); 7.810 (0.7); 7.794 (0.8); 7.786 (2.5); 7.262 (13.8); 7.254 (1.6); 7.223 (1.3); 6.956 (1.5); 6.928 (1.5); 5.396 (0.4); 5.385 (0.3); 5.372 (0.4); 5.302 (0.4); 4.628 (0.6); 4.621 (0.6); 4.582 (0.8); 4.574 (0.8); 4.299 (0.8); 4.274 (0.8); 4.253 (0.6); 4.227 (0.6); 4.157 (1.1); 4.133 (3.6); 4.110 (3.9); 4.086 (1.2); 16.0); 1.575 (3.4); 1.284 (4.3); 1.260 (8.6); 1.236 (4.2); 0.069 (1.6); 0.011 (0.5); 0.000 (16.0); −0.011 (0.7)

### Example I.35

¹H-NMR (300.2 MHz, CDCl₃): δ=8.234 (1.6); 8.231 (1.7); 8.203 (1.2); 8.143 (4.1); 8.115 (4.3); 8.006 (5.8); 7.872 (5.1); 7.866 (1.8); 7.859 (0.5); 7.842 (0.5); 7.835 (1.5); 7.810 (0.5); 7.799 (4.5); 7.792 (1.5); 7.776 (1.5); 7.769 (5.0); 7.758 (0.5); 7.307 (0.8); 7.277 (0.9); 7.262 (35.5); 7.215 (2.8); 7.185 (2.5); 7.053 (1.2); 7.025 (1.2); 6.818 (4.3); 6.789 (4.1); 5.717 (3.4); 5.302 (15.9); 5.249 (2.5); 4.994 (2.7); 4.537 (2.7); 4.490 (2.4); 2.010 (0.3); 1.713 (16.0); 1.559 (3.1); 1.269 (0.4); 1.254 (0.5); 1.246 (0.5); 0.069 (9.3); 0.057 (0.4); 0.011 (1.2); 0.000 (40.7); −0.011 (1.7)

### Example I.36

¹H-NMR (300.2 MHz, CDCl₃): δ=8.603 (7.8); 8.160 (9.7); 8.044 (3.2); 8.038 (2.8); 8.024 (2.6); 7.882 (9.0); 7.875 (3.1); 7.858 (3.6); 7.852 (9.8); 7.841 (1.1); 7.327 (9.7); 7.300 (34.9); 7.271 (5.5); 5.496 (1.9); 5.468 (2.0); 5.339 (16.0); 4.526 (2.0); 4.520 (1.9); 4.479 (3.2); 4.473 (3.1); 4.347 (2.3); 4.319 (2.1); 4.300 (1.5); 4.272 (1.4); 4.180 (0.4); 4.157 (0.5); 4.093 (0.4); 4.086 (0.4); 4.079 (0.4); 4.061 (0.4); 4.021 (0.9); 1.596 (11.1); 1.334 (0.4); 1.304 (0.9); 1.292 (1.9); 1.259 (0.4); 0.108 (3.2); 0.039 (35.5); 0.028 (1.8)

### Example I.37

¹H-NMR (300.2 MHz, CDCl₃): δ=8.500 (5.7); 8.071 (5.5); 7.959 (6.6); 7.881 (0.6); 7.870 (5.8); 7.863 (1.9); 7.847 (1.9); 7.840 (6.5); 7.829 (0.7); 7.378 (6.6); 7.300 (51.6); 7.277 (3.7); 7.247 (3.2); 5.339 (13.2); 4.742 (2.7); 4.694 (3.7); 4.503 (5.4); 4.499 (5.5); 4.451 (2.8); 1.693 (16.0); 1.588 (17.9); 0.108 (0.6); 0.050 (1.8); 0.039 (52.9); 0.028 (2.0)

### Example I.38

¹H-NMR (300.2 MHz, CDCl₃): δ=8.136 (0.4); 8.047 (0.5); 7.587 (0.3); 7.300 (6.7); 7.285 (0.4); 7.255 (0.3); 6.905 (0.3); 1.603 (16.0); 0.108 (0.7); 0.038 (7.0); 0.028 (0.3)

### Example I.39

¹H-NMR (300.2 MHz, CDCl₃): δ=8.138 (3.4); 8.109 (4.7); 8.083 (1.3); 8.041 (5.3); 8.014 (2.1); 7.909 (4.9); 7.882 (2.0); 7.598 (3.4); 7.569 (5.2); 7.543 (2.0); 7.307 (9.3); 7.300 (23.3); 7.273 (7.8); 7.250 (4.7); 7.222 (5.3); 7.197 (1.8); 6.892 (1.4); 6.864 (0.6); 6.794 (3.6); 6.766 (4.5); 6.740 (1.2); 6.703 (2.7); 6.677 (1.1); 6.515 (1.4); 6.488 (0.6); 5.339 (4.3); 5.323 (2.9); 5.313 (1.8); 5.297 (1.4); 5.276 (2.9); 5.250 (1.3); 4.990 (4.1); 4.963 (1.9); 4.573 (2.9); 4.545 (1.3); 4.526 (2.7); 4.500 (1.0); 1.745 (16.0); 1.718 (6.5); 1.598 (16.5); 1.571 (7.7); 1.294 (0.7); 1.266 (0.5); 0.108 (3.2); 0.082 (1.2); 0.046 (9.2); 0.039 (22.4); 0.012 (7.1)

### Example I.40

¹H-NMR (300.2 MHz, CDCl₃): δ=8.131 (4.9); 8.117 (2.0); 8.088 (2.0); 8.033 (5.1); 7.589 (0.4); 7.578 (4.6); 7.571 (1.5); 7.555 (1.5); 7.548 (5.3); 7.538 (0.5); 7.300 (15.7); 7.153 (2.5); 7.141 (5.4); 7.134 (1.7); 7.125 (2.2); 7.119 (1.7); 7.112 (4.6); 7.101 (0.5); 5.549 (0.7); 5.524 (0.7); 4.525 (0.9); 4.517 (1.0); 4.478 (1.4); 4.471 (1.4); 4.308 (1.4); 4.281 (1.4); 4.261 (1.0); 4.234 (1.0); 4.116 (2.3); 4.104 (2.3); 1.609 (16.0); 1.293 (0.5); 0.108 (1.4); 0.049 (0.5); 0.039 (15.0); 0.028 (0.5)

### Example I.41

¹H-NMR (300.2 MHz, CDCl₃): δ=8.115 (14.5); 8.025 (14.6); 7.948 (3.6); 7.919 (4.4); 7.889 (3.7); 7.646 (0.6); 7.438 (1.2); 7.427 (12.9); 7.420 (4.2); 7.405 (4.6); 7.397 (15.8); 7.386 (1.7); 7.367 (0.6); 7.300 (121.1); 7.270 (0.4); 7.233 (0.5); 7.144 (1.6); 7.133 (16.0); 7.126 (4.7); 7.111 (4.1); 7.103 (12.7); 7.093 (1.2); 6.949 (0.7); 6.828 (5.9); 6.801 (5.5); 5.364 (1.4); 5.350 (1.8); 5.339 (2.9); 5.330 (2.1); 5.315 (1.6); 4.590 (3.1); 4.581 (3.2); 4.543 (4.8); 4.534 (4.8); 4.393 (4.7); 4.368 (4.5); 4.346 (3.1); 4.321 (2.9); 4.000 (8.1); 3.985 (8.0); 1.660 (0.5); 1.594 (134.6); 1.527 (0.7); 1.380 (0.4); 1.342 (0.5); 1.292 (1.1); 0.920 (0.4); 0.234 (0.5); 0.120 (1.1); 0.108 (33.8); 0.049 (3.9); 0.038 (128.9); 0.027 (5.1); −0.008 (0.3); −0.029 (0.6); −0.160 (0.6)

### Example I.42

¹H-NMR (300.2 MHz, CDCl₃): δ=8.045 (1.5); 8.017 (1.8); 8.011 (1.8); 8.001 (4.0); 7.983 (1.7); 7.921 (3.9); 7.424 (0.5); 7.413 (4.0); 7.406 (1.4); 7.391 (1.5); 7.383 (4.9); 7.372 (0.6); 7.300 (17.2); 7.118 (0.6); 7.107 (4.9); 7.100 (1.5); 7.085 (1.3); 7.078 (4.0); 7.067 (0.4); 6.722 (1.7); 6.717 (1.7); 6.695 (1.6); 6.690 (1.7); 4.855 (2.7); 4.811 (1.4); 4.765 (1.8); 4.496 (2.0); 4.449 (1.5); 2.047 (2.0); 1.607 (16.0); 0.107 (2.0); 0.049 (0.8); 0.038 (18.3); 0.027 (0.8)

### Example I.43

¹H-NMR (300.2 MHz, CDCl₃): δ=8.591 (11.5); 8.161 (14.7); 8.045 (16.0); 7.646 (0.6); 7.367 (0.5); 7.339 (6.0); 7.308 (11.8); 7.300 (110.2); 7.279 (13.8); 7.242 (2.4); 7.232 (19.4); 7.224 (4.8); 7.209 (3.8); 7.201 (10.4); 7.190 (0.9); 6.949 (0.6); 5.480 (2.5); 5.453 (2.5); 4.518 (2.8); 4.510 (2.9); 4.471 (4.6); 4.463 (4.7); 4.342 (4.6); 4.314 (4.2); 4.295 (2.8); 4.267 (2.8); 3.948 (4.5); 3.938 (4.5); 2.048 (8.9); 1.664 (0.4); 1.597 (53.9); 1.533 (0.3); 1.290 (1.1); 0.234 (0.4); 0.108 (2.3); 0.049 (4.1); 0.038 (119.4); 0.027 (4.2); −0.160 (0.4)

### Example I.44

¹H-NMR (300.2 MHz, CDCl₃): δ=8.477 (5.7); 8.070 (6.8); 7.958 (7.2); 7.335 (7.2); 7.328 (3.3); 7.325 (3.3); 7.318 (1.7); 7.300 (48.0); 7.220 (1.2); 7.209 (8.8); 7.201 (2.3); 7.186 (1.9); 7.179 (5.0); 7.167 (0.5); 5.340 (4.8); 4.732 (2.5); 4.685 (3.7); 4.484 (4.1); 4.461 (6.6); 4.437 (2.8); 1.680 (16.0); 1.655 (0.6); 1.598 (17.9); 1.307 (0.4); 1.292 (0.4); 1.284 (0.4); 0.108 (1.4); 0.049 (2.3); 0.038 (48.0); 0.027 (1.7)

### Example I.45

¹H-NMR (300.2 MHz, CDCl₃): δ≤15.116 (0.4); 15.105 (0.4); 8.468 (5.5); 8.066 (6.4); 7.957 (6.7); 7.646 (1.0); 7.439 (6.4); 7.431 (2.1); 7.416 (2.3); 7.409 (7.4); 7.398 (1.0); 7.366 (1.1); 7.316 (8.1); 7.300 (198.5); 7.233 (0.5); 7.137 (0.9); 7.126 (7.5); 7.119 (2.0); 7.104 (1.9); 7.097 (6.0); 6.949 (1.1); 5.340 (12.4); 4.727 (2.5); 4.680 (3.7); 4.480 (3.9); 4.433 (9.2); 1.721 (0.4); 1.675 (16.0); 1.593 (225.5); 1.526 (1.0); 1.500 (0.5); 1.466 (0.4); 1.306 (0.9); 1.293 (1.4); 1.260 (0.5); 0.918 (0.5); 0.897 (0.5); 0.234 (0.7); 0.172 (0.4); 0.119 (0.9); 0.108 (28.9); 0.069 (0.5); 0.049 (5.8); 0.038 (187.8); 0.027 (7.4); −0.028 (0.6); −0.159 (0.8)

### Example I.46

¹H-NMR (300.2 MHz, CDCl₃): δ=8.468 (5.6); 8.067 (6.3); 7.957 (6.9); 7.646 (0.6); 7.449 (0.7); 7.438 (6.5); 7.431 (2.2); 7.416 (2.5); 7.409 (7.8); 7.398 (0.9); 7.366 (0.5); 7.348 (0.3); 7.316 (7.3); 7.300 (94.3); 7.137 (1.0); 7.126 (7.9); 7.119 (2.3); 7.104 (2.3); 7.097 (6.2); 7.086 (0.6); 6.949 (0.4); 5.340 (12.1); 4.726 (2.6); 4.679 (3.6); 4.480 (4.1); 4.434 (7.8); 1.675 (16.0); 1.598 (49.3); 1.307 (0.8); 1.293 (1.2); 1.284 (0.7); 1.261 (0.6); 1.240 (0.4); 0.107 (14.9); 0.096 (0.7); 0.049 (3.9); 0.038 (89.4); 0.027 (3.4); −0.160 (0.3)

### Example I.47

¹H-NMR (300.2 MHz, CDCl₃): δ=8.600 (7.4); 8.161 (10.0); 8.036 (6.8); 7.756 (5.5); 7.727 (6.4); 7.322 (6.6); 7.314 (10.8); 7.300 (44.3); 5.489 (1.6); 5.462 (1.6); 4.523 (1.8); 4.516 (1.9); 4.476 (3.0); 4.469 (3.0); 4.345 (2.9); 4.317 (2.7); 4.298 (1.8); 4.270 (1.7); 4.059 (1.2); 1.604 (16.0); 1.291 (0.4); 0.108 (2.6); 0.049 (1.5); 0.039 (45.1); 0.028 (1.6)

### Example I.48

¹H-NMR (300.2 MHz, CDCl₃): δ=8.585 (10.3); 8.154 (13.4); 8.011 (12.8); 7.608 (1.2); 7.598 (12.2); 7.591 (3.8); 7.575 (4.0); 7.569 (13.3); 7.558 (1.4); 7.300 (26.5); 7.256 (11.7); 7.105 (1.4); 7.094 (13.6); 7.088 (4.0); 7.072 (3.8); 7.065 (11.9); 7.055 (1.2); 5.467 (2.2); 5.439 (2.2); 4.504 (2.5); 4.497 (2.6); 4.457 (4.2); 4.450 (4.1); 4.328 (4.0); 4.300 (3.7); 4.281 (2.5); 4.253 (2.4); 4.153 (2.2); 2.045 (8.3); 1.632 (16.0); 1.291 (0.4); 0.107 (1.9); 0.048 (1.0); 0.038 (28.3); 0.027 (1.1)

### Example I.49

¹H-NMR (300.2 MHz, CDCl₃): δ=8.469 (5.6); 8.359 (0.4); 8.327 (0.4); 8.216 (0.9); 8.065 (6.5); 8.024 (1.1); 7.958 (6.8); 7.657 (0.5); 7.646 (0.8); 7.637 (0.8); 7.598 (0.9); 7.588 (6.5); 7.580 (2.2); 7.565 (2.1); 7.558 (7.3); 7.547 (0.8); 7.428 (0.4); 7.389 (0.4); 7.358 (0.6); 7.317 (7.5); 7.300 (122.9); 7.085 (0.8); 7.074 (7.2); 7.067 (2.2); 7.052 (2.1); 7.045 (6.4); 7.034 (0.8); 6.949 (0.6); 5.299 (1.0); 5.281 (1.1); 4.728 (2.5); 4.680 (3.6); 4.480 (3.8); 4.442 (6.4); 4.433 (3.1); 2.944 (0.3); 2.888 (0.4); 2.638 (0.3); 2.579 (0.4); 2.049 (0.5); 1.675 (16.0); 1.655 (3.0); 1.590 (46.1); 1.293 (1.5); 0.918 (0.4); 0.235 (0.5); 0.108 (7.9); 0.050 (5.5); 0.039 (133.6); 0.028 (5.0); −0.160 (0.5)

### Example I.50

¹H-NMR (300.2 MHz, CDCl₃): δ=8.490 (5.7); 8.071 (6.6); 7.959 (7.1); 7.743 (3.8); 7.715 (4.4); 7.369 (6.6); 7.300 (49.1); 7.271 (3.8); 5.340 (11.7); 4.738 (2.6); 4.690 (3.7); 4.493 (4.7); 4.486 (6.7); 4.445 (2.9); 1.688 (16.0); 1.596 (17.8); 1.293 (1.0); 0.108 (3.1); 0.049 (1.7); 0.038 (47.7); 0.027 (1.9)

### Example I.51

¹H-NMR (300.2 MHz, CDCl₃): δ=8.112 (4.7); 8.084 (5.0); 8.036 (5.7); 7.905 (5.5); 7.646 (0.6); 7.417 (0.7); 7.407 (5.8); 7.400 (1.9); 7.385 (2.2); 7.377 (7.2); 7.366 (1.5); 7.300 (116.3); 7.289 (2.0); 7.234 (0.5); 7.122 (0.9); 7.112 (7.1); 7.104 (2.1); 7.089 (1.9); 7.082 (5.7); 7.071 (0.6); 6.949 (0.5); 6.755 (5.0); 6.727 (4.8); 5.340 (1.2); 5.320 (2.6); 5.273 (2.9); 4.977 (4.3); 4.564 (3.2); 4.516 (2.8); 1.737 (16.0); 1.735 (15.7); 1.709 (0.4); 1.656 (1.0); 1.589 (156.0); 1.523 (0.7); 1.323 (0.4); 1.293 (2.8); 0.234 (0.4); 0.120 (0.5); 0.108 (7.1); 0.049 (4.7); 0.039 (114.3); 0.028 (4.5); −0.028 (0.6); −0.160 (0.3)

### Example I.52

¹H-NMR (300.2 MHz, CDCl₃): δ=17.800 (0.4); 17.078 (0.4); 12.484 (0.4); 11.639 (0.4); 10.368 (0.4); 8.112 (4.3); 8.084 (4.5); 8.036 (5.6); 7.906 (5.5); 7.646 (1.1); 7.435 (0.4); 7.407 (5.3); 7.400 (1.9); 7.385 (1.9); 7.378 (6.6); 7.367 (1.7); 7.327 (0.6); 7.300 (179.7); 7.233 (0.6); 7.122 (0.7); 7.112 (6.4); 7.105 (2.0); 7.089 (1.6); 7.082 (5.2); 6.949 (0.9); 6.755 (4.5); 6.727 (4.3); 5.811 (0.4); 5.340 (0.7); 5.320 (2.7); 5.274 (2.9); 4.976 (4.2); 4.563 (3.1); 4.517 (2.8); 1.736 (16.0); 1.700 (0.4); 1.671 (0.5); 1.654 (1.4); 1.587 (240.3); 1.521 (1.1); 1.340 (0.4); 1.293 (3.9); 0.893 (0.4); 0.234 (0.8); 0.108 (10.8); 0.050 (5.5); 0.039 (174.0); 0.028 (6.1); −0.028 (0.9); −0.160 (0.7); −1.485 (0.4); −3.388 (0.4)

### Example I.53

¹H-NMR (300.2 MHz, CDCl₃): δ=8.472 (4.8); 8.023 (3.8); 7.898 (3.5); 7.416 (0.4); 7.405 (3.6); 7.398 (1.2); 7.383 (1.3); 7.375 (4.3); 7.365 (0.5); 7.300 (13.9); 7.097 (0.5); 7.086 (4.3); 7.079 (1.3); 7.064 (1.1); 7.057 (3.5); 7.046 (0.4); 6.913 (4.9); 5.339 (0.5); 5.215 (1.7); 5.168 (1.9); 4.834 (2.2); 4.557 (2.1); 4.510 (1.8); 2.211 (16.0); 1.736 (11.9); 1.613 (3.4); 0.107 (0.8); 0.049 (0.5); 0.038 (13.4); 0.027 (0.5)

### Example I.54

¹H-NMR (300.2 MHz, CDCl₃): δ=8.472 (4.0); 8.023 (3.1); 7.899 (2.9); 7.405 (3.0); 7.398 (1.0); 7.383 (1.1); 7.376 (3.6); 7.365 (0.4); 7.300 (19.7); 7.097 (0.4); 7.087 (3.6); 7.079 (1.1); 7.064 (1.0); 7.057 (2.9); 6.913 (4.1); 5.339 (0.5); 5.218 (1.4); 5.171 (1.6); 4.830 (2.0); 4.557 (1.7); 4.510 (1.5); 2.220 (0.4); 2.211 (16.0); 1.737 (9.1); 1.602 (8.9); 1.294 (0.5); 0.108 (1.2); 0.049 (0.8); 0.038 (19.1); 0.027 (0.7)

### Example I.55

¹H-NMR (300.2 MHz, d₆-DMSO): δ=8.537 (11.6); 8.485 (16.0); 7.988 (14.8); 7.706 (8.1); 7.678 (9.3); 7.491 (13.1); 7.426 (0.4); 7.373 (10.4); 7.345 (8.7); 7.287 (3.3); 7.101 (7.2); 6.915 (3.5); 6.216 (6.8); 6.200 (7.0); 5.781 (12.7); 5.229 (2.2); 5.216 (2.6); 5.204 (2.3); 4.494 (1.9); 4.466 (1.8); 4.447 (3.8); 4.420 (3.6); 4.372 (3.8); 4.360 (3.8); 4.325 (1.8); 4.313 (1.6); 3.954 (0.6); 3.351 (40.4); 3.201 (0.4); 3.184 (0.4); 2.531 (6.3); 2.525 (8.2); 2.519 (6.1); 2.012 (0.7); 1.258 (0.4); 1.198 (0.4); 1.079 (0.4); 0.023 (7.0)

### Example I.56

¹H-NMR (400.1 MHz, CDCl₃): δ=8.441 (5.7); 8.072 (2.9); 7.900 (3.8); 7.581 (3.9); 7.560 (4.3); 7.310 (6.8); 7.264 (3.5); 7.227 (4.8); 7.206 (4.3); 6.808 (1.7); 6.666 (3.5); 6.525 (1.7); 4.666 (2.5); 4.630 (3.4); 4.451 (3.6); 4.416 (2.6); 1.641 (16.0); 0.000 (2.4)

### Example I.57

¹H-NMR (400.1 MHz, d₆-DMSO): δ=8.476 (11.7); 8.441 (16.0); 7.946 (16.0); 7.681 (4.1); 7.676 (4.3); 7.655 (4.2); 7.650 (4.2); 7.547 (13.2); 7.472 (2.9); 7.450 (7.0); 7.429 (5.3); 7.395 (4.6); 7.391 (4.4); 7.373 (2.6); 7.370 (2.3); 6.165 (6.6); 6.153 (6.8); 5.197 (2.1); 5.187 (2.4); 5.178 (2.1); 4.455 (2.0); 4.434 (1.9); 4.420 (3.6); 4.399 (3.5); 4.348 (3.5); 4.339 (3.5); 4.313 (1.9); 4.304 (1.8); 3.304 (25.8); 2.505 (9.5); 2.500 (12.7); 2.496 (9.4); 0.000 (11.0); −0.008 (0.6)

### Example I.58

¹H-NMR (300.2 MHz, d₆-DMSO): δ=8.539 (0.4); 8.336 (10.3); 8.315 (7.2); 8.057 (0.4); 7.859 (10.1); 7.702 (2.7); 7.694 (2.7); 7.667 (2.5); 7.660 (2.6); 7.547 (8.9); 7.490 (1.7); 7.461 (4.2); 7.434 (3.8); 7.412 (3.4); 7.410 (3.3); 7.405 (3.0); 7.381 (1.4); 7.373 (1.3); 5.949 (0.7); 5.865 (9.5); 4.565 (0.9); 4.517 (5.2); 4.502 (5.2); 4.455 (1.0); 3.348 (18.9); 2.537 (3.9); 2.531 (7.7); 2.525 (10.3); 2.519 (7.5); 2.513 (3.6); 1.583 (16.0); 0.034 (0.5); 0.023 (11.3); 0.012 (0.5)

### Example I.59

¹H-NMR (300.2 MHz, CDCl₃): δ=8.231 (3.2); 8.202 (3.3); 8.043 (7.2); 8.005 (0.3); 7.952 (8.0); 7.572 (0.8); 7.561 (7.5); 7.554 (2.3); 7.538 (2.4); 7.531 (8.4); 7.521 (0.9); 7.300 (36.8); 7.137 (0.9); 7.126 (8.6); 7.119 (2.5); 7.104 (2.3); 7.097 (7.4); 7.086 (0.7); 7.033 (3.8); 7.004 (3.6); 5.339 (8.7); 4.761 (2.9); 4.714 (8.4); 4.554 (4.7); 4.506 (3.0); 2.996 (0.6); 2.923 (0.5); 1.678 (16.0); 1.604 (13.6); 1.306 (0.5); 1.292 (1.0); 1.283 (0.6); 0.108 (5.8); 0.049 (1.1); 0.038 (37.9); 0.027 (1.4)

### Example I.60

¹H-NMR (300.2 MHz, CDCl₃): δ=8.172 (3.7); 8.147 (10.6); 8.063 (8.6); 7.875 (0.9); 7.864 (7.6); 7.857 (2.5); 7.841 (2.6); 7.833 (8.6); 7.823 (1.1); 7.646 (0.8); 7.365 (4.8); 7.334 (4.4); 7.300 (127.8); 7.241 (3.9); 7.213 (3.6); 6.949 (0.8); 5.573 (1.4); 5.547 (1.4); 5.340 (16.0); 4.547 (1.7); 4.539 (1.7); 4.500 (2.7); 4.492 (2.6); 4.330 (2.7); 4.304 (2.6); 4.284 (1.7); 4.257 (1.8); 4.025 (2.6); 1.663 (0.5); 1.596 (86.9); 1.410 (0.3); 1.349 (0.6); 1.321 (0.8); 1.307 (1.2); 1.292 (1.8); 1.284 (1.3); 1.260 (0.6); 0.919 (0.6); 0.892 (0.5); 0.866 (0.4); 0.854 (0.4); 0.233 (0.5); 0.119 (1.1); 0.107 (26.2); 0.095 (1.0); 0.049 (4.5); 0.038 (124.6); 0.027 (4.6); 0.009 (0.4); −0.029 (0.5); −0.160 (0.5)

### Example I.61

¹H-NMR (300.2 MHz, CDCl₃): δ=9.881 (0.4); 8.157 (6.4); 8.144 (15.5); 8.128 (6.6); 8.060 (16.0); 7.736 (8.7); 7.707 (10.2); 7.646 (0.9); 7.373 (9.5); 7.345 (8.3); 7.300 (151.7); 7.233 (0.6); 7.220 (6.7); 7.192 (6.2); 6.949 (0.9); 5.566 (2.2); 5.543 (2.2); 5.340 (1.2); 4.543 (2.9); 4.536 (3.1); 4.497 (4.7); 4.489 (4.4); 4.327 (4.4); 4.300 (4.4); 4.280 (3.2); 4.254 (3.0); 4.024 (5.3); 4.013 (5.2); 2.260 (0.4); 1.727 (0.3); 1.593 (37.5); 1.519 (0.3); 1.441 (0.3); 1.410 (0.7); 1.372 (1.0); 1.324 (2.0); 1.293 (3.9); 1.213 (0.4); 1.207 (0.4); 1.181 (0.3); 0.942 (0.7); 0.919 (1.1); 0.894 (1.0); 0.866 (1.2); 0.234 (0.7); 0.108 (3.3); 0.049 (5.2); 0.038 (165.4); 0.028 (5.9); −0.029 (0.6); −0.159 (0.5)

### Example I.62

¹H-NMR (300.2 MHz, d₆-DMSO): δ=8.432 (0.5); 8.383 (6.8); 8.339 (0.5); 8.333 (0.4); 8.314 (0.4); 8.264 (0.3); 8.184 (3.3); 8.155 (3.6); 8.045 (6.1); 8.015 (6.8); 7.890 (6.5); 7.537 (0.4); 7.452 (6.0); 7.423 (6.2); 7.381 (3.6); 5.944 (6.6); 5.793 (8.8); 5.756 (0.4); 4.637 (0.3); 4.608 (1.1); 4.558 (5.8); 4.545 (6.1); 4.497 (1.1); 3.363 (10.9); 2.648 (0.4); 2.627 (0.6); 2.535 (23.4); 2.388 (0.4); 1.699 (0.3); 1.599 (16.0); 1.273 (0.6); 0.094 (0.4); 0.032 (10.8)

### Example I.63

¹H-NMR (300.2 MHz, CDCl₃): δ=8.386 (8.8); 8.163 (0.4); 8.141 (12.3); 8.045 (12.9); 7.646 (0.5); 7.601 (1.4); 7.591 (12.3); 7.584 (4.1); 7.568 (4.1); 7.561 (14.1); 7.550 (1.6); 7.300 (117.8); 7.233 (3.1); 7.201 (9.0); 7.103 (1.4); 7.092 (14.0); 7.085 (4.3); 7.069 (3.9); 7.062 (12.6); 7.051 (6.7); 6.949 (0.6); 6.868 (3.2); 5.410 (2.0); 5.396 (1.8); 5.383 (2.1); 5.340 (16.0); 4.500 (0.9); 4.488 (1.4); 4.453 (5.6); 4.441 (5.7); 4.437 (6.3); 4.409 (4.7); 4.390 (1.0); 4.362 (1.3); 3.956 (8.5); 3.945 (8.5); 2.438 (0.4); 1.592 (49.0); 1.293 (1.3); 0.920 (0.3); 0.234 (0.6); 0.108 (3.4); 0.050 (4.1); 0.039 (124.2); 0.028 (4.4); −0.160 (0.5)

### Example I.64

¹H-NMR (300.2 MHz, CDCl₃): δ=8.160 (3.6); 8.105 (5.2); 8.006 (5.6); 7.840 (1.4); 7.659 (1.6); 7.654 (1.6); 7.473 (1.5); 7.446 (0.5); 7.435 (4.9); 7.427 (1.6); 7.412 (1.7); 7.405 (6.0); 7.394 (0.6); 7.356 (3.6); 7.300 (14.9); 7.145 (0.7); 7.134 (6.1); 7.126 (1.8); 7.111 (1.6); 7.104 (4.8); 7.093 (0.4); 4.655 (1.8); 4.607 (2.7); 4.592 (2.8); 4.385 (3.2); 4.338 (2.4); 2.047 (1.9); 1.632 (6.3); 1.613 (16.0); 1.291 (0.7); 0.107 (3.4); 0.037 (9.5); 0.026 (0.4)

### Example I.65

¹H-NMR (300.2 MHz, d₆-DMSO): δ=8.381 (9.7); 8.172 (3.2); 8.143 (3.5); 7.889 (10.0); 7.872 (5.0); 7.843 (5.6); 7.452 (5.3); 7.424 (4.8); 7.376 (4.2); 7.347 (4.0); 5.933 (6.7); 5.902 (0.5); 4.603 (0.9); 4.556 (5.1); 4.541 (5.1); 4.494 (0.9); 3.361 (24.8); 2.547 (3.8); 2.541 (7.9); 2.535 (10.8); 2.529 (7.9); 2.523 (3.7); 2.108 (4.3); 1.598 (16.0); 0.032 (4.5)

### Example I.66

¹H-NMR (300.2 MHz, CDCl₃): δ=8.258 (3.0); 8.229 (3.2); 8.043 (6.3); 7.951 (7.2); 7.302 (7.9); 7.269 (2.0); 7.261 (3.2); 7.231 (5.6); 7.208 (7.4); 7.203 (3.5); 7.179 (0.8); 7.172 (0.7); 7.136 (3.6); 7.107 (3.4); 4.733 (2.6); 4.702 (4.8); 4.686 (4.4); 4.550 (4.4); 4.503 (2.7); 1.668 (16.0); 1.648 (3.7); 0.109 (0.9); 0.049 (0.4); 0.038 (8.0); 0.028 (0.3)

### Example I.67

¹H-NMR (300.2 MHz, CDCl₃): δ=8.227 (3.1); 8.198 (3.2); 8.047 (7.0); 7.944 (7.5); 7.423 (0.7); 7.412 (6.6); 7.405 (2.2); 7.390 (2.5); 7.383 (8.3); 7.372 (0.9); 7.301 (7.7); 7.188 (1.0); 7.177 (8.5); 7.169 (2.4); 7.154 (2.2); 7.147 (6.4); 7.136 (0.6); 7.030 (3.7); 7.001 (3.5); 5.338 (1.7); 4.759 (7.7); 4.706 (4.2); 4.554 (4.5); 4.506 (2.9); 1.677 (16.0); 1.660 (2.0); 1.292 (1.8); 0.108 (0.4); 0.038 (7.7)

### Example I.68

¹H-NMR (300.2 MHz, d₆-DMSO): δ=8.478 (14.2); 8.223 (12.7); 7.975 (14.2); 7.539 (1.1); 7.527 (11.7); 7.520 (3.9); 7.505 (4.6); 7.498 (14.1); 7.486 (1.6); 7.307 (15.3); 7.241 (1.6); 7.230 (14.5); 7.223 (4.3); 7.208 (4.2); 7.200 (11.3); 7.189 (1.2); 6.100 (7.2); 6.084 (7.4); 5.786 (16.0); 5.274 (1.3); 5.256 (3.1); 5.236 (3.3); 5.219 (1.4); 4.445 (0.4); 4.416 (9.4); 4.398 (6.8); 3.353 (42.4); 2.754 (0.3); 2.534 (33.1); 2.528 (43.2); 2.522 (30.5); 1.261 (0.8); 0.037 (1.6); 0.026 (43.6); 0.015 (1.5)

### Example I.69

¹H-NMR (300.2 MHz, CDCl₃): δ=8.538 (13.2); 8.208 (0.4); 8.143 (0.3); 8.113 (14.6); 8.057 (0.5); 8.026 (0.5); 8.020 (0.3); 8.016 (0.3); 7.934 (16.0); 7.744 (9.4); 7.716 (10.5); 7.670 (0.4); 7.373 (15.2); 7.352 (0.6); 7.302 (20.9); 7.278 (9.0); 6.321 (2.7); 6.286 (3.0); 6.264 (3.1); 6.229 (3.3); 5.507 (0.5); 5.427 (8.8); 5.372 (12.5); 5.338 (8.3); 5.223 (0.5); 5.201 (0.4); 4.816 (10.5); 4.775 (5.7); 4.728 (9.9); 4.619 (9.7); 4.571 (5.4); 1.690 (1.9); 1.294 (1.0); 0.110 (1.3); 0.039 (8.0); 0.028 (0.5)

### Example I.70

¹H-NMR (300.2 MHz, CDCl₃): δ=8.193 (6.1); 8.164 (6.7); 8.139 (15.6); 8.059 (16.0); 7.646 (0.7); 7.350 (7.0); 7.321 (6.9); 7.300 (146.0); 7.135 (1.4); 7.124 (2.8); 7.113 (14.4); 7.089 (14.0); 7.078 (2.7); 7.067 (1.3); 6.949 (0.8); 5.539 (2.3); 5.514 (2.3); 5.385 (0.4); 4.521 (2.9); 4.513 (3.2); 4.474 (4.6); 4.466 (4.5); 4.306 (4.7); 4.279 (4.4); 4.259 (3.2); 4.232 (2.9); 4.001 (9.0); 3.989 (8.9); 2.282 (0.3); 2.260 (0.3); 2.047 (0.3); 1.590 (65.8); 1.538 (0.3); 1.346 (0.9); 1.305 (1.5); 1.293 (2.2); 0.919 (0.7); 0.896 (0.5); 0.234 (0.7); 0.108 (26.4); 0.049 (5.0); 0.039 (156.4); 0.028 (6.1); −0.160 (0.7)

### Example I.71

¹H-NMR (300.2 MHz, d₆-DMSO): δ=15.167 (0.3); 13.267 (0.3); 12.426 (0.3); 8.396 (0.5); 8.361 (15.7); 8.236 (0.4); 8.229 (0.6); 8.206 (5.2); 8.177 (5.3); 7.892 (0.3); 7.832 (15.6); 7.548 (1.8); 7.537 (12.2); 7.530 (4.2); 7.515 (4.8); 7.508 (14.8); 7.497 (1.3); 7.315 (0.5); 7.289 (2.2); 7.278 (15.6); 7.270 (5.8); 7.264 (7.6); 7.255 (4.8); 7.248 (12.3); 7.235 (7.0); 6.331 (0.3); 5.297 (14.6); 4.785 (4.0); 4.737 (6.0); 4.580 (5.7); 4.532 (3.9); 4.380 (0.5); 4.152 (1.4); 4.134 (3.9); 4.117 (4.3); 4.099 (1.3); 3.491 (0.4); 3.445 (0.5); 3.419 (0.6); 3.353 (79.3); 3.202 (16.7); 3.185 (16.0); 2.761 (0.4); 2.755 (0.4); 2.534 (37.5); 2.528 (50.5); 2.522 (36.5); 2.297 (0.5); 1.621 (0.7); 1.607 (1.4); 1.597 (1.5); 1.579 (2.6); 1.560 (1.7); 1.534 (0.8); 1.325 (0.4); 1.312 (0.4); 1.263 (1.1); 1.104 (0.6); 1.081 (1.4); 1.057 (0.5); 0.881 (0.4); 0.620 (0.6); 0.607 (1.3); 0.588 (2.1); 0.572 (2.5); 0.557 (2.0); 0.539 (0.8); 0.467 (0.6); 0.436 (1.6); 0.415 (1.8); 0.376 (1.0); 0.352 (1.0); 0.341 (1.4); 0.323 (2.2); 0.312 (2.1); 0.297 (2.5); 0.280 (2.6); 0.266 (2.7); 0.248 (2.2); 0.037 (2.0); 0.026 (51.2); 0.015 (2.4); −0.173 (0.4); −3.527 (0.4)

### Example I.72

¹H-NMR (499.9 MHz, CDCl₃): δ=8.565 (0.3); 8.115 (0.4); 7.977 (0.4); 7.274 (0.5); 7.261 (1.1); 5.298 (16.0); 1.561 (0.7); 0.000 (0.8)

### Example I.73

¹H-NMR (300.2 MHz, d₆-DMSO): δ=8.471 (16.0); 8.108 (5.9); 8.079 (6.5); 7.975 (15.7); 7.677 (1.4); 7.666 (13.7); 7.659 (4.1); 7.644 (4.6); 7.637 (14.5); 7.626 (1.5); 7.296 (5.6); 7.267 (5.2); 7.217 (1.7); 7.206 (15.6); 7.199 (4.4); 7.184 (4.4); 7.177 (12.9); 7.165 (1.2); 7.147 (3.0); 6.969 (6.4); 6.790 (3.2); 6.114 (7.2); 6.099 (7.4); 5.785 (1.5); 5.377 (2.2); 5.367 (2.3); 5.355 (2.3); 4.445 (1.4); 4.420 (1.2); 4.400 (4.1); 4.373 (4.3); 4.361 (4.2); 4.347 (4.1); 4.314 (1.4); 4.300 (1.1); 3.349 (65.1); 2.762 (0.4); 2.541 (19.3); 2.535 (40.9); 2.529 (55.5); 2.523 (39.2); 2.517 (17.8); 2.305 (0.3); 1.275 (0.6); 1.264 (0.7); 0.223 (0.4); 0.038 (2.1); 0.027 (63.3); 0.016 (2.0)

### Example I.74

¹H-NMR (300.2 MHz, d₆-DMSO): δ=8.488 (16.0); 8.298 (5.9); 8.269 (6.4); 7.992 (15.3); 7.710 (8.2); 7.682 (9.6); 7.496 (6.7); 7.467 (6.3); 7.393 (10.8); 7.365 (9.0); 7.291 (3.4); 7.105 (7.4); 6.919 (3.6); 6.209 (7.0); 6.193 (7.3); 5.786 (1.0); 5.286 (2.3); 5.274 (2.5); 4.464 (1.9); 4.437 (1.8); 4.418 (3.9); 4.390 (3.8); 4.343 (3.8); 4.331 (3.9); 4.296 (1.9); 4.284 (1.7); 3.358 (44.1); 3.046 (0.5); 2.534 (9.3); 2.528 (12.2); 2.523 (9.0); 1.262 (0.7); 0.026 (5.7)

### Example I.75

¹H-NMR (499.9 MHz, CDCl₃): δ=8.113 (1.8); 8.095 (1.9); 8.027 (3.6); 7.890 (3.9); 7.264 (1.9); 7.259 (0.5); 7.254 (3.2); 7.237 (4.0); 7.094 (0.6); 7.088 (4.2); 7.085 (1.7); 7.075 (1.3); 7.071 (3.5); 6.886 (2.2); 6.868 (2.1); 4.684 (1.7); 4.655 (2.3); 4.509 (2.5); 4.481 (1.8); 2.961 (0.3); 2.947 (0.9); 2.933 (1.2); 2.919 (0.9); 2.906 (0.4); 1.634 (9.6); 1.274 (15.8); 1.260 (16.0); 0.000 (1.7)

### Example I.76

¹H-NMR (300.2 MHz, CDCl₃): δ=8.411 (9.1); 7.994 (11.0); 7.980 (0.5); 7.912 (11.4); 7.742 (6.3); 7.713 (7.2); 7.354 (10.9); 7.302 (12.7); 7.276 (6.1); 4.732 (4.0); 4.684 (13.3); 4.524 (6.3); 4.476 (4.1); 2.196 (0.4); 2.172 (1.4); 2.147 (1.9); 2.123 (2.3); 2.099 (2.0); 2.074 (0.6); 2.042 (2.4); 1.904 (0.5); 1.879 (1.9); 1.855 (2.4); 1.831 (2.0); 1.807 (1.5); 1.783 (0.6); 1.737 (0.9); 1.292 (0.3); 0.924 (7.5); 0.900 (16.0); 0.875 (6.9); 0.109 (0.5); 0.037 (4.4)

### Example I.77

¹H-NMR (499.9 MHz, d₆-DMSO): δ=8.502 (1.5); 8.378 (1.0); 8.361 (1.0); 8.339 (6.0); 8.009 (1.4); 7.827 (3.4); 7.811 (3.7); 7.799 (5.4); 7.261 (0.6); 7.251 (0.7); 7.242 (0.9); 7.233 (0.9); 7.199 (0.8); 7.188 (1.9); 7.181 (6.8); 7.176 (7.1); 7.171 (5.5); 7.160 (5.0); 7.148 (1.3); 7.140 (2.2); 7.133 (1.6); 7.123 (2.6); 7.115 (2.4); 7.097 (4.9); 7.080 (3.4); 7.073 (0.5); 7.041 (3.6); 7.031 (3.8); 7.023 (2.3); 7.018 (1.2); 7.013 (2.0); 6.835 (1.0); 6.819 (1.0); 6.523 (3.6); 6.506 (3.6); 5.897 (2.7); 5.844 (4.9); 5.754 (3.5); 4.745 (2.2); 4.717 (2.8); 4.564 (2.9); 4.536 (2.2); 3.324 (9.8); 2.502 (4.9); 1.590 (16.0); 1.235 (1.0); 0.000 (1.0)

### Example I.78

¹H-NMR (300.2 MHz, CDCl₃): δ=8.488 (5.3); 8.039 (2.3); 7.895 (2.8); 7.702 (2.5); 7.674 (2.8); 7.298 (3.4); 7.247 (2.7); 7.219 (2.4); 6.977 (5.9); 5.333 (11.1); 5.205 (1.9); 5.158 (2.2); 4.573 (2.3); 4.526 (2.0); 1.743 (16.0); 1.290 (0.4); 0.034 (3.5)

### Example I.79

¹H-NMR (300.2 MHz, CDCl₃): δ=8.133 (5.0); 8.099 (1.7); 8.033 (3.9); 8.012 (0.5); 7.325 (1.0); 7.316 (0.7); 7.313 (0.7); 7.300 (15.8); 7.295 (5.1); 7.294 (5.0); 7.285 (2.5); 7.277 (7.1); 7.268 (1.2); 7.256 (0.9); 7.248 (1.3); 7.171 (2.0); 7.142 (1.9); 5.552 (0.8); 5.527 (0.8); 5.339 (16.0); 4.530 (0.8); 4.522 (0.9); 4.483 (1.3); 4.476 (1.3); 4.312 (1.2); 4.285 (1.2); 4.265 (0.8); 4.238 (0.8); 4.156 (0.7); 1.627 (0.9); 1.304 (0.4); 1.293 (0.4); 1.280 (0.4); 0.108 (1.9); 0.049 (0.7); 0.038 (15.8); 0.027 (0.6)

### Example I.80

¹H-NMR (300.2 MHz, d₆-DMSO): δ=8.362 (11.2); 8.206 (3.8); 8.177 (4.0); 7.832 (11.0); 7.537 (8.6); 7.530 (3.0); 7.515 (3.7); 7.508 (10.5); 7.496 (1.1); 7.288 (1.5); 7.278 (10.9); 7.270 (4.5); 7.265 (5.6); 7.255 (3.7); 7.248 (8.7); 7.236 (5.4); 5.297 (10.6); 4.785 (3.0); 4.738 (4.4); 4.581 (4.4); 4.533 (2.9); 4.396 (0.4); 4.380 (0.8); 4.362 (0.4); 4.152 (1.3); 4.135 (4.1); 4.117 (4.2); 4.100 (1.6); 3.485 (0.7); 3.469 (0.6); 3.462 (0.5); 3.445 (0.6); 3.354 (53.8); 3.202 (16.6); 3.185 (16.0); 2.534 (23.6); 2.528 (30.7); 2.522 (22.1); 1.624 (0.5); 1.595 (1.1); 1.578 (1.9); 1.562 (1.3); 1.534 (0.5); 1.266 (0.5); 1.104 (1.1); 1.081 (2.0); 1.058 (1.0); 0.603 (1.0); 0.589 (1.7); 0.573 (1.8); 0.557 (1.4); 0.468 (0.4); 0.437 (1.2); 0.417 (1.6); 0.376 (0.8); 0.339 (1.1); 0.324 (1.5); 0.312 (1.7); 0.295 (1.9); 0.280 (1.9); 0.266 (2.0); 0.247 (1.5); 0.237 (1.0); 0.026 (30.3)

### Example I.81

¹H-NMR (300.2 MHz, CDCl₃): δ=8.268 (5.9); 8.239 (6.2); 8.064 (14.1); 7.948 (16.0); 7.560 (1.3); 7.550 (13.2); 7.543 (4.3); 7.527 (4.4); 7.520 (15.2); 7.509 (1.6); 7.302 (2.9); 7.146 (1.7); 7.135 (15.3); 7.128 (4.6); 7.113 (4.2); 7.106 (13.1); 7.095 (1.3); 7.040 (7.2); 7.011 (6.8); 4.833 (5.6); 4.785 (8.3); 4.740 (7.2); 4.609 (8.1); 4.577 (0.4); 4.561 (5.4); 2.028 (0.7); 1.620 (3.7); 1.493 (0.6); 1.469 (1.6); 1.449 (2.6); 1.439 (1.3); 1.427 (1.9); 1.403 (0.8); 0.502 (0.6); 0.495 (0.7); 0.488 (1.0); 0.477 (1.6); 0.466 (1.7); 0.458 (2.8); 0.448 (1.6); 0.441 (1.5); 0.421 (0.6); 0.413 (0.4); 0.403 (0.7); 0.392 (0.8); 0.373 (4.2); 0.359 (10.7); 0.349 (6.0); 0.330 (7.5); 0.320 (2.6); 0.288 (0.4); 0.029 (1.5)

### Example I.82

¹H-NMR (300.2 MHz, CDCl₃): δ=8.160 (2.5); 8.104 (3.6); 8.011 (3.7); 7.840 (0.9); 7.660 (1.1); 7.654 (1.0); 7.594 (0.3); 7.583 (3.3); 7.576 (1.0); 7.561 (1.1); 7.554 (3.6); 7.543 (0.4); 7.473 (1.0); 7.358 (2.4); 7.300 (13.6); 7.093 (0.4); 7.082 (3.7); 7.075 (1.1); 7.060 (1.0); 7.053 (3.2); 5.339 (4.3); 4.657 (1.2); 4.610 (1.7); 4.571 (2.1); 4.385 (2.1); 4.337 (1.6); 1.613 (16.0); 1.292 (0.4); 0.107 (1.3); 0.038 (9.4); 0.027 (0.4)

### Example I.83

¹H-NMR (499.9 MHz, CDCl₃): δ=8.567 (0.8); 8.116 (0.9); 7.984 (0.9); 7.836 (0.7); 7.818 (0.8); 7.286 (0.9); 7.260 (2.4); 7.239 (0.6); 5.298 (16.0); 4.110 (0.5); 4.103 (0.6); 2.004 (0.3); 1.556 (2.1); 0.000 (1.8)

### Example I.84

¹H-NMR (499.9 MHz, CDCl₃): δ=8.238 (6.8); 8.221 (7.0); 8.021 (14.6); 7.923 (15.1); 7.522 (1.4); 7.516 (13.0); 7.512 (5.0); 7.502 (4.8); 7.498 (14.1); 7.492 (1.8); 7.262 (10.7); 7.107 (1.6); 7.101 (14.2); 7.097 (5.2); 7.087 (4.7); 7.083 (13.0); 7.077 (1.6); 7.006 (7.6); 6.988 (7.4); 5.297 (8.4); 4.794 (6.6); 4.765 (8.5); 4.679 (13.5); 4.574 (8.4); 4.545 (6.6); 1.608 (16.0); 1.443 (0.8); 1.429 (2.0); 1.416 (3.2); 1.403 (2.2); 1.389 (0.9); 1.256 (0.5); 0.460 (1.3); 0.449 (2.5); 0.445 (2.6); 0.438 (3.4); 0.427 (2.1); 0.416 (0.3); 0.357 (0.5); 0.344 (2.3); 0.341 (3.5); 0.330 (7.2); 0.328 (7.2); 0.317 (8.1); 0.305 (4.4); 0.302 (4.0); 0.291 (1.9); 0.278 (0.7); 0.000 (9.6)

### Example I.85

¹H-NMR (300.2 MHz, CDCl₃): δ=8.139 (10.5); 8.067 (3.3); 8.037 (3.5); 7.996 (13.1); 7.583 (1.5); 7.572 (14.3); 7.565 (4.4); 7.550 (4.8); 7.543 (16.0); 7.532 (1.7); 7.300 (15.1); 7.156 (2.0); 7.145 (18.0); 7.140 (11.0); 7.122 (4.9); 7.115 (15.7); 7.111 (8.9); 6.001 (1.1); 5.337 (3.6); 4.954 (1.9); 4.905 (6.2); 4.863 (7.8); 4.815 (2.6); 2.216 (0.4); 2.211 (0.8); 1.723 (0.6); 1.666 (0.8); 1.409 (0.5); 1.372 (0.7); 1.346 (0.7); 1.339 (0.7); 1.321 (1.4); 1.293 (7.8); 1.258 (0.8); 1.216 (0.4); 1.201 (0.4); 1.074 (0.5); 0.966 (0.3); 0.937 (0.8); 0.917 (1.5); 0.892 (1.6); 0.865 (1.6); 0.108 (3.6); 0.048 (0.4); 0.037 (13.4); 0.026 (0.6)

### Example I.86

¹H-NMR (499.9 MHz, CDCl₃): δ=8.115 (0.4); 7.972 (0.4); 7.817 (0.3); 7.286 (0.3); 7.261 (0.8); 5.299 (16.0); 1.567 (0.5); 0.000 (0.6)

### Example I.87

¹H-NMR (300.2 MHz, d₆-DMSO): δ=8.371 (10.5); 8.344 (0.6); 8.259 (3.5); 8.230 (3.8); 7.936 (0.4); 7.862 (6.1); 7.836 (16.0); 7.490 (0.7); 7.446 (6.4); 7.418 (5.5); 7.364 (4.7); 7.335 (4.4); 5.326 (10.2); 5.166 (0.6); 4.804 (2.8); 4.756 (4.0); 4.593 (4.0); 4.568 (0.4); 4.545 (2.7); 3.353 (24.0); 2.641 (0.4); 2.618 (0.4); 2.535 (4.9); 2.529 (6.5); 2.523 (4.8); 2.101 (0.3); 1.643 (0.4); 1.624 (1.0); 1.616 (1.2); 1.593 (3.1); 1.573 (5.3); 1.553 (0.7); 1.450 (2.0); 0.640 (0.3); 0.624 (0.9); 0.610 (1.5); 0.593 (1.7); 0.579 (1.3); 0.563 (0.6); 0.482 (0.4); 0.454 (1.1); 0.433 (1.4); 0.420 (1.3); 0.405 (0.9); 0.392 (0.7); 0.368 (0.7); 0.355 (1.1); 0.339 (1.5); 0.327 (1.6); 0.310 (1.7); 0.297 (2.0); 0.284 (2.0); 0.265 (1.6); 0.252 (1.0); 0.025 (4.3)

### Example I.88

¹H-NMR (300.2 MHz, CDCl₃): δ=8.362 (11.7); 8.154 (10.1); 7.999 (12.2); 7.977 (0.4); 7.728 (7.6); 7.700 (8.7); 7.298 (34.0); 7.289 (8.6); 7.261 (7.2); 7.077 (16.0); 5.483 (2.1); 5.457 (2.2); 5.337 (8.0); 4.623 (3.2); 4.615 (3.1); 4.576 (4.2); 4.568 (4.2); 4.351 (4.0); 4.324 (3.8); 4.305 (2.9); 4.278 (2.9); 4.161 (2.1); 3.992 (0.4); 1.633 (4.5); 1.320 (0.4); 1.292 (1.2); 1.278 (0.5); 0.916 (0.4); 0.889 (0.3); 0.866 (0.4); 0.107 (0.6); 0.047 (1.1); 0.036 (34.2); 0.025 (1.4)

### Example I.89

¹H-NMR (300.2 MHz, CDCl₃): δ=8.297 (2.9); 8.268 (3.1); 8.053 (7.1); 7.963 (5.5); 7.300 (21.3); 7.237 (3.7); 7.208 (3.5); 7.118 (0.7); 7.107 (1.3); 7.096 (6.9); 7.072 (6.7); 7.061 (1.2); 7.050 (0.6); 4.715 (2.1); 4.667 (3.9); 4.650 (1.7); 4.631 (0.9); 4.552 (4.9); 4.504 (2.8); 1.657 (16.0); 1.612 (2.8); 1.598 (3.3); 1.292 (0.5); 0.107 (5.8); 0.048 (0.5); 0.037 (14.7); 0.026 (0.5)

### Example I.90

¹H-NMR (300.2 MHz, CDCl₃): δ=8.149 (6.4); 8.131 (15.9); 8.120 (6.6); 8.048 (16.0); 7.646 (0.4); 7.300 (87.7); 7.284 (4.7); 7.277 (5.6); 7.252 (8.6); 7.243 (11.8); 7.223 (22.1); 7.197 (1.5); 7.189 (1.4); 6.949 (0.5); 5.541 (2.3); 5.515 (2.5); 5.339 (1.8); 4.521 (3.1); 4.513 (3.1); 4.474 (4.7); 4.467 (4.5); 4.308 (4.7); 4.281 (4.4); 4.261 (3.1); 4.234 (3.1); 4.034 (5.3); 4.024 (5.2); 1.599 (21.4); 1.350 (0.5); 1.324 (0.7); 1.292 (1.6); 0.922 (0.4); 0.234 (0.4); 0.108 (22.6); 0.096 (0.8); 0.049 (3.4); 0.039 (97.6); 0.028 (3.5); 0.014 (0.4)

### Example I.91

¹H-NMR (300.2 MHz, d₆-DMSO): δ=8.362 (14.8); 8.344 (1.3); 8.206 (4.9); 8.177 (5.2); 7.964 (0.4); 7.934 (0.4); 7.832 (16.0); 7.548 (1.3); 7.537 (11.7); 7.529 (4.0); 7.514 (4.4); 7.507 (14.2); 7.496 (1.4); 7.288 (1.9); 7.277 (14.8); 7.270 (5.4); 7.264 (7.4); 7.255 (4.5); 7.248 (11.7); 7.235 (6.9); 6.890 (0.4); 6.861 (0.4); 5.297 (14.1); 5.169 (1.0); 4.786 (3.8); 4.738 (5.8); 4.690 (0.5); 4.581 (5.6); 4.533 (3.8); 3.357 (45.4); 2.534 (7.8); 2.528 (10.3); 2.522 (7.4); 2.101 (4.0); 1.623 (0.7); 1.602 (2.5); 1.572 (9.0); 1.553 (1.5); 1.534 (0.8); 1.261 (0.6); 0.621 (0.5); 0.604 (1.3); 0.589 (2.1); 0.572 (2.3); 0.558 (1.7); 0.541 (0.8); 0.465 (0.5); 0.436 (1.5); 0.416 (1.9); 0.404 (1.8); 0.388 (1.3); 0.376 (1.0); 0.353 (1.0); 0.341 (1.4); 0.323 (2.0); 0.312 (2.3); 0.295 (2.4); 0.280 (2.6); 0.267 (2.8); 0.248 (2.1); 0.236 (1.2); 0.036 (0.5); 0.025 (8.6); 0.014 (0.3)

### Example I.92

¹H-NMR (499.9 MHz, CDCl₃): δ=8.565 (0.8); 8.114 (1.0); 7.975 (1.0); 7.709 (0.7); 7.692 (0.8); 7.274 (1.3); 7.260 (2.9); 5.298 (16.0); 4.440 (0.3); 4.436 (0.3); 4.139 (0.5); 4.132 (0.6); 1.563 (1.7); 0.000 (2.0)

### Example I.93

¹H-NMR (300.2 MHz, CDCl₃): δ=8.307 (6.4); 8.278 (6.7); 8.167 (0.5); 8.071 (14.1); 8.054 (1.1); 7.969 (16.0); 7.606 (7.5); 7.578 (9.2); 7.342 (10.5); 7.313 (8.5); 7.301 (16.3); 7.272 (0.6); 7.225 (0.8); 7.200 (0.4); 7.084 (7.7); 7.055 (7.4); 6.902 (3.9); 6.714 (7.9); 6.526 (4.0); 5.338 (1.9); 5.338 (1.9); 4.852 (6.2); 4.805 (9.2); 4.747 (14.0); 4.627 (9.0); 4.579 (6.0); 2.995 (6.6); 2.922 (5.7); 2.394 (2.3); 1.660 (13.4); 1.505 (0.7); 1.483 (1.8); 1.461 (2.8); 1.440 (2.0); 1.416 (0.8); 0.513 (1.0); 0.497 (2.0); 0.484 (2.1); 0.476 (2.6); 0.467 (1.7); 0.461 (1.9); 0.437 (0.7); 0.429 (0.4); 0.416 (0.9); 0.407 (0.9); 0.399 (2.6); 0.392 (3.3); 0.371 (8.5); 0.361 (3.5); 0.353 (6.5); 0.343 (6.4); 0.330 (1.9); 0.302 (0.4); 0.110 (1.3); 0.049 (0.5); 0.038 (13.4); 0.027 (0.5)

### Example I.94

¹H-NMR (300.2 MHz, CDCl₃): δ=8.385 (6.4); 8.140 (8.7); 8.036 (9.1); 7.453 (1.0); 7.442 (8.1); 7.435 (3.0); 7.420 (3.1); 7.412 (10.0); 7.402 (1.3); 7.337 (0.4); 7.328 (0.4); 7.300 (55.7); 7.235 (2.3); 7.199 (6.5); 7.155 (1.3); 7.144 (9.8); 7.137 (3.2); 7.122 (2.9); 7.114 (8.0); 7.103 (1.0); 7.053 (4.1); 6.949 (0.3); 6.871 (2.3); 5.409 (1.4); 5.394 (1.3); 5.381 (1.6); 5.340 (11.4); 4.499 (0.7); 4.487 (1.0); 4.452 (4.0); 4.440 (4.2); 4.434 (4.4); 4.407 (3.3); 4.388 (0.8); 4.360 (1.0); 4.019 (4.2); 4.008 (4.2); 1.607 (16.0); 1.326 (0.4); 1.292 (1.3); 0.108 (4.5); 0.050 (2.7); 0.039 (60.0); 0.028 (2.3)

### Example I.95

¹H-NMR (300.2 MHz, CDCl₃): δ=8.246 (3.1); 8.217 (3.2); 8.049 (4.1); 7.958 (5.0); 7.647 (0.4); 7.301 (80.0); 7.279 (7.6); 7.271 (3.8); 7.264 (11.9); 7.254 (1.6); 7.242 (1.1); 7.234 (1.8); 7.053 (3.7); 7.023 (3.5); 6.950 (0.5); 5.341 (0.5); 4.770 (2.4); 4.723 (5.7); 4.559 (3.6); 4.512 (2.4); 1.685 (16.0); 1.594 (22.2); 1.294 (1.1); 0.921 (0.4); 0.235 (0.3); 0.109 (9.9); 0.051 (2.6); 0.040 (81.7); 0.029 (2.9); −0.158 (0.4)

### Example I.96

¹H-NMR (300.2 MHz, CDCl₃): δ=8.220 (2.8); 8.191 (2.9); 8.052 (6.8); 7.941 (6.1); 7.422 (0.6); 7.411 (6.2); 7.404 (2.0); 7.388 (2.2); 7.381 (7.7); 7.370 (0.8); 7.301 (10.0); 7.186 (0.9); 7.176 (8.2); 7.168 (2.3); 7.153 (2.0); 7.146 (6.0); 7.135 (0.6); 7.027 (3.4); 6.998 (3.3); 5.337 (0.7); 4.777 (3.4); 4.770 (1.7); 4.748 (2.2); 4.701 (3.5); 4.553 (4.3); 4.505 (2.7); 1.676 (16.0); 1.290 (1.5); 0.106 (0.7); 0.036 (9.8); 0.025 (0.4)

### Example I.97

¹H-NMR (300.2 MHz, CDCl₃): δ=8.338 (6.4); 8.309 (6.8); 8.076 (14.5); 7.958 (16.0); 7.848 (1.4); 7.837 (12.2); 7.831 (4.0); 7.813 (4.8); 7.807 (13.6); 7.796 (1.5); 7.364 (8.7); 7.334 (7.7); 7.301 (3.1); 7.138 (7.6); 7.108 (7.2); 4.852 (5.8); 4.804 (9.6); 4.792 (8.1); 4.626 (8.4); 4.579 (5.7); 2.030 (2.1); 1.506 (0.7); 1.483 (1.9); 1.462 (2.9); 1.452 (1.4); 1.441 (2.1); 1.417 (0.8); 0.523 (0.7); 0.516 (0.9); 0.512 (0.9); 0.498 (1.9); 0.489 (2.2); 0.478 (2.8); 0.466 (1.6); 0.456 (1.1); 0.441 (0.6); 0.434 (0.4); 0.423 (0.8); 0.411 (0.9); 0.392 (4.0); 0.378 (9.6); 0.367 (5.8); 0.354 (7.2); 0.348 (6.8); 0.335 (3.0); 0.305 (0.4); 0.031 (1.8)

### Example I.98

¹H-NMR (300.2 MHz, CDCl₃): δ=9.258 (0.4); 8.164 (3.3); 8.134 (3.3); 7.992 (6.9); 7.915 (8.0); 7.419 (0.7); 7.409 (6.7); 7.401 (2.2); 7.386 (2.5); 7.379 (8.4); 7.368 (0.9); 7.301 (5.7); 7.194 (1.1); 7.184 (8.8); 7.176 (2.4); 7.161 (2.3); 7.154 (6.4); 7.143 (0.6); 7.010 (3.8); 6.981 (3.6); 5.337 (16.0); 4.782 (2.9); 4.734 (4.1); 4.560 (4.1); 4.513 (2.8); 3.445 (1.2); 2.182 (0.5); 2.168 (0.7); 2.135 (0.9); 2.127 (1.0); 2.122 (1.0); 2.097 (0.8); 2.081 (0.8); 1.803 (0.7); 1.791 (0.8); 1.763 (1.0); 1.749 (1.1); 1.717 (0.7); 1.703 (0.7); 1.425 (0.5); 1.417 (0.4); 1.403 (0.6); 1.396 (0.7); 1.378 (0.9); 1.363 (0.8); 1.354 (0.8); 1.335 (2.0); 1.311 (3.1); 1.288 (2.7); 1.265 (1.4); 1.240 (0.5); 1.078 (0.5); 1.056 (0.6); 1.034 (1.1); 1.018 (0.7); 1.010 (1.1); 1.001 (0.5); 0.993 (0.6); 0.985 (0.5); 0.978 (0.4); 0.898 (5.8); 0.875 (11.4); 0.850 (4.4); 0.108 (0.5); 0.037 (5.4)

### Example I.99

¹H-NMR (499.9 MHz, CDCl₃): δ=8.239 (5.8); 8.221 (6.0); 8.021 (12.6); 7.923 (13.1); 7.523 (1.2); 7.516 (11.5); 7.512 (4.0); 7.499 (12.2); 7.492 (1.4); 7.262 (10.7); 7.107 (1.3); 7.101 (12.5); 7.097 (4.1); 7.087 (4.2); 7.083 (11.2); 7.077 (1.3); 7.006 (6.5); 6.988 (6.4); 5.297 (9.6); 4.794 (5.7); 4.765 (7.3); 4.679 (11.7); 4.574 (7.2); 4.545 (5.6); 1.601 (16.0); 1.443 (0.7); 1.429 (1.7); 1.416 (2.7); 1.403 (1.8); 1.389 (0.7); 0.460 (1.1); 0.449 (2.1); 0.445 (2.2); 0.438 (2.9); 0.427 (1.8); 0.357 (0.4); 0.347 (1.8); 0.344 (2.0); 0.341 (2.9); 0.330 (6.1); 0.328 (6.1); 0.317 (7.0); 0.305 (3.7); 0.302 (3.3); 0.291 (1.5); 0.278 (0.6); 0.006 (0.4); 0.000 (9.7)

### Example I.100

¹H-NMR (300.2 MHz, CDCl₃): δ=8.217 (0.6); 8.157 (5.0); 8.128 (5.0); 8.040 (1.7); 8.017 (10.9); 7.906 (12.1); 7.413 (1.0); 7.402 (9.8); 7.395 (3.3); 7.380 (3.6); 7.372 (12.8); 7.362 (1.4); 7.305 (4.2); 7.198 (0.3); 7.185 (1.4); 7.175 (12.9); 7.167 (3.9); 7.152 (3.2); 7.145 (9.8); 7.134 (0.9); 7.005 (5.8); 6.976 (5.5); 4.760 (4.1); 4.713 (6.5); 4.565 (6.6); 4.518 (4.2); 4.164 (0.6); 4.141 (0.6); 3.446 (0.4); 2.994 (11.4); 2.977 (0.5); 2.916 (10.2); 2.745 (0.4); 2.158 (0.7); 2.144 (0.9); 2.112 (1.4); 2.098 (1.5); 2.077 (2.5); 2.071 (1.5); 2.056 (1.3); 1.778 (0.9); 1.763 (1.2); 1.738 (1.3); 1.732 (1.2); 1.723 (1.6); 1.691 (1.0); 1.676 (1.1); 1.497 (0.3); 1.480 (0.5); 1.473 (0.5); 1.455 (1.1); 1.438 (1.0); 1.431 (1.1); 1.414 (1.3); 1.389 (0.9); 1.373 (0.5); 1.314 (0.7); 1.290 (1.5); 1.267 (0.7); 1.138 (0.4); 1.123 (0.6); 1.114 (0.6); 1.098 (1.1); 1.091 (0.8); 1.074 (1.0); 1.056 (1.0); 1.035 (0.7); 1.031 (0.7); 1.016 (0.5); 1.009 (0.4); 0.995 (0.4); 0.919 (8.2); 0.895 (16.0); 0.870 (6.1); 0.106 (1.1); 0.032 (3.3)

### Example I.101

¹H-NMR (499.9 MHz, CDCl₃): δ=8.187 (3.1); 8.169 (3.2); 8.001 (6.6); 7.910 (6.8); 7.521 (0.6); 7.514 (6.3); 7.510 (2.1); 7.501 (2.2); 7.497 (6.7); 7.490 (0.8); 7.260 (16.3); 7.088 (0.7); 7.082 (6.8); 7.078 (2.2); 7.068 (2.1); 7.064 (6.2); 7.058 (0.7); 6.989 (3.5); 6.971 (3.4); 5.298 (1.1); 4.707 (2.9); 4.678 (3.8); 4.662 (5.5); 4.508 (4.0); 4.479 (3.0); 1.639 (16.0); 1.559 (8.7); 1.255 (1.5); 0.006 (0.6); 0.000 (16.6)

### Example I.102

¹H-NMR (499.9 MHz, CDCl₃): δ=8.187 (3.1); 8.169 (3.2); 8.001 (6.6); 7.908 (6.8); 7.521 (0.6); 7.514 (6.2); 7.510 (2.2); 7.501 (2.2); 7.496 (6.7); 7.490 (0.9); 7.260 (13.2); 7.088 (0.7); 7.082 (6.7); 7.078 (2.3); 7.068 (2.2); 7.064 (6.2); 7.058 (0.8); 6.989 (3.5); 6.971 (3.4); 5.298 (1.1); 4.677 (3.9); 4.667 (7.0); 4.508 (4.0); 4.479 (3.0); 1.639 (16.0); 1.562 (10.2); 1.255 (0.4); 0.006 (0.5); 0.000 (13.3)

### Example I.103

¹H-NMR (300.2 MHz, CDCl₃): δ=8.163 (4.6); 8.133 (4.8); 7.994 (10.3); 7.909 (11.2); 7.419 (0.9); 7.408 (9.5); 7.401 (3.1); 7.386 (3.6); 7.379 (11.9); 7.368 (1.3); 7.304 (5.2); 7.192 (1.4); 7.181 (12.3); 7.174 (3.4); 7.159 (3.2); 7.152 (9.1); 7.141 (0.9); 7.016 (5.5); 6.987 (5.2); 4.821 (2.3); 4.783 (4.3); 4.736 (6.2); 4.568 (6.3); 4.520 (4.1); 4.169 (0.7); 4.146 (0.7); 2.238 (0.4); 2.213 (1.4); 2.188 (2.0); 2.165 (2.3); 2.140 (1.9); 2.116 (0.6); 2.082 (3.1); 1.883 (0.6); 1.859 (1.8); 1.834 (2.4); 1.811 (2.3); 1.786 (2.1); 1.762 (1.1); 1.319 (0.9); 1.295 (1.7); 1.272 (0.8); 0.885 (7.7); 0.861 (16.0); 0.836 (7.1); 0.110 (0.9); 0.037 (2.8)

### Example V.01

¹H-NMR (300.2 MHz, CDCl₃): δ=7.881 (2.8); 7.852 (3.0); 7.449 (0.6); 7.438 (5.9); 7.431 (1.9); 7.415 (2.3); 7.408 (7.3); 7.397 (0.8); 7.299 (5.2); 7.241 (0.5); 7.211 (0.6); 7.201 (0.9); 7.191 (7.6); 7.183 (2.2); 7.168 (2.5); 7.161 (8.8); 7.150 (0.7); 7.133 (3.0); 6.818 (0.5); 6.789 (0.4); 5.338 (0.5); 2.614 (16.0); 2.612 (14.4); 1.606 (0.5); 1.470 (0.9); 0.108 (0.4); 0.038 (6.2)

### Example V.02

¹H-NMR (300.2 MHz, CDCl₃): δ=8.519 (3.7); 7.478 (0.4); 7.467 (4.5); 7.460 (1.5); 7.445 (1.6); 7.438 (5.4); 7.427 (0.7); 7.330 (4.0); 7.300 (5.5); 7.172 (0.6); 7.161 (5.6); 7.154 (1.7); 7.139 (1.5); 7.131 (4.4); 7.120 (0.5); 2.635 (16.0); 1.595 (6.3); 0.921 (0.3); 0.109 (1.7); 0.039 (6.2)

### Example V.03

¹H-NMR (300.2 MHz, CDCl₃): δ=8.518 (3.8); 7.912 (0.4); 7.901 (4.0); 7.894 (1.3); 7.878 (1.3); 7.871 (4.5); 7.860 (0.5); 7.695 (0.6); 7.665 (0.6); 7.391 (4.1); 7.323 (2.5); 7.299 (5.3); 7.293 (2.3); 6.908 (0.4); 6.878 (0.3); 5.504 (0.3); 2.651 (16.0); 1.608 (7.9); 1.306 (1.4); 0.942 (0.5); 0.921 (1.6); 0.897 (0.6); 0.109 (1.6); 0.038 (4.8)

### Example V.04

¹H-NMR (300.2 MHz, d₆-DMSO): δ=8.845 (3.1); 7.724 (1.9); 7.695 (2.3); 7.651 (3.3); 7.435 (2.6); 7.407 (2.1); 7.293 (0.9); 7.107 (1.9); 6.921 (0.9); 3.350 (2.0); 2.640 (16.0); 2.531 (0.5); 2.525 (0.7); 2.519 (0.5); 0.020 (0.8)

### Example V.05

¹H-NMR (300.2 MHz, CDCl₃): δ=8.098 (1.9); 8.069 (2.0); 7.411 (0.4); 7.400 (4.0); 7.393 (1.6); 7.378 (1.6); 7.371 (5.2); 7.361 (0.8); 7.262 (12.2); 7.225 (1.5); 7.181 (0.6); 7.170 (5.1); 7.162 (1.6); 7.155 (0.6); 7.147 (1.5); 7.140 (3.9); 7.129 (0.5); 7.053 (2.1); 7.044 (3.3); 7.024 (1.9); 6.862 (1.5); 4.158 (0.4); 4.134 (1.1); 4.110 (1.1); 4.087 (0.4); 2.620 (16.0); 2.047 (5.0); 1.562 (9.9); 1.432 (1.4); 1.284 (1.4); 1.260 (2.8); 1.236 (1.4); 0.070 (9.2); 0.057 (0.5); 0.011 (0.5); 0.000 (15.9); −0.011 (0.9)

### Example V.06

¹H-NMR (300.2 MHz, CDCl₃): δ=8.350 (2.4); 8.322 (2.5); 7.394 (3.2); 7.387 (1.3); 7.372 (1.4); 7.365 (4.3); 7.352 (0.7); 7.263 (7.4); 7.141 (0.8); 7.132 (4.0); 7.125 (1.3); 7.110 (1.4); 7.102 (3.4); 7.092 (0.4); 6.868 (2.5); 6.840 (2.3); 2.682 (0.4); 2.665 (0.6); 2.659 (0.5); 2.617 (16.0); 1.584 (27.0); 1.432 (1.1); 0.070 (4.5); 0.000 (8.6); −0.011 (0.4)

### Example V.07

¹H-NMR (300.2 MHz, d₆-DMSO): δ=8.832 (3.2); 7.763 (3.4); 7.743 (1.3); 7.735 (1.3); 7.708 (1.2); 7.700 (1.2); 7.550 (0.9); 7.521 (2.1); 7.493 (1.6); 7.448 (1.2); 7.444 (1.2); 7.440 (1.2); 7.436 (1.0); 7.419 (0.6); 7.415 (0.7); 7.411 (0.6); 7.407 (0.6); 3.344 (1.7); 2.641 (16.0); 2.537 (0.5); 2.531 (1.0); 2.525 (1.4); 2.519 (1.0); 2.513 (0.5); 0.021 (2.2)

### Example V.08

¹H-NMR (400.0 MHz, d₆-DMSO): δ=8.634 (5.1); 7.482 (1.7); 7.477 (0.7); 7.463 (3.0); 7.446 (1.0); 7.442 (2.4); 7.437 (0.4); 7.307 (5.0); 7.302 (1.4); 7.283 (1.8); 7.264 (0.8); 7.215 (2.6); 7.212 (3.2); 7.193 (2.7); 3.331 (4.3); 2.642 (0.5); 2.595 (16.0); 2.508 (4.1); 2.504 (5.4); 2.499 (4.1); 0.000 (1.0)

### Example V.09

¹H-NMR (400.0 MHz, d₆-DMSO): δ=8.628 (5.2); 7.529 (0.4); 7.520 (4.0); 7.515 (1.4); 7.504 (1.5); 7.498 (4.8); 7.490 (0.6); 7.368 (5.1); 7.275 (0.6); 7.267 (4.8); 7.261 (1.6); 7.250 (1.3); 7.244 (4.0); 7.236 (0.4); 3.333 (3.7); 2.598 (16.0); 2.514 (1.8); 2.510 (3.5); 2.505 (4.6); 2.501 (3.5); 2.496 (1.7); 1.186 (0.4); 0.000 (1.2)

### Example V.10

¹H-NMR (400.0 MHz, d₆-DMSO): δ=8.299 (2.8); 8.278 (2.9); 7.549 (0.4); 7.540 (3.6); 7.535 (1.3); 7.524 (1.4); 7.518 (4.3); 7.510 (0.5); 7.297 (0.5); 7.289 (4.3); 7.284 (1.4); 7.272 (1.2); 7.267 (3.6); 7.258 (0.4); 7.178 (2.9); 7.157 (2.8); 3.329 (6.4); 2.599 (16.0); 2.508 (7.2); 2.504 (9.2); 2.499 (6.8); 0.000 (1.5)

### Example V.11

¹H-NMR (400.1 MHz, CDCl₃): δ=8.081 (2.5); 8.060 (2.6); 7.498 (2.1); 7.476 (2.3); 7.312 (2.1); 7.305 (2.2); 7.260 (6.5); 7.067 (1.4); 7.061 (1.3); 7.046 (1.3); 7.039 (1.2); 6.924 (2.7); 6.903 (2.6); 2.695 (16.0); 1.544 (0.4); 1.432 (0.6); 0.070 (1.2); 0.000 (5.1)

### Example V.12

¹H-NMR (300.2 MHz, d₆-DMSO): δ=8.382 (4.0); 8.369 (0.5); 8.354 (4.2); 8.342 (0.6); 7.808 (0.4); 7.781 (0.3); 7.563 (0.5); 7.552 (5.5); 7.545 (2.3); 7.530 (2.2); 7.523 (7.1); 7.512 (1.0); 7.313 (0.7); 7.302 (6.9); 7.294 (2.6); 7.279 (2.0); 7.272 (5.6); 7.235 (4.5); 7.206 (4.3); 7.184 (0.4); 7.155 (0.4); 5.107 (1.4); 5.081 (16.0); 3.326 (9.1); 2.598 (1.3); 2.508 (5.1); 2.502 (6.9); 2.496 (5.2); 1.247 (1.0); 0.858 (0.8); 0.000 (5.2)

### Example V.13

¹H-NMR (300.2 MHz, CDCl₃): δ=8.195 (2.5); 8.165 (2.7); 7.438 (3.2); 7.431 (1.1); 7.415 (1.2); 7.409 (4.2); 7.398 (0.5); 7.315 (2.8); 7.284 (2.6); 7.262 (15.9); 7.216 (0.5); 7.205 (4.1); 7.198 (1.3); 7.183 (1.1); 7.176 (3.3); 7.165 (0.4); 7.081 (0.4); 4.240 (1.9); 2.826 (1.9); 2.801 (16.0); 1.549 (14.2); 0.069 (3.3); 0.010 (0.5); 0.000 (18.0); −0.011 (0.9)

### Example V.14

¹H-NMR (300.2 MHz, CDCl₃): δ=8.127 (2.5); 8.099 (2.7); 7.637 (2.1); 7.608 (2.4); 7.313 (3.1); 7.300 (19.5); 7.284 (2.5); 6.961 (2.7); 6.933 (2.6); 6.911 (1.0); 6.723 (1.9); 6.535 (1.0); 2.740 (16.0); 1.585 (19.8); 1.307 (0.7); 0.921 (0.6); 0.108 (1.3); 0.049 (1.0); 0.039 (17.8); 0.028 (0.9)

### Example V.15

¹H-NMR (300.2 MHz, CDCl₃): δ=8.524 (3.9); 7.349 (5.7); 7.324 (3.8); 7.313 (1.1); 7.299 (3.9); 7.256 (1.6); 7.245 (6.1); 7.237 (1.6); 7.222 (1.9); 7.215 (3.1); 2.650 (3.2); 2.638 (16.0); 1.636 (2.4); 1.623 (14.4); 1.304 (1.6); 0.940 (0.6); 0.932 (0.6); 0.918 (1.4); 0.895 (0.5); 0.108 (0.5); 0.048 (0.5); 0.036 (3.2)

### Example V.16

¹H-NMR (300.2 MHz, CDCl₃): δ=7.931 (2.8); 7.902 (3.0); 7.885 (0.6); 7.874 (5.5); 7.867 (1.7); 7.851 (1.8); 7.844 (6.2); 7.833 (0.7); 7.368 (3.5); 7.337 (3.1); 7.300 (9.9); 7.253 (3.2); 7.225 (3.0); 2.630 (16.0); 2.628 (14.9); 1.589 (11.0); 0.109 (1.9); 0.049 (0.3); 0.038 (10.2); 0.027 (0.4)

### Example V.17

¹H-NMR (300.2 MHz, CDCl₃): δ=7.918 (2.8); 7.890 (3.0); 7.792 (0.4); 7.745 (3.7); 7.717 (4.3); 7.645 (0.5); 7.618 (0.3); 7.376 (4.1); 7.348 (3.5); 7.300 (15.0); 7.232 (3.3); 7.204 (3.0); 2.627 (16.0); 2.625 (15.1); 1.588 (12.4); 0.109 (2.9); 0.049 (0.5); 0.038 (14.9); 0.027 (0.5)

### Example V.18

¹H-NMR (300.2 MHz, CDCl₃): δ=8.654 (0.6); 8.527 (3.9); 7.752 (1.9); 7.724 (2.1); 7.491 (0.7); 7.315 (2.0); 7.300 (2.3); 7.287 (1.8); 7.104 (4.2); 2.716 (2.7); 2.692 (16.0); 1.614 (2.8); 0.109 (0.5); 0.037 (2.0)

### Example V.19

¹H-NMR (499.9 MHz, d₆-DMSO): δ=8.898 (4.8); 8.651 (0.4); 7.631 (0.4); 7.624 (3.7); 7.607 (4.4); 7.600 (0.9); 7.582 (0.5); 7.387 (0.5); 7.380 (4.7); 7.363 (4.1); 7.357 (0.6); 7.152 (5.1); 6.827 (0.5); 3.318 (1.2); 2.696 (16.0); 2.641 (1.6); 2.606 (15.0); 2.507 (0.8); 1.230 (0.3); 0.877 (0.3)

### Example V.20

¹H-NMR (300.2 MHz, CDCl₃): δ=7.882 (2.9); 7.853 (3.1); 7.599 (0.7); 7.588 (6.6); 7.581 (2.1); 7.566 (2.2); 7.558 (7.3); 7.548 (0.7); 7.300 (14.6); 7.165 (3.4); 7.151 (0.9); 7.141 (8.3); 7.118 (2.1); 7.111 (6.4); 7.100 (0.6); 2.615 (16.0); 2.613 (15.2); 1.589 (10.9); 1.345 (0.6); 1.306 (3.4); 0.942 (1.2); 0.921 (4.0); 0.897 (1.5); 0.108 (0.9); 0.049 (0.5); 0.038 (14.0); 0.027 (0.5)

### Example V.21

¹H-NMR (400.0 MHz, d₆-DMSO): δ=8.288 (2.9); 8.267 (3.0); 7.500 (1.6); 7.496 (0.8); 7.480 (3.0); 7.461 (2.4); 7.320 (1.1); 7.301 (1.8); 7.283 (0.8); 7.234 (2.6); 7.232 (3.2); 7.213 (2.6); 7.116 (3.1); 7.095 (2.9); 3.331 (5.0); 2.619 (0.8); 2.598 (16.0); 2.508 (5.0); 2.504 (6.5); 2.500 (4.9); 0.000 (1.1)

### Example V.22

¹H-NMR (399.8 MHz, CDCl₃): δ=8.488 (4.8); 7.405 (3.7); 7.383 (4.1); 7.261 (3.4); 7.098 (4.3); 7.076 (3.6); 7.002 (4.5); 2.642 (16.0); 1.565 (1.2); 1.432 (0.4); −0.001 (3.6)

### Example V.23

¹H-NMR (499.9 MHz, CDCl₃): δ=8.329 (4.9); 7.430 (0.4); 7.424 (3.6); 7.406 (4.1); 7.400 (0.5); 7.262 (2.5); 7.155 (0.5); 7.148 (4.1); 7.131 (3.6); 7.125 (0.4); 2.684 (16.0); 1.572 (7.9); 0.000 (2.7)

### Example V.24

¹H-NMR (499.9 MHz, CDCl₃): δ=8.389 (2.5); 8.373 (3.4); 8.371 (3.2); 8.354 (2.6); 8.323 (0.4); 8.306 (0.4); 7.412 (0.9); 7.406 (7.3); 7.402 (2.7); 7.392 (2.9); 7.388 (8.4); 7.382 (1.2); 7.372 (0.4); 7.262 (4.5); 7.247 (0.6); 7.229 (0.6); 7.203 (0.5); 7.185 (0.6); 7.124 (1.1); 7.117 (8.4); 7.113 (3.0); 7.104 (2.7); 7.099 (7.5); 7.093 (1.2); 6.934 (0.6); 6.916 (0.5); 6.884 (0.6); 6.864 (3.2); 6.861 (3.1); 6.847 (3.1); 6.844 (3.1); 6.626 (0.4); 6.610 (0.4); 3.769 (0.4); 3.350 (0.3); 2.734 (0.7); 2.708 (2.3); 2.643 (0.7); 2.618 (15.7); 2.609 (16.0); 2.559 (0.9); 1.580 (11.1); 1.431 (0.7); 1.345 (0.4); 0.000 (4.3)

### Example V.25

¹H-NMR (300.2 MHz, CDCl₃): δ=8.519 (3.7); 7.775 (2.6); 7.746 (3.0); 7.381 (4.0); 7.341 (2.8); 7.313 (2.6); 7.300 (8.1); 2.675 (0.8); 2.646 (16.0); 1.598 (15.8); 0.108 (1.3); 0.038 (7.2)

### Example V.26

¹H-NMR (299.9 MHz, CDCl₃): δ=8.066 (2.6); 8.037 (2.6); 7.410 (0.5); 7.399 (3.4); 7.377 (1.6); 7.370 (4.0); 7.257 (6.1); 7.132 (0.6); 7.121 (4.2); 7.098 (1.4); 7.092 (3.2); 6.882 (2.8); 6.854 (2.6); 2.689 (16.0); 1.555 (7.5); −0.005 (5.4)

### Example V.27

¹H-NMR (300.2 MHz, CDCl₃): δ=8.517 (3.6); 7.627 (0.5); 7.617 (4.6); 7.610 (1.5); 7.594 (1.6); 7.587 (5.0); 7.577 (0.6); 7.330 (4.0); 7.299 (5.4); 7.119 (0.6)); 77.108 (5.2) 1 (1.6); 7.085 (1.5); 7.078 (4.5); 7.068 (0.5); 2.635 (16.0); 1.590 (2.6); 0.109 (0.5); 0.039 (5.4)

### Example V.28

¹H-NMR (300.2 MHz, d₆-DMSO): δ=8.316 (2.6); 8.288 (2.7); 7.500 (1.5); 7.472 (2.5); 7.404 (0.6); 7.392 (4.5); 7.385 (1.3); 7.370 (0.9); 7.362 (2.6); 7.274 (0.3); 7.206 (2.7); 7.178 (2.6); 3.324 (27.4); 2.667 (0.5); 2.642 (0.3); 2.618 (0.5); 2.601 (16.0); 2.513 (5.3); 2.507 (11.4); 2.501 (16.0); 2.495 (12.0); 2.490 (6.0); 0.000 (9.9)

### Example V.29

¹H-NMR (300.2 MHz, CDCl₃): δ=8.068 (2.6); 8.040 (2.7); 7.263 (12.9); 7.148 (1.9); 7.118 (2.4); 7.020 (1.9); 7.010 (2.1); 6.882 (1.4); 6.875 (2.9); 6.872 (1.6); 6.852 (1.3); 6.847 (2.8); 6.843 (1.2); 5.302 (5.1); 3.833 (13.6); 2.796 (0.5); 2.709 (0.4); 2.691 (16.0); 2.681 (0.5); 2.048 (0.8); 1.565 (16.4); 1.432 (0.5); 1.261 (0.5); 0.070 (2.6); 0.011 (0.4); 0.000 (11.7); −0.011 (0.5)

### Example V.30

1H-NMR (300.2 MHz, CDCl3): δ=8.115 (2.5); 8.087 (2.6); 7.839 (2.5); 7.832 (0.8); 7.816 (0.8); 7.809 (2.8); 7.798 (0.4); 7.290 (1.5); 7.263 (3.6); 6.982 (2.7); 6.954 (2.5); 2.720 (1.2); 2.716 (0.4); 2.708 (16.0); 2.698 (0.5); 1.432 (0.5); 0.072 (0.5); 0.000 (2.9)

### Example V.31

1H-NMR (300.2 MHz, CDCl3): δ=7.931 (2.8); 7.902 (3.0); 7.355 (3.3); 7.327 (3.0); 7.300 (15.7); 7.142 (0.8); 7.131 (1.4); 7.125 (2.2); 7.121 (6.6); 7.097 (6.5); 7.093 (2.1); 7.086 (1.3); 7.076 (0.7); 2.620 (15.4); 2.618 (16.0); 1.585 (4.9); 0.109 (2.3); 0.050 (0.7); 0.039 (17.2); 0.028 (0.8)

### Example V.32

1H-NMR (300.2 MHz, CDCl₃): δ=7.899 (2.8); 7.898 (2.8); 7.871 (3.0); 7.870 (3.0); 7.626 (3.3); 7.597 (4.1); 7.337 (4.6); 7.308 (3.7); 7.300 (3.0); 7.193 (3.2); 7.192 (3.2); 7.165 (3.0); 7.164 (3.0); 6.908 (1.7); 6.720 (3.5); 6.532 (1.8); 3.200 (0.8); 2.617 (15.6); 2.615 (16.0); 1.630 (0.3); 1.469 (0.9); 1.381 (0.4); 1.268 (0.5); 1.247 (0.5); 0.036 (2.4)

### Example V.33

1H-NMR (499.9 MHz, CDCl₃): δ=8.094 (5.1); 7.263 (2.3); 7.251 (0.5); 7.245 (3.7); 7.241 (1.5); 7.231 (1.7); 7.227 (6.9); 7.222 (1.9); 7.212 (1.3); 7.208 (4.2); 7.202 (0.5); 6.940 (0.5); 6.934 (4.1); 6.930 (1.6); 6.920 (1.7); 6.916 (4.7); 6.914 (5.3); 6.910 (2.0); 6.900 (1.3); 6.896 (3.7); 6.890 (0.4); 2.729 (0.4); 2.716 (16.0); 1.594 (6.2); 0.000 (2.4)

### Example V.34

1H-NMR (300.2 MHz, CDCl₃): δ=8.138 (1.9); 8.110 (2.0); 7.599 (0.5); 7.588 (4.5); 7.581 (1.5); 7.566 (1.8); 7.559 (5.0); 7.548 (0.7); 7.358 (0.3); 7.302 (11.2); 7.264 (1.6); 7.169 (0.7); 7.159 (5.1); 7.151 (1.6); 7.136 (1.7); 7.129 (4.4); 7.118 (0.6); 7.095 (2.2); 7.083 (3.4); 7.067 (2.0); 6.902 (1.6); 3.789 (0.4); 3.558 (0.4); 3.450 (0.4); 2.694 (0.5); 2.685 (0.6); 2.661 (16.0); 1.895 (0.5); 1.595 (1.1); 1.473 (0.4); 1.293 (0.6); 0.110 (1.0); 0.051 (0.6); 0.040 (11.7); 0.029 (0.6)

### Example V.35

1H-NMR (300.2 MHz, CDCl₃): δ=7.895 (2.8); 7.893 (2.8); 7.866 (3.0); 7.865 (3.0); 7.328 (1.6); 7.321 (0.9); 7.318 (0.8); 7.299 (7.0); 7.297 (6.5); 7.284 (2.4); 7.276 (10.4); 7.267 (1.8); 7.255 (1.3); 7.245 (2.1); 7.238 (0.4); 7.180 (3.3); 7.179 (3.3); 7.152 (3.0); 7.151 (3.0); 2.615 (15.9); 2.612 (16.0); 1.627 (0.4); 1.468 (1.2); 0.111 (0.4); 0.036 (1.7)

### Example V.36

1H-NMR (300.2 MHz, CDCl₃): δ=8.768 (2.5); 7.690 (1.0); 7.628 (0.4); 7.617 (3.5); 7.610 (1.1); 7.595 (1.2); 7.587 (3.8); 7.577 (0.4); 7.508 (2.0); 7.407 (2.6); 7.326 (1.0); 7.298 (4.7); 7.126 (0.4); 7.115 (4.0); 7.108 (1.1); 7.093 (1.1); 7.086 (3.4); 7.075 (0.3); 2.648 (16.0); 1.594 (3.9); 0.107 (0.3); 0.037 (4.5)

### Example V.37

1H-NMR (300.2 MHz, CDCl₃): δ=8.769 (2.6); 7.692 (1.0); 7.510 (2.1); 7.479 (0.3); 7.469 (3.3); 7.462 (1.1); 7.446 (1.2); 7.439 (4.0); 7.428 (0.4); 7.407 (2.7); 7.328 (1.1); 7.298 (23.0); 7.179 (0.4); 7.168 (4.1); 7.161 (1.2); 7.146 (1.0); 7.139 (3.3); 2.648 (16.0); 1.581 (20.7); 0.107 (2.5); 0.048 (0.7); 0.037 (22.4); 0.027 (0.9)

### Example V.38

1H-NMR (300.2 MHz, CDCl₃): δ=7.904 (2.8); 7.903 (2.8); 7.876 (3.1); 7.300 (2.5); 7.288 (1.7); 7.287 (1.7); 7.281 (2.1); 7.265 (1.1); 7.258 (3.8); 7.252 (2.6); 7.247 (2.2); 7.238 (3.6); 7.231 (3.7); 7.230 (3.7); 7.226 (3.7); 7.221 (7.3); 7.217 (4.6); 7.197 (0.6); 7.190 (0.5); 2.610 (16.0); 2.608 (15.9); 1.715 (0.7); 1.469 (1.2); 0.036 (2.4)

### Example V.40

1H-NMR (300.2 MHz, d6-DMSO): δ=9.719 (2.7); 8.342 (5.8); 8.314 (6.2); 7.712 (1.3); 7.701 (13.7); 7.694 (4.4); 7.678 (4.6); 7.671 (15.5); 7.660 (1.6); 7.492 (6.7); 7.463 (6.3); 7.350 (2.1); 7.342 (0.7); 7.327 (0.7); 7.320 (2.3); 7.309 (0.5); 7.302 (1.7); 7.291 (16.0); 7.284 (4.7); 7.269 (4.3); 7.261 (13.5); 7.250 (1.3); 6.762 (2.5); 6.754 (0.7); 6.739 (0.7); 6.732 (2.2); 3.356 (19.8); 2.541 (3.5); 2.535 (7.6); 2.529 (10.5); 2.523 (7.7); 2.516 (4.1); 2.499 (1.9); 2.489 (2.2); 2.485 (1.5); 2.474 (3.6); 2.467 (1.7); 2.458 (2.1); 2.449 (2.1); 2.433 (1.0); 1.361 (0.3); 1.240 (0.4); 1.233 (1.0); 1.216 (3.2); 1.205 (7.7); 1.198 (4.3); 1.190 (3.1); 1.179 (8.5); 1.172 (5.1); 1.169 (5.1); 1.161 (7.4); 1.146 (9.3); 1.135 (3.5); 1.117 (0.9); 0.035 (0.3); 0.025 (9.6); 0.014 (0.4)

### Example V.41

1H-NMR (300.2 MHz, CDCl₃): δ=7.931 (5.8); 7.903 (6.2); 7.453 (1.2); 7.442 (12.6); 7.434 (4.2); 7.419 (4.6); 7.412 (16.0); 7.401 (1.7); 7.301 (28.1); 7.246 (1.1); 7.239 (0.4); 7.224 (0.5); 7.217 (1.5); 7.212 (1.9); 7.202 (16.3); 7.194 (4.7); 7.179 (4.2); 7.172 (12.8); 7.166 (7.5); 7.138 (6.2); 6.820 (1.3); 6.812 (0.4); 6.797 (0.3); 6.790 (1.1); 4.825 (1.3); 2.366 (0.8); 2.351 (1.8); 2.340 (2.0); 2.325 (3.7); 2.311 (2.1); 2.300 (2.0); 2.285 (1.0); 1.592 (13.5); 1.471 (0.5); 1.407 (1.7); 1.393 (5.8); 1.381 (9.6); 1.367 (7.2); 1.356 (2.4); 1.320 (0.5); 1.306 (0.6); 1.294 (0.5); 1.277 (0.5); 1.251 (0.4); 1.228 (2.5); 1.216 (7.5); 1.205 (5.4); 1.202 (5.7); 1.190 (8.3); 1.183 (3.7); 1.179 (4.6); 1.163 (3.2); 0.110 (3.1); 0.051 (1.0); 0.040 (30.8); 0.029 (1.1)

### Example V.44

1H-NMR (300.2 MHz, d6-DMSO): δ=8.362 (9.6); 8.333 (10.2); 7.726 (11.4); 7.698 (14.0); 7.525 (11.0); 7.497 (10.4); 7.444 (16.0); 7.415 (13.0); 7.298 (5.7); 7.111 (12.3); 6.925 (6.0); 5.785 (0.9); 3.360 (11.1); 3.146 (1.1); 2.541 (2.8); 2.535 (6.1); 2.529 (8.7); 2.523 (7.6); 2.517 (3.3); 2.507 (3.1); 2.498 (3.6); 2.493 (2.5); 2.482 (6.0); 2.475 (2.6); 2.466 (3.4); 2.457 (3.5); 2.441 (1.6); 1.246 (0.6); 1.238 (1.6); 1.220 (5.1); 1.210 (12.9); 1.202 (7.0); 1.194 (4.8); 1.184 (14.4); 1.176 (10.9); 1.168 (12.6); 1.158 (10.7); 1.152 (15.7); 1.141 (5.6); 1.124 (1.4); 1.109 (0.4); 0.023 (10.1); 0.012 (0.4)

### Example V.45

1H-NMR (300.2 MHz, CDCl₃): δ=7.806 (3.4); 7.778 (3.7); 7.432 (0.9); 7.422 (7.3); 7.414 (2.4); 7.399 (2.7); 7.392 (9.2); 7.381 (1.0); 7.297 (1.4); 7.213 (0.6); 7.191 (1.3); 7.181 (9.6); 7.173 (2.8); 7.158 (2.5); 7.151 (7.3); 7.143 (4.5); 7.115 (3.7); 6.805 (0.7); 6.775 (0.6); 2.902 (1.7); 2.878 (5.3); 2.854 (5.5); 2.830 (1.9); 1.388 (0.5); 1.363 (0.8); 1.337 (0.4); 1.297 (0.4); 1.259 (8.1); 1.235 (16.0); 1.211 (7.6); 0.911 (0.4); 0.031 (1.3)

### Example V.46

1H-NMR (300.2 MHz, CDCl₃): δ=7.814 (3.5); 7.785 (3.8); 7.433 (0.7); 7.423 (7.5); 7.415 (2.6); 7.400 (2.8); 7.393 (9.2); 7.382 (1.0); 7.302 (1.1); 7.210 (0.4); 7.194 (1.1); 7.184 (9.7); 7.176 (2.8); 7.161 (2.6); 7.154 (7.3); 7.144 (4.7); 7.116 (3.8); 6.806 (0.4); 6.776 (0.3); 2.855 (3.5); 2.831 (7.0); 2.807 (3.9); 1.827 (0.8); 1.802 (2.9); 1.778 (5.4); 1.753 (5.3); 1.729 (2.8); 1.705 (0.7); 1.689 (0.8); 1.044 (8.2); 1.019 (16.0); 0.994 (7.3); 0.034 (1.0)

### Example V.47

1H-NMR (300.2 MHz, CDCl₃): δ=7.816 (1.8); 7.788 (2.0); 7.441 (0.4); 7.431 (3.7); 7.423 (1.2); 7.408 (1.4); 7.401 (4.6); 7.390 (0.5); 7.302 (1.0); 7.199 (0.6); 7.188 (4.7); 7.181 (1.4); 7.166 (1.3); 7.159 (3.6); 7.148 (2.4); 7.119 (1.9); 2.760 (3.6); 2.737 (3.9); 2.337 (0.4); 2.314 (0.9); 2.292 (1.1); 2.270 (0.9); 2.247 (0.5); 1.625 (1.5); 1.039 (16.0); 1.017 (15.5); 0.989 (0.5); 0.967 (0.4); 0.038 (0.9)

### Example V.48

1H-NMR (300.2 MHz, CDCl₃): δ=7.812 (3.3); 7.784 (3.6); 7.678 (0.4); 7.652 (0.4); 7.449 (0.7); 7.438 (7.2); 7.431 (2.4); 7.416 (3.0); 7.408 (8.9); 7.398 (1.1); 7.391 (0.6); 7.301 (24.8); 7.248 (1.2); 7.240 (0.4); 7.225 (0.5); 7.218 (1.4); 7.203 (1.1); 7.192 (9.2); 7.184 (2.6); 7.169 (2.5); 7.162 (7.0); 7.152 (4.4); 7.124 (3.6); 6.821 (1.5); 6.814 (0.4); 6.799 (0.4); 6.791 (1.2); 4.802 (0.7); 2.948 (0.4); 2.922 (0.5); 2.895 (0.5); 2.878 (3.3); 2.854 (6.1); 2.829 (3.6); 1.771 (1.2); 1.747 (3.0); 1.722 (3.7); 1.697 (2.7); 1.672 (1.2); 1.592 (17.5); 1.488 (0.7); 1.464 (2.2); 1.439 (3.2); 1.413 (3.3); 1.389 (2.2); 1.365 (0.8); 1.307 (1.2); 1.013 (1.0); 1.001 (8.2); 0.989 (2.2); 0.976 (16.0); 0.965 (1.2); 0.952 (6.6); 0.922 (1.3); 0.899 (0.5); 0.110 (2.8); 0.051 (0.9); 0.040 (26.0); 0.029 (1.0)

### Example VI.01

¹H-NMR (300.2 MHz, CDCl₃): δ=7.879 (3.4); 7.851 (3.7); 7.460 (0.8); 7.449 (7.5); 7.442 (2.6); 7.427 (2.9); 7.419 (9.5); 7.409 (1.2); 7.300 (21.9); 7.246 (0.6); 7.216 (1.1); 7.210 (5.0); 7.199 (9.8); 7.192 (3.2); 7.180 (4.3); 7.177 (3.8); 7.169 (7.6); 7.158 (0.8); 6.819 (0.7); 6.790 (0.6); 4.798 (0.8); 4.509 (16.0); 2.616 (0.5); 1.587 (40.4); 1.347 (0.5); 1.306 (2.2); 0.942 (0.8); 0.921 (2.5); 0.897 (0.9); 0.108 (1.6); 0.049 (0.8); 0.039 (26.1); 0.028 (1.1)

### Example VI.03

¹H-NMR (299.9 MHz, d₆-DMSO): δ=8.367 (4.1); 8.338 (4.3); 7.511 (1.7); 7.505 (0.8); 7.486 (3.3); 7.465 (1.2); 7.459 (2.8); 7.451 (0.5); 7.336 (0.7); 7.332 (1.4); 7.328 (0.9); 7.307 (2.0); 7.302 (0.7); 7.286 (0.5); 7.283 (0.8); 7.279 (0.5); 7.244 (2.9); 7.240 (3.8); 7.233 (1.1); 7.218 (1.7); 7.215 (2.9); 7.212 (2.5); 7.171 (4.2); 7.142 (4.1); 5.077 (16.0); 3.318 (33.7); 2.513 (4.2); 2.507 (9.0); 2.501 (12.4); 2.495 (9.1); 2.489 (4.4); 0.000 (4.6)

### Example VI.04

¹H-NMR (399.8 MHz, CDCl₃): δ=8.091 (3.3); 8.090 (3.9); 8.069 (4.0); 7.417 (0.7); 7.409 (5.3); 7.404 (1.9); 7.392 (2.8); 7.387 (5.6); 7.381 (0.9); 7.379 (0.9); 7.262 (6.3); 7.260 (7.5); 7.135 (0.9); 7.128 (6.2); 7.122 (2.2); 7.110 (2.6); 7.106 (4.9); 7.100 (0.8); 6.937 (4.0); 6.918 (3.4); 6.916 (3.9); 4.761 (13.8); 4.759 (16.0); 2.693 (0.7); 1.575 (1.1); 0.001 (6.9); 0.000 (7.6)

### Example VI.05

¹H-NMR (299.9 MHz, CDCl₃): δ=8.504 (5.4); 7.484 (0.4); 7.476 (1.7); 7.470 (0.8); 7.451 (3.5); 7.430 (1.2); 7.424 (2.9); 7.416 (0.5); 7.313 (1.4); 7.309 (0.9); 7.288 (2.1); 7.259 (5.4); 7.162 (2.9); 7.158 (3.8); 7.152 (1.1); 7.133 (2.9); 7.003 (5.7); 4.662 (0.3); 4.650 (16.0); 1.546 (2.7); 0.000 (5.4)

### Example VI.06

¹H-NMR (299.9 MHz, CDCl₃): δ=8.473 (6.4); 7.428 (0.6); 7.417 (4.5); 7.411 (1.7); 7.395 (1.8); 7.388 (5.9); 7.377 (0.6); 7.260 (12.9); 7.120 (0.7); 7.109 (5.6); 7.102 (1.9); 7.086 (1.6); 7.079 (4.9); 7.069 (0.5); 7.037 (6.7); 4.646 (16.0); 1.543 (12.4); 1.254 (0.4); 0.010 (0.7); 0.009 (0.7); 0.000 (12.0); −0.011 (0.4)

### Example VI.07

¹H-NMR (300.2 MHz, CDCl₃): δ=8.111 (0.7); 8.092 (3.8); 8.083 (0.8); 8.064 (4.0); 7.512 (3.5); 7.483 (4.0); 7.323 (3.2); 7.315 (3.5); 7.265 (2.2); 7.084 (2.3); 7.075 (2.1); 7.054 (2.0); 7.045 (1.9); 6.983 (0.8); 6.976 (4.1); 6.955 (0.8); 6.948 (3.9); 4.760 (2.6); 4.569 (16.0); 4.559 (0.3); 4.542 (0.5); 2.045 (0.9); 1.259 (0.7); 0.074 (1.1); 0.000 (1.1)

### Example VI.08

¹H-NMR (300.2 MHz, CDCl₃): δ=8.110 (3.7); 8.081 (3.9); 7.608 (0.5); 7.305 (1.9); 7.274 (4.5); 7.263 (78.5); 7.232 (1.2); 7.221 (6.8); 7.213 (1.8); 7.198 (1.4); 7.191 (3.1); 6.963 (4.0); 6.935 (3.9); 6.911 (0.4); 4.767 (16.0); 4.723 (0.6); 3.678 (0.3); 1.569 (243.3); 1.456 (0.4); 1.336 (0.4); 1.300 (0.5); 1.253 (1.6); 0.882 (0.6); 0.195 (0.4); 0.081 (0.9); 0.069 (26.9); 0.057 (1.4); 0.011 (2.6); 0.000 (76.2); −0.011 (3.7)

### Example VI.09

¹H-NMR (300.2 MHz, CDCl₃): δ=8.409 (0.5); 8.381 (0.6); 8.094 (3.8); 8.065 (4.2); 8.039 (0.5); 7.263 (21.4); 7.139 (14.5); 7.133 (2.7); 7.120 (7.1); 7.117 (7.4); 7.087 (0.4); 6.975 (1.3); 6.954 (2.1); 6.921 (4.9); 6.897 (2.5); 6.893 (4.2); 6.864 (0.5); 6.836 (0.4); 6.665 (0.6); 6.638 (0.5); 4.852 (2.1); 4.767 (16.0); 2.694 (2.6); 1.571 (75.5); 1.306 (0.9); 1.266 (5.7); 0.904 (2.0); 0.882 (6.1); 0.859 (2.4); 0.070 (1.8); 0.011 (0.7); 0.000 (20.9); −0.011 (1.1)

### Example VI.10

¹H-NMR (300.2 MHz, CDCl₃): δ=8.381 (7.3); 7.494 (0.5); 7.483 (4.7); 7.476 (1.5); 7.461 (1.7); 7.454 (5.8); 7.443 (0.6); 7.300 (15.7); 7.209 (0.7); 7.198 (5.8); 7.191 (1.8); 7.176 (1.5); 7.169 (4.6); 7.158 (0.4); 5.339 (0.6); 4.954 (16.0); 3.371 (0.4); 1.580 (7.4); 0.108 (5.5); 0.049 (0.6); 0.039 (16.3); 0.028 (0.6)

### Example VI.11

¹H-NMR (300.2 MHz, CDCl₃): δ=8.035 (2.7); 8.007 (2.9); 7.420 (0.6); 7.409 (5.8); 7.402 (2.0); 7.387 (2.4); 7.379 (7.3); 7.369 (1.0); 7.262 (14.2); 7.173 (1.4); 7.162 (7.0); 7.155 (2.2); 7.140 (2.1); 7.132 (5.4); 7.121 (0.7); 7.093 (2.7); 7.065 (2.6); 7.049 (2.2); 6.903 (0.4); 6.868 (4.1); 6.687 (2.1); 4.569 (16.0); 4.322 (1.6); 3.500 (0.6); 1.558 (39.3); 1.260 (0.8); 0.882 (0.7); 0.070 (7.3); 0.058 (0.4); 0.011 (0.7); 0.000 (17.8); −0.011 (0.9)

### Example VI.12

¹H-NMR (300.2 MHz, CDCl₃): δ=8.421 (3.7); 8.393 (3.8); 7.413 (0.5); 7.403 (4.8); 7.396 (1.9); 7.380 (2.0); 7.373 (6.4); 7.363 (0.9); 7.342 (0.5); 7.262 (9.5); 7.153 (0.5); 7.142 (0.9); 7.132 (6.0); 7.125 (2.2); 7.109 (1.9); 7.102 (4.9); 7.091 (0.6); 6.925 (3.5); 6.897 (3.3); 6.807 (0.4); 4.722 (0.3); 4.713 (0.3); 4.668 (16.0); 3.916 (0.5); 3.896 (0.9); 3.214 (2.9); 2.617 (0.8); 1.550 (6.0); 1.306 (0.5); 1.266 (3.1); 0.903 (1.1); 0.882 (3.4); 0.858 (1.3); 0.070 (2.1); 0.011 (0.4); 0.000 (10.9); −0.011 (0.5)

### Example VI.13

¹H-NMR (300.2 MHz, CDCl₃): δ=8.100 (2.8); 8.072 (3.0); 7.262 (6.1); 7.149 (2.2); 7.120 (2.7); 7.023 (2.2); 7.013 (2.5); 6.936 (3.1); 6.908 (3.0); 6.886 (1.6); 6.876 (1.5); 6.856 (1.3); 6.847 (1.3); 4.775 (11.9); 3.835 (16.0); 2.690 (0.6); 1.563 (11.7); 1.266 (0.7); 1.260 (0.7); 0.882 (0.8); 0.000 (6.6)

### Example VI.14

¹H-NMR (300.2 MHz, CDCl₃): δ=8.540 (4.2); 8.518 (0.5); 7.489 (0.5); 7.478 (5.3); 7.470 (1.9); 7.455 (2.0); 7.448 (6.5); 7.438 (1.2); 7.376 (4.6); 7.329 (0.5); 7.300 (25.9); 7.186 (0.7); 7.176 (6.5); 7.168 (2.0); 7.161 (0.9); 7.153 (2.0); 7.146 (5.1); 7.135 (0.7); 7.131 (0.6); 5.504 (0.4); 4.365 (16.0); 2.636 (1.6); 1.584 (37.7); 1.294 (0.4); 0.109 (2.6); 0.050 (1.0); 0.039 (28.1); 0.028 (1.2)

### Example VI.15

¹H-NMR (300.2 MHz, CDCl₃): δ=8.759 (0.6); 8.540 (4.4); 8.517 (0.7); 7.638 (0.7); 7.633 (1.2); 7.627 (5.8); 7.620 (2.1); 7.617 (1.4); 7.610 (0.9); 7.604 (2.5); 7.597 (6.3); 7.587 (1.6); 7.398 (0.7); 7.377 (4.8); 7.330 (0.7); 7.300 (7.5); 7.133 (0.9); 7.130 (1.2); 7.123 (6.5); 7.115 (2.0); 7.108 (1.5); 7.100 (2.6); 7.093 (5.6); 7.082 (0.8); 7.079 (1.0); 6.454 (1.2); 4.366 (16.0); 2.636 (2.7); 1.587 (4.6); 1.306 (1.6); 0.943 (0.6); 0.921 (1.8); 0.898 (0.7); 0.110 (0.7); 0.039 (6.9)

### Example VI.16

¹H-NMR (300.2 MHz, CDCl₃): δ=8.150 (3.8); 8.122 (4.0); 7.646 (2.9); 7.618 (3.3); 7.320 (3.7); 7.300 (17.0); 7.292 (3.4); 7.014 (4.0); 6.986 (3.8); 6.916 (1.4); 6.728 (2.9); 6.540 (1.5); 4.803 (16.0); 4.197 (0.4); 4.173 (1.3); 4.149 (1.3); 4.126 (0.5); 2.739 (1.2); 2.085 (5.9); 1.581 (7.3); 1.322 (1.6); 1.299 (3.2); 1.275 (1.5); 0.108 (1.3); 0.049 (0.5); 0.039 (16.8); 0.028 (0.6)

### Example VI.17

¹H-NMR (300.2 MHz, CDCl₃): δ=8.131 (1.1); 8.103 (1.2); 7.646 (1.0); 7.618 (1.2); 7.324 (1.3); 7.300 (8.7); 7.007 (1.2); 6.979 (1.1); 6.917 (0.5); 6.728 (0.9); 6.540 (0.5); 4.615 (4.6); 4.588 (0.4); 2.740 (0.8); 2.085 (0.9); 1.580 (3.7); 1.370 (1.2); 1.346 (2.7); 1.306 (15.9); 0.943 (5.6); 0.922 (16.0); 0.898 (6.3); 0.109 (0.6); 0.050 (0.4); 0.039 (8.0); 0.029 (0.4)

### Example VI.18

¹H-NMR (300.2 MHz, CDCl₃): δ=7.599 (0.5); 7.570 (0.6); 7.300 (5.0); 7.151 (0.6); 7.121 (0.5); 4.337 (1.2); 2.086 (0.5); 1.579 (2.4); 1.370 (0.9); 1.347 (2.1); 1.307 (13.6); 0.944 (5.0); 0.922 (16.0); 0.899 (5.9); 0.040 (5.0)

### Example VI.19

¹H-NMR (300.2 MHz, CDCl₃): δ=7.972 (0.4); 7.944 (0.4); 7.881 (3.4); 7.852 (3.7); 7.609 (0.9); 7.599 (8.7); 7.591 (2.7); 7.576 (3.1); 7.569 (9.6); 7.558 (1.2); 7.358 (0.3); 7.300 (29.3); 7.212 (3.9); 7.183 (4.1); 7.158 (1.4); 7.153 (2.2); 7.147 (9.3); 7.140 (2.8); 7.125 (3.3); 7.118 (7.6); 7.107 (0.8); 6.777 (0.3); 4.511 (16.0); 4.301 (2.0); 3.948 (0.4); 3.303 (1.5); 2.617 (0.4); 1.588 (24.4); 1.367 (0.4); 1.344 (0.9); 1.305 (5.0); 0.942 (1.8); 0.920 (5.8); 0.897 (2.1); 0.108 (2.5); 0.049 (1.0); 0.038 (29.1); 0.027 (1.1)

### Example VI.20

¹H-NMR (300.2 MHz, CDCl₃): δ=8.521 (3.8); 8.493 (4.8); 8.490 (4.6); 8.462 (3.9); 8.453 (0.7); 8.425 (0.7); 7.477 (1.1); 7.466 (10.0); 7.458 (3.3); 7.443 (3.7); 7.436 (12.2); 7.425 (1.6); 7.300 (40.9); 7.284 (0.5); 7.276 (1.0); 7.251 (0.8); 7.229 (0.3); 7.221 (1.0); 7.178 (1.5); 7.167 (12.2); 7.160 (3.8); 7.144 (3.3); 7.137 (9.6); 7.126 (1.0); 6.984 (4.3); 6.978 (4.9); 6.956 (4.4); 6.950 (4.9); 6.950 (4.9); 6.922 (1.0); 6.914 (0.4); 6.892 (0.8); 6.729 (0.7); 6.700 (0.6); 4.876 (3.1); 4.729 (16.0); 4.719 (16.0); 4.416 (0.4); 4.410 (0.4); 2.665 (0.5); 2.649 (0.6); 1.581 (19.3); 1.369 (0.5); 1.347 (0.9); 1.306 (5.0); 0.943 (1.8); 0.921 (5.7); 0.898 (2.1); 0.120 (0.5); 0.108 (12.2); 0.096 (0.5); 0.050 (1.7); 0.039 (44.7); 0.028 (1.7)

### Example VI.21

¹H-NMR (300.2 MHz, CDCl₃): δ=8.573 (0.5); 8.490 (4.7); 7.397 (5.0); 7.363 (2.3); 7.334 (4.1); 7.300 (5.5); 7.269 (1.0); 7.258 (7.4); 7.250 (1.9); 7.235 (1.5); 7.228 (3.9); 7.217 (0.4); 7.159 (0.6); 6.870 (0.5); 6.839 (0.4); 4.586 (1.8); 4.554 (16.0); 4.091 (2.8); 3.898 (0.7); 3.309 (2.1); 2.640 (0.6); 1.605 (3.4); 1.305 (0.9); 0.920 (1.0); 0.897 (0.4); 0.110 (0.9); 0.038 (5.4)

### Example VI.22

¹H-NMR (300.2 MHz, CDCl₃): δ=8.484 (3.0); 7.785 (2.2); 7.756 (2.6); 7.427 (3.3); 7.354 (2.4); 7.326 (2.2); 7.300 (8.2); 5.339 (0.4); 4.586 (0.9); 4.556 (10.7); 4.090 (1.5); 3.314 (0.7); 2.646 (1.0); 1.600 (16.0); 1.346 (0.4); 1.305 (2.1); 0.942 (0.8); 0.920 (2.4); 0.897 (0.9); 0.108 (1.6); 0.038 (7.6)

### Example VI.23

¹H-NMR (300.2 MHz, CDCl₃): δ=8.573 (0.4); 8.482 (3.4); 7.637 (0.4); 7.626 (4.2); 7.619 (1.4); 7.604 (1.4); 7.597 (4.6); 7.587 (0.6); 7.378 (3.8); 7.356 (0.5); 7.300 (8.1); 7.159 (0.4); 7.128 (0.5); 7.117 (4.7); 7.110 (1.4); 7.095 (1.3); 7.088 (4.0); 7.078 (0.5); 6.775 (0.5); 6.745 (0.5); 4.921 (0.4); 4.586 (1.4); 4.552 (12.1); 4.090 (2.1); 2.636 (0.6); 1.602 (16.0); 1.304 (0.9); 0.942 (0.3); 0.920 (1.0); 0.897 (0.4); 0.108 (1.5); 0.038 (7.5)

### Example VI.24

¹H-NMR (300.2 MHz, d₆-DMSO): δ=8.911 (0.8); 8.894 (5.3); 8.866 (0.4); 8.833 (1.0); 7.913 (0.4); 7.898 (0.7); 7.834 (5.6); 7.813 (1.2); 7.758 (1.3); 7.746 (2.3); 7.738 (2.5); 7.729 (0.7); 7.719 (0.7); 7.712 (2.3); 7.704 (2.4); 7.695 (0.5); 7.564 (1.6); 7.555 (0.6); 7.548 (0.5); 7.535 (3.5); 7.526 (0.6); 7.519 (0.9); 7.507 (2.7); 7.491 (0.6); 7.454 (2.2); 7.450 (2.3); 7.446 (2.4); 7.442 (2.0); 7.434 (0.6); 7.425 (1.2); 7.421 (1.4); 7.417 (1.3); 7.413 (1.2); 5.815 (0.7); 5.777 (3.6); 4.986 (16.0); 2.641 (5.2); 2.537 (0.6); 2.531 (1.1); 2.525 (1.5); 2.519 (1.1); 2.513 (0.5); 1.265 (0.5); 0.876 (0.5); 0.019 (1.9)

### Example VI.25

¹H-NMR (300.2 MHz, d₆-DMSO): δ=8.858 (5.1); 8.833 (2.8); 7.843 (5.4); 7.760 (3.0); 7.747 (2.1); 7.740 (3.1); 7.732 (1.3); 7.713 (2.0); 7.705 (3.0); 7.697 (1.2); 7.558 (1.5); 7.549 (0.9); 7.529 (3.4); 7.520 (2.0); 7.511 (0.4); 7.501 (2.6); 7.492 (1.5); 7.454 (2.0); 7.449 (2.2); 7.446 (2.7); 7.442 (2.5); 7.435 (1.0); 7.425 (1.1); 7.420 (1.3); 7.417 (1.5); 7.413 (1.5); 7.406 (0.6); 5.778 (3.2); 5.188 (0.5); 5.171 (16.0); 4.031 (0.4); 4.025 (0.4); 3.348 (3.6); 3.203 (1.5); 2.641 (13.6); 2.537 (0.8); 2.531 (1.6); 2.525 (2.2); 2.519 (1.6); 2.513 (0.8); 2.011 (0.4); 1.266 (1.1); 0.900 (0.3); 0.878 (1.1); 0.855 (0.4); 0.020 (2.5)

### Example VI.26

¹H-NMR (300.2 MHz, d₆-DMSO): δ=9.951 (0.5); 8.972 (0.6); 8.870 (4.9); 7.732 (8.2); 7.704 (3.7); 7.445 (4.1); 7.416 (3.5); 7.388 (0.9); 7.298 (1.4); 7.111 (3.1); 6.926 (1.5); 5.190 (2.3); 5.166 (16.0); 4.031 (3.2); 3.351 (2.7); 3.213 (0.3); 2.641 (1.0); 2.537 (0.5); 2.531 (1.0); 2.525 (1.4); 2.519 (1.0); 2.513 (0.5); 0.021 (1.7)

### Example VI.27

¹H-NMR (300.2 MHz, d₆-DMSO): δ=8.906 (5.4); 8.845 (1.1); 7.829 (0.8); 7.781 (0.5); 7.733 (3.8); 7.721 (7.0); 7.705 (4.4); 7.650 (1.2); 7.470 (0.5); 7.451 (4.6); 7.423 (3.8); 7.408 (0.9); 7.298 (1.6); 7.112 (3.5); 6.926 (1.7); 5.777 (0.8); 4.976 (16.0); 3.375 (0.8); 2.641 (5.2); 2.537 (0.4); 2.531 (0.9); 2.525 (1.2); 2.519 (0.9); 2.513 (0.4); 0.021 (1.4)

### Example VI.28

¹H-NMR (300.2 MHz, CDCl₃): δ=7.917 (3.4); 7.889 (3.8); 7.810 (0.4); 7.757 (4.7); 7.728 (5.6); 7.688 (0.4); 7.661 (0.4); 7.386 (5.0); 7.358 (4.4); 7.300 (36.4); 7.276 (4.0); 7.248 (3.9); 7.233 (0.4); 7.219 (0.4); 4.516 (16.0); 4.506 (1.7); 4.308 (1.3); 3.312 (0.4); 2.628 (1.0); 1.585 (41.2); 1.345 (0.4); 1.307 (1.9); 0.943 (0.6); 0.921 (2.0); 0.898 (0.8); 0.108 (8.4); 0.096 (0.3); 0.049 (1.2); 0.039 (37.1); 0.028 (1.3)

### Example VI.29

¹H-NMR (300.2 MHz, CDCl₃): δ=7.931 (3.5); 7.902 (4.0); 7.886 (7.3); 7.879 (2.3); 7.863 (2.4); 7.856 (8.1); 7.845 (1.3); 7.837 (0.9); 7.810 (1.0); 7.688 (1.1); 7.661 (0.9); 7.646 (0.3); 7.378 (4.5); 7.348 (4.0); 7.300 (41.0); 7.269 (3.9); 7.239 (0.4); 4.517 (16.0); 4.506 (4.3); 4.309 (1.2); 4.301 (0.4); 3.314 (0.5); 2.631 (1.4); 1.585 (43.2); 1.346 (1.3); 1.306 (7.3); 0.943 (2.6); 0.921 (8.6); 0.898 (3.1); 0.108 (8.3); 0.050 (1.3); 0.039 (39.4); 0.028 (1.4)

### Example VI.30

1H-NMR (300.2 MHz, CDCl3): δ=8.148 (0.4); 8.135 (3.7); 8.120 (0.4); 8.106 (4.0); 7.862 (0.4); 7.851 (3.8); 7.844 (1.2); 7.827 (1.5); 7.820 (4.1); 7.810 (0.6); 7.300 (2.3); 7.269 (2.2); 7.263 (5.6); 7.051 (0.5); 7.031 (3.9); 7.022 (0.4); 7.003 (3.7); 6.865 (0.7); 4.803 (0.9); 4.787 (0.4); 4.765 (16.0); 4.724 (0.7); 2.708 (0.6); 1.572 (8.0); 1.266 (0.9); 1.260 (0.9); 0.903 (0.3); 0.882 (1.1); 0.858 (0.4); 0.000 (4.8)

### Example VI.31

1H-NMR (300.2 MHz, CDCl3): δ=7.939 (3.3); 7.911 (3.6); 7.816 (0.3); 7.702 (0.8); 7.697 (0.9); 7.690 (0.8); 7.677 (1.1); 7.671 (1.1); 7.573 (0.4); 7.548 (1.6); 7.524 (1.1); 7.400 (3.9); 7.372 (3.7); 7.355 (0.5); 7.343 (0.3); 7.327 (0.5); 7.312 (0.5); 7.300 (44.0); 7.149 (0.8); 7.139 (1 (2.6); 7.129 (8.1); 7.120 (1.3); 7.105 (7.9); 7.100 (2.7); 7.095 (2.1); 7.084 (0.9); 5.340 (2.0); 5.028 (3.2); 4.517 (16.0); 4.302 (1.2); 3.772 (3.2); 3.433 (15.9); 3.300 (0.8); 2.619 (1.8); 2.617 (1.9); 1.594 (22.3); 1.293 (0.6); 0.108 (5.0); 0.049 (1.6); 0.038 (48.2); 0.027 (1.9)

### Example VI.32

1H-NMR (300.2 MHz, CDCl3): δ=7.982 (3.1); 7.954 (3.4); 7.406 (0.4); 7.394 (3.7); 7.379 (0.4); 7.365 (3.4); 7.300 (30.6); 7.149 (0.7); 7.139 (1.5); 7.133 (2.7); 7.129 (7.1); 7.121 (0.9); 7.105 (7.0); 7.100 (2.3); 7.096 (1.6); 7.085 (0.7); 6.379 (0.7); 6.368 (0.3); 4.341 (16.0); 2.619 (1.3); 1.583 (29.3); 1.296 (0.4); 0.108 (6.3); 0.049 (1.1); 0.039 (32.1); 0.027 (1.2)

### Example VI.33

1H-NMR (300.2 MHz, CDCl3): δ=7.893 (3.3); 7.865 (3.6); 7.342 (1.9); 7.311 (7.1); 7.300 (23.1); 7.288 (12.0); 7.279 (2.3); 7.266 (1.5); 7.257 (2.8); 7.230 (3.9); 7.202 (3.6); 4.513 (16.0); 4.305 (0.5); 3.306 (0.7); 2.619 (0.3); 1.580 (9.3); 1.479 (0.7); 1.306 (0.8); 0.921 (0.7); 0.109 (1.1); 0.050 (0.7); 0.039 (24.0); 0.028 (0.9)

### Example VI.34

1H-NMR (300.2 MHz, CDCl3): δ=7.925 (3.2); 7.924 (3.1); 7.897 (3.4); 7.895 (3.4); 7.460 (0.8); 7.450 (7.2); 7.442 (2.5); 7.427 (2.8); 7.420 (9.1); 7.409 (1.1); 7.300 (24.4); 7.213 (1.4); 7.202 (12.8); 7.194 (3.0); 7.179 (3.3); 7.172 (9.2); 7.161 (0.8); 4.338 (16.0); 1.582 (18.1); 0.050 (1.2); 0.039 (26.1); 0.028 (1.0)

### Example VI.35

1H-NMR (300.2 MHz, CDCl₃): δ=7.906 (3.3); 7.905 (3.4); 7.878 (3.6); 7.877 (3.7); 7.309 (4.4); 7.300 (16.0); 7.294 (3.2); 7.293 (3.2); 7.282 (4.1); 7.281 (4.1); 7.269 (1.6); 7.264 (3.3); 7.259 (2.8); 7.247 (4.1); 7.245 (3.9); 7.238 (4.0); 7.232 (8.9); 7.227 (5.7); 7.210 (0.7); 7.203 (0.7); 7.187 (0.4); 4.512 (16.0); 4.299 (1.0); 3.300 (0.6); 2.615 (0.4); 1.720 (1.1); 1.583 (3.9); 1.479 (0.8); 1.322 (0.3); 1.294 (0.5); 0.109 (3.4); 0.050 (0.7); 0.039 (15.4); 0.028 (0.4)

### Example VI.36

1H-NMR (300.2 MHz, CDCl₃): δ=7.903 (3.4); 7.902 (3.4); 7.875 (3.7); 7.873 (3.6); 7.638 (4.0); 7.609 (4.9); 7.348 (5.5); 7.319 (4.4); 7.302 (2.5); 7.240 (3.9); 7.239 (3.9); 7.212 (3.6); 6.915 (2.1); 6.727 (4.2); 6.539 (2.1); 4.520 (16.0); 3.271 (0.5); 3.220 (0.3); 2.621 (0.5); 2.619 (0.5); 0.039 (2.5)

### Example VII.01

¹H-NMR (300.2 MHz, CDCl₃): δ=8.222 (4.3); 8.019 (4.5); 7.927 (2.0); 7.898 (2.1); 7.462 (0.4); 7.452 (4.1); 7.444 (1.5); 7.429 (1.5); 7.422 (5.4); 7.411 (0.6); 7.300 (12.6); 7.206 (2.3); 7.196 (0.7); 7.185 (5.3); 7.178 (3.7); 7.163 (1.5); 7.155 (4.3); 7.145 (0.5); 5.424 (8.1); 1.608 (16.0); 0.108 (1.3); 0.049 (0.5); 0.038 (14.8); 0.028 (0.6)

### Example VII.02

¹H-NMR (300.2 MHz, CDCl₃): δ=8.578 (5.9); 8.245 (6.7); 8.032 (6.7); 7.496 (0.8); 7.485 (6.2); 7.478 (2.3); 7.463 (2.4); 7.455 (7.7); 7.445 (1.0); 7.397 (6.3); 7.300 (39.6); 7.178 (0.9); 7.168 (7.5); 7.160 (2.6); 7.145 (2.1); 7.138 (6.2); 7.127 (0.7); 5.499 (16.0); 5.340 (7.4); 1.587 (19.7); 0.109 (1.6); 0.050 (2.3); 0.039 (51.8); 0.029 (2.6)

### Example VII.03

¹H-NMR (400.1 MHz, CDCl₃): δ=8.235 (2.1); 8.195 (5.7); 8.174 (5.8); 8.004 (3.3); 7.927 (0.5); 7.906 (0.6); 7.523 (5.1); 7.518 (0.6); 7.501 (5.6); 7.374 (0.6); 7.354 (0.6); 7.328 (5.1); 7.321 (5.4); 7.309 (0.4); 7.297 (0.8); 7.259 (70.7); 7.209 (0.4); 7.078 (3.3); 7.072 (3.1); 7.057 (3.0); 7.050 (2.9); 6.999 (6.0); 6.978 (5.9); 5.704 (16.0); 5.686 (0.5); 5.298 (0.3); 4.555 (0.4); 2.804 (1.2); 2.704 (3.5); 2.003 (2.4); 1.640 (0.3); 1.561 (0.7); 1.505 (0.4); 1.333 (0.4); 1.314 (0.5); 1.284 (0.8); 1.256 (1.7); 0.881 (0.6); 0.069 (1.9); 0.008 (1.6); 0.000 (46.8); −0.008 (1.6)

### Example VII.04

¹H-NMR (499.9 MHz, d₆-DMSO): δ=8.534 (8.6); 8.494 (5.1); 8.477 (5.3); 8.033 (8.1); 7.758 (4.7); 7.752 (4.9); 7.712 (2.1); 7.710 (2.2); 7.694 (2.4); 7.692 (2.5); 7.425 (2.9); 7.419 (2.9); 7.407 (2.6); 7.401 (2.6); 7.327 (5.4); 7.311 (5.3); 5.883 (16.0); 3.319 (14.6); 2.892 (0.5); 2.742 (0.8); 2.733 (0.5); 2.511 (1.1); 2.507 (2.4); 2.504 (3.3); 2.500 (2.5); 2.497 (1.3); 1.989 (0.5); 0.000 (1.3)

### Example VII.05

¹H-NMR (300.2 MHz, CDCl₃): δ=8.615 (8.1); 8.232 (6.5); 8.005 (6.6); 7.497 (0.4); 7.489 (2.0); 7.483 (1.0); 7.464 (4.1); 7.463 (3.8); 7.443 (1.5); 7.437 (3.6); 7.429 (0.8); 7.333 (1.0); 7.329 (2.0); 7.326 (1.3); 7.310 (0.9); 7.305 (2.6); 7.299 (0.9); 7.284 (0.8); 7.280 (1.3); 7.276 (0.9); 7.273 (0.5); 7.271 (0.6); 7.270 (0.7); 7.262 (34.2); 7.252 (0.7); 7.247 (0.5); 7.244 (0.4); 7.171 (1.0); 7.167 (3.8); 7.162 (5.1); 7.155 (1.4); 7.141 (2.2); 7.138 (3.8); 7.134 (3.5); 7.125 (0.6); 7.039 (8.7); 5.629 (16.0); 5.302 (5.5); 1.583 (4.9); 1.253 (0.5); 0.011 (0.8); 0.008 (0.4); 0.000 (25.6); −0.009 (0.7); −0.011 (1.1)

### Example VII.06

¹H-NMR (400.1 MHz, d₆-DMSO): δ=8.530 (8.6); 8.461 (5.5); 8.440 (5.8); 8.032 (8.3); 7.526 (0.5); 7.520 (2.8); 7.515 (1.3); 7.501 (5.0); 7.499 (5.0); 7.485 (1.7); 7.480 (4.2); 7.475 (0.6); 7.344 (1.1); 7.341 (2.0); 7.339 (1.4); 7.323 (3.2); 7.307 (0.8); 7.304 (1.4); 7.302 (0.9); 7.259 (4.6); 7.256 (5.8); 7.251 (1.7); 7.239 (2.8); 7.237 (4.7); 7.235 (4.1); 7.228 (0.6); 7.200 (5.9); 7.179 (5.9); 5.878 (16.0); 3.314 (5.3); 2.897 (0.5); 2.738 (0.4); 2.517 (6.1); 2.512 (12.3); 2.508 (16.5); 2.503 (11.7); 2.499 (5.6)

### Example VII.07

¹H-NMR (300.2 MHz, CDCl₃): δ=8.352 (5.4); 8.344 (5.5); 8.219 (6.7); 8.016 (6.8); 7.608 (0.5); 7.518 (2.0); 7.511 (1.0); 7.493 (4.2); 7.471 (1.5); 7.465 (3.5); 7.457 (0.7); 7.357 (1.0); 7.353 (2.0); 7.350 (1.2); 7.334 (1.0); 7.329 (2.6); 7.323 (0.8); 7.308 (0.7); 7.304 (1.2); 7.300 (0.7); 7.285 (5.7); 7.277 (5.8); 7.271 (1.1); 7.262 (77.9); 7.147 (3.9); 7.143 (5.1); 7.136 (1.4); 7.122 (2.3); 7.118 (3.9); 7.115 (3.5); 7.106 (0.6); 6.911 (0.4); 5.845 (16.0); 1.562 (52.8); 1.253 (0.5); 0.011 (1.9); 0.000 (56.2); −0.011 (2.2)

### Example VII.08

¹H-NMR (499.9 MHz, d₆-DMSO): δ=8.527 (8.3); 8.478 (4.7); 8.461 (4.8); 8.029 (7.7); 7.506 (4.1); 7.488 (5.8); 7.414 (1.0); 7.407 (8.4); 7.402 (2.8); 7.393 (2.2); 7.389 (6.0); 7.382 (0.7); 7.277 (4.9); 7.260 (4.8); 5.877 (16.0); 3.315 (10.4); 2.505 (3.5); 2.502 (4.8); 2.499 (3.8); 0.000 (1.7)

### Example VII.09

¹H-NMR (400.1 MHz, d₆-DMSO): δ=8.530 (8.8); 8.472 (5.7); 8.451 (5.9); 8.032 (8.6); 7.569 (0.7); 7.561 (7.5); 7.555 (2.5); 7.544 (2.7); 7.538 (9.0); 7.530 (0.9); 7.322 (1.0); 7.314 (9.1); 7.308 (2.8); 7.297 (2.4); 7.291 (7.5); 7.283 (0.7); 7.260 (6.1); 7.239 (6.1); 5.878 (16.0); 5.859 (0.3); 3.312 (7.1); 2.897 (1.1); 2.739 (0.9); 2.517 (7.1); 2.512 (14.4); 2.508 (19.4); 2.503 (13.6); 2.499 (6.3)

### Example VII.10

¹H-NMR (400.1 MHz, d₆-DMSO): δ=8.522 (7.4); 8.470 (4.9); 8.449 (5.2); 8.028 (7.2); 7.489 (2.5); 7.488 (2.5); 7.483 (2.8); 7.482 (2.8); 7.379 (1.4); 7.378 (1.4); 7.372 (1.3); 7.371 (1.3); 7.357 (1.9); 7.356 (1.9); 7.351 (1.8); 7.350 (1.8); 7.242 (5.4); 7.230 (4.5); 7.221 (5.5); 7.209 (3.4); 5.877 (13.2); 5.859 (0.5); 3.312 (6.2); 2.897 (0.4); 2.739 (0.4); 2.738 (0.4); 2.530 (0.4); 2.517 (6.2); 2.513 (12.6); 2.508 (17.3); 2.504 (12.5); 2.499 (6.3); 2.108 (16.0)

### Example VII.11

¹H-NMR (400.1 MHz, d₆-DMSO): δ=8.530 (7.2); 8.463 (4.5); 8.442 (4.7); 8.032 (7.0); 7.474 (2.4); 7.452 (2.8); 7.406 (3.4); 7.400 (3.6); 7.240 (4.9); 7.219 (4.9); 7.172 (2.1); 7.166 (2.1); 7.151 (1.9); 7.145 (1.8); 5.877 (12.9); 3.313 (5.3); 2.897 (0.4); 2.738 (0.3); 2.517 (5.5); 2.512 (11.1); 2.508 (14.9); 2.503 (10.6); 2.499 (5.0); 2.366 (16.0)

### Example VII.12

¹H-NMR (400.1 MHz, d₆-DMSO): δ=8.529 (8.8); 8.461 (5.7); 8.440 (5.9); 8.031 (8.6); 7.352 (0.8); 7.345 (0.6); 7.337 (1.0); 7.329 (6.9); 7.325 (3.2); 7.320 (7.1); 7.309 (11.1); 7.307 (11.1); 7.297 (1.1); 7.285 (0.4); 7.222 (6.1); 7.201 (6.0); 5.876 (16.0); 5.856 (0.4); 3.313 (5.9); 2.517 (6.5); 2.512 (13.1); 2.508 (17.7); 2.503 (12.4); 2.499 (5.8)

### Example VII.13

¹H-NMR (400.1 MHz, d₆-DMSO): δ=8.524 (8.8); 8.506 (5.6); 8.485 (5.8); 8.030 (8.5); 7.562 (1.2); 7.555 (1.3); 7.550 (1.2); 7.540 (1.5); 7.535 (2.5); 7.527 (3.4); 7.513 (3.4); 7.505 (2.3); 7.491 (1.2); 7.379 (6.0); 7.358 (5.8); 7.242 (0.8); 7.238 (0.9); 7.235 (0.8); 7.231 (0.8); 7.218 (1.4); 7.215 (1.4); 7.212 (1.3); 7.199 (0.7); 7.195 (0.8); 7.192 (0.7); 7.188 (0.6); 5.887 (16.0); 3.313 (9.6); 2.530 (0.3); 2.517 (7.3); 2.512 (14.7); 2.508 (19.7); 2.503 (13.9); 2.499 (6.5)

### Example VII.14

¹H-NMR (400.1 MHz, d₆-DMSO): δ=8.525 (8.8); 8.505 (6.2); 8.484 (6.4); 8.031 (8.5); 7.472 (1.0); 7.468 (1.1); 7.460 (1.2); 7.456 (1.4); 7.452 (1.9); 7.448 (2.1); 7.441 (3.4); 7.436 (2.9); 7.425 (1.9); 7.421 (3.2); 7.416 (2.1); 7.409 (1.0); 7.404 (1.0); 7.396 (1.0); 7.390 (1.8); 7.385 (1.4); 7.378 (1.8); 7.373 (1.4); 7.370 (1.3); 7.362 (7.0); 7.358 (1.3); 7.353 (1.0); 7.341 (7.3); 7.335 (2.2); 7.320 (2.1); 7.316 (2.1); 7.301 (0.8); 7.300 (0.8); 7.297 (0.8); 5.889 (16.0); 5.872 (0.4); 3.315 (6.3); 2.897 (0.5); 2.739 (0.4); 2.738 (0.4); 2.530 (0.4); 2.526 (0.6); 2.517 (6.0); 2.513 (12.1); 2.508 (16.7); 2.504 (12.0); 2.499 (6.0); 2.463 (0.3)

### Example VII.15

¹H-NMR (400.1 MHz, d₆-DMSO): δ=8.537 (8.8); 8.494 (6.0); 8.472 (6.3); 8.035 (8.7); 7.500 (0.6); 7.491 (2.9); 7.485 (1.0); 7.475 (3.0); 7.469 (3.0); 7.460 (1.1); 7.454 (2.8); 7.445 (0.8); 7.436 (0.4); 7.317 (6.5); 7.295 (6.5); 5.882 (16.0); 5.862 (0.5); 3.311 (8.5); 2.531 (0.3); 2.517 (7.6); 2.513 (16.0); 2.508 (22.1); 2.504 (16.3); 2.499 (8.3); 2.463 (0.5); 2.459 (0.4)

### Example VII.16

¹H-NMR (300.2 MHz, CDCl₃): δ=8.222 (8.9); 8.194 (4.8); 8.020 (2.0); 8.004 (5.5); 7.608 (0.4); 7.520 (3.5); 7.512 (3.9); 7.358 (2.0); 7.350 (1.8); 7.329 (2.9); 7.321 (2.8); 7.279 (0.4); 7.277 (0.4); 7.276 (0.4); 7.273 (0.7); 7.262 (62.1); 7.250 (1.2); 7.247 (0.9); 7.246 (0.8); 7.244 (0.8); 7.240 (0.6); 7.234 (0.5); 7.228 (0.4); 7.200 (4.7); 7.171 (3.2); 7.054 (4.8); 7.025 (4.7); 6.911 (0.4); 5.710 (12.5); 2.959 (16.0); 2.886 (13.8); 2.885 (13.5); 1.570 (15.1); 1.252 (0.4); 0.011 (1.8); 0.009 (1.1); 0.000 (49.7); −0.010 (1.4); −0.011 (1.9); −0.018 (0.4)

### Example VII.17

¹H-NMR (300.2 MHz, CDCl₃): δ=8.231 (3.3); 8.222 (2.9); 8.194 (2.8); 8.091 (0.4); 8.082 (3.2); 8.075 (1.2); 8.059 (1.1); 8.053 (3.4); 8.044 (0.6); 8.019 (0.4); 8.008 (3.3); 7.299 (0.5); 7.290 (3.4); 7.283 (1.2); 7.278 (0.4); 7.276 (0.4); 7.275 (0.5); 7.273 (0.6); 7.263 (33.8); 7.252 (1.0); 7.031 (2.8); 7.002 (2.8); 5.719 (7.4); 2.959 (1.3); 2.887 (1.1); 2.885 (1.1); 2.641 (16.0); 2.562 (0.3); 2.048 (0.9); 1.567 (8.5); 1.261 (0.6); 0.011 (0.8); 0.007 (0.5); 0.000 (25.4); −0.009 (0.8); −0.011 (1.1)

### Example VII.18

¹H-NMR (300.2 MHz, CDCl₃): δ=8.450 (5.1); 8.422 (5.4); 8.193 (7.8); 8.019 (7.8); 7.608 (0.5); 7.429 (0.8); 7.418 (6.5); 7.411 (2.4); 7.396 (2.6); 7.389 (8.3); 7.378 (1.2); 7.330 (0.4); 7.300 (0.5); 7.262 (77.9); 7.230 (0.3); 7.152 (1.1); 7.141 (7.6); 7.134 (2.5); 7.119 (2.3); 7.112 (6.4); 7.101 (0.6); 6.955 (4.7); 6.927 (4.6); 6.911 (0.6); 5.568 (16.0); 5.302 (0.9); 1.554 (49.9); 1.340 (0.4); 1.252 (1.1); 0.881 (0.3); 0.195 (0.5); 0.081 (0.9); 0.069 (25.4); 0.057 (1.3); 0.026 (0.3); 0.011 (2.9); 0.000 (87.8); −0.011 (4.3); −0.031 (0.6); −0.200 (0.4)

### Example VII.19

¹H-NMR (300.2 MHz, CDCl₃): δ=8.221 (3.0); 8.196 (2.4); 8.167 (2.5); 8.001 (3.0); 7.264 (6.6); 7.157 (1.8); 7.127 (2.3); 7.031 (1.8); 7.022 (2.1); 6.965 (2.6); 6.937 (2.4); 6.897 (1.4); 6.887 (1.2); 6.867 (1.1); 6.857 (1.0); 5.716 (6.8); 5.301 (16.0); 3.841 (13.1); 3.827 (0.7); 3.818 (0.5); 3.808 (1.2); 1.610 (5.6); 0.070 (0.4); 0.000 (6.8)

### Example VII.20

¹H-NMR (300.2 MHz, CDCl₃): δ=8.233 (10.0); 8.205 (3.0); 8.201 (5.1); 8.005 (7.2); 7.865 (6.9); 7.857 (3.0); 7.841 (5.6); 7.834 (6.7); 7.309 (5.6); 7.278 (5.7); 7.266 (5.9); 7.053 (5.2); 7.025 (4.9); 5.718 (16.0); 5.305 (6.6); 5.301 (12.5); 1.662 (6.4); 1.258 (0.5); 0.003 (3.1); 0.000 (5.5)

### Example VII.21

¹H-NMR (300.2 MHz, CDCl₃): δ=8.572 (6.1); 8.248 (6.8); 8.034 (7.0); 7.931 (0.6); 7.920 (5.9); 7.914 (2.2); 7.897 (2.0); 7.890 (6.7); 7.452 (6.4); 7.332 (4.0); 7.300 (30.7); 5.503 (16.0); 5.340 (5.5); 1.593 (10.7); 1.308 (0.5); 1.295 (0.6); 0.109 (7.2); 0.050 (1.3); 0.039 (35.7); 0.029 (1.7)

### Example VII.22

¹H-NMR (300.2 MHz, CDCl₃): δ=8.266 (6.8); 8.246 (4.8); 8.217 (4.9); 8.044 (6.7); 7.660 (3.3); 7.631 (4.0); 7.327 (4.6); 7.300 (44.3); 7.039 (5.0); 7.010 (4.7); 6.923 (1.7); 6.735 (3.4); 6.547 (1.7); 5.753 (16.0); 5.339 (0.4); 1.591 (21.4); 1.352 (0.4); 1.293 (1.1); 0.108 (3.0); 0.050 (1.5); 0.039 (42.6); 0.028 (1.5)

### Example VII.23

¹H-NMR (499.9 MHz, d₆-DMSO): δ=8.946 (1.3); 8.897 (1.3); 8.756 (9.9); 8.532 (8.7); 8.416 (1.2); 8.027 (8.2); 8.015 (0.3); 7.597 (0.7); 7.590 (7.0); 7.586 (2.5); 7.577 (2.7); 7.572 (8.6); 7.566 (1.2); 7.555 (0.6); 7.545 (1.1); 7.541 (0.5); 7.538 (0.4); 7.532 (0.5); 7.528 (1.2); 7.402 (1.0); 7.395 (8.5); 7.391 (2.8); 7.381 (2.5); 7.377 (7.2); 7.370 (1.9); 7.356 (0.6); 7.351 (1.1); 5.929 (16.0); 3.300 (185.7); 2.681 (3.9); 2.591 (0.4); 2.560 (0.4); 2.507 (8.9); 2.503 (18.2); 2.500 (25.1); 2.496 (18.7); 2.493 (9.8); 2.070 (0.8); 0.006 (0.3); 0.000 (7.5); −0.007 (0.5)

### Example VII.24

¹H-NMR (300.2 MHz, CDCl₃): δ=8.223 (8.6); 8.022 (8.8); 7.930 (3.9); 7.902 (4.2); 7.646 (0.6); 7.613 (0.8); 7.602 (8.5); 7.595 (2.8); 7.579 (2.8); 7.572 (9.5); 7.562 (1.1); 7.366 (0.6); 7.300 (100.9); 7.233 (0.5); 7.209 (4.3); 7.181 (4.0); 7.145 (1.0); 7.134 (9.5); 7.127 (3.0); 7.112 (2.6); 7.104 (8.2); 7.094 (0.9); 6.949 (0.5); 5.425 (16.0); 1.657 (0.6); 1.597 (38.8); 1.593 (86.1); 1.524 (0.5); 1.326 (0.4); 1.292 (0.9); 0.919 (0.3); 0.233 (0.4); 0.120 (0.7); 0.108 (20.9); 0.095 (0.7); 0.049 (3.4); 0.038 (102.6); 0.027 (3.3); −0.028 (0.4); −0.161 (0.4)

### Example VII.25

¹H-NMR (300.2 MHz, CDCl₃): δ=8.518 (4.9); 8.490 (6.7); 8.487 (5.9); 8.459 (5.1); 8.265 (0.4); 8.237 (14.7); 8.057 (15.0); 7.646 (0.3); 7.492 (1.4); 7.481 (13.5); 7.473 (4.4); 7.458 (5.0); 7.451 (16.0); 7.440 (2.0); 7.412 (0.5); 7.300 (55.9); 7.191 (1.9); 7.180 (16.7); 7.173 (5.0); 7.158 (4.6); 7.150 (13.0); 7.140 (1.6); 7.016 (5.7); 7.010 (5.5); 6.988 (5.5); 6.982 (5.2); 6.949 (0.3); 5.619 (15.7); 5.607 (15.6); 5.571 (0.9); 2.692 (1.1); 2.046 (0.5); 1.610 (13.9); 1.306 (0.4); 1.292 (0.5); 0.119 (0.5); 0.107 (10.3); 0.095 (0.5); 0.048 (2.4); 0.047 (1.7); 0.038 (60.4); 0.030 (1.9); 0.028 (1.8); 0.027 (2.3); 0.018 (0.4)

### Example VII.26

¹H-NMR (300.2 MHz, CDCl₃): δ=8.584 (5.9); 8.245 (6.9); 8.030 (6.9); 7.414 (6.1); 7.368 (2.9); 7.340 (4.7); 7.338 (4.5); 7.300 (12.6); 7.264 (1.1); 7.253 (9.0); 7.245 (2.4); 7.231 (1.9); 7.223 (5.0); 7.212 (0.5); 5.502 (16.0); 5.337 (9.8); 4.170 (0.7); 4.146 (0.7); 2.082 (3.1); 1.639 (5.4); 1.320 (0.9); 1.296 (1.8); 1.273 (0.8); 0.107 (1.4); 0.048 (0.4); 0.037 (12.6); 0.026 (0.5)

### Example VII.27

¹H-NMR (300.2 MHz, CDCl₃): δ=8.578 (5.8); 8.244 (6.8); 8.031 (6.9); 7.645 (0.8); 7.634 (6.9); 7.627 (2.2); 7.612 (2.3); 7.605 (7.7); 7.594 (0.8); 7.398 (6.0); 7.300 (24.3); 7.124 (0.8); 7.113 (7.8); 7.106 (2.3); 7.091 (2.2); 7.084 (6.9); 7.073 (0.7); 5.500 (16.0); 5.339 (3.1); 1.609 (14.4); 0.108 (1.0); 0.049 (0.9); 0.038 (25.7); 0.027 (1.0)

### Example VII.28

¹H-NMR (300.2 MHz, CDCl₃): δ=8.576 (4.9); 8.247 (5.7); 8.033 (5.9); 7.793 (3.5); 7.765 (4.0); 7.445 (5.3); 7.350 (3.8); 7.322 (3.6); 7.310 (1.1); 7.300 (32.4); 5.504 (13.7); 5.339 (13.6); 1.600 (16.0); 1.293 (0.4); 0.108 (1.3); 0.049 (1.6); 0.038 (34.7); 0.027 (1.3)

### Example VII.29

¹H-NMR (300.2 MHz, d₆-DMSO): δ=9.008 (6.8); 8.549 (9.5); 8.059 (9.2); 7.752 (8.8); 7.717 (5.0); 7.462 (5.7); 7.434 (4.6); 7.307 (1.8); 7.121 (4.2); 6.935 (2.0); 5.945 (15.0); 5.781 (0.8); 4.088 (1.2); 4.064 (3.6); 4.057 (0.6); 4.041 (3.6); 4.017 (1.2); 3.347 (22.1); 2.537 (1.9); 2.531 (4.0); 2.525 (5.5); 2.519 (4.0); 2.513 (1.9); 2.012 (16.0); 1.221 (4.4); 1.198 (8.8); 1.174 (4.3); 0.023 (3.8)

### Example VII.30

¹H-NMR (300.2 MHz, d₆-DMSO): δ=8.999 (7.1); 8.539 (10.0); 8.057 (10.0); 7.866 (7.7); 7.770 (2.8); 7.762 (2.9); 7.735 (2.7); 7.727 (2.8); 7.579 (2.1); 7.550 (4.6); 7.522 (3.5); 7.471 (2.7); 7.467 (2.7); 7.463 (2.5); 7.459 (2.2); 7.441 (1.4); 7.438 (1.6); 7.433 (1.4); 7.430 (1.3); 5.950 (16.0); 5.781 (15.8); 3.352 (4.1); 2.537 (2.1); 2.531 (4.4); 2.525 (6.0); 2.519 (4.4); 2.513 (2.1); 0.022 (7.5); 0.011 (0.4)

### Example VII.31

¹H-NMR (300.2 MHz, CDCl₃): δ=8.225 (8.9); 8.021 (9.1); 7.974 (4.0); 7.946 (4.2); 7.899 (1.0); 7.888 (7.9); 7.881 (2.8); 7.865 (2.9); 7.858 (8.7); 7.847 (1.1); 7.362 (5.1); 7.332 (4.6); 7.300 (30.4); 7.288 (5.0); 7.260 (4.3); 5.433 (16.0); 5.338 (10.9); 1.606 (6.4); 1.293 (0.6); 0.108 (0.7); 0.049 (1.4); 0.038 (32.7); 0.027 (1.3)

### Example VII.32

¹H-NMR (499.9 MHz, CDCl₃): δ=8.182 (8.2); 7.976 (8.1); 7.915 (3.9); 7.898 (4.1); 7.711 (5.5); 7.694 (6.0); 7.327 (5.7); 7.310 (5.3); 7.263 (5.1); 7.221 (4.3); 7.204 (4.1); 5.390 (16.0); 5.296 (0.4); 1.634 (0.7); 0.000 (5.5); −0.007 (0.4)

### Example VII.33

1H-NMR (300.2 MHz, CDCl₃): δ=8.225 (8.1); 8.030 (8.4); 7.994 (3.9); 7.966 (4.1); 7.646 (0.5); 7.408 (4.5); 7.380 (4.1); 7.319 (0.6); 7.300 (86.9); 7.153 (0.9); 7.142 (1.8); 7.132 (8.7); 7.108 (8.5); 7.104 (2.6); 7.099 (1.7); 7.088 (0.8); 6.949 (0.4); 5.431 (16.0); 1.589 (31.8); 1.354 (0.5); 1.292 (1.3); 0.920 (0.4); 0.234 (0.4); 0.108 (12.4); 0.049 (3.3); 0.039 (93.5); 0.028 (3.2); 0.015 (0.4); −0.160 (0.3)

### Example VII.34

1H-NMR (499.9 MHz, CDCl₃): δ=8.186 (4.0); 7.970 (4.1); 7.847 (1.8); 7.830 (1.9); 7.288 (3.1); 7.271 (3.8); 7.267 (1.9); 7.106 (0.6); 7.101 (4.1); 7.097 (1.4); 7.087 (1.3); 7.084 (3.4); 7.078 (0.4); 7.061 (2.0); 7.044 (2.0); 5.393 (7.4); 2.966 (0.8); 2.952 (1.1); 2.938 (0.8); 2.924 (0.4); 1.286 (15.9); 1.272 (16.0); 1.259 (0.5); 0.000 (1.2)

### Example VII.35

1H-NMR (300.2 MHz, CDCl₃): δ=8.250 (6.6); 8.098 (3.8); 8.070 (4.2); 8.040 (7.3); 7.647 (0.5); 7.615 (1.0); 7.604 (8.3); 7.597 (2.6); 7.582 (3.1); 7.574 (9.1); 7.564 (1.3); 7.302 (68.9); 7.158 (3.9); 7.147 (1.4); 7.136 (10.1); 7.129 (6.3); 7.113 (3.0); 7.106 (8.0); 7.096 (1.0); 7.018 (2.7); 6.950 (0.5); 6.836 (5.1); 6.655 (2.6); 5.561 (16.0); 5.341 (1.5); 1.613 (15.8); 1.293 (1.5); 0.122 (0.4); 0.109 (8.8); 0.098 (0.4); 0.051 (1.4); 0.040 (42.7); 0.029 (1.6)

### Example VII.36

1H-NMR (300.2 MHz, CDCl₃): δ=8.819 (4.9); 8.252 (7.2); 8.056 (7.3); 7.644 (0.5); 7.586 (1.8); 7.502 (0.7); 7.491 (6.8); 7.483 (6.1); 7.468 (2.4); 7.461 (8.0); 7.450 (0.9); 7.405 (3.7); 7.298 (87.1); 7.223 (1.9); 7.193 (0.8); 7.182 (8.1); 7.174 (2.3); 7.159 (2.1); 7.152 (6.5); 7.141 (0.6); 6.947 (0.5); 5.624 (16.0); 5.338 (6.7); 1.583 (53.8); 1.291 (2.3); 0.107 (1.7); 0.048 (2.8); 0.038 (89.7); 0.027 (3.3); −0.161 (0.4)

### Example VII.37

1H-NMR (300.2 MHz, CDCl₃): δ=8.222 (7.7); 8.024 (8.6); 7.993 (0.4); 7.957 (3.9); 7.930 (4.2); 7.646 (0.4); 7.337 (0.3); 7.311 (5.7); 7.300 (83.2); 7.283 (5.0); 7.267 (2.9); 7.265 (3.4); 7.261 (3.9); 7.239 (7.6); 7.233 (7.7); 7.226 (6.4); 7.222 (3.9); 7.198 (0.6); 6.949 (0.4); 5.426 (16.0); 5.340 (1.1); 1.591 (25.1); 1.368 (0.4); 1.350 (0.5); 1.293 (1.0); 0.920 (0.4); 0.234 (0.4); 0.108 (10.6); 0.067 (0.4); 0.049 (3.6); 0.039 (88.4); 0.028 (3.1); 0.018 (0.4)

### Example VII.38

1H-NMR (300.2 MHz, d6-DMSO): δ=8.833 (10.2); 8.551 (9.6); 8.057 (9.4); 7.585 (0.8); 7.573 (7.8); 7.566 (2.5); 7.551 (3.0); 7.544 (9.5); 7.533 (1.1); 7.496 (10.9); 7.334 (1.1); 7.323 (9.8); 7.315 (2.8); 7.300 (2.7); 7.293 (7.4); 7.282 (0.8); 5.912 (16.0); 5.786 (1.3); 3.355 (11.4); 2.540 (3.3); 2.534 (6.8); 2.528 (9.2); 2.522 (6.6); 2.516 (3.1); 0.026 (8.5); 0.015 (0.3)

### Example VII.39

1H-NMR (300.2 MHz, CDCl₃): δ=8.225 (7.9); 8.021 (8.6); 7.940 (3.9); 7.912 (4.3); 7.342 (3.0); 7.312 (7.6); 7.300 (34.5); 7.284 (2.2); 7.275 (13.6); 7.266 (3.0); 7.252 (2.2); 7.244 (4.8); 7.227 (4.8); 7.198 (4.4); 5.428 (16.0); 5.339 (3.2); 2.084 (0.4); 1.608 (5.6); 1.298 (0.5); 1.292 (0.5); 0.108 (4.4); 0.049 (1.2); 0.038 (37.2); 0.027 (1.4)

### Example VII.40

1H-NMR (300.2 MHz, CDCl₃): δ=8.606 (8.2); 8.265 (6.7); 8.026 (7.0); 7.762 (4.0); 7.733 (4.6); 7.321 (4.4); 7.298 (5.9); 7.294 (4.1); 7.159 (8.6); 5.663 (16.0); 5.329 (10.2); 0.031 (3.8)

### Example VII.41

1H-NMR (300.2 MHz, CDCl₃): δ=8.817 (5.5); 8.251 (7.2); 8.055 (7.1); 7.651 (0.8); 7.640 (6.4); 7.634 (2.7); 7.618 (2.3); 7.611 (7.3); 7.585 (1.8); 7.481 (5.6); 7.404 (3.9); 7.298 (49.1); 7.223 (1.9); 7.139 (0.9); 7.128 (7.1); 7.122 (2.9); 7.106 (2.2); 7.099 (6.5); 5.624 (16.0); 5.338 (4.5); 1.586 (30.9); 1.342 (0.5); 1.291 (2.2); 0.918 (0.4); 0.107 (2.0); 0.048 (2.4); 0.038 (51.2)

### Example VII.42

1H-NMR (300.2 MHz, CDCl₃): δ=8.223 (8.7); 8.017 (9.0); 7.947 (3.9); 7.918 (4.2); 7.637 (4.5); 7.609 (5.4); 7.332 (6.2); 7.301 (8.5); 7.234 (4.5); 7.206 (4.2); 6.915 (2.3); 6.727 (4.6); 6.539 (2.3); 5.432 (16.0); 5.334 (1.5); 3.292 (0.4); 1.741 (0.6); 0.034 (4.6)

### Example IX.01

¹H-NMR (300.2 MHz, CDCl₃): δ=8.496 (5.1); 7.450 (0.6); 7.439 (6.3); 7.432 (2.1); 7.417 (2.3); 7.409 (7.9); 7.399 (0.9); 7.300 (31.2); 7.183 (5.8); 7.151 (1.0); 7.140 (7.8); 7.133 (2.4); 7.118 (2.1); 7.110 (6.4); 7.099 (0.7); 5.340 (0.9); 3.053 (3.8); 3.037 (4.9); 2.917 (2.6); 2.901 (2.0); 1.682 (16.0); 1.582 (18.0); 1.304 (0.7); 0.921 (0.7); 0.109 (1.3); 0.050 (1.0); 0.049 (0.7); 0.047 (0.7); 0.039 (33.9); 0.029 (1.4)

### Example IX.02

¹H-NMR (400.0 MHz, d₆-DMSO): δ=8.630 (0.5); 8.170 (6.5); 7.467 (0.5); 7.462 (0.5); 7.450 (2.9); 7.445 (1.8); 7.431 (4.1); 7.429 (4.1); 7.415 (1.5); 7.410 (3.3); 7.404 (0.7); 7.281 (0.3); 7.263 (1.4); 7.260 (1.8); 7.258 (1.2); 7.242 (2.9); 7.236 (6.9); 7.226 (0.9); 7.223 (1.2); 7.220 (0.8); 7.191 (0.4); 7.188 (0.4); 7.173 (1.1); 7.170 (1.1); 7.155 (4.0); 7.152 (4.9); 7.147 (1.5); 7.135 (2.3); 7.133 (3.5); 7.131 (3.0); 7.124 (0.6); 7.105 (0.3); 6.428 (0.5); 3.327 (40.6); 3.251 (0.7); 3.077 (4.0); 3.022 (3.1); 3.009 (3.5); 2.996 (0.5); 2.825 (2.4); 2.812 (2.2); 2.711 (0.6); 2.622 (0.5); 2.592 (3.5); 2.562 (0.5); 2.542 (136.6); 2.525 (1.3); 2.511 (17.8); 2.507 (35.0); 2.502 (45.6); 2.498 (33.1); 2.493 (16.0); 2.472 (0.5); 2.432 (0.5); 2.429 (0.5); 2.368 (0.6); 2.329 (0.4); 1.989 (0.7); 1.642 (0.6); 1.582 (16.0); 1.258 (0.4); 1.235 (1.4); 1.135 (0.4); 1.119 (0.5); 1.106 (12.4); 0.853 (0.5); 0.836 (0.4); 0.000 (4.3)

### Example IX.03

¹H-NMR (400.0 MHz, d₆-DMSO): δ=9.657 (0.4); 8.172 (5.6); 7.502 (0.6); 7.496 (0.7); 7.487 (4.7); 7.481 (2.0); 7.470 (1.9); 7.465 (5.5); 7.456 (0.9); 7.447 (0.4); 7.430 (0.5); 7.421 (0.3); 7.408 (0.3); 7.303 (5.5); 7.218 (0.8); 7.213 (0.9); 7.204 (5.5); 7.199 (2.2); 7.188 (1.8); 7.182 (4.7); 7.176 (1.0); 7.149 (0.4); 6.772 (0.5); 6.750 (0.5); 3.748 (0.4); 3.660 (0.6); 3.602 (0.4); 3.327 (26.5); 3.251 (0.7); 3.077 (5.1); 3.025 (2.6); 3.013 (2.9); 2.996 (0.6); 2.821 (2.2); 2.808 (1.9); 2.712 (0.5); 2.594 (1.8); 2.564 (0.3); 2.542 (118.0); 2.511 (17.7); 2.507 (35.6); 2.502 (47.3); 2.498 (35.2); 2.494 (17.7); 2.368 (0.6); 2.329 (0.4); 1.989 (0.7); 1.760 (0.5); 1.622 (0.4); 1.581 (14.0); 1.298 (0.5); 1.259 (0.9); 1.235 (2.8); 1.193 (0.4); 1.183 (1.1); 1.169 (0.5); 1.135 (0.5); 1.119 (0.6); 1.106 (16.0); 1.082 (0.4); 1.046 (0.6); 0.867 (0.4); 0.854 (0.9); 0.836 (0.7); 0.813 (0.3); 0.000 (3.9)

### Example IX.04

¹H-NMR (400.0 MHz, d₆-DMSO): δ=9.319 (0.3); 7.931 (3.5); 7.910 (3.6); 7.489 (0.4); 7.473 (2.5); 7.453 (4.3); 7.434 (3.4); 7.421 (0.9); 7.401 (0.6); 7.285 (1.6); 7.266 (2.5); 7.248 (1.3); 7.234 (0.6); 7.216 (0.8); 7.197 (0.7); 7.179 (4.3); 7.160 (3.8); 7.134 (0.8); 7.120 (0.4); 7.013 (3.7); 6.993 (3.6); 6.389 (0.3); 3.744 (0.4); 3.628 (1.6); 3.601 (0.5); 3.329 (35.2); 3.251 (0.6); 3.077 (1.6); 3.040 (2.9); 3.027 (3.3); 2.996 (0.4); 2.818 (2.6); 2.805 (2.4); 2.712 (1.2); 2.569 (1.9); 2.542 (199.7); 2.521 (2.1); 2.507 (30.0); 2.503 (40.3); 2.498 (31.6); 2.459 (1.8); 2.368 (1.3); 2.330 (0.4); 1.989 (0.6); 1.769 (0.3); 1.760 (0.7); 1.751 (0.3); 1.630 (0.3); 1.585 (0.3); 1.565 (16.0); 1.259 (0.4); 1.235 (1.1); 1.183 (0.3); 1.135 (0.4); 1.119 (0.4); 1.106 (5.1); 0.854 (0.4); 0.000 (3.4)

### Example IX.05

1H-NMR (300.2 MHz, d6-DMSO): δ=8.216 (1.9); 8.188 (3.6); 8.163 (2.2); 8.115 (6.9); 8.086 (7.4); 7.721 (6.3); 7.707 (14.0); 7.678 (16.0); 7.450 (4.5); 7.417 (10.0); 7.403 (13.1); 7.389 (14.5); 7.374 (10.6); 7.362 (6.3); 7.289 (6.2); 7.103 (13.2); 6.917 (6.4); 3.358 (15.3); 3.070 (8.3); 3.054 (10.1); 2.921 (7.8); 2.905 (6.5); 2.540 (5.5); 2.534 (10.8); 2.528 (14.3); 2.522 (10.3); 1.616 (4.3); 1.592 (0.3); 1.556 (0.6); 1.399 (0.8); 1.381 (1.7); 1.371 (1.9); 1.354 (3.0); 1.337 (1.9); 1.329 (1.8); 1.311 (0.9); 1.269 (0.3); 1.218 (0.5); 1.165 (0.3); 1.140 (0.4); 1.133 (0.3); 1.125 (0.4); 1.110 (0.4); 0.519 (0.8); 0.512 (0.7); 0.500 (2.0); 0.482 (7.8); 0.468 (3.4); 0.455 (8.7); 0.449 (6.0); 0.441 (5.0); 0.427 (3.2); 0.422 (3.2); 0.410 (3.6); 0.404 (2.9); 0.392 (3.1); 0.361 (1.0); 0.356 (1.4); 0.348 (3.1); 0.331 (3.9); 0.322 (1.9); 0.309 (2.6); 0.301 (1.5); 0.293 (1.0); 0.034 (0.8); 0.024 (15.2); 0.013 (0.7)

### Example IX.06

1H-NMR (300.2 MHz, CDCl₃): δ=7.441 (0.4); 7.418 (0.4); 7.411 (0.7); 7.389 (0.3); 7.371 (0.5); 7.360 (4.9); 7.353 (1.8); 7.343 (0.9); 7.338 (2.0); 7.330 (6.3); 7.320 (0.9); 7.313 (0.9); 7.300 (5.3); 7.202 (0.3); 7.193 (0.6); 7.181 (0.4); 7.172 (0.4); 7.163 (0.7); 7.143 (0.4); 7.135 (0.3); 7.124 (0.7); 7.114 (6.5); 7.106 (2.0); 7.091 (1.9); 7.084 (6.9); 7.071 (1.1); 7.064 (0.5); 7.054 (3.0); 7.042 (0.6); 5.883 (2.6); 5.851 (2.5); 4.844 (2.7); 4.809 (3.0); 4.633 (0.4); 4.198 (0.5); 4.192 (1.5); 4.186 (1.6); 4.181 (0.6); 4.162 (0.5); 4.157 (1.3); 4.151 (1.4); 4.145 (0.6); 3.827 (0.7); 3.536 (1.9); 3.171 (0.4); 2.892 (0.4); 2.654 (0.6); 2.616 (0.9); 2.614 (0.9); 2.533 (0.5); 2.081 (16.0); 1.985 (2.4); 1.725 (1.1); 1.676 (0.6); 1.596 (4.3); 1.550 (0.7); 1.263 (0.3); 0.041 (5.3)

### Example IX.07

1H-NMR (300.2 MHz, d6-DMSO): δ=8.092 (6.0); 8.064 (6.4); 7.891 (0.4); 7.864 (0.4); 7.565 (1.5); 7.554 (12.8); 7.546 (5.0); 7.531 (5.1); 7.524 (16.0); 7.515 (2.3); 7.380 (6.8); 7.352 (6.4); 7.322 (2.3); 7.311 (16.0); 7.304 (4.8); 7.289 (5.7); 7.282 (12.3); 7.270 (1.4); 7.258 (1.0); 4.810 (0.5); 4.651 (0.6); 4.252 (0.7); 4.234 (0.6); 3.480 (0.5); 3.462 (0.5); 3.354 (13.8); 3.065 (7.0); 3.049 (8.4); 2.910 (6.7); 2.894 (5.6); 2.534 (9.4); 2.528 (12.6); 2.522 (9.1); 2.387 (0.4); 2.364 (0.5); 1.389 (0.6); 1.372 (1.3); 1.362 (1.5); 1.345 (2.5); 1.328 (1.5); 1.320 (1.6); 1.302 (0.8); 1.262 (0.4); 0.515 (0.6); 0.495 (1.8); 0.477 (6.5); 0.465 (3.0); 0.449 (7.1); 0.436 (3.0); 0.433 (3.1); 0.420 (2.6); 0.415 (2.4); 0.408 (1.7); 0.401 (3.0); 0.383 (2.6); 0.350 (1.0); 0.341 (2.6); 0.324 (3.3); 0.303 (2.4); 0.294 (1.1); 0.036 (0.6); 0.025 (12.4); 0.014 (0.5)

### Example IX.08

1H-NMR (300.2 MHz, d6-DMSO): δ=8.193 (1.0); 8.165 (1.8); 8.140 (1.1); 8.092 (4.6); 8.064 (5.0); 7.696 (2.7); 7.689 (1.5); 7.678 (14.8); 7.671 (6.6); 7.656 (5.0); 7.648 (16.0); 7.637 (1.6); 7.414 (2.1); 7.383 (5.9); 7.354 (4.9); 7.262 (1.2); 7.251 (12.5); 7.243 (5.4); 7.241 (6.4); 7.233 (2.4); 7.228 (3.6); 7.221 (10.6); 7.211 (5.4); 7.200 (0.5); 3.357 (7.1); 3.064 (5.3); 3.048 (6.5); 2.910 (5.0); 2.894 (4.4); 2.540 (2.4); 2.534 (5.1); 2.528 (6.8); 2.522 (4.9); 2.516 (2.3); 2.014 (0.5); 1.604 (0.3); 1.591 (3.0); 1.391 (0.4); 1.372 (1.0); 1.361 (1.3); 1.344 (2.0); 1.328 (1.4); 1.320 (1.3); 1.302 (0.9); 1.268 (2.7); 0.902 (0.8); 0.880 (2.5); 0.857 (0.9); 0.513 (0.4); 0.493 (1.1); 0.475 (4.9); 0.462 (2.2); 0.448 (5.5); 0.434 (2.8); 0.420 (2.0); 0.415 (2.0); 0.401 (2.3); 0.384 (2.0); 0.349 (0.8); 0.341 (2.0); 0.324 (2.6); 0.311 (1.0); 0.302 (1.8); 0.294 (1.0); 0.286 (0.7); 0.022 (7.4)

### Example IX.10

1H-NMR (300.2 MHz, CDCl₃): δ=8.255 (6.0); 7.429 (0.6); 7.418 (5.2); 7.410 (1.8); 7.395 (2.0); 7.388 (6.2); 7.377 (0.8); 7.300 (3.4); 7.128 (0.8); 7.117 (6.4); 7.109 (2.1); 7.094 (1.8); 7.087 (5.1); 7.076 (0.6); 6.970 (6.5); 5.337 (1.2); 3.029 (3.3); 3.012 (3.9); 2.841 (2.6); 2.839 (2.5); 2.824 (2.2); 2.822 (2.1); 1.696 (16.0); 1.612 (2.2); 0.039 (3.5)

### Example IX.11

1H-NMR (300.2 MHz, d6-DMSO): δ=9.802 (0.3); 8.242 (1.1); 8.215 (2.0); 8.189 (1.2); 8.140 (7.8); 8.111 (8.5); 7.960 (0.3); 7.875 (13.8); 7.847 (16.0); 7.813 (0.5); 7.754 (2.7); 7.729 (2.5); 7.502 (3.6); 7.489 (12.2); 7.472 (14.1); 7.461 (11.1); 7.444 (10.1); 7.015 (0.5); 6.986 (0.4); 3.355 (20.6); 3.075 (9.2); 3.059 (11.3); 3.035 (0.5); 3.027 (0.8); 3.010 (0.7); 2.925 (8.6); 2.908 (7.3); 2.879 (0.5); 2.540 (6.0); 2.534 (12.8); 2.528 (17.5); 2.522 (12.6); 2.516 (5.9); 1.898 (0.3); 1.605 (1.2); 1.591 (10.7); 1.543 (1.0); 1.474 (0.3); 1.405 (0.7); 1.378 (2.1); 1.358 (3.4); 1.342 (2.2); 1.333 (2.1); 1.315 (1.2); 1.269 (2.5); 0.903 (0.7); 0.881 (2.3); 0.858 (0.9); 0.503 (1.7); 0.485 (9.0); 0.472 (3.7); 0.458 (10.9); 0.448 (5.1); 0.430 (4.0); 0.417 (4.5); 0.397 (3.3); 0.385 (1.2); 0.354 (3.6); 0.345 (2.1); 0.336 (4.0); 0.324 (1.9); 0.315 (2.5); 0.307 (2.2); 0.298 (1.4); 0.277 (0.6); 0.034 (0.5); 0.023 (18.0); 0.012 (0.8)

### Biological Examples

The advanced fungicidal activity of the active compound combinations according to the invention is evident from the examples below. While the individual active compounds exhibit weaknesses with regard to the fungicidal activity, the combinations have an activity which exceeds a simple addition of activities.

A synergistic effect of fungicides is always present when the fungicidal activity of the active compound combinations exceeds the total of the activities of the active compounds when applied individually. The expected activity for a given combination of two active compounds can be calculated as follows (cf. Colby, S. R., “Calculating Synergistic and Antagonistic Responses of Herbicide Combinations”, Weeds 1967, 15, 20-22):

If

X is the efficacy when active compound A is applied at an application rate of m ppm (or g/ha),

Y is the efficacy when active compound B is applied at an application rate of n ppm (or g/ha),

E is the efficacy when the active compounds A and B are applied at application rates of m and n ppm (or g/ha), respectively, and

then

$$E = X + Y - \frac{X \cdot Y}{100}$$

The degree of efficacy, expressed in % is denoted. 0% means an efficacy which corresponds to that of the control while an efficacy of 100% means that no disease is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

A further way of demonstrating a synergistic effect is the method of Tammes (cf. “Isoboles, a graphic representation of synergism in pesticides” in Neth. J. Plant Path., 1964, 70, 73-80).

The invention is illustrated by the following examples. However the invention is not limited to the examples.

### Example A: In Vivo Preventive Test on Alternaria (Tomatoes)

Solvent: 24.5 parts by weight of acetone
   24.5 parts by weight of dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. After the spray coating has dried on, the plants are inoculated with an aqueous spore suspension of Alternaria solani. The plants are then placed in an incubation cabinet at approximately 20° C. and a relative atmospheric humidity of 100%.

The test is evaluated 3 days after the inoculation. 0% means an efficacy which corresponds to that of the untreated control while an efficacy of 100% means that no disease is observed.

The table below clearly shows that the observed activity of the active compound combination according to the invention is greater than the calculated activity, i.e. a synergistic effect is present.

TABLE A1
in vivo preventive test on Alternaria (tomatoes)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 49 | |
| (trifluoromethyl)pyridin-3-yl]-1-(1H-1,2,4- | | 1 | 13 | |
| triazol-1-yl)propan-2-ol | | | | |
| (I.59) 2-[6-(4-bromophenoxy)-2- | | 5 | 54 | |
| (trifluoromethyl)pyridin-3-yl]-1-(1H-1,2,4- | | 1 | 13 | |
| triazol-1-yl)propan-2-ol | | | | |
| 1.012 ipconazole | | 10 | 88 | |
| | | 5 | 67 | |
| | | 2.5 | 28 | |
| 1.020 spiroxamine | | 100 | 49 | |
| | | 50 | 38 | |
| | | 25 | 13 | |
| 1.021 tebuconazole | | 10 | 74 | |
| | | 5 | 21 | |
| | | 2.5 | 5 | |
| 4.005 pencycuron | | 100 | 33 | |
| | | 50 | 21 | |
| | | 25 | 5 | |
| 13.001 fludioxonil | | 20 | 95 | |
| | | 10 | 85 | |
| | | 5 | 77 | |
| (I.01) + 1.012 | 1:2 | 5 + 10 | 94 | 94 |
| (I.01) + 1.012 | 1:1 | 5 + 5 | 85 | 83 |
| (I.01) + 1.012 | 2:1 | 5 + 2.5 | 77 | 63 |
| (I.01) + 1.012 | 1:10 | 1 + 10 | 90 | 90 |
| (I.01) + 1.012 | 1:5 | 1 + 5 | 79 | 71 |
| (I.01) + 1.012 | 1:2.5 | 1 + 2.5 | 44 | 37 |
| (I.01) + 1.020 | 1:20 | 5 + 100 | 85 | 74 |
| (I.01) + 1.020 | 1:10 | 5 + 50 | 67 | 68 |
| (I.01) + 1.020 | 1:5 | 5 + 25 | 72 | 55 |
| (I.01) + 1.020 | 1:100 | 1 + 100 | 64 | 55 |
| (I.01) + 1.020 | 1:50 | 1 + 50 | 13 | 46 |
| (I.01) + 1.020 | 1:25 | 1 + 25 | 0 | 24 |
| (I.59) + 1.020 | 1:20 | 5 + 100 | 79 | 76 |
| (I.59) + 1.020 | 1:10 | 5 + 50 | 77 | 72 |
| (I.59) + 1.020 | 1:5 | 5 + 25 | 67 | 60 |
| (I.59) + 1.020 | 1:100 | 1 + 100 | 85 | 55 |
| (I.59) + 1.020 | 1:50 | 1 + 50 | 49 | 46 |
| (I.59) + 1.020 | 1:25 | 1 + 25 | 33 | 24 |
| (I.59) + 1.021 | 1:2 | 5 + 10 | 92 | 88 |
| (I.59) + 1.021 | 1:1 | 5 + 5 | 87 | 63 |
| (I.59) + 1.021 | 2:1 | 5 + 2.5 | 69 | 56 |
| (I.59) + 1.021 | 1:10 | 1 + 10 | 69 | 78 |
| (I.59) + 1.021 | 1:5 | 1 + 5 | 44 | 31 |
| (I.59) + 1.021 | 1:2.5 | 1 + 2.5 | 33 | 17 |
| (I.59) + 4.005 | 1:20 | 5 + 100 | 64 | 69 |
| (I.59) + 4.005 | 1:10 | 5 + 50 | 79 | 63 |
| (I.59) + 4.005 | 2:5 | 5 + 25 | 67 | 56 |
| (I.59) + 4.005 | 1:100 | 1 + 100 | 64 | 42 |
| (I.59) + 4.005 | 1:50 | 1 + 50 | 54 | 31 |
| (I.59) + 4.005 | 1:25 | 1 + 25 | 5 | 17 |
| (I.59) + 13.001 | 1:4 | 5 + 20 | 97 | 98 |
| (I.59) + 13.001 | 1:2 | 5 + 10 | 95 | 93 |
| (I.59) + 13.001 | 1:1 | 5 + 5 | 91 | 89 |
| (I.59) + 13.001 | 1:20 | 1 + 20 | 95 | 96 |
| (I.59) + 13.001 | 1:10 | 1 + 10 | 94 | 87 |
| (I.59) + 13.001 | 1:5 | 1 + 5 | 87 | 80 |

*found = activity found
**calc. = activity calculated using Colby's formula

TABLE A2
in vivo preventive test on Alternaria (tomatoes)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 32 | |
| (trifluoromethyl)pyridin-3-yl]-1-(1H-1,2,4 - | | 1 | 3 | |
| triazol-1-yl)propan-2-ol | | | | |
| (I.59) 2-[6-(4-bromophenoxy)-2- | | 5 | 18 | |
| (trifluoromethyl)pyridin-3-yl]-1-(1H-1,2,4 - | | 1 | 11 | |
| triazol-1-yl)propan-2-ol | | | | |
| 2.005 fluopyram | | 20 | 84 | |
| | | 10 | 61 | |
| | | 5 | 53 | |
| 2.017 penflufen | | 20 | 47 | |
| | | 10 | 26 | |
| | | 5 | 11 | |
| 2.027 3-(difluoromethyl)-1-methyl-N-(1,1,3- | | 4 | 11 | |
| trimethyl-2,3-dihydro-1H-inden-4-yl)-1H- | | 2 | 3 | |
| pyrazole-4-carboxamide | | 1 | 0 | |
| 3.020 trifloxystrobin | | 4 | 53 | |
| | | 2 | 42 | |
| | | 1 | 24 | |
| 3.025 (3S,6S,7R,8R)-8-benzyl-3-[({3- | | 20 | 58 | |
| [(isobutyryloxy)methoxy]-4-methoxypyridin-2- | | 10 | 18 | |
| yl}carbonyl)amino]-6-methyl-4,9-dioxo-1,5- | | 5 | 18 | |
| dioxonan-7-yl 2-methylpropanoate | | | | |
| (I.01) + 3.020 | 1:0.8 | 5 + 4 | 76 | 68 |
| (I.01) + 3.020 | 1:0.4 | 5 + 2 | 63 | 60 |
| (I.01) + 3.020 | 1:0.2 | 5 + 1 | 47 | 48 |
| (I.01) + 3.020 | 1:4 | 1 + 4 | 66 | 54 |
| (I.01) + 3.020 | 1:2 | 1 + 2 | 42 | 44 |
| (I.01) + 3.020 | 1:1 | 1 + 1 | 11 | 26 |
| (I.59) + 2.005 | 1:4 | 5 + 20 | 92 | 87 |
| (I.59) + 2.005 | 1:2 | 5 + 10 | 82 | 68 |
| (I.59) + 2.005 | 1:1 | 5 + 5 | 71 | 61 |
| (I.59) + 2.005 | 1:20 | 1 + 20 | 86 | 86 |
| (I.59) + 2.005 | 1:10 | 1 + 10 | 87 | 65 |
| (I.59) + 2.005 | 1:5 | 1 + 5 | 53 | 58 |
| (I.59) + 2.017 | 1:4 | 5 + 20 | 82 | 57 |
| (I.59) + 2.017 | 1:2 | 5 + 10 | 37 | 40 |
| (I.59) + 2.017 | 1:1 | 5 + 5 | 47 | 27 |
| (I.59) + 2.017 | 1:20 | 1 + 20 | 63 | 53 |
| (I.59) + 2.017 | 1:10 | 1 + 10 | 47 | 34 |
| (I.59) + 2.017 | 1:5 | 1 + 5 | 32 | 20 |
| (I.59) + 2.027 | 1:0.8 | 5 + 4 | 76 | 27 |
| (I.59) + 2.027 | 1:0.4 | 5 + 2 | 37 | 21 |
| (I.59) + 2.027 | 1:0.2 | 5 + 1 | 47 | 18 |
| (I.59) + 2.027 | 1:4 | 1 + 4 | 37 | 20 |
| (I.59) + 2.027 | 1:2 | 1 + 2 | 26 | 13 |
| (I.59) + 2.027 | 1:1 | 1 + 1 | 11 | 11 |
| (I.59) + 3.025 | 1:4 | 5 + 20 | 79 | 66 |
| (I.59) + 3.025 | 1:2 | 5 + 10 | 71 | 33 |
| (I.59) + 3.025 | 1:1 | 5 + 5 | 63 | 33 |
| (I.59) + 3.025 | 1:20 | 1 + 20 | 76 | 62 |
| (I.59) + 3.025 | 1:10 | 1 + 10 | 58 | 27 |
| (I.59) + 3.025 | 1:5 | 1 + 5 | 53 | 27 |

*found = activity found
**calc. = activity calculated using Colby's formula

TABLE A3
in vivo preventive test on Alternaria (tomatoes)

| | | Application rate | | |
|---|---|---|---|---|
| | | of active compound | Efficacy in % | |
| Active compounds | | in ppm a.i. | found* | calc.** |
| (I.59) 2-[6-(4-bromophenoxy)-2- | | 5 | 21 | |
| (trifluoromethyl)pyridin-3-yl]-1- | | 1 | 13 | |
| (1H-1,2,4-triazol-1-yl)propan-2-ol | | | | |
| 5.004 chlorothalonil | | 50 | 33 | |
| | | 25 | 13 | |
| | | 12.5 | 0 | |
| 5.013 mancozeb | | 50 | 77 | |
| | | 25 | 33 | |
| | | 12.5 | 28 | |
| (I.59) + 5.004 | 1:10 | 5 + 50 | 59 | 47 |
| (I.59) + 5.004 | 1:5 | 5 + 25 | 59 | 31 |
| (I.59) + 5.004 | 1:2.5 | 5 + 12.5 | 49 | 21 |
| (I.59) + 5.004 | 1:50 | 1 + 50 | 38 | 42 |
| (I.59) + 5.004 | 1:25 | 1 + 25 | 33 | 24 |
| (I.59) + 5.004 | 1:12.5 | 1 + 12.5 | 13 | 13 |
| (I.59) + 5.013 | 1:10 | 5 + 50 | 88 | 82 |
| (I.59) + 5.013 | 1:5 | 5 + 25 | 74 | 47 |
| (I.59) + 5.013 | 1:2.5 | 5 + 12.5 | 38 | 43 |
| (I.59) + 5.013 | 1:50 | 1 + 50 | 87 | 80 |
| (I.59) + 5.013 | 1:25 | 1 + 25 | 33 | 42 |
| (I.59) + 5.013 | 1:12.5 | 1 + 12.5 | 5 | 37 |

*found = activity found
**calc. = activity calculated using Colby's formula

### Example B: In Vivo Preventive Test on Colletotrichum (Tomatoes)

Solvent: 24.5 parts by weight of acetone
   24.5 parts by weight of dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. After the spray coating has dried on, the plants are inoculated with an aqueous spore suspension of Colletotrichum coccodes. The plants are then placed in an incubation cabinet at approximately 24° C. and a relative atmospheric humidity of 100%.

The test is evaluated 3 days after the inoculation. 0% means an efficacy which corresponds to that of the untreated control while an efficacy of 100% means that no disease is observed.

The table below clearly shows that the observed activity of the active compound combination according to the invention is greater than the calculated activity, i.e. a synergistic effect is present.

TABLE B1
in vivo preventive test on Colletotrichum (tomatoes)

| | | Application rate | | |
|---|---|---|---|---|
| | | of active compound | Efficacy in % | |
| Active compounds | | in ppm a.i. | found* | calc.** |
| (I.59) 2-[6-(4-bromophenoxy)-2- | | 5 | 67 | |
| (trifluoromethyl)pyridin-3-yl]-1- | | 1 | 44 | |
| (1H-1,2,4-triazol-1-yl)propan-2-ol | | | | |
| 1.018 prothioconazole | | 10 | 79 | |
| | | 5 | 59 | |
| | | 2.5 | 38 | |
| 1.020 spiroxamine | | 100 | 49 | |
| | | 50 | 44 | |
| | | 25 | 33 | |
| 1.021 tebuconazole | | 10 | 64 | |
| | | 5 | 44 | |
| | | 2.5 | 44 | |
| 4.005 pencycuron | | 100 | 33 | |
| | | 50 | 33 | |
| | | 25 | 33 | |
| (I.59) + 1.018 | 1:2 | 5 + 10 | 92 | 93 |
| (I.59) + 1.018 | 1:1 | 5 + 5 | 92 | 86 |
| (I.59) + 1.018 | 2:1 | 5 + 2.5 | 92 | 79 |
| (I.59) + 1.018 | 1:10 | 1 + 10 | 85 | 88 |
| (I.59) + 1.018 | 1:5 | 1 + 5 | 87 | 77 |
| (I.59) + 1.018 | 1:2.5 | 1 + 2.5 | 74 | 65 |
| (I.59) + 1.020 | 1:20 | 5 + 100 | 87 | 83 |
| (I.59) + 1.020 | 1:10 | 5 + 50 | 91 | 81 |
| (I.59) + 1.020 | 1:5 | 5 + 25 | 87 | 78 |
| (I.59) + 1.020 | 1:100 | 1 + 100 | 79 | 71 |
| (I.59) + 1.020 | 1:50 | 1 + 50 | 87 | 68 |
| (I.59) + 1.020 | 1:25 | 1 + 25 | 67 | 62 |
| (I.59) + 1.021 | 1:2 | 5 + 10 | 94 | 88 |
| (I.59) + 1.021 | 1:1 | 5 + 5 | 91 | 81 |
| (I.59) + 1.021 | 2:1 | 5 + 2.5 | 92 | 81 |
| (I.59) + 1.021 | 1:10 | 1 + 10 | 92 | 80 |
| (I.59) + 1.021 | 1:5 | 1 + 5 | 64 | 68 |
| (I.59) + 1.021 | 1:2.5 | 1 + 2.5 | 44 | 68 |
| (I.59) + 4.005 | 1:20 | 5 + 100 | 90 | 78 |
| (I.59) + 4.005 | 1:10 | 5 + 50 | 85 | 78 |
| (I.59) + 4.005 | 2:5 | 5 + 25 | 87 | 78 |
| (I.59) + 4.005 | 1:100 | 1 + 100 | 74 | 62 |
| (I.59) + 4.005 | 1:50 | 1 + 50 | 64 | 62 |
| (I.59) + 4.005 | 1:25 | 1 + 25 | 64 | 62 |

*found = activity found
**calc. = activity calculated using Colby's formula

TABLE B2
in vivo preventive test on Colletotrichum (tomatoes)

| | | Application rate of active | Efficacy in % | |
|---|---|---|---|---|
| Active compounds | | compound in ppm a.i. | found* | calc.** |
| (I.59) 2-[6-(4-bromophenoxy)-2- | | 5 | 0 | |
| (trifluoromethyl)pyridin-3-yl]-1-(1H- | | 1 | 0 | |
| 1,2,4-triazol-1-yl)propan-2-ol | | | | |
| 5.004 chlorothalonil | | 50 | 8 | |
| | | 25 | 8 | |
| | | 12.5 | 0 | |
| 5.013 mancozeb | | 50 | 0 | |
| | | 25 | 0 | |
| | | 12.5 | 0 | |
| (I.59) + 5.004 | 1:10 | 5 + 50 | 60 | 8 |
| (I.59) + 5.004 | 1:5 | 5 + 25 | 60 | 8 |
| (I.59) + 5.004 | 1:2.5 | 5 + 12.5 | 55 | 0 |
| (I.59) + 5.004 | 1:50 | 1 + 50 | 8 | 8 |
| (I.59) + 5.004 | 1:25 | 1 + 25 | 0 | 8 |
| (I.59) + 5.004 | 1:12.5 | 1 + 12.5 | 0 | 0 |
| (I.59) + 5.013 | 1:10 | 5 + 50 | 58 | 0 |
| (I.59) + 5.013 | 1:5 | 5 + 25 | 65 | 0 |
| (I.59) + 5.013 | 1:2.5 | 5 + 12.5 | 50 | 0 |
| (I.59) + 5.013 | 1:50 | 1 + 50 | 35 | 0 |
| (I.59) + 5.013 | 1:25 | 1 + 25 | 23 | 0 |
| (I.59) + 5.013 | 1:12.5 | 1 + 12.5 | 0 | 0 |

*found = activity found
**calc. = activity calculated using Colby's formula

### Example C: In Vivo Preventive Test on Phakopsora (Soybeans)

Solvent: 24.5 parts by weight of acetone
   24.5 parts by weight of dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. After the spray coating has dried on, the plants are inoculated with an aqueous spore suspension of the causal agent of soybean rust (Phakopsora pachyrhizi) and stay for 24 h without light in an incubation cabinet at approximately 24° C. and a relative atmospheric humidity of 95%. The plants remain in the incubation cabinet at approximately 24° C. and a relative atmospheric humidity of approximately 80% and a day/night interval of 12 h.

The test is evaluated 7 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE C1
in vivo preventive test on Phakopsora test (soybeans)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 50 | |
| (trifluoromethyl)pyridin-3-yl]-1-(1H- | | 1 | 0 | |
| 1,2,4-triazol-1-yl)propan-2-ol | | | | |
| (I.59) 2-[6-(4-bromophenoxy)-2- | | 5 | 50 | |
| (trifluoromethyl)pyridin-3-yl]-1-(1H- | | 1 | 8 | |
| 1,2,4-triazol-1-yl)propan-2-ol | | | | |
| 1.020 spiroxamine | | 100 | 75 | |
| | | 50 | 50 | |
| | | 25 | 23 | |
| (I.01) + 1.020 | 1:20 | 5 + 100 | 96 | 88 |
| (I.01) + 1.020 | 1:10 | 5 + 50 | 95 | 75 |
| (I.01) + 1.020 | 1:5 | 5 + 25 | 85 | 61 |
| (I.01) + 1.020 | 1:100 | 1 + 100 | 93 | 75 |
| (I.01) + 1.020 | 1:50 | 1 + 50 | 83 | 50 |
| (I.01) + 1.020 | 1:25 | 1 + 25 | 35 | 23 |
| (I.59) + 1.020 | 1:20 | 5 + 100 | 98 | 88 |
| (I.59) + 1.020 | 1:10 | 5 + 50 | 90 | 75 |
| (I.59) + 1.020 | 1:5 | 5 + 25 | 90 | 61 |
| (I.59) + 1.020 | 1:100 | 1 + 100 | 88 | 77 |
| (I.59) + 1.020 | 1:50 | 1 + 50 | 78 | 54 |
| (I.59) + 1.020 | 1:25 | 1 + 25 | 35 | 28 |

*found = activity found
**calc. = activity calculated using Colby's formula

TABLE C2
in vivo preventive test on Phakopsora (soybeans)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 68 | |
| (trifluoromethyl)pyridin-3-yl]-1-(1H-1,2,4- | | 1 | 0 | |
| triazol-1-yl)propan-2-ol | | | | |
| (I.59) 2-[6-(4-bromophenoxy)-2- | | 5 | 50 | |
| (trifluoromethyl)pyridin-3-yl]-1-(1H-1,2,4- | | 1 | 0 | |
| triazol-1-yl)propan-2-ol | | | | |
| 2.002 bixafen | | 10 | 15 | |
| | | 5 | 0 | |
| | | 2.5 | 0 | |
| 2.017 penflufen | | 20 | 83 | |
| | | 10 | 43 | |
| | | 5 | 8 | |
| 2.027 3-(difluoromethyl)-1-methyl-N-(1,1,3- | | 4 | 100 | |
| trimethyl-2,3-dihydro-1H-inden-4-yl)-1H- | | 2 | 95 | |
| pyrazole-4-carboxamide | | 1 | 50 | |
| 3.025 (3S,6S,7R,8R)-8-benzyl-3-[({3- | | 20 | 63 | |
| [(isobutyryloxy)methoxy]-4-methoxypyridin-2- | | 10 | 40 | |
| yl}carbonyl)amino]-6-methyl-4,9-dioxo-1,5- | | 5 | 23 | |
| dioxonan-7-yl 2-methylpropanoate | | | | |
| (I.01) + 2.002 | 1:2 | 5 + 10 | 80 | 72 |
| (I.01) + 2.002 | 1:1 | 5 + 5 | 65 | 68 |
| (I.01) + 2.002 | 2:1 | 5 + 2.5 | 73 | 68 |
| (I.01) + 2.002 | 1:10 | 1 + 10 | 0 | 15 |
| (I.01) + 2.002 | 1:5 | 1 + 5 | 0 | 0 |
| (I.01) + 2.002 | 1:2.5 | 1 + 2.5 | 0 | 0 |
| (I.01) + 2.017 | 1:4 | 5 + 20 | 100 | 94 |
| (I.01) + 2.017 | 1:2 | 5 + 10 | 90 | 81 |
| (I.01) + 2.017 | 1:1 | 5 + 5 | 96 | 70 |
| (I.01) + 2.017 | 1:20 | 1 + 20 | 85 | 83 |
| (I.01) + 2.017 | 1:10 | 1 + 10 | 75 | 43 |
| (I.01) + 2.017 | 1:5 | 1 + 5 | 50 | 8 |
| (I.01) + 1.027 | 1:0.8 | 5 + 4 | 100 | 100 |
| (I.01) + 1.027 | 1:0.4 | 5 + 2 | 94 | 98 |
| (I.01) + 1.027 | 1:0.2 | 5 + 1 | 90 | 84 |
| (I.01) + 1.027 | 1:4 | 1 + 4 | 100 | 100 |
| (I.01) + 1.027 | 1:2 | 1 + 2 | 99 | 95 |
| (I.01) + 1.027 | 1:1 | 1 + 1 | 84 | 50 |
| (I.01) + 3.025 | 1:4 | 5 + 20 | 91 | 88 |
| (I.01) + 3.025 | 1:2 | 5 + 10 | 91 | 88 |
| (I.01) + 3.025 | 1:1 | 5 + 5 | 90 | 75 |
| (I.01) + 3.025 | 1:20 | 1 + 20 | 80 | 63 |
| (I.01) + 3.025 | 1:10 | 1 + 10 | 65 | 40 |
| (I.01) + 3.025 | 1:5 | 1 + 5 | 30 | 23 |
| (I.59) + 2.002 | 1:2 | 5 + 10 | 65 | 58 |
| (I.59) + 2.002 | 1:1 | 5 + 5 | 58 | 50 |
| (I.59) + 2.002 | 2:1 | 5 + 2.5 | 58 | 50 |
| (I.59) + 2.002 | 1:10 | 1 + 10 | 8 | 15 |
| (I.59) + 2.002 | 1:5 | 1 + 5 | 0 | 0 |
| (I.59) + 2.002 | 1:2.5 | 1 + 2.5 | 0 | 0 |
| (I.59) + 2.017 | 1:4 | 5 + 20 | 98 | 91 |
| (I.59) + 2.017 | 1:2 | 5 + 10 | 69 | 71 |
| (I.59) + 2.017 | 1:1 | 5 + 5 | 65 | 54 |
| (I.59) + 2.017 | 1:20 | 1 + 20 | 81 | 83 |
| (I.59) + 2.017 | 1:10 | 1 + 10 | 80 | 43 |
| (I.59) + 2.017 | 1:5 | 1 + 5 | 23 | 8 |
| (I.59) + 2.027 | 1:0.8 | 5 + 4 | 100 | 100 |
| (I.59) + 2.027 | 1:0.4 | 5 + 2 | 96 | 98 |
| (I.59) + 2.027 | 1:0.2 | 5 + 1 | 88 | 75 |
| (I.59) + 2.027 | 1:4 | 1 + 4 | 100 | 100 |
| (I.59) + 2.027 | 1:2 | 1 + 2 | 98 | 95 |
| (I.59) + 2.027 | 1:1 | 1 + 1 | 65 | 50 |
| (I.59) + 3.025 | 1:4 | 5 + 20 | 90 | 81 |
| (I.59) + 3.025 | 1:2 | 5 + 10 | 70 | 70 |
| (I.59) + 3.025 | 1:1 | 5 + 5 | 70 | 61 |
| (I.59) + 3.025 | 1:20 | 1 + 20 | 78 | 63 |
| (I.59) + 3.025 | 1:10 | 1 + 10 | 40 | 40 |
| (I.59) + 3.025 | 1:5 | 1 + 5 | 28 | 23 |

*found = activity found
**calc. = activity calculated using Colby's formula

TABLE C3
in vivo preventive test on Phakopsora (soybeans)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 50 | |
| (trifluoromethyl)pyridin-3-yl]-1-(1H- | | 1 | 0 | |
| 1,2,4-triazol-1-yl)propan-2-ol | | | | |
| (I.59) 2-[6-(4-bromophenoxy)-2- | | 5 | 40 | |
| (trifluoromethyl)pyridin-3-yl]-1-(1H- | | 1 | 0 | |
| 1,2,4-triazol-1-yl)propan-2-ol | | | | |
| 5.004 chlorothalonil | | 50 | 0 | |
| | | 25 | 8 | |
| | | 12.5 | 0 | |
| 5.013 mancozeb | | 50 | 90 | |
| | | 25 | 45 | |
| | | 12.5 | 23 | |
| 5.018 propineb | | 20 | 83 | |
| | | 10 | 23 | |
| | | 5 | 0 | |
| 12.003 metalaxyl | | 200 | 23 | |
| | | 100 | 0 | |
| | | 50 | 0 | |
| 12.004 metalaxyl-M (mefenoxam) | | 200 | 15 | |
| | | 100 | 0 | |
| | | 50 | 0 | |
| (I.01) + 5.004 | 1:10 | 5 + 50 | 90 | 50 |
| (I.01) + 5.004 | 1:5 | 5 + 25 | 48 | 54 |
| (I.01) + 5.004 | 1:2.5 | 5 + 12.5 | 55 | 50 |
| (I.01) + 5.004 | 1:50 | 1 + 50 | 40 | 0 |
| (I.01) + 5.004 | 1:25 | 1 + 25 | 8 | 8 |
| (I.01) + 5.004 | 1:12.5 | 1 + 12.5 | 0 | 0 |
| (I.01) + 5.018 | 1:10 | 5 + 50 | 100 | 91 |
| (I.01) + 5.018 | 1:5 | 5 + 25 | 73 | 61 |
| (I.01) + 5.018 | 1:2.5 | 5 + 12.5 | 78 | 50 |
| (I.01) + 5.018 | 1:50 | 1 + 50 | 94 | 83 |
| (I.01) + 5.018 | 1:25 | 1 + 25 | 25 | 23 |
| (I.01) + 5.018 | 1:12.5 | 1 + 12.5 | 8 | 0 |
| (I.01) + 12.003 | 1:40 | 5 + 200 | 96 | 61 |
| (I.01) + 12.003 | 1:20 | 5 + 100 | 85 | 50 |
| (I.01) + 12.003 | 1:10 | 5 + 50 | 80 | 50 |
| (I.01) + 12.003 | 1:200 | 1 + 200 | 53 | 23 |
| (I.01) + 12.003 | 1:100 | 1 + 100 | 8 | 0 |
| (I.01) + 12.003 | 1:50 | 1 + 50 | 0 | 0 |
| (I.01) + 12.004 | 1:40 | 5 + 200 | 89 | 58 |
| (I.01) + 12.004 | 1:20 | 5 + 100 | 86 | 50 |
| (I.01) + 12.004 | 1:10 | 5 + 50 | 63 | 50 |
| (I.01) + 12.004 | 1:200 | 1 + 200 | 50 | 15 |
| (I.01) + 12.004 | 1:100 | 1 + 100 | 8 | 0 |
| (I.01) + 12.004 | 1:50 | 1 + 50 | 0 | 0 |
| (I.59) + 5.004 | 1:10 | 5 + 50 | 90 | 40 |
| (I.59) + 5.004 | 1:5 | 5 + 25 | 53 | 45 |
| (I.59) + 5.004 | 1:2.5 | 5 + 12.5 | 55 | 40 |
| (I.59) + 5.004 | 1:50 | 1 + 50 | 38 | 0 |
| (I.59) + 5.004 | 1:25 | 1 + 25 | 13 | 8 |
| (I.59) + 5.004 | 1:12.5 | 1 + 12.5 | 0 | 0 |
| (I.59) + 5.013 | 1:10 | 5 + 50 | 96 | 94 |
| (I.59) + 5.013 | 1:5 | 5 + 25 | 81 | 67 |
| (I.59) + 5.013 | 1:2.5 | 5 + 12.5 | 63 | 54 |
| (I.59) + 5.013 | 1:50 | 1 + 50 | 89 | 90 |
| (I.59) + 5.013 | 1:25 | 1 + 25 | 55 | 45 |
| (I.59) + 5.013 | 1:12.5 | 1 + 12.5 | 8 | 23 |
| (I.59) + 5.018 | 1:10 | 5 + 50 | 98 | 90 |
| (I.59) + 5.018 | 1:5 | 5 + 25 | 80 | 54 |
| (I.59) + 5.018 | 1:2.5 | 5 + 12.5 | 60 | 40 |
| (I.59) + 5.018 | 1:50 | 1 + 50 | 89 | 83 |
| (I.59) + 5.018 | 1:25 | 1 + 25 | 30 | 23 |
| (I.59) + 5.018 | 1:12.5 | 1 + 12.5 | 0 | 0 |
| (I.59) + 12.003 | 1:40 | 5 + 200 | 91 | 54 |
| (I.59) + 12.003 | 1:20 | 5 + 100 | 89 | 40 |
| (I.59) + 12.003 | 1:10 | 5 + 50 | 75 | 40 |
| (I.59) + 12.003 | 1:200 | 1 + 200 | 65 | 23 |
| (I.59) + 12.003 | 1:100 | 1 + 100 | 8 | 0 |
| (I.59) + 12.003 | 1:50 | 1 + 50 | 0 | 0 |
| (I.59) + 12.004 | 1:40 | 5 + 200 | 93 | 49 |
| (I.59) + 12.004 | 1:20 | 5 + 100 | 88 | 40 |
| (I.59) + 12.004 | 1:10 | 5 + 50 | 65 | 40 |
| (I.59) + 12.004 | 1:200 | 1 + 200 | 60 | 15 |
| (I.59) + 12.004 | 1:100 | 1 + 100 | 40 | 0 |
| (I.59) + 12.004 | 1:50 | 1 + 50 | 0 | 0 |

*found = activity found
**calc. = activity calculated using Colby's formula

### Example D: In Vivo Preventive Test on Sphaerotheca (Cucumbers)

Solvent: 24.5 parts by weight of acetone
   24.5 parts by weight of dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. After the spray coating has dried on, the plants are inoculated with an aqueous spore suspension of Sphaerotheca fuliginea. The plants are then placed in a greenhouse at approximately 23° C. and a relative atmospheric humidity of approximately 70%.

The test is evaluated 7 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE D1
in vivo preventive test on Sphaerotheca test (cucumbers)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 93 | |
| (trifluoromethyl)pyridin-3-yl]-1-(1H-1,2,4- | | 1 | 20 | |
| triazol-1-yl)propan-2-ol | | | | |
| (I.59) 2-[6-(4-bromophenoxy)-2- | | 5 | 89 | |
| (trifluoromethyl)pyridin-3-yl]-1-(1H-1,2,4- | | 1 | 20 | |
| triazol-1-yl)propan-2-ol | | | | |
| 1.012 ipconazole | | 10 | 100 | |
| | | 5 | 87 | |
| | | 2.5 | 26 | |
| 1.018 prothioconazole | | 10 | 100 | |
| | | 5 | 96 | |
| | | 2.5 | 71 | |
| 1.020 spiroxamine | | 100 | 49 | |
| | | 50 | 37 | |
| | | 25 | 31 | |
| 1.021 tebuconazole | | 10 | 83 | |
| | | 5 | 69 | |
| | | 2.5 | 37 | |
| (I.01) + 1.018 | 1:2 | 5 + 10 | 100 | 100 |
| (I.01) + 1.018 | 1:1 | 5 + 5 | 100 | 100 |
| (I.01) + 1.018 | 2:1 | 5 + 2.5 | 100 | 98 |
| (I.01) + 1.018 | 1:10 | 1 + 10 | 100 | 100 |
| (I.01) + 1.018 | 1:5 | 1 + 5 | 100 | 97 |
| (I.01) + 1.018 | 1:2.5 | 1 + 2.5 | 96 | 77 |
| (I.01) + 1.020 | 1:20 | 5 + 100 | 96 | 96 |
| (I.01) + 1.020 | 1:10 | 5 + 50 | 96 | 96 |
| (I.01) + 1.020 | 1:5 | 5 + 25 | 87 | 95 |
| (I.01) + 1.020 | 1:100 | 1 + 100 | 91 | 59 |
| (I.01) + 1.020 | 1:50 | 1 + 50 | 66 | 50 |
| (I.01) + 1.020 | 1:25 | 1 + 25 | 20 | 45 |
| (I.01) + 1.021 | 1:2 | 5 + 10 | 100 | 99 |
| (I.01) + 1.021 | 1:1 | 5 + 5 | 99 | 98 |
| (I.01) + 1.021 | 2:1 | 5 + 2.5 | 94 | 96 |
| (I.01) + 1.021 | 1:10 | 1 + 10 | 93 | 86 |
| (I.01) + 1.021 | 1:5 | 1 + 5 | 81 | 75 |
| (I.01) + 1.021 | 1:2.5 | 1 + 2.5 | 63 | 50 |
| (I.59) + 1.012 | 1:2 | 5 + 10 | 100 | 100 |
| (I.59) + 1.012 | 1:1 | 5 + 5 | 100 | 99 |
| (I.59) + 1.012 | 2:1 | 5 + 2.5 | 97 | 92 |
| (I.59) + 1.012 | 1:10 | 1 + 10 | 97 | 100 |
| (I.59) + 1.012 | 1:5 | 1 + 5 | 86 | 90 |
| (I.59) + 1.012 | 1:2.5 | 1 + 2.5 | 63 | 41 |

*found = activity found
**calc. = activity calculated using Colby's formula

TABLE D2
in vivo preventive test on Sphaerotheca (cucumbers)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 65 | |
| (trifluoromethyl)pyridin-3-yl]-1-(1H-1,2,4- | | 1 | 15 | |
| triazol-1-yl)propan-2-ol | | | | |
| (I.59) 2-[6-(4-bromophenoxy)-2- | | 5 | 55 | |
| (trifluoromethyl)pyridin-3-yl]-1-(1H-1,2,4- | | 1 | 8 | |
| triazol-1-yl)propan-2-ol | | | | |
| 15.047 3-(4,4-difluoro-3,3-dimethyl-3,4- | | 10 | 8 | |
| dihydroisoquinolin-1-yl)quinoline | | 5 | 0 | |
| | | 2.5 | 0 | |
| (I.01) + 15.047 | 1:2 | 5 + 10 | 93 | 68 |
| (I.01) + 15.047 | 1:1 | 5 + 5 | 83 | 65 |
| (I.01) + 15.047 | 2:1 | 5 + 2.5 | 88 | 65 |
| (I.01) + 15.047 | 1:10 | 1 + 10 | 23 | 21 |
| (I.01) + 15.047 | 1:5 | 1 + 5 | 0 | 15 |
| (I.01) + 15.047 | 1:2.5 | 1 + 2.5 | 0 | 15 |
| (I.59) + 15.047 | 1:2 | 5 + 10 | 93 | 58 |
| (I.59) + 15.047 | 1:1 | 5 + 5 | 91 | 55 |
| (I.59) + 15.047 | 2:1 | 5 + 2.5 | 70 | 55 |
| (I.59) + 15.047 | 1:10 | 1 + 10 | 15 | 14 |
| (I.59) + 15.047 | 1:5 | 1 + 5 | 0 | 8 |
| (I.59) + 15.047 | 1:2.5 | 1 + 2.5 | 0 | 8 |

*found = activity found
**calc. = activity calculated using Colby's formula

TABLE D3
in vivo preventive test on Sphaerotheca (cucumbers)

| | | Application rate of active | Efficacy in % | |
|---|---|---|---|---|
| Active compounds | | compound in ppm a.i. | found* | calc.** |
| (I.59) 2-[6-(4-bromophenoxy)-2- | | 5 | 88 | |
| (trifluoromethyl)pyridin-3-yl]-1-(1H-1,2,4- | | 1 | 0 | |
| triazol-1-yl)propan-2-ol | | | | |
| 2.038 N-(5-chloro-2-isopropylbenzyl)-N- | | 4 | 98 | |
| cyclopropyl-3-(difluoromethyl)-5-fluoro-1- | | 2 | 93 | |
| methyl-1H-pyrazole-4-carboxamide | | 1 | 40 | |
| (I.59) + 2.038 | 1:0.8 | 5 + 4 | 100 | 100 |
| (I.59) + 2.038 | 1:0.4 | 5 + 2 | 96 | 99 |
| (I.59) + 2.038 | 1:0.2 | 5 + 1 | 86 | 93 |
| (I.59) + 2.038 | 1:4 | 1 + 4 | 99 | 98 |
| (I.59) + 2.038 | 1:2 | 1 + 2 | 98 | 93 |
| (I.59) + 2.038 | 1:1 | 1 + 1 | 58 | 40 |

*found = activity found
**calc. = activity calculated using Colby's formula

### Example E: In Vivo Preventive Test on Venturia (Apples)

Solvent: 24.5 parts by weight of acetone
   24.5 parts by weight of dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. After the spray coating has dried on, the plants are inoculated with an aqueous conidia suspension of the causal agent of apple scab (Venturia inaequalis) and then remain for 1 day in an incubation cabinet at approximately 20° C. and a relative atmospheric humidity of 100%. The plants are then placed in a greenhouse at approximately 21° C. and a relative atmospheric humidity of approximately 90%.

The test is evaluated 10 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE E1
in vivo preventive test on Venturia (apples)

| | | Application rate | | |
|---|---|---|---|---|
| | | of active com- | Efficacy in % | |
| Active compounds | | pound in ppm a.i. | found* | calc.** |
| (I.01) 2-[6-(4-chlorophenoxy)-2- | | 5 | 74 | |
| (trifluoromethyl)pyridin-3-yl]-1- | | 1 | 78 | |
| (1H-1,2,4-triazol-1-yl)propan-2-ol | | | | |
| (I.59) 2-[6-(4-bromophenoxy)-2- | | 5 | 74 | |
| (trifluoromethyl)pyridin-3-yl]-1- | | 1 | 58 | |
| (1H-1,2,4-triazol-1-yl)propan-2-ol | | | | |
| 1.018 prothioconazole | | 10 | 61 | |
| | | 5 | 30 | |
| | | 2.5 | 0 | |
| 1.020 spiroxamine | | 100 | 14 | |
| | | 50 | 0 | |
| | | 25 | 0 | |
| 1.021 tebuconazole | | 10 | 44 | |
| | | 5 | 34 | |
| | | 2.5 | 4 | |
| 4.005 pencycuron | | 100 | 4 | |
| | | 50 | 0 | |
| | | 25 | 0 | |
| 13.001 fludioxonil | | 20 | 4 | |
| | | 10 | 4 | |
| | | 5 | 8 | |
| 13.004 proquinazid | | 50 | 0 | |
| | | 25 | 0 | |
| | | 12.5 | 0 | |
| (I.01) + 1.020 | 1:20 | 5 + 100 | 95 | 77 |
| (I.01) + 1.020 | 1:10 | 5 + 50 | 86 | 74 |
| (I.01) + 1.020 | 1:5 | 5 + 25 | 86 | 74 |
| (I.01) + 1.020 | 1:100 | 1 + 100 | 91 | 81 |
| (I.01) + 1.020 | 1:50 | 1 + 50 | 94 | 78 |
| (I.01) + 1.020 | 1:25 | 1 + 25 | 73 | 78 |
| (I.01) + 1.021 | 1:2 | 5 + 10 | 86 | 85 |
| (I.01) + 1.021 | 1:1 | 5 + 5 | 91 | 83 |
| (I.01) + 1.021 | 2:1 | 5 + 2.5 | 83 | 75 |
| (I.01) + 1.021 | 1:10 | 1 + 10 | 93 | 87 |
| (I.01) + 1.021 | 1:5 | 1 + 5 | 93 | 85 |
| (I.01) + 1.021 | 1:2.5 | 1 + 2.5 | 89 | 78 |
| (I.01) + 4.005 | 1:20 | 5 + 100 | 86 | 75 |
| (I.01) + 4.005 | 1:10 | 5 + 50 | 94 | 74 |
| (I.01) + 4.005 | 1:5 | 5 + 25 | 94 | 74 |
| (I.01) + 4.005 | 1:100 | 1 + 100 | 92 | 78 |
| (I.01) + 4.005 | 1:50 | 1 + 50 | 81 | 78 |
| (I.01) + 4.005 | 1:25 | 1 + 25 | 86 | 78 |
| (I.01) + 13.001 | 1:4 | 5 + 20 | 96 | 75 |
| (I.01) + 13.001 | 1:2 | 5 + 10 | 93 | 75 |
| (I.01) + 13.001 | 1:1 | 5 + 5 | 94 | 76 |
| (I.01) + 13.001 | 1:20 | 1 + 20 | 90 | 78 |
| (I.01) + 13.001 | 1:10 | 1 + 10 | 94 | 78 |
| (I.01) + 13.001 | 1:5 | 1 + 5 | 93 | 79 |
| (I.01) + 13.004 | 1:10 | 5 + 50 | 90 | 74 |
| (I.01) + 13.004 | 1:5 | 5 + 25 | 92 | 74 |
| (I.01) + 13.004 | 1:2.5 | 5 + 12.5 | 79 | 74 |
| (I.01) + 13.004 | 1:50 | 1 + 50 | 90 | 78 |
| (I.01) + 13.004 | 1:25 | 1 + 25 | 92 | 78 |
| (I.01) + 13.004 | 1:12.5 | 1 + 12.5 | 76 | 78 |
| (I.59) + 1.018 | 1:2 | 5 + 10 | 88 | 90 |
| (I.59) + 1.018 | 1:1 | 5 + 5 | 74 | 82 |
| (I.59) + 1.018 | 2:1 | 5 + 2.5 | 87 | 74 |
| (I.59) + 1.018 | 1:10 | 1 + 10 | 85 | 84 |
| (I.59) + 1.018 | 1:5 | 1 + 5 | 91 | 70 |
| (I.59) + 1.018 | 1:2.5 | 1 + 12.5 | 70 | 58 |
| (I.59) + 1.020 | 1:20 | 5 + 100 | 85 | 77 |
| (I.59) + 1.020 | 1:10 | 5 + 50 | 90 | 74 |
| (I.59) + 1.020 | 1:5 | 5 + 25 | 86 | 74 |
| (I.59) + 1.020 | 1:100 | 1 + 100 | 79 | 63 |
| (I.59) + 1.020 | 1:50 | 1 + 50 | 79 | 58 |
| (I.59) + 1.020 | 1:25 | 1 + 25 | 88 | 58 |
| (I.59) + 1.021 | 1:2 | 5 + 10 | 87 | 85 |
| (I.59) + 1.021 | 1:1 | 5 + 5 | 85 | 83 |
| (I.59) + 1.021 | 2:1 | 5 + 2.5 | 89 | 75 |
| (I.59) + 1.021 | 1:10 | 1 + 1090 | 90 | 76 |
| (I.59) + 1.021 | 1:5 | 1 + 5 | 80 | 72 |
| (I.59) + 1.021 | 1:2.5 | 1 + 2.5 | 74 | 59 |
| (I.59) + 4.005 | 1:20 | 5 + 100 | 94 | 75 |
| (I.59) + 4.005 | 1:10 | 5 + 50 | 94 | 74 |
| (I.59) + 4.005 | 1:5 | 5 + 25 | 84 | 74 |
| (I.59) + 4.005 | 1:100 | 1 + 100 | 81 | 59 |
| (I.59) + 4.005 | 1:50 | 1 + 50 | 92 | 58 |
| (I.59) + 4.005 | 1:25 | 1 + 25 | 81 | 58 |
| (I.59) + 13.001 | 1:4 | 5 + 20 | 89 | 75 |
| (I.59) + 13.001 | 1:2 | 5 + 10 | 94 | 75 |
| (I.59) + 13.001 | 1:1 | 5 + 5 | 90 | 76 |
| (I.59) + 13.001 | 1:20 | 1 + 20 | 92 | 59 |
| (I.59) + 13.001 | 1:10 | 1 + 10 | 83 | 59 |
| (I.59) + 13.001 | 1:5 | 1 + 5 | 88 | 61 |
| (I.59) + 13.004 | 1:10 | 5 + 50 | 86 | 74 |
| (I.59) + 13.004 | 1:5 | 5 + 25 | 84 | 74 |
| (I.59) + 13.004 | 1:2.5 | 5 + 12.5 | 78 | 74 |
| (I.59) + 13.004 | 1:50 | 1 + 50 | 83 | 58 |
| (I.59) + 13.004 | 1:25 | 1 + 25 | 82 | 58 |
| (I.59) + 13.004 | 1:12.5 | 1 + 12.5 | 91 | 58 |

*found = activity found
**calc. = activity calculated using Colby's formula

TABLE E2
in vivo preventive test on Venturia (apples)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 5 | 88 | |
| (trifluoromethyl)pyridin-3-yl]-1-(1H-1,2,4- | | 1 | 61 | |
| triazol-1-yl)propan-2-ol | | | | |
| (I.59) 2-[6-(4-bromophenoxy)-2- | | 5 | 37 | |
| (trifluoromethyl)pyridin-3-yl]-1-(1H-1,2,4- | | 1 | 33 | |
| triazol-1-yl)propan-2-ol | | | | |
| 5.004 chlorothalonil | | 50 | 93 | |
| | | 25 | 14 | |
| | | 12.5 | 24 | |
| 5.013 mancozeb | | 50 | 95 | |
| | | 25 | 18 | |
| | | 12.5 | 0 | |
| 5.018 propineb | | 20 | 100 | |
| | | 10 | 94 | |
| | | 5 | 54 | |
| 12.003 metalaxyl | | 200 | 19 | |
| | | 100 | 11 | |
| | | 50 | 11 | |
| 12.004 metalaxyl-M (mefenoxam) | | 200 | 30 | |
| | | 100 | 11 | |
| | | 50 | 0 | |
| 15.008 cyflufenamid | | 20 | 4 | |
| | | 10 | 0 | |
| | | 5 | 0 | |
| (I.01) + 5.004 | 1:10 | 5 + 50 | 100 | 99 |
| (I.01) + 5.004 | 1:5 | 5 + 25 | 99 | 89 |
| (I.01) + 5.004 | 1:2.5 | 5 + 12.5 | 94 | 90 |
| (I.01) + 5.004 | 1:50 | 1 + 50 | 100 | 97 |
| (I.01) + 5.004 | 1:25 | 1 + 25 | 99 | 67 |
| (I.01) + 5.004 | 1:12.5 | 1 + 12.5 | 88 | 70 |
| (I.01) + 5.013 | 1:10 | 5 + 50 | 98 | 99 |
| (I.01) + 5.013 | 1:5 | 5 + 25 | 98 | 90 |
| (I.01) + 5.013 | 1:2.5 | 5 + 12.5 | 96 | 88 |
| (I.01) + 5.013 | 1:50 | 1 + 50 | 99 | 98 |
| (I.01) + 5.013 | 1:25 | 1 + 25 | 97 | 68 |
| (I.01) + 5.013 | 1:12.5 | 1 + 12.5 | 95 | 61 |
| (I.01) + 5.018 | 1:10 | 5 + 50 | 99 | 100 |
| (I.01) + 5.018 | 1:5 | 5 + 25 | 99 | 99 |
| (I.01) + 5.018 | 1:2.5 | 5 + 12.5 | 99 | 94 |
| (I.01) + 5.018 | 1:50 | 1 + 50 | 100 | 100 |
| (I.01) + 5.018 | 1:25 | 1 + 25 | 98 | 98 |
| (I.01) + 5.018 | 1:12.5 | 1 + 12.5 | 96 | 82 |
| (I.01) + 12.003 | 1:40 | 5 + 200 | 88 | 90 |
| (I.01) + 12.003 | 1:20 | 5 + 100 | 82 | 89 |
| (I.01) + 12.003 | 1:10 | 5 + 50 | 81 | 89 |
| (I.01) + 12.003 | 1:200 | 1 + 200 | 78 | 69 |
| (I.01) + 12.003 | 1:100 | 1 + 100 | 74 | 66 |
| (I.01) + 12.003 | 1:50 | 1 + 50 | 70 | 66 |
| (I.01) + 12.004 | 1:40 | 5 + 200 | 80 | 91 |
| (I.01) + 12.004 | 1:20 | 5 + 100 | 84 | 89 |
| (I.01) + 12.004 | 1:10 | 5 + 50 | 86 | 88 |
| (I.01) + 12.004 | 1:200 | 1 + 200 | 93 | 73 |
| (I.01) + 12.004 | 1:100 | 1 + 100 | 78 | 66 |
| (I.01) + 12.004 | 1:50 | 1 + 50 | 60 | 61 |
| (I.59) + 5.004 | 1:10 | 5 + 50 | 99 | 96 |
| (I.59) + 5.004 | 1:5 | 5 + 25 | 99 | 45 |
| (I.59) + 5.004 | 1:2.5 | 5 + 12.5 | 96 | 52 |
| (I.59) + 5.004 | 1:50 | 1 + 50 | 98 | 95 |
| (I.59) + 5.004 | 1:25 | 1 + 25 | 98 | 42 |
| (I.59) + 5.004 | 1:12.5 | 1 + 12.5 | 93 | 49 |
| (I.59) + 5.013 | 1:10 | 5 + 50 | 99 | 97 |
| (I.59) + 5.013 | 1:5 | 5 + 25 | 98 | 48 |
| (I.59) + 5.013 | 1:2.5 | 5 + 12.5 | 83 | 37 |
| (I.59) + 5.013 | 1:50 | 1 + 50 | 100 | 97 |
| (I.59) + 5.013 | 1:25 | 1 + 25 | 96 | 44 |
| (I.59) + 5.013 | 1:12.5 | 1 + 12.5 | 90 | 33 |
| (I.59) + 5.018 | 1:10 | 5 + 50 | 100 | 100 |
| (I.59) + 5.018 | 1:5 | 5 + 25 | 100 | 96 |
| (I.59) + 5.018 | 1:2.5 | 5 + 12.5 | 95 | 71 |
| (I.59) + 5.018 | 1:50 | 1 + 50 | 99 | 100 |
| (I.59) + 5.018 | 1:25 | 1 + 25 | 99 | 96 |
| (I.59) + 5.018 | 1:12.5 | 1 + 12.5 | 96 | 69 |
| (I.59) + 12.003 | 1:40 | 5 + 200 | 93 | 49 |
| (I.59) + 12.003 | 1:20 | 5 + 100 | 86 | 44 |
| (I.59) + 12.003 | 1:10 | 5 + 50 | 92 | 44 |
| (I.59) + 12.003 | 1:200 | 1 + 200 | 91 | 45 |
| (I.59) + 12.003 | 1:100 | 1 + 100 | 85 | 40 |
| (I.59) + 12.003 | 1:50 | 1 + 50 | 84 | 40 |
| (I.59) + 12.004 | 1:40 | 5 + 200 | 91 | 46 |
| (I.59) + 12.004 | 1:20 | 5 + 100 | 94 | 44 |
| (I.59) + 12.004 | 1:10 | 5 + 50 | 84 | 37 |
| (I.59) + 12.004 | 1:200 | 1 + 200 | 80 | 53 |
| (I.59) + 12.004 | 1:100 | 1 + 100 | 81 | 40 |
| (I.59) + 12.004 | 1:50 | 1 + 50 | 81 | 33 |
| (I.59) + 15.008 | 1:4 | 5 + 20 | 79 | 39 |
| (I.59) + 15.008 | 1:2 | 5 + 10 | 81 | 37 |
| (I.59) + 15.008 | 1:1 | 5 + 5 | 75 | 37 |
| (I.59) + 15.008 | 1:20 | 1 + 20 | 79 | 35 |
| (I.59) + 15.008 | 1:10 | 1 + 10 | 65 | 33 |
| (I.59) + 15.008 | 1:5 | 1 + 5 | 69 | 33 |

*found = activity found
**calc. = activity calculated using Colby's formula

### Example F: In Vivo Preventive Blumeria Test (Barley)

Solvent: 49 parts by weight of N,N-dimethylacetamide
Emulsifier: 1 part by weight of alkylaryl polyglycol ether

To produce a suitable preparation of active compound, 1 part by weight of active compound or active compound combination is mixed with the stated amounts of solvent and emulsifier, and the concentrate is diluted with water to the desired concentration.

To test for preventive activity, young plants are sprayed with the preparation of active compound or active compound combination at the stated rate of application. After the spray coating has been dried, the plants are dusted with spores of Blumeria graminis f.sp. hordei. The plants are placed in the greenhouse at a temperature of approximately 18° C. and a relative atmospheric humidity of approximately 80% to promote the development of mildew pustules.

The test is evaluated 7 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE F1
in vivo preventive Blumeria test (barley)

| | | Application rate of active | Efficacy in % | |
|---|---|---|---|---|
| Active compounds | | compound in ppm a.i. | found* | calc.** |
| (I.59) 2-[6-(4-bromophenoxy)-2- | | 100 | 93 | |
| (trifluoromethyl)pyridin-3-yl]-1-(1H-1,2,4- | | 50 | 57 | |
| triazol-1-yl)propan-2-ol | | 25 | 57 | |
| 2.005 fluopyram | | 60 | 29 | |
| | | 30 | 0 | |
| | | 15 | 0 | |
| (I.59) + 2.005 | 1.67:1 | 100 + 600 | 100 | 95 |
| (I.59) + 2.005 | 1.67:1 | 50 + 30 | 100 | 57 |
| (I.59) + 2.005 | 1.67:1 | 25 + 15 | 29 | 57 |

*found = activity found
**calc. = activity calculated using Colby's formula

TABLE F2
in vivo preventive Blumeria test (barley)

| | | Application rate | | |
|---|---|---|---|---|
| | | of active com- | Efficacy in % | |
| Active compounds | | pound in ppm a.i. | found* | calc.** |
| (I.59) 2-[6-(4-bromophenoxy)-2- | | 100 | 78 | |
| (trifluoromethyl)pyridin-3-yl]-1- | | 50 | 56 | |
| (1H-1,2,4-triazol-1-yl)propan-2-ol | | 25 | 22 | |
| 1.020 spiroxamine | | 250 | 100 | |
| | | 125 | 89 | |
| | | 62.5 | 33 | |
| 5.004 chlorothalonil | | 250 | 44 | |
| | | 125 | 44 | |
| | | 62.5 | 22 | |
| (I.59) + 1.020 | 1:2.5 | 100 + 250 | 100 | 100 |
| (I.59) + 1.020 | 1:2.5 | 50 + 125 | 100 | 95 |
| (I.59) + 1.020 | 1:2.5 | 25 + 62.5 | 67 | 48 |
| (I.59) + 5.004 | 1:2.5 | 100 + 250 | 100 | 88 |
| (I.59) + 5.004 | 1:2.5 | 50 + 125 | 100 | 75 |
| (I.59) + 5.004 | 1:2.5 | 25 + 62.5 | 44 | 40 |

*found = activity found
**calc. = activity calculated using Colby's formula

### Example G: In Vivo Preventive Leptosphaeria nodorum Test (Wheat)

Solvent: 49 parts by weight of N,N-dimethylacetamide
Emulsifier: 1 part by weight of alkylaryl polyglycol ether

To produce a suitable preparation of active compound, 1 part by weight of active compound or active compound combination is mixed with the stated amounts of solvent and emulsifier, and the concentrate is diluted with water to the desired concentration.

To test for preventive activity, young plants are sprayed with the preparation of active compound or active compound combination at the stated rate of application. After the spray coating has been dried, the plants are sprayed with a spore suspension of Leptosphaeria nodorum. The plants remain for 48 hours in an incubation cabinet at approximately 20° C. and a relative atmospheric humidity of approximately 100%. The plants are placed in the greenhouse at a temperature of approximately 25° C. and a relative atmospheric humidity of approximately 80%.

The test is evaluated 8 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE G1
in vivo preventive Leptosphaeria nodorum test (wheat)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 80 | 86 | |
| (trifluoromethyl)pyridin-3-yl]-1-(1H-1,2,4- | | 40 | 57 | |
| triazol-1-yl)propan-2-ol | | 20 | 43 | |
| 4.005 pencycuron | | 250 | 29 | |
| | | 125 | 14 | |
| | | 62.5 | 14 | |
| 5.013 mancozeb | | 1000 | 14 | |
| | | 500 | 14 | |
| | | 250 | 14 | |
| 12.003 metalaxyl | | 1000 | 0 | |
| | | 500 | 0 | |
| | | 250 | 29 | |
| 12.004 metalaxyl-M (mefenoxam) | | 1000 | 14 | |
| | | 500 | 0 | |
| | | 250 | 0 | |
| 13.004 proquinazid | | 1000 | 14 | |
| | | 500 | 14 | |
| | | 250 | 0 | |
| 15.008 cyflufenamid | | 1000 | 0 | |
| | | 500 | 0 | |
| | | 250 | 0 | |
| (I.01) + 4.005 | 1:3.125 | 80 + 250 | 93 | 90 |
| (I.01) + 4.005 | 1:3.125 | 40 + 125 | 86 | 63 |
| (I.01) + 4.005 | 1:3.125 | 20 + 62.5 | 57 | 51 |
| (I.01) + 5.013 | 1:12.5 | 80 + 1000 | 100 | 88 |
| (I.01) + 5.013 | 1:12.5 | 40 + 500 | 93 | 63 |
| (I.01) + 5.013 | 1:12.5 | 20 + 250 | 43 | 51 |
| (I.01) + 12.003 | 1:12.5 | 80 + 1000 | 93 | 86 |
| (I.01) + 12.003 | 1:12.5 | 40 + 500 | 86 | 57 |
| (I.01) + 12.003 | 1:12.5 | 20 + 250 | 57 | 59 |
| (I.01) + 12.004 | 1:12.5 | 80 + 1000 | 100 | 88 |
| (I.01) + 12.004 | 1:12.5 | 40 + 500 | 93 | 57 |
| (I.01) + 12.004 | 1:12.5 | 20 + 250 | 71 | 43 |
| (I.01) + 13.004 | 1:12.5 | 80 + 1000 | 100 | 88 |
| (I.01) + 13.004 | 1:12.5 | 40 + 500 | 93 | 63 |
| (I.01) + 13.004 | 1:12.5 | 20 + 250 | 86 | 43 |
| (I.01) + 15.008 | 1:12.5 | 80 + 1000 | 93 | 86 |
| (I.01) + 15.008 | 1:12.5 | 40 + 500 | 71 | 57 |
| (I.01) + 15.008 | 1:12.5 | 20 + 250 | 29 | 43 |

*found = activity found
**calc. = activity calculated using Colby's formula

### Example H: In Vivo Preventive Puccinia triticina Test (Wheat)

Solvent: 49 parts by weight of N,N-dimethylacetamide
Emulsifier: 1 part by weight of alkylaryl polyglycol ether

To produce a suitable preparation of active compound, 1 part by weight of active compound or active compound combination is mixed with the stated amounts of solvent and emulsifier, and the concentrate is diluted with water to the desired concentration.

To test for preventive activity, young plants are sprayed with the preparation of active compound or active compound combination at the stated rate of application. After the spray coating has been dried, the plants are sprayed with a spore suspension of Puccinia triticina. The plants remain for 48 hours in an incubation cabinet at approximately 20° C. and a relative atmospheric humidity of approximately 100%. The plants are placed in the greenhouse at a temperature of approximately 20° C. and a relative atmospheric humidity of approximately 80%.

The test is evaluated 8 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE H1
in vivo preventive Puccinia triticina test (wheat)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 80 | 67 | |
| (trifluoromethyl)pyridin-3-yl]-1-(1H-1,2,4- | | 40 | 33 | |
| triazol-1-yl)propan-2-ol | | 20 | 22 | |
| 1.012 ipconazole | | 80 | 89 | |
| | | 40 | 67 | |
| | | 20 | 0 | |
| 1.018 prothioconazole | | 100 | 0 | |
| | | 50 | 0 | |
| | | 25 | 0 | |
| 2.002 bixafen | | 100 | 67 | |
| | | 50 | 33 | |
| | | 25 | 22 | |
| 2.005 fluopyram | | 60 | 33 | |
| | | 30 | 0 | |
| | | 15 | 0 | |
| 2.038 N-(5-chloro-2-isopropylbenzyl)-N- | | 30 | 33 | |
| cyclopropyl-3-(difluoromethyl)-5-fluoro-1- | | 15 | 33 | |
| methyl-1H-pyrazole-4-carboxamide | | 7.5 | 33 | |
| 3.020 trifloxystrobin | | 10 | 11 | |
| | | 5 | 0 | |
| | | 2.5 | 0 | |
| 3.025 (3S,6S,7R,8R)-8-benzyl-3-[({3- | | 150 | 89 | |
| [(isobutyryloxy)methoxy]-4-methoxypyridin-2- | | 75 | 67 | |
| yl}carbonyl)amino]-6-methyl-4,9-dioxo-1,5- | | 37.5 | 22 | |
| dioxonan-7-yl 2-methylpropanoate | | | | |
| 13.001 fludioxonil | | 80 | 22 | |
| | | 40 | 0 | |
| | | 20 | 0 | |
| (I.01) + 1.012 | 1:1 | 80 + 80 | 94 | 96 |
| (I.01) + 1.012 | 1:1 | 40 + 40 | 94 | 78 |
| (I.01) + 1.012 | 1:1 | 20 + 20 | 56 | 22 |
| (I.01) + 1.018 | 1:1.25 | 80 + 100 | 89 | 67 |
| (I.01) + 1.018 | 1:1.25 | 40 + 50 | 44 | 33 |
| (I.01) + 1.018 | 1:1.25 | 20 + 25 | 0 | 22 |
| (I.01) + 2.002 | 1:1.25 | 80 + 100 | 100 | 89 |
| (I.01) + 2.002 | 1:1.25 | 40 + 50 | 67 | 56 |
| (I.01) + 2.002 | 1:1.25 | 20 + 25 | 33 | 40 |
| (I.01) + 2.005 | 1.33:1 | 80 + 60 | 94 | 78 |
| (I.01) + 2.005 | 1.33:1 | 40 + 30 | 67 | 33 |
| (I.01) + 2.005 | 1.33:1 | 20 + 15 | 33 | 22 |
| (I.01) + 2.038 | 1.67:1 | 80 + 30 | 100 | 78 |
| (I.01) + 2.038 | 1.67:1 | 40 + 15 | 94 | 56 |
| (I.01) + 2.038 | 1.67:1 | 20 + 7.5 | 56 | 48 |
| (I.01) + 3.020 | 8:1 | 80 + 10 | 89 | 70 |
| (I.01) + 3.020 | 8:1 | 40 + 5 | 67 | 33 |
| (I.01) + 3.020 | 8:1 | 20 + 2.5 | 0 | 22 |
| (I.01) + 3.025 | 1:1.875 | 80 + 150 | 94 | 96 |
| (I.01) + 3.025 | 1:1.875 | 40 + 75 | 94 | 78 |
| (I.01) + 3.025 | 1:1.875 | 20 + 37.5 | 33 | 40 |
| (I.01) + 13.001 | 1:1 | 80 + 80 | 89 | 74 |
| (I.01) + 13.001 | 1:1 | 40 + 40 | 56 | 33 |
| (I.01) + 13.001 | 1:1 | 20 + 20 | 22 | 22 |

*found = activity found
**calc. = activity calculated using Colby's formula

TABLE H2
in vivo preventive Puccinia triticina test (wheat)

| | | Application rate of active | Efficacy in % | |
|---|---|---|---|---|
| Active compounds | | compound in ppm a.i. | found* | calc.** |
| (I.59) 2-[6-(4-bromophenoxy)-2- | | 100 | 78 | |
| (trifluoromethyl)pyridin-3-yl]-1-(1H-1,2,4- | | 50 | 44 | |
| triazol-1-yl)propan-2-ol | | 25 | 11 | |
| 1.012 ipconazole | | 80 | 100 | |
| | | 40 | 44 | |
| | | 20 | 0 | |
| 1.018 prothioconazole | | 100 | 0 | |
| | | 50 | 0 | |
| | | 25 | 0 | |
| 1.021 tebuconazole | | 100 | 89 | |
| | | 50 | 78 | |
| | | 25 | 22 | |
| 2.005 fluopyram | | 60 | 0 | |
| | | 30 | 0 | |
| | | 15 | 0 | |
| 2.017 penflufen | | 80 | 100 | |
| | | 40 | 89 | |
| | | 20 | 56 | |
| 2.038 N-(5-chloro-2-isopropylbenzyl)-N- | | 30 | 44 | |
| cyclopropyl-3-(difluoromethyl)-5-fluoro-1- | | 15 | 33 | |
| methyl-1H-pyrazole-4-carboxamide | | 7.5 | 22 | |
| 13.001 fludioxonil | | 80 | 0 | |
| | | 40 | 0 | |
| | | 20 | 0 | |
| (I.59) + 1.012 | 1.25:1 | 100 + 80 | 100 | 100 |
| (I.59) + 1.012 | 1.25:1 | 50 + 40 | 100 | 69 |
| (I.59) + 1.012 | 1.25:1 | 25 + 20 | 22 | 11 |
| (I.59) + 1.018 | 1:1 | 100 + 100 | 100 | 78 |
| (I.59) + 1.018 | 1:1 | 50 + 50 | 44 | 44 |
| (I.59) + 1.018 | 1:1 | 25 + 25 | 22 | 11 |
| (I.59) + 1.021 | 1:1 | 100 + 100 | 100 | 98 |
| (I.59) + 1.021 | 1:1 | 50 + 50 | 100 | 88 |
| (I.59) + 1.021 | 1:1 | 25 + 25 | 22 | 31 |
| (I.59) + 2.005 | 1.67:1 | 100 + 60 | 94 | 78 |
| (I.59) + 2.005 | 1.67:1 | 50 + 30 | 67 | 44 |
| (I.59) + 2.005 | 1.67:1 | 25 + 15 | 0 | 11 |
| (I.59) + 2.017 | 1.25:1 | 100 + 80 | 100 | 100 |
| (I.59) + 2.017 | 1.25:1 | 50 + 40 | 100 | 94 |
| (I.59) + 2.017 | 1.25:1 | 25 + 20 | 89 | 60 |
| (I.59) + 2.038 | 3.33:1 | 100 + 30 | 89 | 88 |
| (I.59) + 2.038 | 3.33:1 | 50 + 15 | 89 | 63 |
| (I.59) + 2.038 | 3.33:1 | 25 + 7.5 | 44 | 31 |
| (I.59) + 13.001 | 1.25:1 | 100 + 80 | 100 | 78 |
| (I.59) + 13.001 | 1.25:1 | 50 + 40 | 78 | 44 |
| (I.59) + 13.001 | 1.25:1 | 25 + 20 | 22 | 11 |

*found = activity found
**calc. = activity calculated using Colby's formula

TABLE H3
in vivo preventive Puccinia triticina test (wheat)

| | | Application rate of active | Efficacy in % | |
|---|---|---|---|---|
| Active compounds | | compound in ppm a.i. | found* | calc.** |
| (I.01) 2-[6-(4-chlorophenoxy)-2- | | 80 | 60 | |
| (trifluoromethyl)pyridin-3-yl]-1-(1H-1,2,4- | | 40 | 50 | |
| triazol-1-yl)propan-2-ol | | 20 | 30 | |
| 4.005 pencycuron | | 250 | 0 | |
| | | 125 | 0 | |
| | | 62.5 | 0 | |
| 5.004 chlorothalonil | | 250 | 40 | |
| | | 125 | 0 | |
| | | 62.5 | 0 | |
| 12.003 metalaxyl | | 1000 | 30 | |
| | | 500 | 0 | |
| | | 250 | 0 | |
| 12.004 metalaxyl-M (mefenoxam) | | 1000 | 0 | |
| | | 500 | 0 | |
| | | 250 | 0 | |
| 13.004 proquinazid | | 1000 | 0 | |
| | | 500 | 0 | |
| | | 250 | 0 | |
| (I.01) + 4.005 | 1:3:125 | 80 + 250 | 80 | 60 |
| (I.01) + 4.005 | 1:3:125 | 40 + 125 | 70 | 50 |
| (I.01) + 4.005 | 1:3:125 | 20 + 62.5 | 20 | 30 |
| (I.01) + 5.004 | 1:3:125 | 80 + 250 | 100 | 76 |
| (I.01) + 5.004 | 1:3:125 | 40 + 125 | 80 | 50 |
| (I.01) + 5.004 | 1:3:125 | 20 + 62.5 | 50 | 30 |
| (I.01) + 12.003 | 1:12:5 | 80 + 1000 | 70 | 72 |
| (I.01) + 12.003 | 1:12:5 | 40 + 500 | 70 | 50 |
| (I.01) + 12.003 | 1:12:5 | 20 + 250 | 40 | 30 |
| (I.01) + 12.004 | 1:12:5 | 80 + 1000 | 90 | 60 |
| (I.01) + 12.004 | 1:12:5 | 40 + 500 | 80 | 50 |
| (I.01) + 12.004 | 1:12:5 | 20 + 250 | 60 | 30 |
| (I.01) + 13.004 | 1:12:5 | 80 + 1000 | 90 | 60 |
| (I.01) + 13.004 | 1:12:5 | 40 + 500 | 90 | 50 |
| (I.01) + 13.004 | 1:12:5 | 20 + 250 | 60 | 30 |

*found = activity found
**calc. = activity calculated using Colby's formula

TABLE 114
in vivo preventive Puccinia triticina test (wheat)

| | | Application rate of active | Efficacy in % | |
|---|---|---|---|---|
| Active compounds | | compound in ppm a.i. | found* | calc.** |
| (I.59) 2-[6-(4-bromophenoxy)-2- | | 100 | 94 | |
| (trifluoromethyl)pyridin-3-yl]-1-(1H-1,2,4- | | 50 | 56 | |
| triazol-1-yl)propan-2-ol | | 25 | 11 | |
| 1.020 spiroxamine | | 250 | 33 | |
| | | 125 | 33 | |
| | | 62.5 | 11 | |
| 4.005 pencycuron | | 250 | 33 | |
| | | 125 | 11 | |
| | | 62.5 | 0 | |
| 5.004 chlorothalonil | | 250 | 33 | |
| | | 125 | 33 | |
| | | 62.5 | 0 | |
| 12.003 metalaxyl | | 1000 | 44 | |
| | | 500 | 44 | |
| | | 250 | 11 | |
| 12.004 metalaxyl-M (mefenoxam) | | 1000 | 44 | |
| | | 500 | 22 | |
| | | 250 | 0 | |
| 13.004 proquinazid | | 1000 | 33 | |
| | | 500 | 33 | |
| | | 250 | 11 | |
| 15.008 cyflufenamid | | 1000 | 22 | |
| | | 500 | 0 | |
| | | 250 | 0 | |
| 15.047 quinofumelin | | 500 | 22 | |
| | | 250 | 11 | |
| | | 125 | 11 | |
| (I.59) + 1.020 | 1:2.5 | 100 + 250 | 100 | 96 |
| (I.59) + 1.020 | 1:2.5 | 50 + 125 | 89 | 70 |
| (I.59) + 1.020 | 1:2.5 | 25 + 62.5 | 33 | 21 |
| (I.59) + 4.005 | 1:2.5 | 100 + 250 | 100 | 96 |
| (I.59) + 4.005 | 1:2.5 | 50 + 125 | 94 | 60 |
| (I.59) + 4.005 | 1:2.5 | 25 + 62.5 | 56 | 11 |
| (I.59) + 5.004 | 1:2.5 | 100 + 250 | 100 | 96 |
| (I.59) + 5.004 | 1:2.5 | 50 + 125 | 100 | 70 |
| (I.59) + 5.004 | 1:2.5 | 25 + 62.5 | 44 | 11 |
| (I.59) + 12.003 | 1:10 | 100 + 1000 | 100 | 97 |
| (I.59) + 12.003 | 1:10 | 50 + 500 | 94 | 75 |
| (I.59) + 12.003 | 1:10 | 25 + 250 | 78 | 21 |
| (I.59) + 12.004 | 1:10 | 100 + 1000 | 100 | 97 |
| (I.59) + 12.004 | 1:10 | 50 + 500 | 94 | 65 |
| (I.59) + 12.004 | 1:10 | 25 + 250 | 89 | 11 |
| (I.59) + 13.004 | 1:10 | 100 + 1000 | 100 | 96 |
| (I.59) + 13.004 | 1:10 | 50 + 500 | 100 | 70 |
| (I.59) + 13.004 | 1:10 | 25 + 250 | 33 | 21 |
| (I.59) + 15.008 | 1:10 | 100 + 1000 | 94 | 96 |
| (I.59) + 15.008 | 1:10 | 50 + 500 | 94 | 56 |
| (I.59) + 15.008 | 1:10 | 25 + 250 | 44 | 11 |
| (I.59) + 15.047 | 1:5 | 100 + 500 | 94 | 96 |
| (I.59) + 15.047 | 1:5 | 50 + 250 | 89 | 60 |
| (I.59) + 15.047 | 1:5 | 25 + 125 | 22 | 21 |

*found = activity found
**calc. = activity calculated using Colby's formula

### Example I: In Vivo Preventive Septoria tritici Test (Wheat)

Solvent: 49 parts by weight of N,N-dimethylacetamide
Emulsifier: 1 part by weight of alkylaryl polyglycol ether

To produce a suitable preparation of active compound, 1 part by weight of active compound or active compound combination is mixed with the stated amounts of solvent and emulsifier, and the concentrate is diluted with water to the desired concentration.

To test for preventive activity, young plants are sprayed with the preparation of active compound or active compound combination at the stated rate of application. After the spray coating has been dried, the plants are sprayed with a spore suspension of Septoria tritici. The plants remain for 48 hours in an incubation cabinet at approximately 20° C. and a relative atmospheric humidity of approximately 100% and afterwards for 60 hours at approximately 15° C. in a translucent incubation cabinet at a relative atmospheric humidity of approximately 100%. The plants are placed in the greenhouse at a temperature of approximately 15° C. and a relative atmospheric humidity of approximately 80%.

The test is evaluated 21 days after the inoculation. 0% means an efficacy which corresponds to that of the untreated control, while an efficacy of 100% means that no disease is observed.

The table below clearly shows that the observed activity of the active compound combination according to the invention is greater than the calculated activity, i.e. a synergistic effect is present.

TABLE I1
in vivo preventive Septoria tritici test (wheat)

| | Application rate of active | Efficacy in % | |
|---|---|---|---|
| Active compounds | compound in ppm a.i. | found* | calc.** |
| (I.01) 2-[6-(4-chlorophenoxy)-2- | 80 | 100 | |
| (trifluoromethyl)pyridin-3-yl]-1-(1H-1,2,4-triazol-1-yl) | 40 | 63 | |
| propan-2-ol | 20 | 13 | |
| 2.005 fluopyram | 60 | 88 | |
| | 30 | 38 | |
| | 15 | 13 | |
| 2.027 3-(difluoromethyl)-1-methyl-N-(1,1,3- | 250 | 88 | |
| trimethyl-2,3-dihydro-1H-inden-4-yl)-1H- | 125 | 63 | |
| pyrazole-4-carboxamide | 62.5 | 25 | |
| 3.025 (3S,6S,7R,8R)-8-benzyl-3-[({3- | 150 | 63 | |
| [(isobutyryloxy)methoxy]-4-methoxypyridin-2- | 75 | 13 | |
| yl}carbonyl)amino]-6-methyl-4,9-dioxo-1,5- | 37.5 | 13 | |
| dioxonan-7-yl 2-methylpropanoate | | | |
| (I.01) + 2.005 1.33:1 | 80 + 60 | 100 | 100 |
| (I.01) + 2.005 1.33:1 | 40 + 30 | 88 | 77 |
| (I.01) + 2.005 1.33:1 | 20 + 15 | 38 | 23 |
| (I.01) + 2.027 1:3.125 | 80 + 250 | 100 | 100 |
| (I.01) + 2.027 1:3.125 | 40 + 125 | 100 | 86 |
| (I.01) + 2.027 1:3.125 | 20 + 62.5 | 63 | 34 |
| (I.01) + 3.025 1:1.875 | 80 + 150 | 100 | 100 |
| (I.01) + 3.025 1:1.875 | 40 + 75 | 94 | 67 |
| (I.01) + 3.025 1:1.875 | 20 + 37.5 | 13 | 23 |

*found = activity found
**calc. = activity calculated using Colby's formula

TABLE I2
in vivo preventive Septoria tritici test (wheat)

| | Application rate of active | Efficacy in % | |
|---|---|---|---|
| Active compounds | compound in ppm a.i. | found* | calc.** |
| (I.59) 2-[6-(4-chlorophenoxy)-2- | 100 | 86 | |
| (trifluoromethyl)pyridin-3-yl]-1-(1H-1,2,4-triazol-1-yl) | 50 | 0 | |
| propan-2-ol | 25 | 0 | |
| 1.012 ipconazole | 80 | 0 | |
| | 40 | 0 | |
| | 20 | 0 | |
| 1.018 prothioconazole | 100 | 43 | |
| | 50 | 14 | |
| | 25 | 0 | |
| 1.021 tebuconazole | 100 | 0 | |
| | 50 | 0 | |
| | 25 | 0 | |
| 2.005 fluopyram | 60 | 71 | |
| | 30 | 29 | |
| | 15 | 29 | |
| 2.017 penflufen | 80 | 0 | |
| | 40 | 0 | |
| | 20 | 29 | |
| 2.027 3-(difluoromethyl)-1-methyl-N-(1,1,3- | 250 | 43 | |
| trimethyl-2,3-dihydro-1H-inden-4-yl)-1H- | 125 | 43 | |
| pyrazole-4-carboxamide | 62.5 | 29 | |
| 3.020 trifloxystrobin | 10 | 29 | |
| | 5 | 29 | |
| | 2.5 | 29 | |
| 3.025 (3S,6S,7R,8R)-8-benzyl-3-[({3- | 150 | 71 | |
| [(isobutyryloxy)methoxy]-4-methoxypyridin-2- | 75 | 71 | |
| yl]}carbonyl)amino]-6-methyl-4,9-dioxo-1,5- | 37.5 | 14 | |
| dioxonan-7-yl 2-methylpropanoate | | | |
| 13.001 fludioxonil | 80 | 29 | |
| | 40 | 29 | |
| | 20 | 29 | |
| (I.59) + 1.012 1.25:1 | 100 + 80 | 86 | 86 |
| (I.59) + 1.012 1.25:1 | 50 + 40 | 57 | 0 |
| (I.59) + 1.012 1.25:1 | 25 + 20 | 0 | 0 |
| (I.59) + 1.018 1:1 | 100 + 100 | 86 | 92 |
| (I.59) + 1.018 1:1 | 50 + 50 | 57 | 14 |
| (I.59) + 1.018 1:1 | 25 + 25 | 43 | 0 |
| (I.59) + 1.021 1:1 | 100 + 100 | 93 | 86 |
| (I.59) + 1.021 1:1 | 50 + 50 | 71 | 0 |
| (I.59) + 1.021 1:1 | 25 + 25 | 57 | 0 |
| (I.59) + 2.005 1.67:1 | 100 + 60 | 100 | 96 |
| (I.59) + 2.005 1.67:1 | 50 + 30 | 86 | 29 |
| (I.59) + 2.005 1.67:1 | 25 + 15 | 43 | 29 |
| (I.59) + 2.017 1.25:1 | 100 + 80 | 86 | 86 |
| (I.59) + 2.017 1.25:1 | 50 + 40 | 86 | 0 |
| (I.59) + 2.017 1.25:1 | 25 + 20 | 0 | 29 |
| (I.59) + 2.027 1:2.5 | 100 + 250 | 100 | 92 |
| (I.59) + 2.027 1:2.5 | 50 + 125 | 57 | 43 |
| (I.59) + 2.027 1:2.5 | 25 + 62.5 | 43 | 29 |
| (I.59) + 3.020 10:1 | 100 + 10 | 93 | 90 |
| (I.59) + 3.020 10:1 | 50 + 5 | 57 | 29 |
| (I.59) + 3.020 10:1 | 25 + 6.5 | 29 | 29 |
| (I.59) + 3.025 1:1.5 | 100 + 150 | 100 | 96 |
| (I.59) + 3.025 1:1.5 | 50 + 75 | 86 | 71 |
| (I.59) + 3.025 1:1.5 | 25 + 37.5 | 71 | 14 |
| (I.59) + 13.001 1.25:1 | 100 + 80 | 93 | 90 |
| (I.59) + 13.001 1.25:1 | 50 + 40 | 93 | 29 |
| (I.59) + 13.001 1.25:1 | 25 + 20 | 57 | 29 |

*found = activity found
**calc. = activity calculated using Colby's formula

TABLE I3
in vivo preventive Septoria tritici test (wheat)

| | Application rate of active | Efficacy in % | |
|---|---|---|---|
| Active compounds | compound in ppm a.i. | found* | calc.** |
| (I.01) 2-[6-(4-chlorophenoxy)-2- | 80 | 71 | |
| (trifluoromethyl)pyridin-3-yl]-1-(1H-1,2,4-triazol-1-yl) | 40 | 43 | |
| propan-2-ol | 20 | 29 | |
| 1.020 spiroxamine | 250 | 57 | |
| | 125 | 14 | |
| | 62.5 | 0 | |
| 4.005 pencycuron | 250 | 0 | |
| | 125 | 0 | |
| | 62.5 | 0 | |
| 5.004 chlorothalonil | 250 | 14 | |
| | 125 | 0 | |
| | 62.5 | 0 | |
| 5.013 mancozeb | 1000 | 29 | |
| | 500 | 29 | |
| | 250 | 29 | |
| 12.003 metalaxyl | 1000 | 0 | |
| | 500 | 0 | |
| | 250 | 0 | |
| 12.004 metalaxyl-M (mefenoxam) | 1000 | 0 | |
| | 500 | 0 | |
| | 250 | 0 | |
| 13.004 proquinazid | 1000 | 0 | |
| | 500 | 0 | |
| | 250 | 0 | |
| 15.008 cyflufenamid | 1000 | 29 | |
| | 500 | 29 | |
| | 250 | 14 | |
| 15.047 quinofumelin | 500 | 0 | |
| | 250 | 0 | |
| | 125 | 0 | |
| (I.01) + 1.020 1:3.125 | 80 + 250 | 93 | 88 |
| (I.01) + 1.020 1:3.125 | 40 + 125 | 71 | 51 |
| (I.01) + 1.020 1:3.125 | 20 + 62.5 | 43 | 29 |
| (I.01) + 4.005 1:3.125 | 80 + 250 | 100 | 71 |
| (I.01) + 4.005 1:3.125 | 40 + 125 | 93 | 43 |
| (I.01) + 4.005 1:3.125 | 20 + 62.5 | 71 | 29 |
| (I.01) + 5.004 1:3.125 | 80 + 250 | 100 | 76 |
| (I.01) + 5.004 1:3.125 | 40 + 125 | 86 | 43 |
| (I.01) + 5.004 1:3.125 | 20 + 62.5 | 43 | 29 |
| (I.01) + 5.013 1:12.5 | 80 + 1000 | 100 | 80 |
| (I.01) + 5.013 1:12.5 | 40 + 500 | 93 | 59 |
| (I.01) + 5.013 1:12.5 | 20 + 250 | 29 | 49 |
| (I.01) + 12.003 1:12.5 | 80 + 1000 | 100 | 71 |
| (I.01) + 12.003 1:12.5 | 40 + 500 | 100 | 43 |
| (I.01) + 12.003 1:12.5 | 20 + 250 | 71 | 29 |
| (I.01) + 12.004 1:12.5 | 80 + 1000 | 100 | 71 |
| (I.01) + 12.004 1:12.5 | 40 + 500 | 100 | 43 |
| (I.01) + 12.004 1:12.5 | 20 + 250 | 71 | 29 |
| (I.01) + 13.004 1:12.5 | 80 + 1000 | 100 | 71 |
| (I.01) + 13.004 1:12.5 | 40 + 500 | 93 | 43 |
| (I.01) + 13.004 1:12.5 | 20 + 250 | 71 | 29 |
| (I.01) + 15.008 1:12.5 | 80 + 1000 | 100 | 80 |
| (I.01) + 15.008 1:12.5 | 40 + 500 | 86 | 59 |
| (I.01) + 15.008 1:12.5 | 20 + 250 | 29 | 39 |
| (I.01) + 15.047 1:6.25 | 80 + 500 | 100 | 71 |
| (I.01) + 15.047 1:6.25 | 40 + 250 | 71 | 43 |
| (I.01) + 15.047 1:6.25 | 20 + 125 | 0 | 29 |

*found = activity found
**calc. = activity calculated using Colby's formula

### Example J: In Vitro-Test with Fungal Microorganisms

Wells of 96-well microtiter plates are filled with 10 μl of a preparation of test compound or compound combination in methanol+emulsifier alkylaryl-polyglycol-ether. Thereafter, the solvent is evaporated in a hood. At the next step, into each well 100 μl of liquid potato dextrose medium is given, that has been amended with an appropriate concentration of spores or mycelium suspension of the test fungus.

With the aid of a photometer the extinction in all wells is measured at the wavelength of 620 nm.

The microtiter plates are incubated at 20° C. and 85% relative humidity. The inhibition of growth is determined again photometrically 3-5 days after the application. Efficacy is calculated in relation to the untreated control, 0% efficacy means fungal growth as high as in untreated control while 100% efficacy means no fungal growth is measured.

TABLE J1
in vitro-Test with Alternaria alternata

| | Ex. 1.018 | | | |
|---|---|---|---|---|
| Ex. I.01 | prothioconazole | | | Colby expected |
| (ppm) | (ppm) | Ratio | Efficacy % | value % |
| 0.04 | | | 0 | |
| | 0.2 | | 91 | |
| 0.04 | 0.2 | 1:5 | 99 | 91 |

TABLE J2
in vitro-Test with Alternaria alternata

| | Ex. 1.021 | | | |
|---|---|---|---|---|
| Ex. I.01 | tebuconazole | | | Colby expected |
| (ppm) | (ppm) | Ratio | Efficacy % | value % |
| 0.2 | | | 10 | |
| 0.04 | | | 0 | |
| 0.008 | | | 12 | |
| | 1 | | 36 | |
| | 0.2 | | 24 | |
| | 0.04 | | 19 | |
| 0.2 | 1 | 1:5 | 100 | 42 |
| 0.04 | 0.2 | 1:5 | 44 | 24 |
| 0.008 | 0.04 | 1:5 | 43 | 29 |

TABLE J3
in vitro-Test with Alternaria alternata

| | Ex. 2.002 | | | |
|---|---|---|---|---|
| Ex. I.01 | bixafen | | | Colby expected |
| (ppm) | (ppm) | Ratio | Efficacy % | value % |
| 0.2 | | | 0 | |
| 0.04 | | | 0 | |
| | 1 | | 88 | |
| | 0.2 | | 84 | |
| 0.2 | 1 | 1:5 | 90 | 88 |
| 0.04 | 0.2 | 1:5 | 91 | 84 |

TABLE J4
in vitro-Test with Alternaria alternata

| | Ex. 1.015 | | | |
|---|---|---|---|---|
| Ex. I.59 | paclobutrazol | | | Colby expected |
| (ppm) | (ppm) | Ratio | Efficacy % | value % |
| 0.2 | | | 38 | |
| | 1 | | 0 | |
| 0.2 | 1 | 1:5 | 85 | 38 |

TABLE J5
in vitro-Test with Alternaria alternata

| | Ex. 1.018 | | | |
|---|---|---|---|---|
| Ex. I.59 | prothioconazole | | | Colby expected |
| (ppm) | (ppm) | Ratio | Efficacy % | value % |
| 0.008 | | | 44 | |
| | 0.04 | | 0 | |
| 0.008 | 0.04 | 1:5 | 72 | 44 |

TABLE J6
in vitro-Test with Alternaria alternata

| | Ex. 2.002 | | | |
|---|---|---|---|---|
| Ex. I.59 | bixafin | | | Colby expected |
| (ppm) | (ppm) | Ratio | Efficacy % | value % |
| 0.04 | | | 0 | |
| 0.008 | | | 0 | |
| | 0.2 | | 57 | |
| | 0.04 | | 55 | |
| 0.04 | 0.2 | 1:5 | 83 | 57 |
| 0.008 | 0.04 | 1:5 | 66 | 55 |

TABLE J7
in vitro-Test with Alternaria alternata

| | Ex. 13.004 | | | |
|---|---|---|---|---|
| Ex. I.59 | proquinazid | | | Colby expected |
| (ppm) | (ppm) | Ratio | Efficacy % | value % |
| 0.04 | | | 50 | |
| 0.008 | | | 44 | |
| | 4 | | 0 | |
| | 0.8 | | 0 | |
| 0.04 | 4 | 1:100 | 53 | 50 |
| 0.008 | 0.8 | 1:100 | 55 | 44 |

TABLE J8
in vitro-Test with Botrytis cinerea

| | Ex. 1.020 | | | |
|---|---|---|---|---|
| Ex. I.59 | spiroxamine | | | Colby expected |
| (ppm) | (ppm) | Ratio | Efficacy % | value % |
| 0.2 | | | 1 | |
| 0.04 | | | 0 | |
| | 20 | | 9 | |
| | 4 | | 7 | |
| 0.2 | 20 | 1:100 | 83 | 10 |
| 0.04 | 4 | 1:100 | 27 | 7 |

TABLE J9
in vitro-Test with Botrytis cinerea

| | Ex. 2.002 | | | |
|---|---|---|---|---|
| Ex. I.59 | bixafin | | | Colby expected |
| (ppm) | (ppm) | Ratio | Efficacy % | value % |
| 1 | | | 100 | |
| 0.2 | | | 0 | |
| | 5 | | 91 | |
| | 1 | | 63 | |
| 1 | 5 | 1:5 | 99 | 100 |
| 0.2 | 1 | 1:5 | 70 | 63 |

TABLE J10
in vitro-Test with Botrytis cinerea

| Ex. I.59 | Ex. 15.047 | | | Colby expected |
|---|---|---|---|---|
| (ppm) | (ppm) | Ratio | Efficacy % | value % |
| 1 | | | 100 | |
| 0.2 | | | 0 | |
| | 5 | | 0 | |
| | 1 | | 0 | |
| 1 | 5 | 1:5 | 100 | 100 |
| 0.2 | 1 | 1:5 | 77 | 0 |

TABLE J11
in vitro-Test with Fusarium culmorum

| | Ex. 1.012 | | | |
|---|---|---|---|---|
| Ex. I.01 | ipconazole | | | Colby expected |
| (ppm) | (ppm) | Ratio | Efficacy % | value % |
| 1 | | | 19 | |
| 0.2 | | | 26 | |
| | 5 | | 99 | |
| | 1 | | 96 | |
| 1 | 5 | 1:5 | 100 | 99 |
| 0.2 | 1 | 1:5 | 99 | 97 |

TABLE J12
in vitro-Test with Fusarium culmorum

| | Ex. 1.018 | | | |
|---|---|---|---|---|
| Ex. I.01 | prothioconazole | | | Colby expected |
| (ppm) | (ppm) | Ratio | Efficacy % | value % |
| 0.04 | | | 44 | |
| | 0.2 | | 99 | |
| 0.04 | 0.2 | 1:5 | 100 | 99 |

TABLE J13
in vitro -Test with Fusarium culmorum

| | Ex. 1.012 | | | |
|---|---|---|---|---|
| Ex. I.59 | ipconazole | | | Colby expected |
| (ppm) | (ppm) | Ratio | Efficacy % | value % |
| 0.04 | | | 0 | |
| 0.008 | | | 0 | |
| | 0.2 | | 13 | |
| | 0.04 | | 7 | |
| 0.04 | 0.2 | 1:5 | 85 | 13 |
| 0.008 | 0.04 | 1:5 | 31 | 7 |

TABLE J14
in vitro -Test with Fusarium culmorum

| Ex. I.59 | Ex. 15.047 | | | Colby expected |
|---|---|---|---|---|
| (ppm) | (ppm) | Ratio | Efficacy % | value % |
| 0.04 | | | 0 | |
| 0.008 | | | 0 | |
| | 0.2 | | 100 | |
| | 0.04 | | 83 | |
| 0.04 | 0.2 | 1:5 | 100 | 100 |
| 0.008 | 0.04 | 1:5 | 90 | 83 |

TABLE J15
in vitro -Test with Leptosphaeria nodorum

| | Ex. 5.004 | | | |
|---|---|---|---|---|
| Ex. I.01 | chlorothalonil | | | Colby expected |
| (ppm) | (ppm) | Ratio | Efficacy % | value % |
| 0.008 | | | 91 | |
| | 0.04 | | 0 | |
| 0.008 | 0.04 | 1:5 | 99 | 91 |

TABLE J16
in vitro -Test with Pyrenophora teres

| | Ex. 1.018 | | | |
|---|---|---|---|---|
| Ex. I.01 | prothioconazole | | | Colby expected |
| (ppm) | (ppm) | Ratio | Efficacy % | value % |
| 0.04 | | | 26 | |
| | 0.2 | | 22 | |
| 0.04 | 0.2 | 1:5 | 56 | 42 |

TABLE J17
in vitro -Test with Pyrenophora teres

| | Ex. 2.002 | | | |
|---|---|---|---|---|
| Ex. I.01 | bixafen | | | Colby expected |
| (ppm) | (ppm) | Ratio | Efficacy % | value % |
| 1 | | | 5 | |
| 0.2 | | | 0 | |
| 0.04 | | | 0 | |
| | 5 | | 72 | |
| | 1 | | 60 | |
| | 0.2 | | 46 | |
| 1 | 5 | 1:5 | 91 | 73 |
| 0.2 | 1 | 1:5 | 68 | 60 |
| 0.04 | 0.2 | 1:5 | 51 | 46 |

TABLE J18
in vitro -Test with Pyrenophora teres

| Ex. I.01 | Ex. 2.027 | | | Colby expected |
|---|---|---|---|---|
| (ppm) | (ppm) | Ratio | Efficacy % | value % |
| 0.2 | | | 0 | |
| 0.04 | | | 0 | |
| | 20 | | 62 | |
| | 4 | | 43 | |
| 0.2 | 20 | 1:100 | 74 | 62 |
| 0.04 | 4 | 1:100 | 48 | 43 |

TABLE J19
in vitro -Test with Pyrenophora teres

| Ex. I.01 | Ex. 2.038 | | | Colby expected |
|---|---|---|---|---|
| (ppm) | (ppm) | Ratio | Efficacy % | value % |
| 0.2 | | | 0 | |
| 0.04 | | | 0 | |
| 0.008 | | | 0 | |
| | 20 | | 55 | |
| | 4 | | 82 | |
| | 0.8 | | 57 | |
| 0.2 | 20 | 1:100 | 92 | 55 |
| 0.04 | 4 | 1:100 | 88 | 82 |
| 0.008 | 0.8 | 1:100 | 68 | 57 |

TABLE J20
in vitro -Test with Pyrenophora teres

| | Ex. 3.020 | | | |
|---|---|---|---|---|
| Ex. I.01 | trifloxystrobin | | | Colby expected |
| (ppm) | (ppm) | Ratio | Efficacy % | value % |
| 1 | | | 5 | |
| | 5 | | 6 | |
| 1 | 5 | 1:5 | 32 | 11 |

TABLE J21
in vitro -Test with Pyrenophora teres

| Ex. I.01 | Ex. 3.025 | | | Colby expected |
|---|---|---|---|---|
| (ppm) | (ppm) | Ratio | Efficacy % | value % |
| 1 | | | 5 | |
| | 100 | | 10 | |
| 1 | 100 | 1:100 | 53 | 15 |

TABLE J22
in vitro -Test with Pyrenophora teres

| | Ex. 4.005 | | | |
|---|---|---|---|---|
| Ex. I.01 | pencycuron | | | Colby expected |
| (ppm) | (ppm) | Ratio | Efficacy % | value % |
| 1 | | | 21 | |
| 0.2 | | | 19 | |
| | 100 | | 5 | |
| | 20 | | 17 | |
| 1 | 100 | 1:100 | 51 | 25 |
| 0.2 | 20 | 1:100 | 35 | 33 |

TABLE J23
in vitro -Test with Pyrenophora teres

| | Ex. 5.013 | | | |
|---|---|---|---|---|
| Ex. I.01 | mancozeb | | | Colby expected |
| (ppm) | (ppm) | Ratio | Efficacy % | value % |
| 0.2 | | | 14 | |
| 0.04 | | | 1 | |
| | 20 | | 81 | |
| | 4 | | 25 | |
| 0.2 | 20 | 1:100 | 91 | 84 |
| 0.04 | 4 | 1:100 | 32 | 26 |

TABLE J24
in vitro -Test with Pyrenophora teres

| | Ex. 5.018 | | | |
|---|---|---|---|---|
| Ex. I.01 | propineb | | | Colby expected |
| (ppm) | (ppm) | Ratio | Efficacy % | value % |
| 0.04 | | | 1 | |
| | 4 | | 22 | |
| 0.04 | 4 | 1:100 | 45 | 23 |

TABLE J25
in vitro -Test with Pyrenophora teres

| Ex. I.01 | Ex. 15.047 | | | Colby expected |
|---|---|---|---|---|
| (ppm) | (ppm) | Ratio | Efficacy % | value % |
| 0.2 | | | 14 | |
| 0.04 | | | 1 | |
| 0.008 | | | 0 | |
| | 1 | | 64 | |
| | 0.2 | | 76 | |
| | 0.04 | | 28 | |
| 0.2 | 1 | 1:5 | 81 | 69 |
| 0.04 | 0.2 | 1:5 | 82 | 76 |
| 0.008 | 0.04 | 1:5 | 45 | 28 |

TABLE J26
in vitro -Test with Pyrenophora teres

| | Ex. 5.013 | | | |
|---|---|---|---|---|
| Ex. I.59 | mancozeb | | | Colby expected |
| (ppm) | (ppm) | Ratio | Efficacy % | value % |
| 1 | | | 0 | |
| 0.04 | | | 0 | |
| | 100 | | 83 | |
| | 4 | | 76 | |
| 1 | 100 | 1:100 | 94 | 83 |
| 0.04 | 4 | 1:100 | 93 | 76 |

TABLE J27
in vitro -Test with Pyricularia oryzae

| | Ex. 1.021 | | | |
|---|---|---|---|---|
| Ex. I.01 | tebuconazole | | | Colby expected |
| (ppm) | (ppm) | Ratio | Efficacy % | value % |
| 0.2 | | | 7 | |
| 0.04 | | | 0 | |
| | 1 | | 87 | |
| | 0.2 | | 87 | |
| 0.2 | 1 | 1:5 | 96 | 88 |
| 0.04 | 0.2 | 1:5 | 100 | 87 |

TABLE J28
in vitro -Test with Pyricularia oryzae

| | Ex. 2.017 | | | |
|---|---|---|---|---|
| Ex. I.01 | penflufen | | | Colby expected |
| (ppm) | (ppm) | Ratio | Efficacy % | value % |
| 1 | | | 61 | |
| 0.2 | | | 0 | |
| | 5 | | 91 | |
| | 1 | | 44 | |
| 1 | 5 | 1:5 | 100 | 96 |
| 0.2 | 1 | 1:5 | 72 | 44 |

TABLE J29
in vitro -Test with Pyricularia oryzae

| Ex. I.01 | Ex. 2.038 | | | Colby expected |
|---|---|---|---|---|
| (ppm) | (ppm) | Ratio | Efficacy % | value % |
| 0.2 | | | 0 | |
| 0.04 | | | 1 | |
| 0.008 | | | 4 | |
| | 20 | | 75 | |
| | 4 | | 51 | |
| | 0.8 | | 0 | |
| 0.2 | 20 | 1:100 | 96 | 75 |
| 0.04 | 4 | 1:100 | 63 | 51 |
| 0.008 | 0.8 | 1:100 | 23 | 4 |

TABLE J30
in vitro -Test with Pyricularia oryzae

| | Ex. 3.020 | | | |
|---|---|---|---|---|
| Ex. I.01 | trifloxystrobin | | | Colby expected |
| (ppm) | (ppm) | Ratio | Efficacy % | value % |
| 1 | | | 61 | |
| | 5 | | 98 | |
| 1 | 5 | 1:5 | 100 | 99 |

TABLE J31
in vitro -Test with Pyricularia oryzae

| Ex. I.01 | Ex. 3.025 | | | Colby expected |
|---|---|---|---|---|
| (ppm) | (ppm) | Ratio | Efficacy % | value % |
| 0.2 | | | 0 | |
| 0.04 | | | 1 | |
| 0.008 | | | 4 | |
| | 20 | | 100 | |
| | 4 | | 84 | |
| | 0.8 | | 91 | |
| 0.2 | 20 | 1:100 | 100 | 100 |
| 0.04 | 4 | 1:100 | 97 | 84 |
| 0.008 | 0.8 | 1:100 | 100 | 91 |

TABLE J32
in vitro -Test with Pyricularia oryzae

| | Ex. 13.001 | | | |
|---|---|---|---|---|
| Ex. I.01 | fludioxonil | | | Colby expected |
| (ppm) | (ppm) | Ratio | Efficacy % | value % |
| 1 | | | 95 | |
| 0.2 | | | 7 | |
| | 5 | | 89 | |
| | 1 | | 87 | |
| 1 | 5 | 1:5 | 100 | 99 |
| 0.2 | 1 | 1:5 | 97 | 88 |

TABLE J33
in vitro -Test with Pyricularia oryzae

| | Ex. 1.021 | | | |
|---|---|---|---|---|
| Ex. I.59 | tebuconazole | | | Colby expected |
| (ppm) | (ppm) | Ratio | Efficacy % | value % |
| 0.2 | | | 0 | |
| | 1 | | 89 | |
| 0.2 | 1 | 1:5 | 91 | 89 |

TABLE J34
in vitro -Test with Pyricularia oryzae

| Ex. I.59 | Ex. 3.025 | | | Colby expected |
|---|---|---|---|---|
| (ppm) | (ppm) | Ratio | Efficacy % | value % |
| 0.2 | | | 0 | |
| 0.04 | | | 13 | |
| 0.008 | | | 11 | |
| | 20 | | 72 | |
| | 4 | | 85 | |
| | 0.8 | | 67 | |
| 0.2 | 20 | 1:100 | 85 | 72 |
| 0.04 | 4 | 1:100 | 96 | 87 |
| 0.008 | 0.8 | 1:100 | 82 | 71 |

TABLE J35
in vitro -Test with Pyricularia oryzae

| | Ex. 13.001 | | | |
|---|---|---|---|---|
| Ex. I.59 | fludioxonil | | | Colby expected |
| (ppm) | (ppm) | Ratio | Efficacy % | value % |
| 1 | | | 49 | |
| 0.2 | | | 0 | |
| 0.04 | | | 0 | |
| | 5 | | 79 | |
| | 1 | | 88 | |
| | 0.2 | | 82 | |
| 1 | 5 | 1:5 | 97 | 89 |
| 0.2 | 1 | 1:5 | 89 | 88 |
| 0.04 | 0.2 | 1:5 | 95 | 82 |

TABLE J36
in vitro -Test with Pyricularia oryzae

| | Ex. 15.008 | | | |
|---|---|---|---|---|
| Ex. I.59 | cyflufenamid | | | Colby expected |
| (ppm) | (ppm) | Ratio | Efficacy % | value % |
| 0.2 | | | 0 | |
| 0.04 | | | 0 | |
| | 20 | | 91 | |
| | 4 | | 17 | |
| 0.2 | 20 | 1:100 | 93 | 91 |
| 0.04 | 20 | 1:100 | 20 | 17 |

TABLE J37
in vitro -Test with Rhizoctonia solani

| | Ex. 5.018 | | | |
|---|---|---|---|---|
| Ex. I.01 | propineb | | | Colby expected |
| (ppm) | (ppm) | Ratio | Efficacy % | value % |
| 0.04 | | | 0 | |
| | 4 | | 34 | |
| 0.04 | 4 | 1:100 | 58 | 34 |

TABLE J38
in vitro -Test with Rhizoctonia solani

| | Ex. 1.012 | | | |
|---|---|---|---|---|
| Ex. I.59 | ipconazole | | | Colby expected |
| (ppm) | (ppm) | Ratio | Efficacy % | value % |
| 0.04 | | | 0 | |
| 0.008 | | | 0 | |
| | 0.2 | | 96 | |
| | 0.04 | | 35 | |
| 0.04 | 0.2 | 1:5 | 97 | 96 |
| 0.008 | 0.04 | 1:5 | 52 | 35 |

TABLE J39
in vitro -Test with Rhizoctonia solani

| | Ex. 5.013 | | | |
|---|---|---|---|---|
| Ex. I.59 | mancozeb | | | Colby expected |
| (ppm) | (ppm) | Ratio | Efficacy % | value % |
| 0.2 | | | 97 | |
| 0.04 | | | 23 | |
| | 20 | | 99 | |
| | 4 | | 57 | |
| 0.2 | 20 | 1:100 | 99 | 100 |
| 0.04 | 4 | 1:100 | 91 | 67 |

TABLE J40
in vitro -Test with Rhizoctonia solani

| Ex. I.59 | Ex. 15.047 | | | Colby expected |
|---|---|---|---|---|
| (ppm) | (ppm) | Ratio | Efficacy % | value % |
| 1 | | | 100 | |
| 0.2 | | | 97 | |
| | 5 | | 0 | |
| | 1 | | 0 | |
| 1 | 5 | 1:5 | 100 | 100 |
| 0.2 | 1 | 1:5 | 100 | 97 |

TABLE J41
in vitro -Test with Septoria tritici

| | Ex. 1.020 | | | |
|---|---|---|---|---|
| Ex. I.01 | spiroxamine | | | Colby expected |
| (ppm) | (ppm) | Ratio | Efficacy % | value % |
| 0.04 | | | 95 | |
| 0.008 | | | 69 | |
| | 4 | | 34 | |
| | 0.8 | | 25 | |
| 0.04 | 4 | 1:100 | 100 | 97 |
| 0.008 | 0.8 | 1:100 | 85 | 77 |

TABLE J42
in vitro -Test with Septoria tritici

| | Ex. 2.005 | | | |
|---|---|---|---|---|
| Ex. I.01 | fluopyram | | | Colby expected |
| (ppm) | (ppm) | Ratio | Efficacy % | value % |
| 0.04 | | | 94 | |
| 0.008 | | | 61 | |
| | 0.2 | | 93 | |
| | 0.04 | | 43 | |
| 0.04 | 0.2 | 1:5 | 100 | 100 |
| 0.008 | 0.04 | 1:5 | 87 | 78 |

TABLE J43
in vitro -Test with Septoria tritici

| | Ex. 12.003 | | | |
|---|---|---|---|---|
| Ex. I.01 | metalaxyl | | | Colby expected |
| (ppm) | (ppm) | Ratio | Efficacy % | value % |
| 1 | | | 86 | |
| 0.2 | | | 85 | |
| | 100 | | 35 | |
| | 20 | | 51 | |
| 1 | 100 | 1:100 | 100 | 91 |
| 0.2 | 20 | 1:100 | 100 | 93 |

TABLE J44
in vitro -Test with Septoria tritici

| | Ex. 12.004 | | | |
|---|---|---|---|---|
| Ex. I.01 | mefenxam | | | Colby expected |
| (ppm) | (ppm) | Ratio | Efficacy % | value % |
| 1 | | | 86 | |
| 0.2 | | | 85 | |
| | 100 | | 28 | |
| | 20 | | 45 | |
| 1 | 100 | 1:100 | 100 | 90 |
| 0.2 | 20 | 1:100 | 100 | 92 |

TABLE J45
in vitro -Test with Septoria tritici

| | Ex. 13.004 | | | |
|---|---|---|---|---|
| Ex. I.01 | mefenxam | | | Colby expected |
| (ppm) | (ppm) | Ratio | Efficacy % | value % |
| 1 | | | 86 | |
| 0.2 | | | 85 | |
| | 100 | | 28 | |
| | 20 | | 55 | |
| 1 | 100 | 1:100 | 100 | 90 |
| 0.2 | 20 | 1:100 | 100 | 93 |

TABLE J46
in vitro -Test with Septoria tritici

| | Ex. 1.015 | | | |
|---|---|---|---|---|
| Ex. I.59 | paclobutrazol | | | Colby expected |
| (ppm) | (ppm) | Ratio | Efficacy % | value % |
| 0.2 | | | 53 | |
| | 1 | | 13 | |
| 0.2 | 1 | 1:5 | 96 | 59 |

TABLE J47
in vitro -Test with Septoria tritici

| | Ex. 2.005 | | | |
|---|---|---|---|---|
| Ex. I.59 | fluopyram | | | Colby expected |
| (ppm) | (ppm) | Ratio | Efficacy % | value % |
| 0.04 | | | 86 | |
| 0.008 | | | 49 | |
| | 0.2 | | 67 | |
| | 0.04 | | 22 | |
| 0.04 | 0.2 | 1:5 | 100 | 95 |
| 0.008 | 0.04 | 1:5 | 76 | 60 |

TABLE J48
in vitro -Test with Septoria tritici

| | Ex. 3.020 | | | |
|---|---|---|---|---|
| Ex. I.59 | trifloxystrobin | | | Colby expected |
| (ppm) | (ppm) | Ratio | Efficacy % | value % |
| 1 | | | 70 | |
| | 5 | | 90 | |
| 1 | 5 | 1:5 | 100 | 97 |

TABLE J49
in vitro -Test with Septoria tritici

| | Ex. 4.005 | | | |
|---|---|---|---|---|
| Ex. I.59 | pencycuron | | | Colby expected |
| (ppm) | (ppm) | Ratio | Efficacy % | value % |
| 1 | | | 65 | |
| 0.2 | | | 55 | |
| | 100 | | 0 | |
| | 20 | | 8 | |
| 1 | 100 | 1:100 | 71 | 65 |
| 0.2 | 20 | 1:100 | 68 | 59 |

TABLE J50
in vitro -Test with Septoria tritici

| | Ex. 5.018 | | | |
|---|---|---|---|---|
| Ex. I.59 | propineb | | | Colby expected |
| (ppm) | (ppm) | Ratio | Efficacy % | value % |
| 0.04 | | | 96 | |
| 0.008 | | | 54 | |
| | 4 | | 19 | |
| | 0.8 | | 12 | |
| 0.04 | 4 | 1:100 | 100 | 97 |
| 0.008 | 0.8 | 1:100 | 71 | 60 |

TABLE J51
in vitro -Test with Septoria tritici

| | Ex. 12.003 | | | |
|---|---|---|---|---|
| Ex. I.59 | metalaxyl | | | Colby expected |
| (ppm) | (ppm) | Ratio | Efficacy % | value % |
| 1 | | | 65 | |
| 0.2 | | | 55 | |
| | 100 | | 5 | |
| | 20 | | 15 | |
| 1 | 100 | 1:100 | 100 | 67 |
| 0.2 | 20 | 1:100 | 94 | 62 |

TABLE J52
in vitro -Test with Septoria tritici

| | Ex. 12.004 | | | |
|---|---|---|---|---|
| Ex. I.59 | mefenxam | | | Colby expected |
| (ppm) | (ppm) | Ratio | Efficacy % | value % |
| 1 | | | 65 | |
| 0.2 | | | 55 | |
| | 100 | | 28 | |
| | 20 | | 40 | |
| 1 | 100 | 1:100 | 96 | 75 |
| 0.2 | 20 | 1:100 | 96 | 73 |

TABLE J53
in vitro -Test with Ustilago avenae

| | Ex. 1.018 | | | |
|---|---|---|---|---|
| Ex. I.59 | prothioconazole | | | Colby expected |
| (ppm) | (ppm) | Ratio | Efficacy % | value % |
| 1 | | | 100 | |
| 0.2 | | | 0 | |
| | 5 | | 100 | |
| | 1 | | 85 | |
| 1 | 5 | 1:5 | 100 | 100 |
| 0.2 | 1 | 1:5 | 97 | 85 |

TABLE J54
in vitro -Test with Ustilago avenae

| | Ex. 1.020 | | | |
|---|---|---|---|---|
| Ex. I.59 | spiroxamine | | | Colby expected |
| (ppm) | (ppm) | Ratio | Efficacy % | value % |
| 1 | | | 100 | |
| 0.2 | | | 0 | |
| | 100 | | 100 | |
| | 20 | | 12 | |
| 1 | 100 | 1:100 | 100 | 100 |
| 0.2 | 20 | 1:100 | 93 | 12 |

TABLE J55
in vitro -Test with Ustilago avenae

| | Ex. 2.005 | | | |
|---|---|---|---|---|
| Ex. I.59 | fluopyram | | | Colby expected |
| (ppm) | (ppm) | Ratio | Efficacy % | value % |
| 1 | | | 86 | |
| | 5 | | 0 | |
| 1 | 5 | 1:5 | 100 | 86 |

TABLE J56
in vitro -Test with Ustilago avenae

| Ex. I.59 | Ex. 2.038 | | | Colby expected |
|---|---|---|---|---|
| (PPm) | (ppm) | Ratio | Efficacy % | value % |
| 0.2 | | | 0 | |
| 0.04 | | | 0 | |
| 0.008 | | | 0 | |
| | 20 | | 52 | |
| | 4 | | 49 | |
| | 0.8 | | 43 | |
| 0.2 | 20 | 1:100 | 55 | 52 |
| 0.04 | 4 | 1:100 | 54 | 49 |
| 0.008 | 0.8 | 1:100 | 57 | 43 |

Effect on Non-Target Species

Some of the active compound combinations according to the invention have an improved compatibility with non-target species, thus potentially providing more environmental friendly solutions. This is evident from the example below. Experiments show that the combinations have the potential for reducing undesirable effects against these non-target species compared to the prediction based on the properties of the individual active compounds. Thereby, the invention will bring environmental benefit. The invention can also bring agronomic benefit through the possibility of e.g. higher registered application rates where/if needed to minimize pest resistance while preserving environmental quality or reducing the mitigation measures that are needed to ensure the safe use of the product towards the environment.

A more environmentally friendly fungicidal product is identified when the effect of the active compound combination is lower than expected under the hypothesis of concentration addition, which hypothesis is classically used for the regulatory environmental risk assessment of plant protection products. Under the hypothesis of concentration addition for a mixture of the several active compounds, the sum of the concentration of chemicals (cᵢ) multiplied with their respective potency in a mixture provoking x % effect (1/ECₓᵢ) is equal to 1 (cf. Cedergreen, N., “Quantifying Synergy: A Systematic Review of Mixture Toxicity Studies within Environmental Toxicology”, PLOSone 2014, 9(5), e96580):

$${\sum }_{i = 1}^{n} \frac{{c}_{i}}{{EC}_{xi}} = 1 \qquad [ 1 ]$$

with ECₓᵢ the Effect Concentration (EC) of each chemical i (in ppm) causing x % effect on the ecotoxicity test endpoint.

Under this hypothesis, the expected effect of the combination of active compounds can be calculated as follows:

$${EC}_{x mix} = {( {\sum }_{i = 1}^{n} \frac{{p}_{i}}{{EC}_{xi}} )}^{- 1} \qquad [ 2 ]$$

With pᵢ being the proportion of each active compound i in the combination.

For each compound combination, the predicted ECₓ value is calculated. It is then compared to an experimentally measured value. The ratio of predicted versus measured effect for the combination (thereafter called the Model Deviation Ratio or MDR) is then calculated. Results are interpreted as follows:
if MDR <1, the compound combination shows less effects, i.e. is more environmentally favorable than expected;
if MDR >1, the compound combination shows more effects, i.e. is less environmentally favorable than expected.

The environmental effect of the compound combinations was measured experimentally in laboratory ecotoxicity screening studies with fish (Danio rerio). Fish embryos were exposed at 28.5° C. for 96 hours to the active compounds alone and in combinations according to the invention. Mortality was recorded after 96 h for each tested concentration and a reference control. These data were then used in order to calculate the concentration causing the mortality of 50% of exposed fish i.e. lethal concentration 50%, LC₅₀. The LC₅₀ values (in ppm (=mg/L) a.i.) obtained for the active compounds alone were used to estimate the predicted toxicity of the compound combination, using Equation [2]. Then, the MDR values were calculated.

The invention is illustrated by the following examples. However the invention is not limited to the examples.

### Example K: In Vivo Ecotoxicity Screening Test on Fish (Danio rerio)

Solvent: 0.5% by weight dimethyl sulfoxide

To produce a suitable preparation of active compound, the compound is first diluted in a pure solution of the vehicle solvent dimethyl sulfoxide. This concentrate is then diluted with water to the desired a.i. concentration, leading to a maximal solvent concentration of 0.5% by weight. The compounds alone and the combinations were tested for five increasing concentrations between 0.01 and 1000 ppm a.i., (e.g. 0.1, 1.0, 10 and 100 ppm a.i). For the combinations, compounds A and B were mixed in a weight ratio of 5:1 to 1:5 and five increasing concentrations were tested for each ratio.

The table below clearly shows that the observed effect of active compound combinations according to the invention is lower than the predicted effect, i.e. the combinations according to the invention have the potential for lowering undesirable environmental effects on non-target species.

TABLE K1
in vivo ecotoxicity screening test on fish (D. rerio): results after 96 h

| | | | Ecotoxicity | | |
|---|---|---|---|---|---|
| | | Tested concentration | LC_{50-96 h (ppm a.i.)} | | |
| Active compounds | | range in ppm a.i. | found* | calc.** | MDR |
| (I-01) | 2-[6-(4-chlorophenoxy)-2- | 1-12 | 6.21 | | |
| | (trifluoromethyl)pyridin-3-yl]-1- | | | | |
| | (1H-1,2,4-triazol-1-yl)propan-2-ol | | | | |
| (I-59) | 2-[6-(4-bromophenoxy)-2- | 1-16 | 6.00 | | |
| | (trifluoromethyl)pyridin-3-yl]-1- | | | | |
| | (1H-1,2,4-triazol-1-yl)propan-2-ol | | | | |
| 1.012 | ipconazole | 0.01-40 | 6.57 | | |
| 1.018 | prothioconazole | 0.01-100 | 3.16 | | |
| 1.020 | spiroxamine | 0.01-40 | 14.81 | | |
| 1.021 | tebuconazole | 0.01-100 | 19.7 | | |
| 2.002 | bixafen | 0.01-100 | 0.154 | | |
| 2.005 | fluopyram | 10-200 | >200 | | |
| 2.017 | penflufen | 0.01-100 | 0.62 | | |
| 2.038 | N-(5-chloro-2-isopropylbenzyl)-N- | 0.01-100 | 1.74 | | |
| | cyclopropyl-3-(difluoromethyl)-5- | | | | |
| | fluoro-1-methyl-1H-pyrazole-4- | | | | |
| | carboxamide | | | | |
| 3.020 | trifloxystrobin | 0.01-30 | 0.24 | | |
| 3.025 | (3S,6S,7R,8R)-8-benzyl-3-[({3- | 0.01-30 | 1.87 | | |
| | [(isobutyryloxy)methoxy]-4- | | | | |
| | methoxypyridin-2-yl}carbonyl)amino]- | | | | |
| | 6-methyl-4,9-dioxo-1,5-dioxonan-7-yl | | | | |
| | 2-methylpropanoate | | | | |
| 4.005 | pencycuron | 0.01-35 | >200 | | |
| 5.018 | propineb | 0.01-100 | 25.18 | | |
| 12.003 | metalaxyl | 0.01-200 | >200 | | |
| 12.004 | metalaxyl-M (mefenoxam) | 0.01-200 | >200 | | |
| 13.001 | fludioxonil | 0.1-10 | 0.89 | | |
| 13.004 | proquinazid | 0.01-100 | 9.89 | | |
| 15.008 | cyflufenamid | 0.01-100 | 5.2 | | |
| 15.047 | 3-(4,4-difluoro-3,3-dimethyl-3,4- | 1-40 | 7.82 | | |
| | dihydro isoquinolin-1-yl)quinoline | | | | |
| (I-01) + 1.012 | 1:5 | 0.1 + 0.5-10 + 50 | 6.70 | 6.51 | 0.97 |
| (I-01) + 1.012 | 5:1 | 1 + 0.2-12 + 2.4 | 7.28 | 6.27 | 0.86 |
| (I-01) + 1.018 | 1:5 | 0.1 + 0.5-1.2 + 6 | 3.18 | 3.44 | 1.08 |
| (I-01) + 1.018 | 5:1 | 1 + 0.2-12 + 2.4 | 6.58 | 5.35 | 0.81 |
| (I-01) + 1.020 | 1:5 | 1 + 5-12 + 60 | 13.43 | 12.04 | 0.90 |
| (I-01) + 1.020 | 5:1 | 1 + 0.2-12 + 2.4 | 11.06 | 6.88 | 0.62 |
| (I-01) + 1.021 | 1:5 | 1 + 5-12 + 60 | 17.52 | 14.47 | 0.83 |
| (I-01) + 1.021 | 5:1 | 1 + 0.2-12 + 2.4 | 7.58 | 7.01 | 0.93 |
| (I-01) + 2.002 | 1:5 | 0.01 + 0.05-0.12 + 0.6 | 0.18 | 0.18 | 1.00 |
| (I-01) + 2.002 | 5:1 | 0.1 + 0.02-10 + 2 | 1.21 | 0.82 | 0.68 |
| (I-01) + 2.005 | 1:5 | 1 + 5-12 + 60 | 27.63 | 32.27 | 1.17 |
| (I-01) + 2.005 | 5:1 | 1 + 0.2-12 + 2.4 | 11.06 | 7.41 | 0.67 |
| (I-01) + 2.017 | 1:5 | 0.1 + 0.5-1.2 + 6 | 1.14 | 0.73 | 0.64 |
| (I-01) + 2.017 | 5:1 | 1 + 0.2-12 + 2.4 | 2.75 | 2.48 | 0.90 |
| (I-01) + 2.038 | 1:5 | 0.1 + 0.5-1.2 + 6 | 1.56 | 1.98 | 1.27 |
| (I-01) + 2.038 | 5:1 | 1 + 0.2-12 + 2.4 | 7.28 | 4.35 | 0.60 |
| (I-01) + 3.020 | 1:5 | 0.01 + 0.05-0.12 + 0.6 | 0.36 | 0.29 | 0.78 |
| (I-01) + 3.020 | 5:1 | 1 + 0.2-12 + 2.4 | 1.29 | 1.21 | 0.94 |
| (I-01) + 3.025 | 1:5 | 0.1 + 0.5-1.2 + 6 | 3.80 | 2.12 | 0.56 |
| (I-01) + 3.025 | 5:1 | 1 + 0.2-12 + 2.4 | 38.60 | 4.48 | 0.12 |
| (I-01) + 4.005 | 1:5 | 1 + 5-12 + 60 | 55.32 | 32.27 | 0.58 |
| (I-01) + 4.005 | 5:1 | 1 + 0.2-12 + 2.4 | 7.60 | 7.41 | 0.97 |
| (I-01) + 5.018 | 1:5 | 0.3 + 1.5-30 + 150 | 19.22 | 16.69 | 0.87 |
| (I-01) + 5.018 | 5:1 | 1 + 0.2-12 + 2.4 | 7.72 | 7.11 | 0.92 |
| (I-01) + 12.003 | 1:5 | 1 + 5-12 + 60 | 42.08 | 32.27 | 0.77 |
| (I-01) + 12.003 | 5:1 | 1 + 0.2-12 + 2.4 | 10.17 | 7.41 | 0.73 |
| (I-01) + 12.004 | 1:5 | 1 + 5-12 + 60 | 38.32 | 32.27 | 0.84 |
| (I-01) + 12.004 | 5:1 | 0.1 + 0.02-10 + 2 | 7.55 | 7.41 | 0.98 |
| (I-01) + 13.001 | 1:5 | 0.01 + 0.05-1 + 5 | 0.77 | 1.04 | 1.34 |
| (I-01) + 13.001 | 5:1 | 1 + 0.2-12 + 2.4 | 3.52 | 6.21 | 0.89 |
| (I-01) + 13.004 | 1:5 | 0.1 + 0.5-10 + 50 | 9.47 | 9.00 | 0.95 |
| (I-01) + 13.004 | 5:1 | 1 + 0.2-12 + 2.4 | 7.34 | 6.62 | 0.90 |
| (I-01) + 15.008 | 1:5 | 1 + 5-12 + 60 | 8.00 | 2.83 | 0.35 |
| (I-01) + 15.008 | 5:1 | 1 + 0.2-12 + 2.4 | 7.12 | 6.02 | 0.85 |
| (I-01) + 15.047 | 1:5 | 1 + 5-12 + 60 | 6.17 | 7.50 | 1.21 |
| (I-01) + 15.047 | 5:1 | 1 + 0.2-12 + 2.4 | 7.72 | 6.43 | 0.83 |
| (I-59) + 1.012 | 1:5 | 0.1 + 0.5-10 + 50 | 10.40 | 6.47 | 0.62 |
| (I-59) + 1.012 | 5:1 | 1 + 0.2-12 + 2.4 | 7.41 | 6.09 | 0.82 |
| (I-59) + 1.018 | 1:5 | 0.1 + 0.5-1.2 + 6 | 3.46 | 3.43 | 0.99 |
| (I-59) + 1.018 | 5:1 | 1 + 0.2-12 + 2.4 | 6.93 | 5.22 | 0.75 |
| (I-59) + 1.020 | 1:5 | 1 + 5-12 + 60 | 14.69 | 11.90 | 0.81 |
| (I-59) + 1.020 | 5:1 | 1 + 0.2-12 + 2.4 | 7.49 | 6.66 | 0.89 |
| (I-59) + 1.021 | 1:5 | 1 + 5-12 + 60 | 17.88 | 14.27 | 0.80 |
| (I-59) + 1.021 | 5:1 | 1 + 0.2-12 + 2.4 | 7.12 | 6.79 | 0.95 |
| (I-59) + 2.002 | 1:5 | 0.01 + 0.05-0.12 + 0.6 | 0.18 | 0.18 | 1.00 |
| (I-59) + 2.002 | 5:1 | 0.1 + 0.02-10 + 2 | 1.30 | 0.82 | 0.63 |
| (I-59) + 2.005 | 1:5 | 1 + 5-12 + 60 | 22.69 | 31.30 | 1.38 |
| (I-59) + 2.005 | 5:1 | 1 + 0.2-12 + 2.4 | 7.34 | 7.16 | 0.97 |
| (I-59) + 2.017 | 1:5 | 0.1 + 0.5-1.2 + 6 | 0.85 | 0.73 | 0.86 |
| (I-59) + 2.017 | 5:1 | 1 + 0.2-12 + 2.4 | 1.90 | 2.45 | 1.29 |
| (I-59) + 2.038 | 1:5 | 0.05 + 0.25-1.2 + 6 | 1.76 | 1.97 | 1.12 |
| (I-59) + 2.038 | 5:1 | 1 + 0.2-12 + 2.4 | 6.46 | 4.26 | 0.66 |
| (I-59) + 3.020 | 1:5 | 0.005 + 0.025-0.12 + 0.6 | 0.35 | 0.29 | 0.83 |
| (I-59) + 3.020 | 5:1 | 0.1 + 0.02-10 + 2 | 2.36 | 1.20 | 0.51 |
| (I-59) + 3.025 | 1:5 | 0.1 + 0.5-1.2 + 6 | 2.98 | 2.11 | 0.71 |
| (I-59) + 3.025 | 5:1 | 1 + 0.2-12 + 2.4 | 7.28 | 4.39 | 0.60 |
| (I-59) + 4.005 | 1:5 | 1 + 5-12 + 60 | 33.59 | 31.30 | 0.93 |
| (I-59) + 4.005 | 5:1 | 1 + 0.2-12 + 2.4 | 6.25 | 7.16 | 1.15 |
| (I-59) + 5.018 | 1:5 | 0.05 + 0.25-25 + 125 | 19.23 | 16.43 | 0.85 |
| (I-59) + 5.018 | 5:1 | 1 + 0.2-12 + 2.4 | 7.03 | 6.87 | 0.98 |
| (I-59) + 12.003 | 1:5 | 1 + 5-12 + 60 | 37.07 | 31.30 | 0.84 |
| (I-59) + 12.003 | 5:1 | 1 + 0.2-12 + 2.4 | 7.96 | 7.16 | 0.90 |
| (I-59) + 12.004 | 1:5 | 1 + 5-12 + 60 | 37.06 | 31.30 | 0.84 |
| (I-59) + 12.004 | 5:1 | 1 + 0.2-12 + 2.4 | 7.28 | 7.16 | 0.98 |
| (I-59) + 13.001 | 1:5 | 0.1 + 0.5-1.2 + 6 | 0.64 | 1.03 | 1.61 |
| (I-59) + 13.001 | 5:1 | 0.1 + 0.2-12 + 2.4 | 3.59 | 3.06 | 0.85 |
| (I-59) + 13.004 | 1:5 | 0.1 + 0.5-10 + 50 | 9.55 | 8.93 | 0.94 |
| (I-59) + 13.004 | 5:1 | 1 + 0.2-12 + 2.4 | 6.84 | 6.42 | 0.94 |
| (I-59) + 15.008 | 1:5 | 1 + 5-12 + 60 | 9.22 | 2.79 | 0.30 |
| (I-59) + 15.008 | 5:1 | 1 + 0.2-12 + 2.4 | 7.28 | 5.85 | 0.80 |
| (I-59) + 15.047 | 1:5 | 1 + 5-12 + 60 | 6.24 | 7.44 | 1.19 |
| (I-59) + 15.047 | 5:1 | 1 + 0.2-12 + 2.4 | 7.12 | 6.24 | 0.88 |

*found = experimentally measured value
**calc. = predicted value

1. An active compound combination comprising
(A) at least one triazole derivative of formula (I) 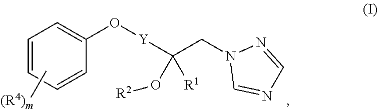
wherein
R¹ represents hydrogen, C₁-C₆-alkyl, C₂-C₆-alkenyl, C₂-C₆-alkynyl, C₃-C₈-cycloalkyl, C₃-C₈-cycloalkyl-C₁-C₄-alkyl, phenyl, phenyl-C₁-C₄-alkyl, phenyl-C₂-C₄-alkenyl or phenyl-C₂-C₄-alkynyl;
R² represents hydrogen, C₁-C₆-alkyl, C₂-C₆-alkenyl, C₂-C₆-alkynyl, C₃-C₈-cycloalkyl, C₃-C₈-cycloalkyl-C₁-C₄-alkyl, phenyl, phenyl-C₁-C₄-alkyl, phenyl-C₁-C₄-alkenyl or phenyl-C₂-C₄-alkynyl,
wherein the aliphatic moieties, excluding cycloalkyl moieties, of R¹ and/or R² may carry 1, 2, 3 or up to the maximum possible number of identical or different groups R^{a} which independently of one another are selected from halogen, CN, nitro, phenyl, C₁-C₄-alkoxy and C₁-C₄-halogenalkoxy, wherein the phenyl may be substituted by 1, 2, 3, 4 or 5 substituents selected from halogen, CN, nitro, C₁-C₄-alkyl, C₁-C₄-alkoxy, C₁-C₄-halogenalkyl, C₁-C₄-halogenalkoxy,
and wherein the cycloalkyl and/or phenyl moieties of R¹ and/or R² may carry 1, 2, 3, 4, 5 or up to the maximum number of identical or different groups R^{b} which independently of one another are selected from halogen, CN, nitro, C₁-C₄-alkyl, C₁-C₄-alkoxy, C₁-C₄-halogenalkyl and C₁-C₄-halogenalkoxy;
each R⁴ represents independently of one another halogen, CN, nitro, C₁-C₄-alkyl, C₁-C₄-halogenalkyl, C₁-C₄-alkoxy, C₁-C₄-halogenalkoxy, C₁-C₄-alkylcarbonyl, hydroxy-substituted C₁-C₄-alkyl or pentafluoro-λ⁶-sulfanyl;
m is an integer and is 0, 1, 2, 3, 4 or 5;
Y represents a 6-membered aromatic heterocycle containing 1 or 2 nitrogen atom(s) as heteroatom(s) selected from 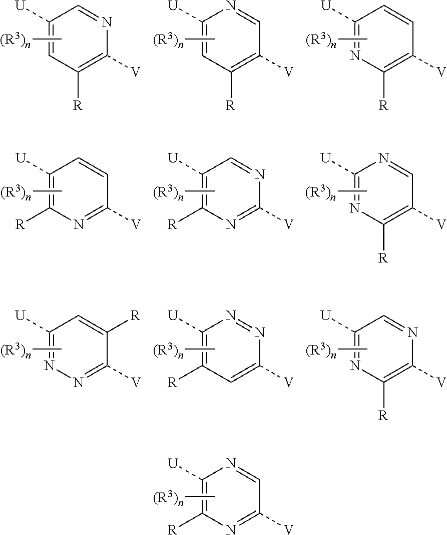
wherein Y is connected to the O of formula (I) via the bonds identified with “U” and Y is connected to the CR¹(OR²) moiety of formula (I) via the bonds identified with “V” and
wherein
R represents hydrogen, C₁-C₂-halogenalkyl, C₁-C₂-halogenalkoxy, C₁-C₂-alkylcarbonyl or halogen;
each R³ represents independently of one another halogen, CN, nitro, C₁-C₄-alkyl, C₁-C₄-halogenalkyl, C₁-C₄-alkoxy or C₁-C₄-halogenalkoxy;
n is an integer and is 0, 1 or 2;
or a salt or N-oxide thereof,
and
(B) at least one further active compound selected from the following groups
(1) inhibitors of the ergosterol synthesis,
(2) inhibitors of the respiratory chain at complex I or II,
(3) inhibitors of the respiratory chain at complex III,
(4) inhibitors of the mitosis and cell division,
(5) compounds capable of having a multisite action,
(6) compounds capable of inducing a host defense,
(7) inhibitors of the amino acid and/or protein biosynthesis,
(8) inhibitors of the ATP production,
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler,
(15) other fungicides.

2. The active compound combination according to claim 1, wherein the triazole derivative of formula (I) is a triazole derivative of formula (I), wherein
each R⁴ represents independently of one another halogen, CN, nitro, C₁-C₄-alkyl, C₁-C₄-halogenalkyl, C₁-C₄-alkoxy, C₁-C₄-halogenalkoxy or pentafluoro-λ⁶-sulfanyl;
and/or
R represents hydrogen, C₁-C₂-halogenalkyl or halogen,
or a salt or N-oxide thereof.

3. The active compound combination according to claim 1, wherein the triazole derivative of formula (I) is a triazole derivative of formula (I), wherein
Y represents a 6-membered aromatic heterocycle containing 1 or 2 nitrogen atom(s) as heteroatom(s) selected from 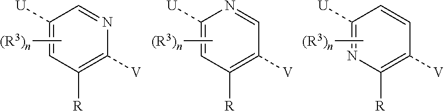
wherein Y is connected to the O of formula (I) via the bonds identified with “U” and Y is connected to the CR¹(OR²) moiety of formula (I) via the bonds identified with “V”,
or a salt or N-oxide thereof.

4. The active compound combination according to claim 1, wherein the triazole derivative of formula (I) is a triazole derivative of formula (I), wherein
R¹ represents hydrogen, C₁-C₄-alkyl, C₂-C₆-alkenyl, C₂-C₆-alkynyl, cyclopropyl, phenyl, benzyl, phenylethenyl or phenylethinyl;
R² represents hydrogen, C₁-C₄-alkyl, allyl, propargyl or benzyl,
wherein the aliphatic moieties, excluding cycloalkyl moieties, of R¹ and/or R² may carry 1, 2, 3 or up to the maximum possible number of identical or different groups R^{e} which independently of one another are selected from halogen, CN, nitro, phenyl, C₁-C₄-alkoxy and C₁-C₄-halogenalkoxy, wherein the phenyl may be substituted by 1, 2, 3, 4 or 5 substituents selected independently of one another from halogen; CN; nitro; C₁-C₄-alkyl; C₁-C₄-alkoxy; C₁-C₄-halogenalkyl; C₁-C₄-halogenalkoxy,
and wherein the cycloalkyl and/or phenyl moieties of R¹ and/or R² may carry 1, 2, 3, 4, 5 or up to the maximum number of identical or different groups R^{b} which independently of one another are selected from halogen, CN, nitro, C₁-C₄-alkyl, C₁-C₄-alkoxy, C₁-C₄-halogenalkyl and C₁-C₄-halogenalkoxy;
each R⁴ represents independently of one another CF₃, OCF₃, Br, Cl or pentafluoro-λ⁶-sulfanyl;
m is 1, 2 or 3;
Y represents 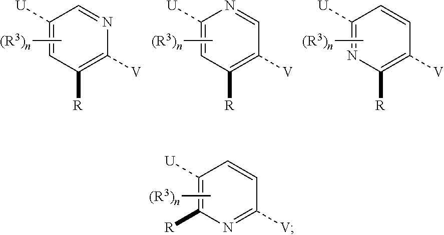
wherein Y is connected to the O of formula (I) via the bonds identified with “U” and Y is connected to the CR¹(OR²) moiety of formula (I) via the bonds identified with “V”
or a salt or N-oxide thereof.

5. The active compound combination according to claim 1, wherein the triazole derivative of formula (I) is a triazole derivative of formula (I), wherein
R¹ represents hydrogen, C₁-C₄-alkyl or cyclopropyl;
R² represents hydrogen;
R⁴ represents CF₃, OCF₃, Br, Cl or pentafluoro-λ⁶-sulfanyl;
m is 1;
Y represents 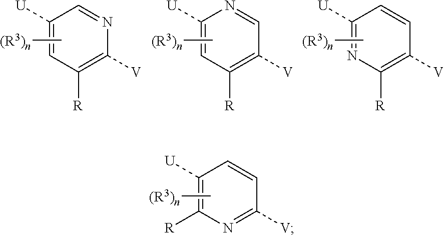
wherein Y is connected to the O of formula (I) via the bonds identified with “U” and Y is connected to the CR¹(OR²) moiety of formula (I) via the bonds identified with “V” and
R represents C₁-halogenalkyl;
n is 0;
or a salt or N-oxide thereof.

6. The active compound combination according to claim 1, wherein the triazole derivative of formula (I) is a triazole derivative of formula (I), wherein
R⁴ represents Cl or Br in the 4-position of the phenyl moiety of formula (I);
or a salt or N-oxide thereof.

7. The active combination according to claim 1, wherein the triazole derivative of formula (I) is selected from the group consisting of (I.01) 2-[6-(4-chlorophenoxy)-2-(trifluoromethyl)pyridin-3-yl]-1-(1H-1,2,4-triazol-1-yl)propan-2-ol, (I.59) 2-[6-(4-bromophenoxy)-2-(trifluoromethyl)pyridin-3-yl]-1-(1H-1,2,4-triazol-1-yl)propan-2-ol, (I.81) 1-[6-(4-bromophenoxy)-2-(trifluoromethyl)pyridin-3-yl]-1-cyclopropyl-2-(1H-1,2,4-triazol-1-yl)ethanol and (I.91) 1-[6-(4-chlorophenoxy)-2-(trifluoromethyl)pyridin-3-yl]-1-cyclopropyl-2-(1H-1,2,4-triazol-1-yl)ethanol.

8. The active compound combination according to claim 1, wherein the further active compound is selected from the group consisting of (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) Pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1 S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazole-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) 2-[4-(4-chlorophenoxy)-2-(trifluoromethyl)phenyl]-1-(1H-1,2,4-triazol-1-yl)propan-2-ol, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-fluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1 S)-1-(3,5-difluorophenyl)ethoxy]-2-methylpyridin-3-yl}-N-ethyl-N-methylimidoformamide, (1.078) N′-{5-bromo-6-[(cis-4-isopropycyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Mefentrifluconazole, (1.082) Ipfentrifluconazole, (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) 3-(difluoromethyl)-N-(7-fluoro-1,1,3-trimethyl-2,3-dihydro-1H-inden-4-yl)-1-methyl-1H-pyrazole-4-carboxamide, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1 S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile, (6.001) acibenzolar-S-methyl, (6.002) isotianil, (6.003) probenazole, (6.004) tiadinil, (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinolone, (8.001) silthiofam, (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one, (10.001) propamocarb, (10.002) propamocarb hydrochloride, (10.003) tolclofos-methyl, (11.001) tricyclazole, (11.002) 2,2,2-trifluoroethyl {3-methyl-1-[(4-methylbenzoyl)amino]butan-2-yl}carbamate, (12.001) benalaxyl, (12.002) benalaxyl-M (kiralaxyl), (12.003) metalaxyl, (12.004) metalaxyl-M (mefenoxam), (13.001) fludioxonil, (13.002) iprodione, (13.003) procymidone, (13.004) proquinazid, (13.005) quinoxyfen, (13.006) vinclozolin, (14.001) fluazinam, (14.002) meptyldinocap, (15.001) Abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) 2,6-dimethyl-1H,5H-[1,4]dithiino[2,3-c:5,6-c′]dipyrrole-1,3,5,7(2H,6H)-tetrone, (15.035) 2-[3,5-bis(difluoromethyl)-1H-pyrazol-1-yl]-1-[4-(4-{5-[2-(prop-2-yl}-1-yloxy)phenyl]-4,5-dihydro-1,2-oxazol-3-yl)-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) 2-{2-[(7,8-difluoro-2-methylquinolin-3-yl)oxy]-6-fluorophenyl}propan-2-ol, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) 3-(4,4-difluoro-3,3-dimethyl-3,4-dihydroisoquinolin-1-yl)quinoline, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, and (15.062) 5-fluoro-4-imino-3-methyl-1-[(4-methylphenyl)sulfonyl]-3,4-dihydropyrimidin-2(1H)-one.

9. The active compound combination according to claim 1, wherein the further active compound is selected from the group consisting of (1.012) ipconazole, (1.018) prothioconazole, (1.020) spiroxamine, (1.021) tebuconazole, (2.002) bixafen, (2.005) fluopyram, (2.017) penflufen, (2.027) 3-(difluoromethyl)-1-methyl-N-(1,1,3-trimethyl-2,3-dihydro-1H-inden-4-yl)-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide, (3.020) trifloxystrobin, (3.025) (3S,6S,7R,8R)-8-benzyl-3-[({3-[(isobutyryloxy)methoxy]-4-methoxypyridin-2-yl}carbonyl)-amino]-6-methyl-4,9-dioxo-1,5-dioxonan-7-yl 2-methylpropanoate, (4.005) pencycuron, (5.004) chlorothalonil, (5.013) mancozeb, (5.018) propineb, (12.003) metalaxyl, (12.004) metalaxyl-M (mefenoxam), (13.001) fludioxonil, (13.004) proquinazid, (15.008) cyflufenamid, and (15.047) 3-(4,4-difluoro-3,3-dimethyl-3,4-dihydroisoquinolin-1-yl)quinolone.

10. Composition for controlling one or more harmful microorganisms, optionally phytopathogenic harmful fungi, in crop protection and/Qr in protection of one or more materials, comprising a content of the active compound combination according to claim 1, in addition to at least one extender and/or surfactant.

11. Method for controlling one or more harmful microorganisms, phytopathogenic harmful fungi, in crop protection and/or in protection of one or more materials, comprising applying the active compound combination according to claim 1 or a composition thereof to the harmful microorganisms and/or a habitat thereof.

12. A product comprising an active compound combination according to claim 1 or a composition thereof for control of one or more harmful microorganisms, optionally phytopathogenic harmful fungi, in crop protection and/r in protection of one or more materials.

13. A product comprising an active compound combination according to claim 1 or a composition thereof for treatment of a transgenic plant.

14. A product comprising an active compound combination according to claim 1 or a composition thereof for treatment of seed, optionally seed of a transgenic plant.

15. Seed coated with the active compound combination according to claim 1 or a composition thereof.
